(19) United States
(12) Patent Application Publication
(10) Pub. No.: US 2026/0236423 A1
(43) Pub. Date: Aug. 13, 2026

(54) Cross-Domain Memory Infrastructure Between NVLink Networks and PCIe Fabrics via Protocol and Address Translations

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/632,309

(22) Filed: Mar. 29, 2026

Related U.S. Application Data
(63) Continuation-in-part of application No. 19/371,779, filed on Oct. 28, 2025, now Pat. No. 12,657,153.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

Training and inference of large-scale AI models, including large language models (LLMs), mixture-of-experts (MoE) models, multi-modal models, and diffusion models, require GPU clusters interconnected via NVLink to access memory, storage, and networking resources via PCIe, optionally including transferring model weights, key-value cache entries, and activation tensors. A computer, coupled between a first interface communicating according to an NVLink-based protocol with a first entity and a second interface communicating according to a PCIe protocol with a second entity, translates between NVLink-based PDUs and PCIe TLPs, including PCIe UIO TLPs. The translations may include translating physical addresses between address spaces associated with the respective protocols, translating between NVLink-based request types and PCIe TLP types, and translating identifier fields such as Tags, SourceIDs, DestinationIDs, and RequesterIDs. The computer may further translate between Flit Mode and Non-Flit Mode, and may be implemented as a semiconductor device, an active cable, or a chiplet.

### CROSS-REFERENCE TO RELATED APPLICATIONS

This Application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This Application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

NVLink is a high-bandwidth interconnect technology designed for communication among GPUs, accelerators, and switches in computing systems. NVLink utilizes Protocol Data Units (PDUs) that carry data, addresses, and identifiers between entities connected via NVLink links. NVLink-based systems may include NVLink switches that facilitate multi-entity communication within an NVLink fabric. NVLink PDUs may carry physical addresses associated with an NVLink-based address space.

Peripheral Component Interconnect Express (PCIe) is an interconnect technology that enables communication between hosts and devices in computing systems. PCIe specifications define Transaction Layer Packets (TLPs) that carry memory read requests, memory write requests, completions, and other transaction types across PCIe links. PCIe supports multiple data stream modes for encoding TLPs on the physical link. Non-Flit Mode (NFM) utilizes byte-level encoding with per-TLP CRC protection, while Flit Mode (FM) organizes data into fixed-size units with different encoding and error protection mechanisms. The data stream mode is determined during link training through negotiation between the agents at each end of the link.

Unordered Input/Output (UIO) is an optional capability defined in PCIe that introduces TLP types including UIO Memory Read (UIOMRd), UIO Memory Write (UIOMWr), and UIO Read Completion with Data (UIORdCplD). UIO TLPs are associated with UIO Virtual Channels and are defined for Flit Mode operation. UIO enables multi-path routing and may provide improved performance in fabric environments. PCIe specifications require that the entire path from requester to completer supports UIO and has UIO enabled.

Artificial intelligence (AI) workloads, including training and inference of large language models (LLMs), mixture-of-experts (MoE) models, multi-modal models, and diffusion models, place increasing demands on interconnect bandwidth and memory capacity in computing systems. These workloads may involve communication of model weights, key-value (KV) cache entries, activation tensors, and embedding tables between GPUs and memory resources.

### SUMMARY

Computing environments may incorporate entities that utilize different interconnect protocols while requiring coordinated access to shared resources. Entities communicating via NVLink may need to access resources coupled to entities communicating via PCIe, or vice versa. NVLink and PCIe may utilize different address spaces, different Protocol Data Unit formats, and different request and completion types. Some implementations provide methods and systems for translating between NVLink-based PDUs and PCIe TLPs, enabling interoperability between entities utilizing these different protocols.

In various implementations, a method comprises operating a computer coupled between a first interface that communicates according to an NVLink-based protocol with a first entity, and a second interface that communicates according to a PCIe protocol with a second entity; and translating, by the computer, between NVLink-based PDUs communicated via the first interface and PCIe TLPs communicated via the second interface, wherein the translating comprises translating physical addresses between a first address space associated with the NVLink-based protocol and a second address space associated with the PCIe protocol, and translating between NVLink-based request types and PCIe TLP types. The PCIe TLPs may include Memory Read (MRd) requests and Completions with Data (CplD). The computer may translate between Flit Mode (FM) and Non-Flit Mode (NFM) TLP formats. The PCIe TLPs may carry data payloads associated with AI workloads.

In other implementations, a system comprises a first interface configured to communicate according to an NVLink-based protocol with a first entity; a second interface configured to communicate according to a PCIe protocol with a second entity; and a computer coupled between the first and second interfaces, configured to translate between NVLink-based traffic communicated via the first interface and PCIe traffic communicated via the second interface, comprising translating physical addresses between a first address space associated with the NVLink-based protocol and a second address space associated with the PCIe protocol. The computer may be implemented in an IC package having a ball grid array layout and may reside within a cable module.

In yet other implementations, a method comprises operating a computer coupled between a first interface that communicates according to an NVLink-based protocol with a first entity, and a second interface that communicates according to a PCIe protocol with a second entity; and translating, by the computer, between NVLink-based PDUs communicated via the first interface and PCIe UIO TLPs communicated via the second interface. The translating may further comprise translating physical addresses between address spaces associated with the respective protocols. The PCIe UIO TLPs may be associated with a UIO Virtual Channel.

In still other implementations, a system comprises a first interface configured to communicate according to an NVLink-based protocol with a first entity; a second interface configured to communicate according to a PCIe protocol with a second entity; and a computer coupled between the first and second interfaces, configured to translate between NVLink-based traffic communicated via the first interface and PCIe UIO TLPs communicated via the second interface.

### BRIEF DESCRIPTION OF THE DRAWINGS

FIG. 1A illustrates an example of a system that translates between NVLink-based traffic and PCIe-based traffic;

FIG. 1B illustrates an example of a TFD demonstrating translations between an NVLink read request and a PCIe UIOMRd;

FIG. 1C illustrates an example of a TFD demonstrating translations between an NVLink read request and a PCIe MRd;

FIG. 2A illustrates an example of a cable comprising an RPU that translates between PCIe-based traffic and NVLink-based traffic;

FIG. 2B illustrates an example of a TFD demonstrating translations between PCIe-based requests and NVLink-based requests;

FIG. 3A illustrates an example of a memory switch configured to provide memory to its coupled entities;

FIG. 3B illustrates an example of a TFD demonstrating NVLink requests from entities to access memory;

FIG. 4A illustrates an example of a system that implements an NVLink-based switch, or an NVLink Memory Switch, utilizing a CHI-based interconnect;

FIG. 4B illustrates an example of a TFD demonstrating NVLink switching operation between entities through a switch interconnect;

FIG. 5A illustrates an example of a system comprising a processor comprising an NVLink-C2C interface;

FIG. 5B illustrates an example of a system comprising a CPU comprising an NVLink-C2C chiplet, such as NVLink Fusion;

FIG. 6A illustrates an example of a system comprising a CXL host coupled to a CXL device over two bridges that utilize an NVLink PHY;

FIG. 6B illustrates an example of a TFD depicting tunneling of CXL.io transactions between a host and a device through two bridges that utilize IEEE 802.3 and NVLink flits;

FIG. 7A illustrates an example of a system configured to enable CXL over NVLink, such as via CXL tunneling over NVLink;

FIG. 7B illustrates an example of a TFD demonstrating CXL communications over NVLink, such as CXL over NVLink, or CXL tunneling over NVLink;

FIG. 8A illustrates an example of a system configured to enable PCIe over NVLink, such as via PCIe tunneling over NVLink;

FIG. 8B illustrates an example of a TFD demonstrating PCIe UIO communications over NVLink, such as PCIe UIO over NVLink, or PCIe UIO tunneling over NVLink;

FIG. 9A illustrates an example of a processor comprising an NVLink interface, processing cores, LLCs, and a coherent interconnect;

FIG. 9B illustrates an example of a processor comprising NVLink interfaces and DDR channels;

FIG. 10A illustrates an example of a processor comprising an NVLink interface, processing cores, caches, and a coherent interconnect;

FIG. 10B illustrates an example of a TFD demonstrating translating an NVLink read request to a read transactions of a protocol utilized by a processor's coherent interconnect to access memory;

FIG. 11A illustrates an example of a system comprising a processor that includes an NVLink interface;

FIG. 11B illustrates an example of a TFD demonstrating two translations from NVLink-based traffic to traffic conforming to a protocol utilized by a processor's coherent interconnect;

FIG. 12A illustrates an example of a system that translates between NVLink-based traffic and ISoL traffic;

FIG. 12B illustrates an example of a TFD demonstrating translations between NVLink-based traffic and Intel UPI traffic;

FIG. 13A illustrates an example of a system that translates between CXL.mem and PCIe;

FIG. 13B illustrates an example of a transaction flow diagram (TFD) demonstrating translations between CXL.mem M2S request and PCIe MRd;

FIG. 13C illustrates an example of a TFD demonstrating translations between CXL.mem M2S request and PCIe UIOMRd;

FIG. 14A illustrates an example of a system comprising first and second entities coupled by a computer that translates between CXL.mem and PCIe;

FIG. 14B illustrates an example of a TFD demonstrating translations between CXL.mem M2S RwD and PCIe MWr;

FIG. 14C illustrates an example of a TFD demonstrating translations between CXL.mem M2S RwD and PCIe UIOMWr;

FIG. 15A illustrates an example of a system comprising a cable that translates between CXL-based traffic and PCIe-based traffic;

FIG. 15B illustrates an example of a TFD demonstrating translations performed by an active cable between CXL.mem transactions and PCIe transactions;

FIG. 16A illustrates an example of a system that translates between first and second PCIe-based protocols;

FIG. 16B illustrates an example of a TFD demonstrating translations between PCIe MRd and PCIe UIOMRd;

FIG. 16C illustrates an example of a TFD demonstrating translations between PCIe UIOMRd and PCIe MRd;

FIG. 17A illustrates an example of a system enabling an entity to access DRAM and other resources via a CXL device port and a coherent interconnect interface;

FIG. 17B illustrates an example of a TFD showing address translations between CXL.mem M2S Req MemRd and ARM CHI REQ ReadOnce;

FIG. 18A illustrates an example of a system comprising a CXL memory switch appliance comprising a CPU having processing cores and memory controllers;

FIG. 18B illustrates an example of a TFD depicting a multi-host memory access scenario wherein two entities access memory through a shared coherent interconnect infrastructure;

FIG. 19A illustrates an example of a system that translates between CXL-based traffic and PCIe-based traffic;

FIG. 19B illustrates an example of a TFD demonstrating translations between CXL.io UIOMRd and PCIe UIOMRd;

FIG. 19C illustrates an example of a TFD demonstrating translations between CXL.io UIOMRd and PCIe MRd;

FIG. 20A illustrates an example of a system that translates between CXL.io traffic;

FIG. 20B illustrates an example of a TFD demonstrating translations between CXL.io MRd and CXL.io UIOMRd;

FIG. 20C illustrates an example of a TFD demonstrating translations between CXL.io UIOMRd and CXL.io MRd;

FIG. 21A illustrates an example of a system comprising a processor comprising a CXL endpoint;

FIG. 21B illustrates an example of a TFD demonstrating translations between CXL.mem and CXL.cache messages;

FIG. 22A illustrates an example of a system comprising a processor comprising a CXL EP coupled to the processor's coherent interconnect via an ISoL interface;

FIG. 22B illustrates an example of a TFD demonstrating a translating a CXL.mem M2S Read request to an ISoL request;

FIG. 23A illustrates an example of a system comprising an entity, such as a processor or a node controller, configured to translate between CXL-based messages and ISoL messages;

FIG. 23B illustrates an example of a TFD demonstrating translations between CXL.mem and Intel UPI;

FIG. 24A illustrates an example of a system comprising a processor, a node controller, or a switch, which includes a CXL device, configured to translate between CXL-based traffic and ISoL traffic;

FIG. 24B illustrates an example of a TFD demonstrating translations between CXL.mem and UPI, including translating error and data corruption indications, such as poison;

FIG. 25A illustrates an example of a system comprising a processor or an RPU, configured to translate between CXL-based traffic and ISoL traffic;

FIG. 25B illustrates an example of a TFD demonstrating translations between CXL.mem messages and ISoL messages;

FIG. 26A illustrates an example of GPU/CPU coupled to an xPU comprising dies coupled by chip-to-chip interfaces;

FIG. 26B illustrates an example of a custom accelerator comprising an NVLink Fusion chiplet;

FIG. 27A illustrates an example of a system that translates between NVLink-based traffic and CHI-based coherent interconnect traffic;

FIG. 27B illustrates an example of a TFD showing the translation of NVLink read request to CHI ReadOnce request;

FIG. 28A illustrates an example of a system that translates between NVLink-based traffic and ARM CHI traffic;

FIG. 28B illustrates an example of an RPU that translates between NVLink traffic and CHI traffic, utilizing an intermediate protocol based on ARM AMBA ACE-Lite;

FIG. 29A illustrates an example of a system that translates between NVLink traffic and CHI-based traffic;

FIG. 29B illustrates an example of an RPU that translates between NVLink traffic and CHI traffic;

FIG. 30A illustrates an example of a TFD showing translating an NVLink read request to a PCIe UIO read request to an ARM CHI ReadOnce request;

FIG. 30B illustrates an example of a TFD showing translating an NVLink read request to a CXL.cache RdCurr request to an ARM CHI ReadOnce request;

FIG. 31A illustrates an example of a system comprising an external entity coupled to an optional NVLink switch coupled to a processor comprising an RPU comprising an NVLink interface, a Request Agent (RA) Proxy, and a Home Agent (HA) Proxy;

FIG. 31B illustrates an example of a system comprising a processor comprising NVLink chiplets (such as NVLink Fusion) to translate between NVLink and CHI;

FIG. 32A illustrates an example of a system comprising an xPU comprising an RPU that translates between NVLink traffic and CHI traffic;

FIG. 32B illustrates an example of a system comprising an entity including NVLink and CXL ports coupled to CHI interfaces that enable memory access via a processor's coherent interconnect;

FIG. 33A illustrates an example of a system comprising a processor comprising an NVLink chiplet coupled via NVLink-C2C to the processor's coherent interconnect;

FIG. 33B illustrates an example of a system comprising an xPU coupled to a GPU utilizing an RPU that translates between NVLink traffic and CHI-based traffic;

FIG. 34A illustrates an example of a system functioning as a multi-protocol memory switch appliance or a multi-protocol memory pool comprising NVLink-based interfaces;

FIG. 34B illustrates an example of a TFD depicting a multi-entity memory access scenario wherein separate NVLink and UALink transactions utilize the same coherent interconnect infrastructure for memory access;

FIG. 35 illustrates an example of a heterogeneous computing system comprising an NVLink chiplet coupled to an accelerator based on ARM mesh architecture;

FIG. 36A illustrates an example of a system that may function as an NVLink memory switch appliance or an NVLink memory pool;

FIG. 36B illustrates an example of a TFD depicting a multi-entity memory access scenario wherein GPUs access memory mapped to physical address spaces through NVLink to ARM CHI translations;

FIG. 37A illustrates an example of a system that translates between NVLink-based traffic and CXL-based traffic;

FIG. 37B illustrates an example of a TFD demonstrating translations between an NVLink request and a CXL.io request;

FIG. 38A illustrates an example of a system that translates between NVLink-based traffic and CXL-based traffic;

FIG. 38B illustrates an example of a TFD demonstrating translations between NVLink-based read requests and CXL.io UIO TLPs;

FIG. 38C illustrates an example of a TFD demonstrating translations between NVLink-based read requests and CXL.io MRd TLPs;

FIG. 39A illustrates an example of a system comprising a computer configured to translate between CXL.io traffic and NVLink-based traffic;

FIG. 39B illustrates an example of a TFD demonstrating translations between CXL.io read requests and NVLink-based read requests;

FIG. 40A illustrates an example of a system comprising an apparatus that translates between NVLink-based traffic and CXL.mem traffic;

FIG. 40B illustrates an example of a TFD demonstrating translations between NVLink-based traffic and CXL.mem traffic;

FIG. 41A illustrates an example of a system, comprising an RPU having an NVLink interface, which enables a GPU to access resources coupled to the RPU over CXL.mem;

FIG. 41B illustrates an example of a TFD demonstrating translations between an NVLink-based protocol and CXL.mem utilized for communicating with a CXL device or CXL memory;

FIG. 41C illustrates an example of a TFD demonstrating translations between NVLink-based requests and CXL.mem requests;

FIG. 42A illustrates an example of a system that translates between an NVLink-based protocol and a CXL protocol;

FIG. 42B illustrates an example of a system comprising an RPU in an NVLink switch or NVSwitch, coupled to NVLink and CXL.mem entities;

FIG. 42C illustrates an example of a system comprising an xPU with an NVLink Fusion chiplet;

FIG. 43A illustrates an example of a system comprising a processor including a coherent interconnect and an NVLink interface;

FIG. 43B illustrates an example of a TFD demonstrating two NVLink read requests forwarded to different memories via a coherent interconnect;

FIG. 44A illustrates an example of a system comprising a processor comprising an NVLink interface and a CXL RP;

FIG. 44B illustrates an example of a TFD demonstrating translating a first NVLink request to a coherent interconnect protocol, and translating a second NVLink read request to a CXL.mem M2S MemRd request;

FIG. 45A illustrates an example of a processing pipeline for extracting passenger protocol messages from carrier protocol communications received over a PHY based on IEEE 802.3 PMA;

FIG. 45B illustrates an example of a packet structure that may be suitable for L3 switching operations;

FIG. 45C illustrates an example of a packet structure that may be suitable for L2 switching operations; and

FIG. 46A, FIG. 46B, and FIG. 46C illustrate three examples of variations for the Passenger Protocol PDU that may be encapsulated within the Carrier Protocol PDU illustrated in FIG. 45B.

### DETAILED DESCRIPTION

In heterogeneous computing architectures, entities may communicate using different interconnect protocols while requiring coordinated access to shared resources. NVLink is a high-bandwidth interconnect technology utilized for communication among GPUs, accelerators, and switches, while PCIe is an interconnect technology utilized for communication between hosts and devices. NVLink-based PDUs utilize an NVLink-based address space, whereas PCIe TLPs utilize a PCIe address space, such as a Host Physical Address (HPA) space. In environments where a first entity communicating via NVLink needs to access resources coupled to a second entity communicating via PCIe, or vice versa, translations between NVLink-based PDUs and PCIe TLPs may facilitate memory operations and data transfers across the different protocol domains. Such translations may be performed by a computer, an apparatus, a cable, or other suitable devices positioned between the first entity and the second entity. The translations may include translating physical addresses between the NVLink-based address space and the PCIe address space, translating between NVLink-based request types and PCIe TLP types, and translating identifier fields such as Tags, SourceIDs, DestinationIDs, and RequesterIDs. The translations may support AI workloads, such as training and inference of large language models (LLMs), mixture-of-experts (MoE) models, multi-modal models, and diffusion models, which may involve transferring model weights, key-value (KV) cache entries, activation tensors, and embedding tables between NVLink-connected entities and PCIe-connected resources.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe Transaction Layer Packets (TLPs) communicated via the second interface, wherein the translating comprises: translating physical addresses between a first address space associated with the NVLink-based protocol and a second address space associated with the PCIe protocol; and translating between NVLink-based request types and PCIe TLP types. The computer may be implemented as a semiconductor device, an integrated circuit (IC), a chiplet, an active cable, a switch, or another suitable device positioned between the first entity and the second entity. The first address space may include an NVLink-based network address space or a GPU physical address space, and the second address space may include an HPA space or another PCIe memory address space. The computer may maintain address translation tables, such as Link TLBs or address mapping tables, to translate between addresses in the first and second address spaces. The translating may be bidirectional: in one direction, the computer may translate NVLink-based PDUs received from the first entity to PCIe TLPs sent to the second entity; in the opposite direction, the computer may translate PCIe TLPs received from the second entity to NVLink-based PDUs sent to the first entity. The NVLink-based request types may include NVLink read requests and NVLink write requests, and the PCIe TLP types may include Memory Read (MRd) requests, Memory Write (MWr) requests, and Completions. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity, the NVLink-based request comprising a first address in the first address space; wherein the PCIe TLPs comprise a PCIe Memory Read (MRd) request comprising a second address in the second address space; and wherein the translating further comprises translating the NVLink-based request to the PCIe MRd and sending the PCIe MRd to the second entity via the second interface. The NVLink-based request may be an NVLink read request carrying a GPU physical address or an NVLink-based network address. The computer may translate this address to an HPA or another address within the PCIe memory address space. The computer may further translate NVLink Tags or transaction identifiers to PCIe Tags for tracking the transaction.

In some implementations of the method, the PCIe TLPs further comprise a PCIe Completion with Data (CplD) from the second entity, the PCIe CplD comprising a data payload corresponding to the PCIe MRd; and wherein the translating further comprises translating the PCIe CplD to an NVLink-based response comprising the data payload. The computer may correlate the PCIe CplD with the previously sent PCIe MRd using the PCIe Tag, and may translate the PCIe Tag back to the corresponding NVLink Tag or transaction identifier. The data payload may be forwarded from the PCIe CplD into the NVLink-based response without modification.

In some implementations of the method, the PCIe TLPs comprise a PCIe Memory Read (MRd) request from the second entity, the PCIe MRd comprising a first address in the second address space; wherein the NVLink-based PDUs comprise an NVLink-based request comprising a second address in the first address space; and wherein the translating further comprises translating the PCIe MRd to the NVLink-based request and sending the NVLink-based request to the first entity via the first interface. In the opposite direction, the second entity may initiate a PCIe MRd targeting a resource accessible via the NVLink fabric. The computer may translate the PCIe address, such as an HPA, to an NVLink-based address, and may generate NVLink identifier fields such as SourceID and DestinationID that are not present in the PCIe domain. The computer may further translate the PCIe Tag to an NVLink Tag for transaction tracking.

In some implementations of the method, the NVLink-based PDUs further comprise an NVLink-based response from the first entity, the NVLink-based response comprising a data payload; and wherein the translating further comprises translating the NVLink-based response to a PCIe Completion with Data (CplD) comprising the data payload. The computer may translate the NVLink Tag back to the PCIe Tag of the original MRd and may generate PCIe completion header fields such as CompleterID and RequesterID. The data payload may be forwarded from the NVLink response into the PCIe CplD.

In some implementations of the method, the PCIe MRd further comprises a RequesterID, and wherein the PCIe CplD further comprises a CompleterID and the RequesterID, and wherein the computer generates the CompleterID for the PCIe CplD. The CompleterID may identify the computer as the PCIe Completer for the transaction. The RequesterID may be reflected from the original PCIe MRd to enable correct routing of the CplD back to the originating entity. These identifiers may be set during enumeration or initialization phases.

In some implementations of the method, the PCIe MRd further comprises a RequesterID and a first Tag, and wherein the NVLink-based request further comprises a SourceID, a DestinationID, and a second Tag; and wherein translating the PCIe MRd to the NVLink-based request comprises generating the SourceID and the DestinationID, and translating the first Tag to the second Tag. The PCIe domain utilizes RequesterID (Bus/Device/Function) for identifying the requester, whereas the NVLink domain utilizes separate SourceID and DestinationID fields for routing. The computer may generate the SourceID based on its own NVLink identity, and the DestinationID based on the target entity in the NVLink fabric. The computer may maintain a Tag mapping table to translate between PCIe Tags and NVLink Tags and to correlate responses with their corresponding requests.

In some implementations of the method, the PCIe TLPs communicated via the second interface utilize a Flit Mode (FM) format, and wherein the first entity comprises a GPU or an accelerator, and the second entity comprises a PCIe host or a PCIe device. Flit Mode may be supported by PCIe Revision 6.0 and above, and may provide increased bandwidth efficiency and support for 14-bit Tags. The second entity may be a PCIe host, such as a CPU or a Root Complex, or a PCIe device, such as an NVMe SSD, a network interface card (NIC), or a memory controller.

In some implementations of the method, the computer translates between Flit Mode (FM) and Non-Flit Mode (NFM) TLP formats for the PCIe TLPs communicated via the second interface, and wherein the NVLink-based PDUs carry data associated with an artificial intelligence (AI) model comprising at least one of: a large language model (LLM), a mixture-of-experts (MoE) model, a multi-modal model, or a diffusion model. When the second interface operates in a different data stream mode than an adjacent PCIe link segment, the computer may translate between FM and NFM TLP formats, including adapting header formats, Tag widths, and encoding mechanisms. LLMs may include transformer-based architectures, MoE models may route inputs to subsets of expert sub-networks, multi-modal models may process inputs across text, image, and video modalities, and diffusion models may generate content through iterative denoising.

In some implementations of the method, the PCIe TLPs carry a data payload not exceeding 64 Double Words (DWs), and wherein the computer translates an NVLink-based PDU to multiple PCIe TLPs. The 64 DW ceiling (256 bytes) may correspond to a maximum payload size supported by the NVLink-based protocol, which may be imposed on the PCIe domain. When an NVLink request targets a data block that exceeds the PCIe Maximum Payload Size or requires multiple completions, the computer may split the request into smaller PCIe TLPs and may reassemble the returned data before translating it back to the NVLink domain.

In some implementations of the method, at least one physical address within the second address space, which is a PCIe memory address space, is not mapped to an NVLink address in the first address space, and wherein the NVLink-based PDUs and the PCIe TLPs carry data associated with an artificial intelligence (AI) workload, the data comprising at least one of: model weights, key-value (KV) cache entries, activation tensors, or embedding tables. The computer may expose only a subset of the PCIe memory address space to the NVLink domain. Unmapped PCIe addresses may correspond to configuration registers, management interfaces, or memory regions reserved for local use by the second entity. KV cache entries may be utilized during autoregressive inference, activation tensors may represent intermediate computation results, and embedding tables may map discrete tokens to continuous vector representations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system translates between NVLink-based traffic and PCIe traffic. The system may support various form factors, including semiconductor devices packaged in retimer-compatible BGA layouts, active cables with optical or copper physical media, and chiplet-based implementations. The system may further include NVLink switches or PCIe switches positioned between the interfaces and the respective entities, enabling multi-entity topologies. The system may be deployed in datacenters, high-performance computing (HPC) environments, or AI/ML training and inference clusters, where NVLink-connected accelerators/GPUs need to access PCIe-attached resources such as host memory, NVMe storage, or network interface cards.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe traffic communicated via the second interface, comprising translating physical addresses between a first address space associated with the NVLink-based protocol and a second address space associated with the PCIe protocol. The system may be deployed in environments where NVLink-connected entities, such as GPUs, accelerators, or NVLink switches, need to access resources coupled to PCIe-connected entities, such as PCIe hosts, NVMe SSDs, or network interface cards. The computer may be implemented as a semiconductor device comprising translation logic, address mapping tables, and pending transaction trackers. The first and second interfaces may support different link speeds, lane widths, and signaling technologies. The system may support bidirectional translation, wherein in one direction the computer translates NVLink-based traffic to PCIe traffic, and in the opposite direction the computer translates PCIe traffic to NVLink-based traffic. Optional switches may be positioned between the first interface and the first entity, and between the second interface and the second entity, to support multi-entity topologies.

In some implementations of the system, the computer is implemented in an IC package having differential input/output (I/O) balls positioned according to a ball grid array (BGA) layout, and wherein the system further comprises a cable including a first module and a second module coupled by a physical medium, the computer residing within the first module or the second module. The BGA layout may conform to a retimer specification, such as the PCIe 5.0, 6.0, or 7.0 Retimer Supplemental Features and Standard BGA Footprint Specification. The physical medium may include a copper wire, a twinaxial cable, a multimode fiber (MMF), or a single-mode fiber (SMF). The cable may be implemented as an Active Optical Cable (AOC) or an Active Copper Cable (ACC).

In some implementations of the system, the computer comprises an NVLink Fusion chiplet, and wherein an NVLink switch is coupled between the first interface and the first entity. The NVLink Fusion chiplet may integrate the translation logic, address mapping functionality, and NVLink interface within a chiplet package. The NVLink switch may enable multi-entity connectivity, allowing multiple accelerators (e.g., GPUs) to access PCIe resources through the same computer. The NVLink Fusion chiplet may be a component of an RPU within an active cable or a discrete semiconductor device.

In some implementations of the system, the second interface operates in Flit Mode (FM), and wherein the NVLink-based traffic and the PCIe traffic carry data associated with an artificial intelligence (AI) workload comprising at least one of: model training, model inference, or model fine-tuning. Flit Mode operation on the second interface may provide increased bandwidth efficiency and support for 14-bit Tags and UIO capabilities. Model training may involve distributing gradient computations and model parameters across NVLink-connected GPUs while accessing datasets stored on PCIe-attached storage. Model inference may involve transferring model weights and KV cache entries between memory tiers. Model fine-tuning may involve adapting pre-trained model parameters using task-specific data.

In some implementations, the translations between NVLink-based traffic and PCIe traffic may involve PCIe Unordered I/O (UIO) TLPs. UIO is an optional capability defined in PCIe that introduces TLP types associated with UIO Virtual Channels, including UIO Memory Read (UIOMRd) and UIO Read Completion with Data (UIORdCplD). UIO enables multi-path routing and may provide improved performance in fabric environments. In environments where a first entity communicating via NVLink needs to access resources coupled to a second entity via PCIe UIO, or vice versa, translations between NVLink-based PDUs and PCIe UIO TLPs may facilitate memory operations and data transfers. UIO TLPs are defined for Flit Mode and are associated with dedicated UIO Virtual Channels. The translations between NVLink-based PDUs and PCIe UIO TLPs may involve translating between NVLink identifier fields, such as SourceID and DestinationID, and PCIe UIO identifier fields, such as RequesterID and DestinationBDF/BF. The translations may support AI workloads such as training and inference of LLMs, MoE models, and multi-modal models.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe UIO Transaction Layer Packets (TLPs) communicated via the second interface. The computer may be implemented as a semiconductor device, an IC, a chiplet, an active cable, a switch, or another suitable device positioned between the first entity and the second entity. PCIe UIO TLPs are distinct from standard PCIe TLPs and are associated with UIO Virtual Channels. The method may be bidirectional: in one direction, the computer may translate NVLink-based PDUs received from the first entity to PCIe UIO TLPs sent to the second entity; in the opposite direction, the computer may translate PCIe UIO TLPs received from the second entity to NVLink-based PDUs sent to the first entity. The translating may include opcode translations, Tag translations, address translations, and identifier translations between the NVLink-based domain and the PCIe UIO domain. The PCIe UIO TLPs may include UIOMRd, UIOMWr, UIORdCplD, UIORdCpl, and UIOWrCpl. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity; wherein the PCIe UIO TLPs comprise a PCIe UIO Memory Read (UIOMRd) request; and wherein the translating further comprises translating the NVLink-based request to the PCIe UIOMRd and sending the PCIe UIOMRd to the second entity via the second interface. The NVLink-based request may be an NVLink read request comprising a physical address and a Tag or transaction identifier. The computer may translate the NVLink-based request to a PCIe UIOMRd carrying a translated address and a PCIe Tag. The UIOMRd may utilize a UIO Virtual Channel for transmission to the second entity.

In some implementations of the method, the PCIe UIO TLPs further comprise a PCIe UIO Read Completion with Data (UIORdCplD) from the second entity, the UIORdCplD comprising a data payload; and wherein the translating further comprises translating the UIORdCplD to an NVLink-based response comprising the data payload. The computer may correlate the UIORdCplD with the previously sent UIOMRd using the PCIe Tag, and may translate the response back to the NVLink domain. UIO completions may be received in any order by the requester, and the computer may handle out-of-order completions when reassembling data for the NVLink response.

In some implementations of the method, the PCIe UIO TLPs comprise a PCIe UIO Memory Read (UIOMRd) request from the second entity; wherein the NVLink-based PDUs comprise an NVLink-based request; and wherein the translating further comprises translating the UIOMRd to the NVLink-based request and sending the NVLink-based request to the first entity via the first interface. In the opposite direction, the second entity may initiate a PCIe UIOMRd targeting a resource accessible via the NVLink fabric. The computer may translate the UIOMRd to an NVLink-based request, generating NVLink SourceID and DestinationID fields and translating the PCIe Tag to an NVLink Tag. The UIOMRd may carry a RequesterID that the computer may store for generating the corresponding UIORdCplD.

In some implementations of the method, the NVLink-based PDUs further comprise an NVLink-based response from the first entity, the NVLink-based response comprising a data payload; and wherein the translating further comprises translating the NVLink-based response to a PCIe UIO Read Completion with Data (UIORdCplD) comprising the data payload. The computer may generate PCIe UIO completion header fields, such as CompleterID and DestinationBDF/BF, when constructing the UIORdCplD. The DestinationBDF/BF may correspond to the RequesterID of the originating UIOMRd. The data payload may be forwarded from the NVLink response into the UIORdCplD.

In some implementations of the method, the translating further comprises translating physical addresses between a first address space associated with the NVLink-based protocol and a second address space associated with the PCIe protocol. The address translation for UIO transactions may utilize the same address mapping tables or Link TLBs as standard PCIe translations. The first address space may include an NVLink-based network address space, and the second address space may include a PCIe memory address space. The address translation may be applied in both directions.

In some implementations of the method, the PCIe UIO TLPs carry a data payload not exceeding 64 Double Words (DWs), wherein the PCIe UIO TLPs are associated with a UIO Virtual Channel, and wherein the NVLink-based PDUs carry data associated with an artificial intelligence (AI) model comprising at least one of: a large language model (LLM), a mixture-of-experts (MoE) model, or a multi-modal model. The 64 DW ceiling (256 bytes) may correspond to a maximum payload size supported by the NVLink-based protocol. UIO TLPs may only be transmitted on Virtual Channels configured for UIO. The first UIO Virtual Channel may be VC2, and a second UIO Virtual Channel, if supported, may be VC4. LLMs may generate token sequences using autoregressive decoding, MoE models may route tokens to specialized expert sub-networks, and multi-modal models may fuse representations across text, image, and video inputs.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

In some implementations, translations between NVLink-based traffic and PCIe UIO TLPs may be implemented as a system comprising interfaces and a computer. The system may support PCIe UIO transactions that enable multi-path routing and out-of-order completions, providing performance benefits for fabric-based deployments. The system may be deployed in environments where NVLink-connected accelerators/GPUs need to access PCIe UIO-capable resources, or where PCIe UIO-capable entities need to access resources accessible via the NVLink fabric.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe UIO Transaction Layer Packets (TLPs) communicated via the second interface. The system may be deployed in environments where NVLink-connected entities need to access PCIe UIO-capable resources, or vice versa. The computer may translate between NVLink-based PDUs and PCIe UIO TLPs, including UIOMRd, UIOMWr, and UIORdCplD. The system may support bidirectional translation: in one direction the computer translates NVLink-based traffic to PCIe UIO TLPs, and in the opposite direction the computer translates PCIe UIO TLPs to NVLink-based traffic. The second interface may operate in Flit Mode, as UIO TLPs are defined for Flit Mode. The system may be implemented in various form factors, including semiconductor devices, active cables, chiplets, and switches.

In some implementations of the system, at least one physical address within a PCIe memory address space is not mapped to an NVLink address, and wherein the first entity comprises a GPU, a CPU, or an accelerator, and the second entity comprises a PCIe host or a PCIe device. The partial address space exposure may allow the system to selectively map only certain PCIe memory regions to the NVLink domain. The first entity may be a GPU, a CPU, or an accelerator connected via NVLink. The second entity may be a PCIe host, such as a CPU comprising a Root Complex, or a PCIe device, such as an NVMe SSD or a network interface card.

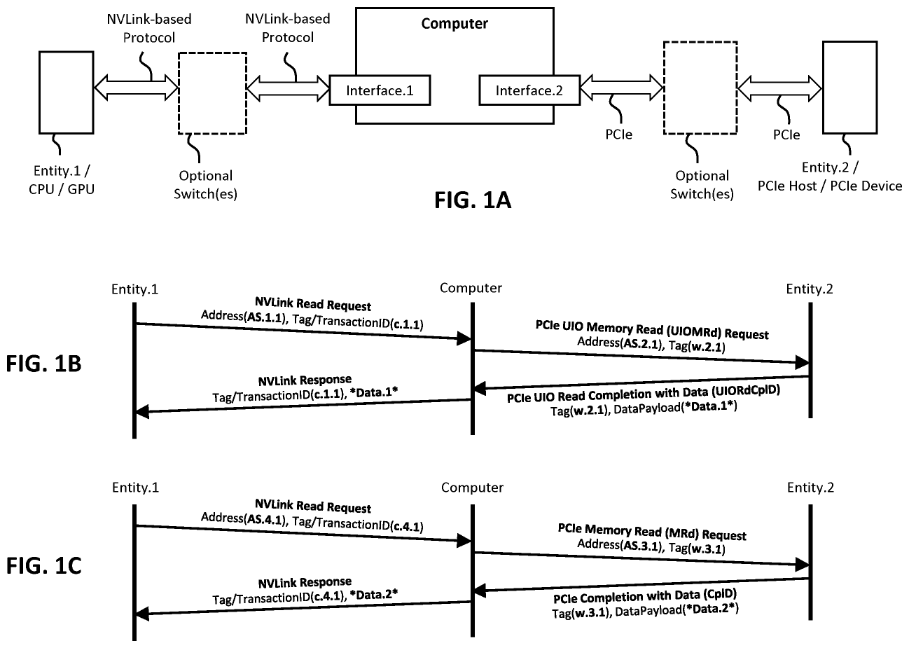

FIG. 1A illustrates an example of a system comprising a computer, which may be referred to as a semiconductor device, coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a PCIe-based protocol with a second entity (Entity.2), which may be a PCIe host or a PCIe device. The first interface may communicate bidirectionally with the first entity using the NVLink-based protocol. The second interface may communicate bidirectionally with the second entity using PCIe. The computer may be implemented in an IC package having high-speed differential I/O balls positioned according to a ball grid array (BGA) layout defined by a retimer specification, such as the PCIe 5.0, 6.0, or 7.0 Retimer Supplemental Features and Standard BGA Footprint Specification. The computer may translate between NVLink-based traffic communicated via the first interface and PCIe traffic communicated via the second interface, including translating physical addresses between a first address space associated with the NVLink-based protocol and a second address space associated with the PCIe protocol. Optional switch(es) may be positioned between the first interface and the first entity. Similarly, optional switch(es) may be positioned between the second interface and the second entity. The system may support bidirectional translation, wherein the computer may translate NVLink-based traffic to PCIe traffic in one direction, and may translate PCIe traffic to NVLink-based traffic in the opposite direction.

FIG. 1B illustrates an example of a TFD demonstrating translations, in one direction, between NVLink-based requests, such as NVLink read requests, received from a first entity (Entity.1), which may be a CPU or a GPU, and PCIe UIO TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address Address(AS.1.1), such as a GPU physical address or an NVLink-based network address, and Tag/TransactionID(c.1.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe UIO Memory Read (UIOMRd) request comprising Address(AS.2.1) and Tag(w.2.1), and may send the PCIe UIOMRd to the second entity. Upon receiving a completion from the second entity, which may include a PCIe UIO Read Completion with Data (UIORdCplD) comprising Tag(w.2.1) and DataPayload(*Data.1*), the computer may translate the PCIe UIORdCplD to an NVLink response comprising Tag/TransactionID(c.1.1) and *Data.1*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe UIO memory read requests in response to receiving an NVLink request from the first entity, such as when splitting an NVLink request for a large block of data to smaller PCIe UIO memory read requests, or when prefetching data from the second entity. The computer may translate NVLink-based traffic to PCIe UIO traffic in one direction, and/or may translate PCIe UIO traffic to NVLink-based traffic in the opposite direction.

FIG. 1C illustrates an example of a TFD demonstrating translations, in one direction, between NVLink-based requests, such as NVLink read requests, received from a first entity (Entity.1), which may be a CPU or a GPU, and PCIe TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.4.1), and Tag/TransactionID(c.4.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe request, such as a PCIe Memory Read (MRd) request comprising a physical address, such as an HPA Address(AS.3.1), and Tag(w.3.1), and may send the PCIe MRd to the second entity. Upon receiving a completion from the second entity, which may include a PCIe Completion with Data (CplD) comprising Tag(w.3.1) and DataPayload(*Data.2*), the computer may translate the PCIe CplD to an NVLink response comprising Tag/TransactionID(c.4.1) and *Data.2*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe memory read requests in response to receiving an NVLink request from the first entity, such as when splitting an NVLink request for a large block of data to smaller PCIe memory read requests, or when prefetching data from the second entity. The computer may translate NVLink-based traffic to PCIe traffic in one direction, and/or may translate PCIe traffic to NVLink-based traffic in the opposite direction.

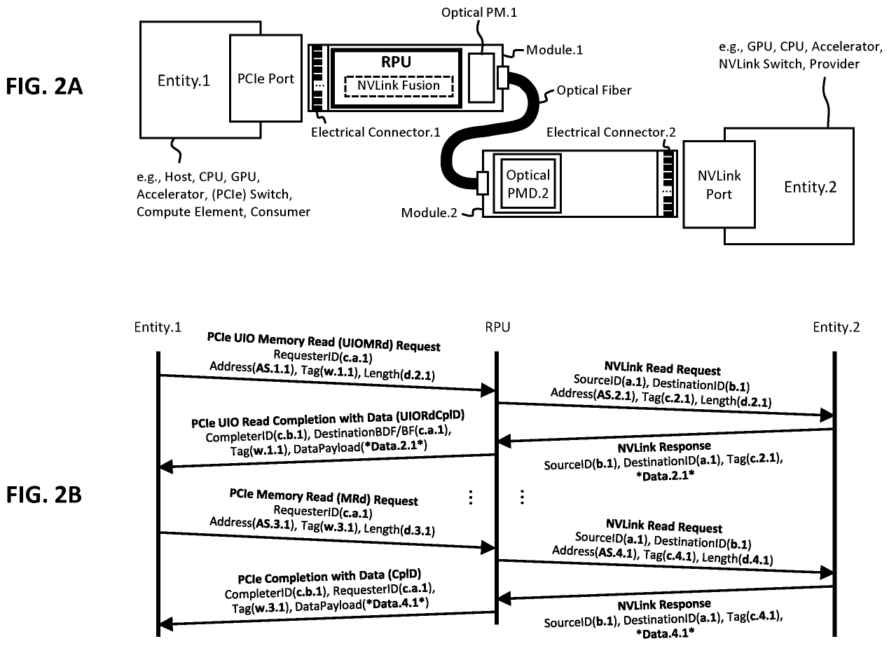

FIG. 2A illustrates an example of a cable comprising an RPU that translates between PCIe-based traffic and NVLink-based traffic. A first entity (Entity.1), which may be a host, a CPU, a GPU, an accelerator, a PCIe switch, or a compute element, and which may be referred to as a consumer, is coupled to a PCIe Port. The PCIe Port is coupled via a first electrical connector (Electrical Connector.1) to a first module (Module.1) within the cable. Module.1 may include an RPU, wherein the RPU may include an NVLink Fusion chiplet shown as an optional component, and an optical physical medium dependent (Optical PMD.1). The RPU within Module.1 may translate between PCIe-based traffic received from the first entity via the PCIe Port and NVLink-based traffic for transmission over the cable, and may translate between NVLink-based traffic received over the cable and PCIe-based traffic sent to the first entity. The cable may further include an optical fiber coupling Module.1 to a second module (Module.2), wherein the optical fiber carries NVLink-based traffic between the modules. Module.2 may include an optical physical medium dependent (Optical PMD.2). Module.2 is coupled via a second electrical connector (Electrical Connector.2) to an NVLink Port of a second entity (Entity.2), which may be a GPU, a CPU, an accelerator, or an NVLink switch, and which may be referred to as a provider. Placing the RPU in Module.1, closer to the PCIe Port, facilitates the translation from PCIe signaling to NVLink signaling at the entry point of the cable, such that the optical fiber carries NVLink-based traffic rather than PCIe-based traffic. NVLink may incorporate electrical signaling characteristics that are compatible with longer-reach interconnects, and may utilize a signaling rate higher than PCIe, and may therefore require fewer lanes for the same bandwidth. Consequently, placing the RPU closer to the PCIe Port may allow for reducing the number of optical fibers or optical wavelengths, which may simplify the cable design and reduce cost. In other examples, the RPU may reside in Module.2 instead of Module.1.

FIG. 2B illustrates an example of a TFD demonstrating translations, by an RPU, between PCIe-based requests received from a first entity (Entity.1) and NVLink-based requests sent to a second entity (Entity.2). The TFD illustrates two exemplary transactions, separated by a vertical ellipsis, demonstrating both PCIe UIO and standard PCIe paths. In a first exemplary transaction, the first entity may send a PCIe UIO Memory Read (UIOMRd) request comprising RequesterID(c.a.1), Address(AS.1.1), Tag(w.1.1), and Length(d.2.1). The RPU may translate the PCIe UIOMRd to an NVLink read request comprising SourceID(b.1), DestinationID(a.1), Address(AS.2.1), Tag(c.2.1), and Length(d.2.1), and may send the NVLink read request to the second entity. Upon receiving an NVLink response from the second entity comprising SourceID(b.1), DestinationID(a.1), Tag(c.2.1), and *Data.2.1*, the RPU may translate the NVLink response to a PCIe UIO Read Completion with Data (UIORdCplD) comprising CompleterID(c.b.1), DestinationBDF/BF(c.a.1), Tag(w.1.1), and DataPayload(*Data.2.1*), and may send the PCIe UIORdCplD to the first entity. The DestinationBDF/BF field in the UIORdCplD may correspond to the RequesterID of the originating UIOMRd, facilitating routing of the completion back to the requester.

In a second exemplary transaction, the first entity may send a PCIe Memory Read (MRd) request comprising RequesterID(c.a.1), Address(AS.3.1), Tag(w.3.1), and Length(d.3.1). The RPU may translate the PCIe MRd to an NVLink read request comprising SourceID(a.1), DestinationID(b.1), Address(AS.4.1), Tag(c.4.1), and Length(d.4.1), and may send the NVLink read request to the second entity. Upon receiving an NVLink response from the second entity comprising SourceID(b.1), DestinationID(a.1), Tag(c.4.1), and *Data.4.1*, the RPU may translate the NVLink response to a PCIe Completion with Data (CplD) comprising CompleterID(c.b.1), RequesterID(c.a.1), Tag(w.3.1), and DataPayload(*Data.4.1*), and may send the PCIe CplD to the first entity. In both transactions, the RPU may generate NVLink SourceID and DestinationID values when translating from PCIe requests, and may generate PCIe CompleterID values when translating NVLink responses to PCIe completions. The RPU may maintain state information, such as pending transaction tables, to correlate PCIe Tags with NVLink Tags and to associate completions with their corresponding requests. The RPU may translate physical addresses between the PCIe address space and the NVLink address space.

In various implementations, an apparatus comprising: processing cores coupled via an interconnect to memory controllers coupled to memory channels capable of supporting memory having a capacity of at least 64 GB; wherein the interconnect utilizes a protocol based on Coherent Hub Interface (CHI-based protocol); first and second resource provisioning units (RPUs) comprising first and second NVLink interfaces and first and second CHI interfaces; wherein the first and second NVLink interfaces utilize differential pairs and are capable of communicating according to NVLink-based protocol with first and second entities external to the apparatus, respectively; and wherein the first and second RPUs are configured to translate between messages conforming to the NVLink-based protocol and messages conforming to the CHI-based protocol to enable the first and second entities to access in parallel the memory via the respective first and second NVLink interfaces and the interconnect. Sentences in the form of “access the memory” encompass accessing at least a portion of the memory, where the portion may range from a minimal addressable unit to the entire memory capacity, indicating open-ended claim language.

In some implementations of the apparatus, the first entity comprises a graphics processing unit (GPU) configured to: access dynamic random-access memory (DRAM) coupled to the memory channels via the first NVLink interface and the first RPU, and receive memory access requests from the processing cores targeting GPU-attached memory; wherein the first RPU is further configured to translate CHI-based requests to NVLink-based requests. The bidirectional communication may enable the GPU to function as both an initiator of memory transactions to system DRAM and a target for processor-initiated accesses to GPU-attached memory such as HBM. The RPU may maintain transaction context for both directions, managing protocol differences in flow control, credit management, and response generation between the NVLink and CHI-based domains.

In some implementations of the apparatus, the interconnect is a coherent interconnect, the GPU comprises on-package high-bandwidth memory (HBM), and the first RPU translates CHI-based write-back traffic targeting the HBM to NVLink-based traffic.

In some implementations of the apparatus, the interconnect is a coherent interconnect, the first RPU is further configured to maintain translations from first physical addresses associated with the first NVLink interface to physical addresses associated with the coherent interconnect, and the second RPU is further configured to maintain separate translations from second physical addresses associated with the second NVLink interface to the physical addresses associated with the coherent interconnect.

In some implementations of the apparatus, the interconnect comprises first and second interconnect components, the first RPU is coupled to the first interconnect component, and the second RPU is coupled to the second interconnect component, whereby the apparatus provides distributed bandwidth for the first and second entities to access resources.

In some implementations of the apparatus, a path between at least one of the first or second RPUs and at least one memory controller and/or processing core comprises one interconnect component. In some implementations, the RPU and at least one memory controller may be coupled to the same interconnect component, providing a low-latency communication path between the NVLink interface and memory attached to the xPU.

In some implementations of the apparatus, each of the first and second RPUs exposes registers accessible utilizing memory-mapped I/O (MMIO) operations via an Advanced Microcontroller Bus Architecture (AMBA) Advanced Peripheral Bus (APB) interface, enabling detection of RPU presence, NVLink-interface status, and translation capabilities.

In some implementations of the apparatus, each of the first and second RPUs is configured to: translate physical addresses associated with the respective NVLink-based protocol to physical addresses associated with the CHI-based protocol, and translate NVLink command encodings to corresponding CHI opcodes.

In some implementations of the apparatus, at least one of the first or second RPUs comprises a gateway utilizing a streaming interface protocol based on Advanced Microcontroller Bus Architecture (AMBA) Credited eXtensible Stream (CXS); and wherein the first and second entities are accelerators, from which at least one comprises a graphics processing unit (GPU).

In some implementations of the apparatus, each of the first and second RPUs comprises a request node that does not include a hardware-coherent cache and is configured to communicate with the interconnect according to the CHI-based protocol; and wherein the first and second entities are accelerators, from which at least one comprises a graphics processing unit (GPU).

In some implementations of the apparatus, at least one of the request nodes comprises an I/O-coherent request node (RN-I) or an I/O-coherent Request Node with Distributed Virtual Memory support (RN-D).

In some implementations of the apparatus, the interconnect comprises at least one crosspoint comprising at least four mesh ports and at least two device ports, wherein at least one of the first or second RPUs is coupled to one of the at least two device ports; and wherein the first and second entities are accelerators, from which at least one comprises a graphics processing unit (GPU).

In some implementations of the apparatus, each of the first and second NVLink interfaces supports virtual channels, and the respective RPUs map the virtual channels to corresponding quality-of-service fields of the CHI-based protocol.

In some implementations of the apparatus, the mapping between NVLink virtual channels and CHI quality-of-service fields is programmable via the MMIO registers exposed by the RPUs.

In some implementations of the apparatus, the memory comprises dynamic random-access memory (DRAM) having a capacity of at least 256 GB; wherein the first and second entities are accelerators, from which at least one comprises a graphics processing unit (GPU); and wherein the first and second entities can access in parallel different regions of the DRAM.

In some implementations, the apparatus further comprises a third NVLink interface coupled via a third RPU to the interconnect, enabling a third entity to access resources via the third NVLink interface and the interconnect, while maintaining I/O-coherency without cache coherency participation. The implementation may be scaled to support multiple NVLink-coupled entities, with their own translation paths through the I/O-coherent or non-coherent nodes, enabling high-bandwidth parallel access to system memory resources while the CHI-based protocol maintains appropriate ordering and coherency at the I/O level without requiring the NVLink entities to participate in cache coherency protocols.

In some implementations of the apparatus, each of the first and second RPUs maintains a link translation look-aside buffer that translates NVLink network addresses, including destination identifiers, into physical addresses employed by the interconnect.

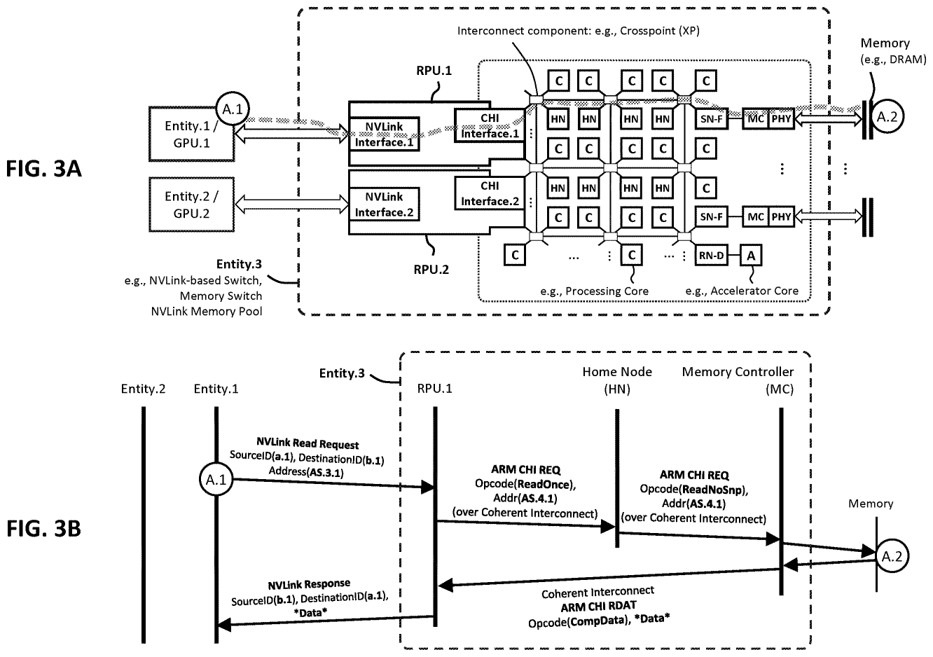

FIG. 3A illustrates an example of a memory switch configured to provide memory to entities coupled to it. Entity.1 is coupled to the memory switch wherein the entity may utilize the memory coupled to the coherent interconnect. The memory switch may function as an NVLink-based switch or an NVLink memory pool, providing switching capabilities between entities while also enabling access to memory resources.

FIG. 3B illustrates an example of a TFD demonstrating an NVLink request from Entity.1 to access memory. RPU.1 receives an NVLink request carrying a read request comprising an address, and translates it to an ARM CHI request comprising ReadOnce, potentially with a different address due to address translation. The request flows through the coherent interconnect to a home node (HN), which may translate it to a ReadNoSnp transaction destined to a memory controller (MC). The MC retrieves the data from memory and may return the data to RPU.1 without routing through the HN, or alternatively may send the data through the HN to RPU.1. Then RPU.1 generates the NVLink response with the data to Entity.1.

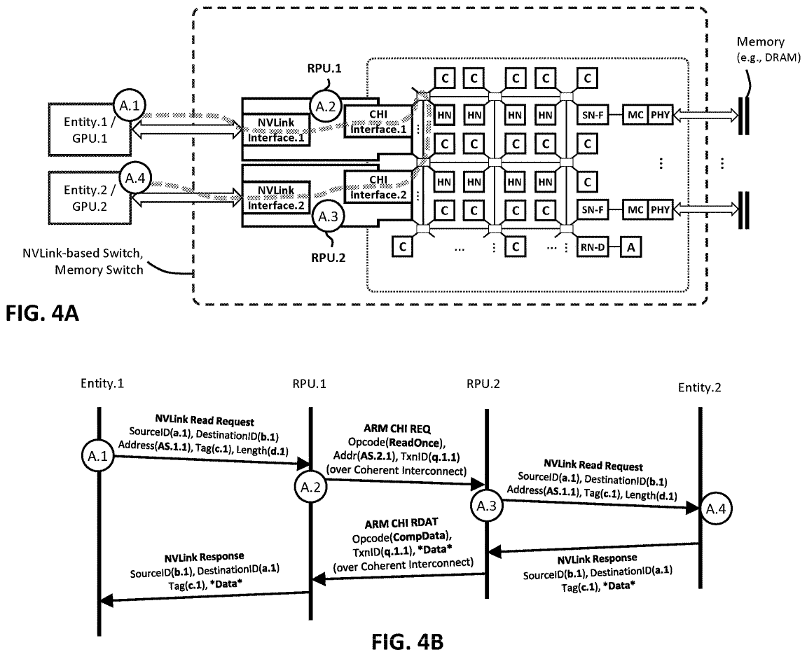

FIG. 4A illustrates an example of a system that implements an NVLink-based switch, or an NVLink Memory Switch, utilizing a CHI-based interconnect. The switch is coupled to two entities marked in the figure as Entity.1/GPU.1 and Entity.2/GPU.2. The switch may include processing cores, accelerator cores such as security accelerators, and memory controllers, coupled to the CHI-based interconnect. The switch utilizes translations, performed by each of the RPUs, between NVLink-based interfaces and the switch interconnect. The first RPU may enable Entity.1/GPU.1 to access, via the first NVLink interface and the switch interconnect (which may be a coherent interconnect), resources mapped to the address space utilized by the switch interconnect, such as memory resources of the switch. Correspondingly, the second RPU may enable Entity.2/GPU.2 to access, via the second NVLink interface and the switch interconnect, resources mapped to the address space utilized by the switch interconnect, such as memory resources of the switch. The first RPU may map resources of Entity.1/GPU.1, such as memory resources, to the physical address space associated with the switch interconnect, and may further enable Entity.2/GPU.2 to access resources mapped to the address space utilized by the switch interconnect, so that Entity.2/GPU.2 is able to access memory resources of Entity.1/GPU.1, via the second NVLink interface, the switch interconnect, and the first NVLink interface. Correspondingly, the second RPU may map resources of Entity.2/GPU.2, such as memory resources, to the physical address space associated with the switch interconnect, and may further enable Entity.1/GPU.1 to access resources mapped to the address space utilized by the switch interconnect, so that Entity.1/GPU.1 is able to access memory resources of Entity.2/GPU.2, via the first NVLink interface, the switch interconnect, and the second NVLink interface.

FIG. 4B illustrates an example of a TFD demonstrating NVLink switching operation between entities through a switch interconnect. Entity.1/GPU.1 issues a first NVLink request comprising source ID, destination ID and an address (AS.1.1). The first NVLink request is switched through the switch interconnect wherein a first RPU (RPU.1) translates it to an ARM CHI request comprising ReadOnce. The example demonstrates a switching operation wherein the switch typically does not change the message or the PDU, similar to how an Ethernet switch typically does not change an Ethernet frame. The first NVLink request is translated to an ARM CHI request that is translated to a second NVLink request, resulting in a switching operation of an NVLink request that passes from Entity.1/GPU.1 to Entity.2/GPU.2 through the first RPU, the switch interconnect, and a second RPU (RPU.2). The first RPU converts the first NVLink request to an ARM CHI request carrying ReadOnce, possibly utilizing user-defined fields within the switch interconnect protocol to pass fields of the first NVLink request such as NVLink source ID, destination ID, Tags, and length, to the second RPU, wherein the ARM CHI request is translated to the second NVLink request that is sent to Entity.2/GPU.2. ARM CHI may include fields such as RSVDC that may be utilized as user-defined fields for passing transaction-related information such as fields from the first NVLink request of Entity.1/GPU.1 to the second NVLink request sent to Entity.2/GPU.2. Some of the fields of the NVLink traffic received from Entity.1/GPU.1 may be translated, whereas some of the fields may be truncated or compressed to fit within the available user-defined field widths. The second RPU translates the ReadOnce ARM CHI request to the second NVLink request, and translates the first NVLink response to an ARM CHI RDAT. The first RPU on the receiving side may translate the ARM CHI response (ARM CHI RDAT) with CompData and data back to a second NVLink response. The ARM CHI RDAT may also utilize user-defined fields for passing information to the other side, while the data itself may be passed natively through the ARM CHI RDAT data field.

In various implementations, an apparatus comprising: processing cores coupled via a coherent interconnect to memory controllers, wherein the coherent interconnect is based on Coherent Hub Interface (CHI) protocol (CHI-based protocol), and the memory controllers are coupled to memory channels capable of supporting memory having a capacity of at least 64 GB; interconnect gateway coupled to the coherent interconnect, or a Fully Coherent Request Node (RN-F) comprising a hardware-coherent cache and a Fully Coherent Home Node (HN-F) comprising a Point of Coherence (PoC) coupled to the coherent interconnect; an NVLink Chip-to-Chip (NVLink-C2C) interface configured to communicate according to NVLink-C2C coherent protocol with an entity external to the apparatus; and an NVLink-C2C to CHI adapter configured to translate between messages conforming to the NVLink-C2C coherent protocol and messages conforming to the CHI-based protocol, wherein the adapter couples the NVLink-C2C interface to the CCGs or the RN-F and HN-F to enable bidirectional coherent memory access between the entity and the processing cores. The following are two examples according to which the apparatus enables full cache-coherent communication between entities using NVLink-C2C protocol and the CHI-based system. In the first example, RN-F and HN-F nodes provide coherent connectivity, wherein the RN-F node may generate transactions defined by the CHI-based protocol and support snoop transactions, while the HN-F node manages coherency by snooping required RN-F nodes and serving as both the Point of Coherence and Point of Serialization. In the second example, CCGs provide integrated coherent gateway functionality that internally implements RN-F and HN-F capabilities. The adapter may perform coherency-preserving translations that enable the external entity to read from the apparatus's DRAM through the coherent request path while the processing cores may read from the entity's memory through the coherent home path, maintaining full cache coherency across both directions of communication.

In some implementations of the apparatus, the entity comprises a graphics processing unit (GPU), and wherein: the GPU accesses dynamic random-access memory (DRAM) coupled to the memory channels through the NVLink-C2C interface, the adapter, and the coherent interconnect; and the processing cores access memory attached to the GPU through the coherent interconnect, the adapter, and the NVLink-C2C interface. The bidirectional coherent access may enable the GPU to read from the processor's DRAM while maintaining cache coherency utilizing the coherent request functionality, and simultaneously allows the processor cores to access GPU-attached memory such as High Bandwidth Memory (HBM) or High-Bandwidth Flash (HBF) through the coherent home functionality, creating a coherent memory space across heterogeneous processing elements.

In some implementations of the apparatus, the NVLink-C2C interface comprises an NVLink Fusion chiplet coupled to the adapter via a physical layer (PHY), wherein the PHY is a UCIe PHY configured for chiplet-to-chiplet communication. The NVLink Fusion chiplet may provide a modular other implementation of NVLink-C2C protocol processing, with the UCIe PHY offering a standardized chiplet interconnect that enables integration of NVLink-C2C coherent capabilities into processors that may not have native NVLink support.

In some implementations of the apparatus, the adapter comprises a CHI C2C die-to-die adapter with UCIe streaming, configured to bridge between the UCIe PHY domain and the CHI-based domain while maintaining coherency. The ARM CHI C2C die-to-die adapter may implement streaming optimizations for UCIe transfers while performing the applicable translations between NVLink-C2C and CHI, managing credit flow, transaction ordering, and coherency state transitions required for maintaining cache coherency across the die boundary.

In some implementations of the apparatus, the apparatus comprises the RN-F and HN-F coupled to the coherent interconnect, and the adapter couples the NVLink-C2C interface to the RN-F and HN-F; and wherein the apparatus further comprises additional CCGs coupled to the coherent interconnect, and a Compute Express Link (CXL) device coupled to the additional CCGs, configured to communicate with a second entity based on a CXL protocol, wherein the CXL device and the NVLink-C2C interface share access to the memory channels through their respective coherent nodes. Optionally, this configuration provides dedicated coherent paths for different protocols, with the NVLink-C2C interface utilizing discrete RN-F and HN-F nodes while the CXL device utilizes CCGs that internally implement their own coherent functionality, enabling optimizations of protocol paths while sharing access to memory resources.

In some implementations of the apparatus, the CXL device is configured to route CXL.mem and/or CXL.cache transactions through the additional CCGs via a CXS interface; the apparatus further comprises an I/O-coherent Request Node with Distributed Virtual Memory support (RN-D) coupled to the coherent interconnect; and the CXL device is further configured to route CXL.io transactions through the RN-D via an AXI interface. The separation of CXL protocol types may leverage the additional CCGs' coherency management capabilities for CXL.mem and/or CXL.cache transactions while utilizing the simpler RN-D path for CXL.io transactions, with the CXS interface providing an optimized bridge protocol for coherent transactions and the AXI interface handling I/O transactions similar to PCIe.

In some implementations of the apparatus, the CXL device comprises a Global Fabric-Attached Memory (G-FAM) Device (GFD) configured to support only CXL.mem transactions through the additional CCGs. The GFD may allow the CXL transactions to be processed through the coherent path provided by the additional CCGs, which is suitable for memory pooling applications wherein I/O functionality is not required.

In some implementations of the apparatus, the second entity communicates with the CXL device via a physical layer based on IEEE 802.3 physical medium attachment (PMA) coupled to a resource provisioning unit (RPU) that includes the CXL device. The physical layer based on IEEE 802.3 PMA may enable the CXL device to receive CXL protocol messages encapsulated within a carrier protocol, extending the reach of CXL communications beyond traditional PCIe-based physical layers while the NVLink-C2C interface provides high-bandwidth coherent connectivity for tightly-coupled accelerators.

In some implementations of the apparatus, the apparatus comprises the CCGs coupled to the coherent interconnect, and the adapter couples the NVLink-C2C interface to the CCGs; and wherein the apparatus further comprises a Compute Express Link (CXL) device coupled to additional CCGs, wherein the additional CCGs provide shared coherent infrastructure for both the NVLink-C2C interface and the CXL device. Optionally, this configuration leverages the CCGs as unified coherent gateways that handle both NVLink-C2C and CXL protocols, with the CCGs internally implementing the coherent request and home functionality required for coherent transactions, potentially simplifying the system architecture by consolidating coherent protocol handling within shared CCG blocks.

In some implementations of the apparatus, the processing cores are part of a custom CPU comprising an integrated NVLink-C2C interface; and wherein the entity comprises an NVIDIA Blackwell GPU, an accelerator processing unit, or a second custom CPU with an NVLink-C2C interface. The custom CPU design may incorporate native NVLink-C2C support to enable direct coherent communication with NVIDIA GPUs or other NVLink-C2C capable devices, eliminating the need for protocol bridges in GPU-accelerated computing systems while maintaining full cache coherency between the CPU and accelerator domains.

In some implementations of the apparatus, the interconnect gateway comprises at least one of Coherent Multichip Link (CML) or Cache Coherent Interconnect for Accelerators (CCIX) Gateway (CXG) that utilizes a streaming interface protocol; and wherein the gateway is configured to utilize a 32-bit cyclic-redundancy check (CRC-32) to protect transactions conforming to the streaming interface protocol.

In various implementations, a system comprising: a processor comprising processing cores coupled via a coherent interconnect to memory controllers, wherein the coherent interconnect is based on Coherent Hub Interface (CHI) protocol (CHI-based protocol), and the memory controllers are coupled to memory channels coupled to memory having a capacity of at least 64 GB; a first graphics processing unit (GPU) coupled to the coherent interconnect via a first interface path comprising a first NVLink interface and a first adapter; a second GPU coupled to the coherent interconnect via a second interface path comprising a second NVLink interface and a second adapter; and wherein the first adapter and the second adapter are configured to translate between messages conforming to NVLink-based protocol and messages conforming to the CHI-based protocol, enabling the first GPU and the second GPU to communicate with each other through the coherent interconnect while the first and second GPUs have access to the memory via the coherent interconnect. The system may enable GPU-to-GPU communication through the processor's coherent interconnect rather than through direct GPU-to-GPU links or NVSwitch, providing a flexible communication architecture wherein GPUs may exchange data while sharing access to the processor's memory resources. The adapters translate between the NVLink domains and the CHI domain, managing differences in transaction formats, flow control, and addressing. The coherent interconnect serves as a common communication fabric that routes transactions between the GPUs while also handling memory access requests from the GPUs and the processor cores, potentially enabling new computational models wherein GPUs collaborate utilizing shared memory spaces managed by the processor.

Optionally, this implementation may route GPU-to-GPU communications through a processor's coherent interconnect, potentially offering several technical advantages, such as leveraging existing processor interconnect infrastructure without requiring additional dedicated GPU switching hardware, enabling GPUs to communicate while simultaneously accessing processor-attached memory through the same interconnect, and/or allowing heterogeneous accelerators using different protocols to participate in the same communication fabric. This implementation may also facilitate integration scenarios wherein the number or configuration of GPUs is not known at processor design time, as the coherent interconnect may dynamically route communications between whatever GPUs are coupled. Furthermore, by translating GPU protocols to the processor's native coherent protocol, the system may apply the processor's existing quality-of-service, security, and routing mechanisms to GPU traffic, potentially simplifying system-level traffic management. The translations performed by the adapters may enable memory architectures wherein GPUs, CPUs, and other accelerators share common view(s) of memory resources.

In some implementations of the system, the first NVLink interface and the second NVLink interface are NVLink interfaces configured for I/O-coherent communication; the first adapter couples the first NVLink interface to an I/O-coherent Request Node with Distributed Virtual Memory support (RN-D) and a I/O-coherent Home Node (HN-I); and wherein the second adapter couples the second NVLink interface to a second RN-D and a second HN-I. The I/O-coherent NVLink configuration may utilize I/O-Coherent nodes that do not maintain hardware cache coherency, suitable for GPU workloads that manage their own memory consistency, with the RN-D nodes handling DVM transactions and the HN-I nodes managing IO ordering for GPU-initiated operations.

In some implementations of the system, the first NVLink interface and the second NVLink interface are NVLink-C2C interfaces configured for coherent communication; the first adapter couples the first NVLink-C2C interface to a Fully Coherent Request Node (RN-F) and a Fully Coherent Home Node (HN-F); and the second adapter couples the second NVLink-C2C interface to a second RN-F and a second HN-F, enabling cache-coherent GPU-to-GPU communication through the coherent interconnect. The coherent NVLink-C2C configuration may enable the GPUs to participate in the processor's cache coherency protocol, with the RN-F nodes supporting snoop transactions and the HN-F nodes managing coherency as Points of Coherence, allowing GPUs to maintain cache-coherent views of shared data structures during communication.

In some implementations of the system, the first interface path further comprises a first NVLink Fusion chiplet coupled to the first adapter via a first physical layer (PHY); the second interface path further comprises a second NVLink Fusion chiplet coupled to the second adapter via a second PHY; and the first and second PHYs are selected from a UCIe PHY, an NVLink-C2C PHY, or a custom PHY. The NVLink Fusion chiplets may provide modular NVLink-based protocol processing capabilities that can be integrated into systems without native NVLink support, with the PHY selection enabling different physical layer implementations based on packaging technology and bandwidth requirements.

In some implementations, the system further comprises a third accelerator coupled to the coherent interconnect via a third interface path; wherein the third accelerator is selected from a custom accelerator, an xPU, or a third GPU; and wherein the third interface path comprises a Compute Express Link (CXL) device coupled to CXL/CCIX Gateways (CCGs), enabling the third accelerator to communicate with the first GPU and the second GPU through the coherent interconnect. This mixed configuration demonstrates the flexibility of the coherent interconnect to support heterogeneous accelerators using different protocols, with CXL-attached accelerators communicating with NVLink-attached GPUs based on appropriate translations at their respective adapter/gateway interfaces.

In some implementations of the system, the first GPU reads data from the memory through the first adapter and the coherent interconnect while the second GPU reads the same data from the memory; and the first GPU writes results to the memory that are subsequently read by the second GPU, implementing a producer-consumer pattern utilizing the processor's memory. The shared memory access patterns may enable collaborative computing models wherein GPUs coordinate utilizing processor memory rather than utilizing direct GPU memory transfers, potentially simplifying programming models and enabling dynamic work distribution among GPUs.

In some implementations of the system, the first adapter comprises a CHI C2C die-to-die adapter configured to translate between the first NVLink Fusion chiplet's domain and the CHI-based domain; and the second adapter comprises a second CHI C2C die-to-die adapter configured to translate between the second NVLink Fusion chiplet's domain and the CHI-based domain. The ARM CHI C2C die-to-die adapters may provide the translations while managing inter-die communication requirements including credit flow, transaction ordering, and optional support for UCIe streaming when coupled with UCIe PHYs.

In some implementations of the system, the first GPU is an NVIDIA Blackwell GPU with High Bandwidth Memory (HBM); the second GPU is a different GPU architecture; and the coherent interconnect enables the asymmetric GPUs to exchange data despite differences in their native memory architectures and protocol implementations. The support for asymmetric GPU configurations may enable systems to combine GPUs with different capabilities, memory hierarchies, or vendor implementations, with the coherent interconnect and adapters abstracting protocol differences to enable interoperability.

In some implementations of the system, the first adapter translates GPU physical addresses within a first GPU physical address space to CHI physical addresses within the coherent interconnect's physical address space; the second adapter translates GPU physical addresses within a second GPU physical address space to CHI physical addresses; and the processor maintains address mappings that enable the first GPU to access memory regions allocated to the second GPU through the coherent interconnect. The multi-level address translation may enable the GPUs to maintain their own physical address spaces while the processor's coherent interconnect provides a unified addressing scheme for routing transactions, with the processor potentially implementing memory protection and isolation between GPU physical address spaces.

In some implementations, the system further comprises additional GPUs coupled to the coherent interconnect via additional interface paths, the additional interface paths comprise NVLink interfaces and adapters; wherein the GPUs communicate with each other through the coherent interconnect in a fully-connected logical topology without requiring a dedicated GPU switch. The scalable architecture may support arbitrary numbers of GPUs limited by the coherent interconnect's capacity rather than by the dedicated GPU switching hardware, with the GPUs able to communicate with each other through the processor's routing infrastructure.

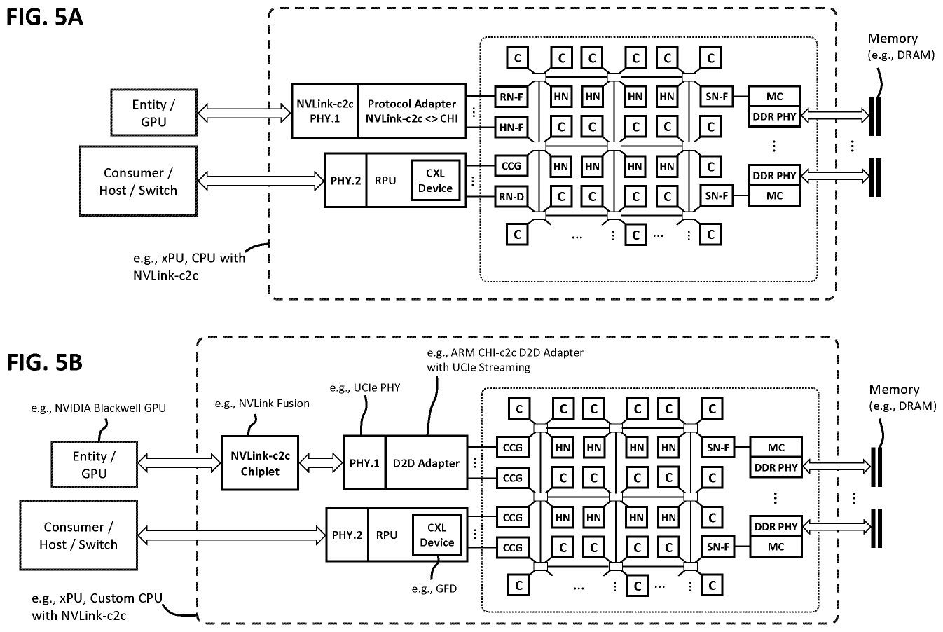

FIG. 5A illustrates an example of a system comprising a processor incorporating protocol interfaces integrating an RPU with a CXL device. The RPU includes or is coupled to a CXL device that is coupled to both (i) a CCG node for handling coherent CXL.mem and/or CXL.cache transactions, and (ii) an RN-D node for handling non-coherent CXL.io transactions. The system may couple the RPU to the CCG over a CXS interface, providing a path for coherent communications. The connection of NVLink-C2C interfaces to fully coherent request nodes (RN-F) and fully coherent home nodes (HN-F) may be included within a gateway node structure, enabling bidirectional coherent access wherein a GPU may read from the processor's DRAM through the RN-F node and the processor cores may read from the GPU's HBM through the HN-F node.

FIG. 5B illustrates an example of a system including a CPU, which may be a custom CPU design, incorporating NVLink-C2C capabilities and optionally including an NVLink-C2C chiplet, such as NVLink Fusion. The system integrates a Global Fabric-Attached Memory (G-FAM) Device (GFD) that operates as a specialized CXL device. The GFD may support only CXL.mem transactions, allowing it to service external requests through CCG nodes that are optimized for handling CXL.mem traffic, thereby simplifying the design by eliminating the need for separate CXL.io handling paths typically managed by RN-D or RN-I nodes.

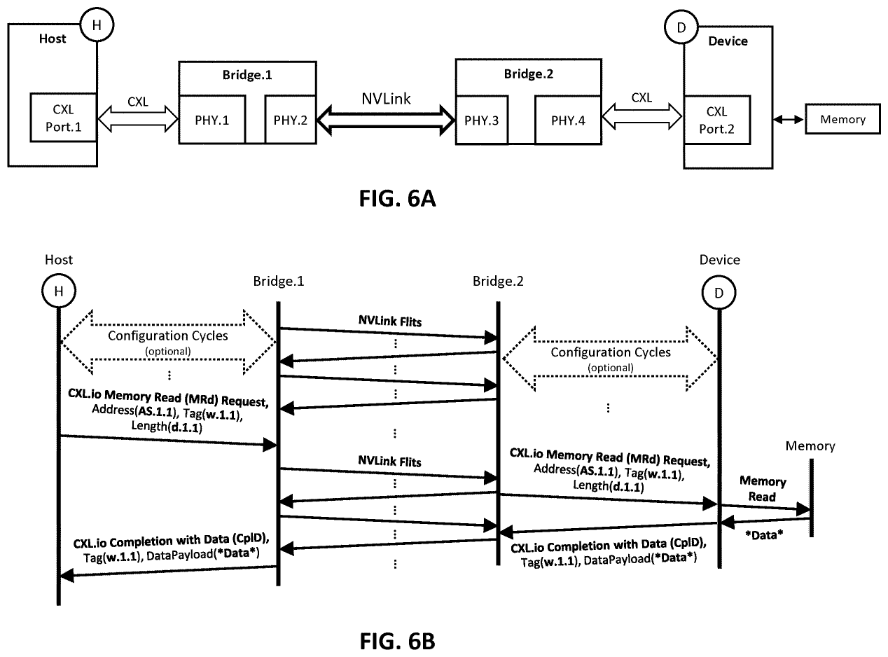

FIG. 6A illustrates an example of a system wherein a host comprising a first CXL port is coupled to Bridge.1 via a first PHY (PHY.1), which may be implemented as a Flex Bus PHY, a UCIe PHY, or an NVLink-C2C PHY. Bridge.1 communicates with Bridge.2 via a second PHY (PHY.2) which may be based on IEEE 802.3 PMA and may include an NVLink PHY instead of a UALink PHY. Bridge.2 is coupled via a fourth PHY (PHY.4) to a device comprising a second CXL port. Using NVLink PHY for inter-bridge communication demonstrates the flexibility of the bridge architecture to support different high-speed interconnect protocols while maintaining CXL protocol compatibility at the host and device interfaces.

FIG. 6B illustrates an example of a TFD depicting tunneling of CXL.io transactions between a host and a device through bridge.1 and bridge.2, utilizing physical layers based on IEEE 802.3 PMA. The TFD shows CXL.io Memory Read (MRd) request transmitted from the host through bridge.1, which translates or encapsulates the request for transmission to bridge.2 over NVLink flits, wherein bridge.2 performs the applicable translations to forward the request as a CXL.io transaction to the device ‘D’, with the corresponding CXL.io Completion with Data (CplD) response following the reverse path from the device through bridge.2 and bridge.1 back to the host ‘H’.

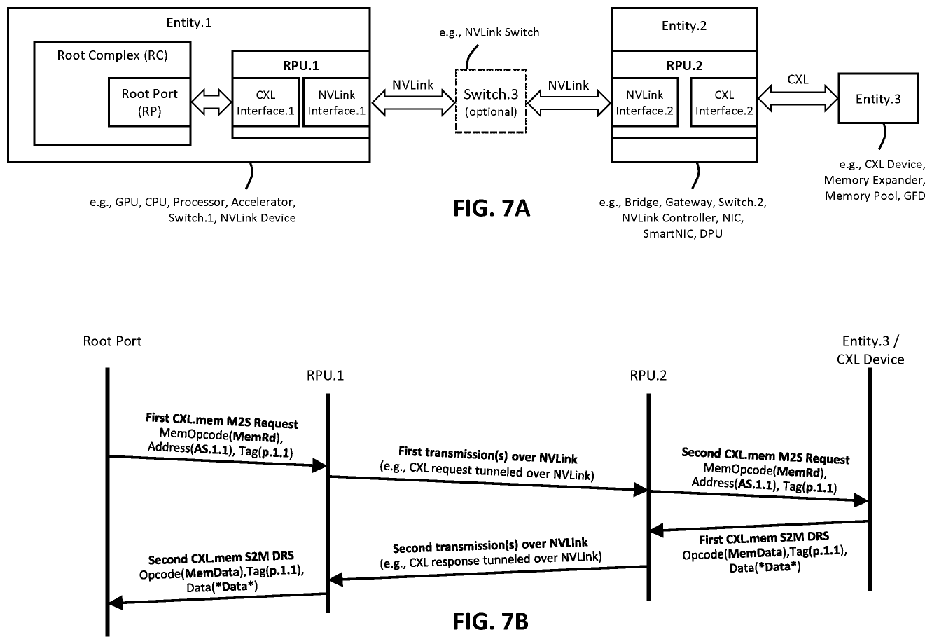

FIG. 7A illustrates an example of a system comprising a first entity (Entity.1), such as a GPU, a CPU, a processor, an accelerator, a first switch (Switch.1), or an NVLink device, wherein the first entity may include a Root Complex (RC) comprising a root port (RP), and may further include a first RPU (RPU.1) comprising a first CXL interface (CXL Interface.1) and a first NVLink Interface (NVLink Interface.1). The system may further include an optional third switch (Switch.3), such as an NVLink switch, and a second entity (Entity.2), such as a bridge, a gateway, a second switch (Switch.2), an NVLink controller, a Network Interface Card (NIC), e.g., an NVLink NIC, a SmartNIC, e.g., an NVLink SmartNIC, or a Data Processing Unit (DPU), e.g., an NVLink DPU. The second entity may include a second RPU (RPU.2) comprising a second CXL interface (CXL Interface.2) and a second NVLink Interface (NVLink Interface.2). The system further includes a third entity (Entity.3), such as a CXL device, a memory expander, a memory pool, or a GFD. The first and second RPUs may enable the first entity to communicate with the third entity according to a CXL-based protocol, via the second entity and optionally via the third switch, such as by translating between CXL-based PDUs (such as TLPs, requests, messages, or flits) and transmissions comprising data indicative of CXL PDUs, such as transmissions comprising data indicative of CXL opcodes and physical addresses, wherein the transmissions utilize NVLink PDUs (such as NVLink requests, NVLink packets, or NVLink flits), which may be sent and received via the first and second NVLink interfaces, optionally enabling the first entity to access resources of the third entity, such as registers or memory.

In some examples, translating between the CXL-based PDUs and the transmissions utilizing NVLink PDUs may enable CXL over NVLink, such as via CXL tunneling over NVLink, e.g., tunneling of CXL.mem requests and responses over NVLink, tunneling of CXL.io TLPs over NVLink, tunneling of CXL-based PDUs over NVLink, or tunneling of CXL transactions over NVLink. In some examples, the first NVLink Interface and the second NVLink Interface may utilize the same physical layer technology. In other examples, the first NVLink interface and the second NVLink interface may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in an NVLink switch.

In some examples, the first entity may be a first switch comprising the first NVLink interface, the second entity may be a second switch comprising the second NVLink interface, and the CXL traffic between the first and second switches may be tunneled over NVLink. Optionally, the first and second switches may be coupled by the third switch, which may be an NVLink switch. In other examples, the first entity may be a first switch comprising the first CXL interface (CLX Interface.1), the second entity may be a second switch comprising the second CXL Interface (CXL Interface.2), and the CXL traffic between the RP and the third entity (e.g., a CXL device) may be tunneled over NVLink via the second switch and optionally via the third switch, which may be an NVLink switch.

FIG. 7B illustrates an example of a TFD demonstrating a CXL communication between a first entity (Entity.1), such as a processor comprising a root port (RP), and a third entity (Entity.3), such as a CXL device, wherein the CXL communication may be tunneled over NVLink. The first entity may initiate a read from the third entity, such as by sending a first CXL.mem M2S request comprising MemOpcode(MemRd), Address(AS.1.1), and Tag(p.1.1) via the RP. The first RPU (RPU.1), which may reside in the first entity, may receive the first CXL.mem M2S request and translate it to first transmission(s) comprising data indicative of CXL PDU, such as transmission(s) comprising data indicative of CXL opcodes and physical addresses, wherein the first RPU may send the first transmission(s) which may utilize one or more NVLink PDUs (such as NVLink requests, NVLink packets, or NVLink flits), to a second RPU (RPU.2), which may reside in a second entity, such as a bridge or a gateway. The first RPU may further translate the first CXL.mem M2S request to the first transmission(s) in a manner that enables reconstruction of the first CXL.mem M2S request at the second RPU with minimal (or no) modifications, effectively tunneling the first CXL.mem M2S request over NVLink. For example, the first RPU may encapsulate the first CXL.mem M2S request into an NVLink request, such as an NVLink write request, and send the NVLink request to the second RPU, wherein the CXL request may be extracted from the NVLink request such as by decapsulation. Additionally or alternatively, the first RPU may encapsulate a CXL flit comprising the first CXL.mem M2S request into an NVLink request, such as an NVLink write request, and send the NVLink request to the second RPU, wherein the CXL flit comprising the first CXL.mem M2S request may be extracted from the NVLink request such as by decapsulation. The second RPU may receive the first transmission(s) and translate it to a second CXL.mem M2S request comprising MemOpcode(MemRd), Address(AS.1.1), and Tag(p.1.1), and send the second CXL.mem M2S request to the third entity. In some examples, the first CXL.mem M2S request and the second CXL.mem M2S request may be identical, whereas in other examples the second RPU may construct the second CXL.mem M2S request based on the first CXL.mem M2S request with variations such as utilizing a different opcode (e.g., MemRdData instead of MemRd), utilizing a different Tag namespace, e.g., Tag(q.2.1) instead of Tag (p.1.1), or utilizing address translations, e.g., Address(AS.2.1) instead of Address(AS.1.1).

The third entity may respond to the second CXL.mem M2S request by sending a first CXL.mem S2M DRS comprising Opcode(MemData), Tag(p.1.1), and Data(*Data*) to the second RPU, wherein the second RPU may translate the first CXL.mem S2M DRS to second transmission(s) comprising data indicative of CXL PDU, and send the second transmission(s) to the first RPU. The first RPU may further receive the second transmission(s) and translate it to a second CXL.mem S2M DRS comprising Opcode(MemData), Tag(p.1.1), and Data(*Data*), and send the second CXL.mem S2M DRS to the RP. In some examples, the first CXL.mem S2M DRS and the second CXL.mem S2M DRS may be identical, whereas in other examples the first RPU may construct the second CXL.mem S2M DRS based on the first CXL.mem S2M DRS with variations, such as updating fields, e.g., Device Load (DevLoad), MetaField, MetaValue, TRP, Opcode, or reserved fields. Additionally or alternatively, the first RPU may alter the structure of the second CXL.mem S2M DRS compared to the original first CXL.mem S2M DRS, such as by adding a trailer.

In some examples, the second CXL.mem M2S request may be different from the first CXL.mem M2S request due to differences in protocol revisions, such as when the first RPU communicates with the RP according to CXL 1.1, whereas the second RPU communicates with the third entity according to CXL 3.2, or such as when message format conversion is required between HBR and PBR formats, e.g., when the second RPU utilizes PBR mode or PBR messages, whereas, for example, the RP is associated with an HBR host. Similarly, the second CXL.mem S2M DRS may be different from the first CXL.mem S2M DRS due to differences in protocol revisions, or such as when message format conversion is required between HBR and PBR formats. In some examples, the first RPU and the second RPU may be coupled by a switch, such as a UALink switch.

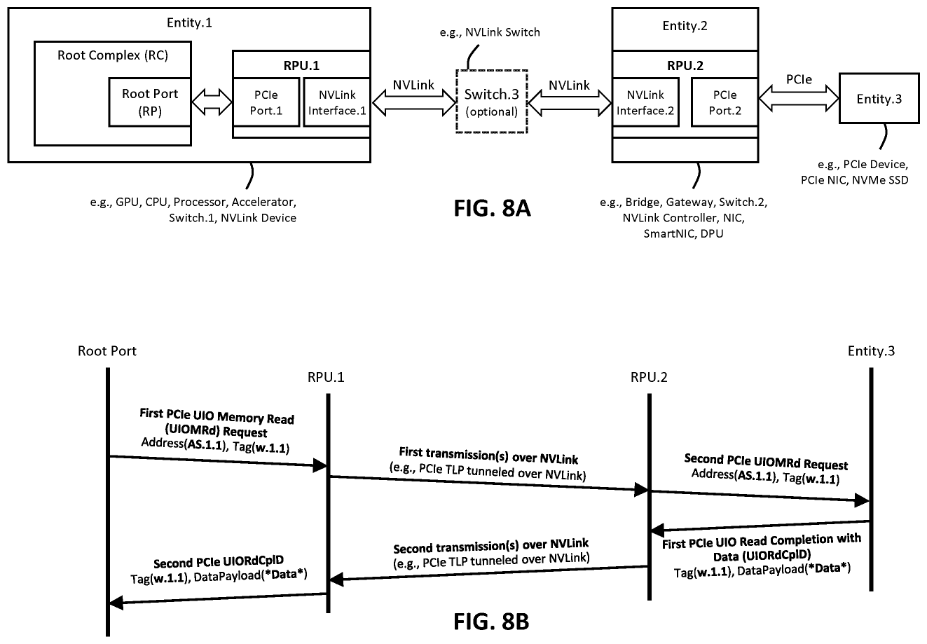

FIG. 8A illustrates an example of a system comprising a first entity (Entity.1), such as a GPU, a CPU, a processor, an accelerator, a first switch (Switch.1), or an NVLink device, wherein the first entity may include a Root Complex (RC) comprising a root port (RP), and may further include a first RPU (RPU.1) comprising a first PCIe port (PCIe Port.1) and a first NVLink Interface (NVLink Interface.1). The system may further include an optional third switch (Switch.3), such as a NVLink switch, and a second entity (Entity.2), such as a bridge, a gateway, a second switch (Switch.2), an NVLink controller, a Network Interface Card (NIC), e.g., an NVLink NIC, a SmartNIC, e.g., an NVLink SmartNIC, or a Data Processing Unit (DPU), e.g., an NVLink DPU. The second entity may include a second RPU (RPU.2) comprising a second PCIe port (PCIe Port.2) and a second NVLink Interface (NVLink Interface.2). The system further includes a third entity (Entity.3), such as a PCIe device, a PCIe NIC, or an NVMe SSD. The first and second RPUs may enable the first entity to communicate with the third entity according to a PCIe-based protocol, via the second entity and optionally via the third switch, such as by translating between PCIe-based PDUs (such as PCIe TLPs, requests, messages, or flits) and transmissions comprising data indicative of PCIe PDUs, such as transmissions comprising data indicative of PCIe TLP types and physical addresses, wherein the transmissions utilize NVLink PDUs (such as NVLink requests, NVLink packets, or NVLink flits), which may be sent and received via the first and second NVLink interfaces, optionally enabling the first entity to access resources of the third entity, such as registers or memory.

In some examples, translating between the PCIe-based PDUs and the transmissions utilizing NVLink PDUs may enable PCIe over NVLink, such as via PCIe tunneling over NVLink, e.g., tunneling of PCIe requests and completions over NVLink, tunneling of PCIe TLPs over NVLink, tunneling of PCIe-based PDUs over NVLink, or tunneling of PCIe transactions over NVLink. In some examples, the first NVLink Interface and the second NVLink Interface may utilize the same physical layer technology. In other examples, the first NVLink interface and the second NVLink interface may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in an NVLink switch.

In some examples, the first entity may be a first switch, such as a first PCIe switch comprising the first NVLink interface, the second entity may be a second switch, such as a second PCIe switch comprising the second NVLink interface, wherein the PCIe traffic between the first PCIe switch and the second PCIe switch may be tunneled over NVLink, and wherein the first PCIe switch and the second PCIe switch may be coupled by the third switch, that may be an NVLink switch. In other examples, the first entity may be a first switch, such as a first NVLink switch comprising the first PCIe Port (PCIe Port.1), the second entity may be a second switch, such as a second NVLink switch comprising the second PCIe Port (PCIe Port.2), wherein the PCIe traffic between the RP and the third entity (e.g., a PCIe device) may be tunneled over NVLink via the second NVLink switch and optionally via the third switch, such as a third NVLink switch.

FIG. 8B illustrates an example of a TFD demonstrating PCIe communication between a first entity (Entity.1), such as a processor comprising a root port (RP), and a third entity (Entity.3), such as a PCIe device, wherein the PCIe communication may be tunneled over NVLink. The first entity may initiate a read from the third entity, such as by sending a first PCIe UIO Memory Read (UIOMRd) request comprising Address(AS.1.1) and Tag(w.1.1) via the RP. The first RPU (RPU.1), which may reside in the first entity, may receive the first PCIe UIOMRd and translate it to first transmission(s) comprising data indicative of PCIe PDU, such as transmission(s) comprising data indicative of TLP types and physical addresses, wherein the first RPU may send the first transmission(s) which may utilize one or more NVLink PDUs (such as NVLink requests, NVLink packets, or NVLink flits), to a second RPU (RPU.2), which may reside in a second entity, such as a bridge or a gateway. The first RPU may further translate the first PCIe UIOMRd to the first transmission(s) in a manner that enables reconstruction of the first PCIe UIOMRd at the second RPU with minimal (or no) modifications, effectively tunneling the first PCIe UIOMRd over NVLink. For example, the first RPU may encapsulate the first PCIe UIOMRd into an NVLink request, such as an NVLink write request, and send the NVLink request to the second RPU, wherein the PCIe request may be extracted from the NVLink request such as by decapsulation. Additionally or alternatively, the first RPU may encapsulate a PCIe flit comprising the first PCIe UIOMRd into an NVLink request, such as an NVLink write request, and send the NVLink request to the second RPU, wherein the PCIe flit comprising the first PCIe UIOMRd may be extracted from the NVLink request such as by decapsulation.

The second RPU may receive the first transmission(s) and translate it to a second PCIe UIOMRd comprising Address(AS.1.1) and Tag(w.1.1), and send the second PCIe UIOMRd to the third entity. In some examples, the first PCIe UIOMRd and the second PCIe UIOMRd may be identical, whereas in other examples, the second RPU may construct the second PCIe UIOMRd based on the first PCIe UIOMRd with variations such as utilizing a different TLP type (e.g., MRd instead of UIOMRd), utilizing a different Tag namespace, e.g., Tag(q.2.1) instead of Tag (w.1.1), or utilizing address translations, e.g., Address(AS.2.1) instead of Address(AS.1.1). The third entity may respond to the second PCIe UIOMRd by sending a first PCIe UIO Read Completion with Data (UIORdCplD) comprising Tag(w.1.1) and DataPayload(*Data*) to the second RPU, wherein the second RPU may translate the first PCIe UIORdCplD to second transmission(s) comprising data indicative of PCIe PDU, and send the second transmission(s) to the first RPU. The first RPU may further receive the second transmission(s) and translate it to a second PCIe UIORdCplD comprising Tag(w.1.1) and DataPayload(*Data*), and send the second PCIe UIORdCplD to the RP.

In some examples, the first PCIe UIORdCplD and the second PCIe UIORdCplD may be identical, whereas in other examples, the first RPU may construct the second PCIe UIORdCplD based on the first PCIe UIORdCplD with variations, such as updating fields, e.g., reserved fields or fields treated as reserved, such as CDL that may represent CXL device load for QoS telemetry, where this field may be treated as reserved for use cases not covered by CXL. Additionally or alternatively, the first RPU may alter the structure of the second PCIe UIORdCplD compared to the original first PCIe UIORdCplD, such as by adding a TLP trailer, such as for supporting Transaction Layer end-to-end 32-bit CRC (ECRC) that may cover the path between the second RPU and the RP.

In some examples, the second PCIe UIOMRd may be different from the first PCIe UIOMRd due to differences in protocol revisions, such as when the first RPU communicates with the RP according to a first PCIe specification revision, whereas the second RPU communicates with the third entity according to a second PCIe specification revision (that may be different than the first PCIe specification revision), or such as when translation is required between Flit Mode (FM) and Non-Flit Mode (NFM) TLP formats. Similarly, the second PCIe UIORdCplD may be different from the first PCIe UIORdCplD due to differences in protocol revisions, or such as when translation is required between FM and NFM TLP formats. In some examples, the first RPU and the second RPU may be coupled by a switch, such as an NVLink switch.

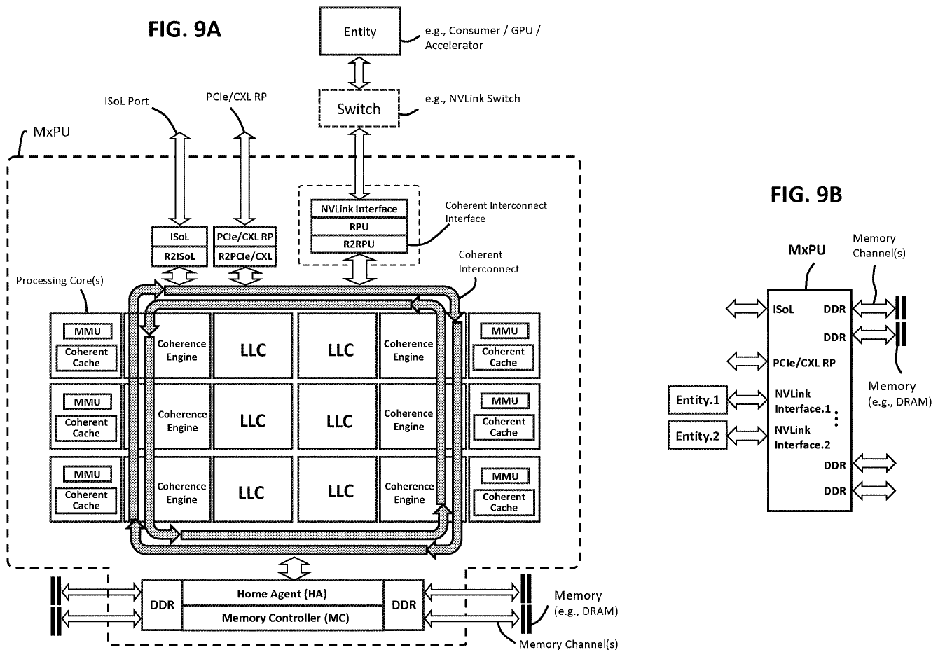

FIG. 9A illustrates an example of a processor (such as an MxPU that may be derived from an established processor design) comprising processing cores, last level cache (LLC), and a coherent interconnect utilizing a topology structure of a ring. Alternatively, the coherent interconnect may utilize other topology structures such as a mesh, a crossbar, or a custom topology. The processor may include an NVLink interface, and an ISoL port, such as a port utilizing ARM CHI C2C, NVIDIA NVLink-C2C, Intel UPI, or AMD Infinity Fabric. The processor may further include a PCIe/CXL root port (PCIe/CXL RP), and may be coupled to memory, such as DRAM, optionally via a memory controller and memory channels. The NVLink interface may communicate with an entity, such as a GPU or a CPU, optionally via a switch, according to an NVLink-based protocol, wherein an RPU may perform physical address translations that may enable the entity to access the memory via the NVLink interface. The illustrated RPU is coupled to the on-chip ring interconnect via a coherent interconnect interface, such as a Ring-to-RPU (R2RPU). Alternatively, the RPU may be coupled to the on-chip ring interconnect essentially directly. Similarly, the illustrated ISoL port is coupled to the on-chip ring interconnect via a coherent interconnect interface, such as a Ring-to-ISoL (R2ISoL), and the PCIe/CXL RP is coupled to the on-chip ring interconnect via a coherent interconnect interface, such as a Ring-to-PCIe/CXL (R2PCIe/CXL). The processor may be implemented as a monolithic die, as chiplets within an IC package, such as by utilizing separate compute die(s) and I/O die(s), or as components on a board.

FIG. 9B illustrates an example of a processor (such as an MxPU) comprising NVLink interfaces, DDR channels, at least one optional PCIe/CXL RP, and at least one optional ISoL. The NVLink interfaces may not utilize the same physical address space, may be coupled to entities, optionally via a switch, and may communicate with the entity according to one or more NVLink-based protocols.

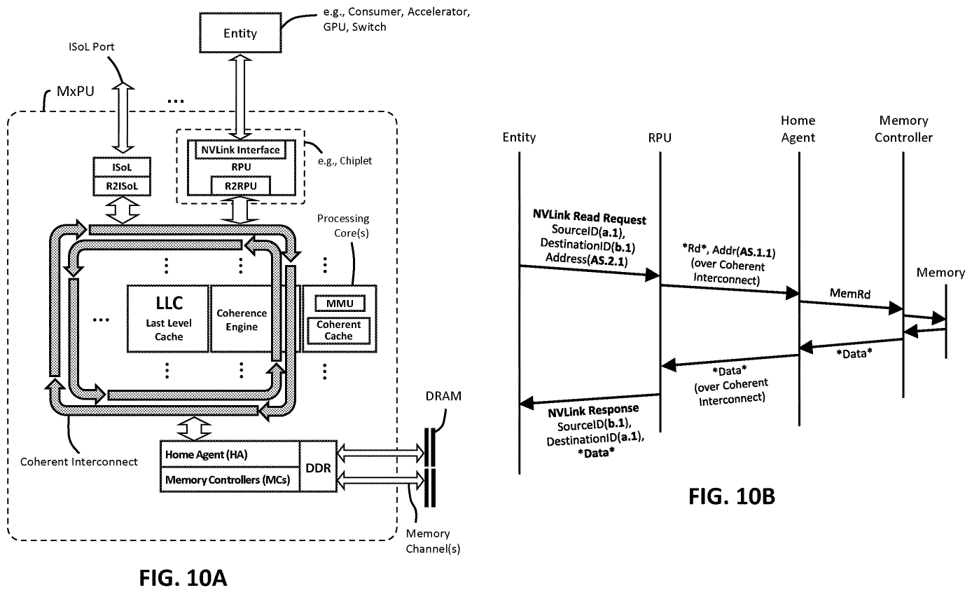

FIG. 10A illustrates an example of a processor (such as an MxPU) comprising processing cores, caches, and a coherent interconnect utilizing a topology structure of a ring. Alternatively, the coherent interconnect may utilize other topology structures such as a mesh, a crossbar, or a custom topology. The processor may further include an ISoL port such as ARM CHI C2C, NVIDIA NVLink-C2C, or Intel UPI, and memory controllers coupled via memory channels to memory, such as DRAM. The processor may include an NVLink interface that may communicate with an entity such as a GPU or an accelerator, according to an NVLink-based protocol, wherein an RPU may perform physical address translations to enable the entity to access the memory. The illustrated RPU is coupled to the coherent interconnect via a Ring-to-RPU (R2RPU) interconnect interface. Alternatively, the RPU may be coupled to the on-chip ring interconnect essentially directly. In some examples, the RPU, the NVLink interface, and the R2RPU may reside on a chiplet, such as an NVLink chiplet or NVLink Fusion, and coupled to the coherent interconnect via a chip-to-chip (C2C) interface. Similarly, the illustrated ISoL port may be coupled to the on-chip ring interconnect via a Ring-to-ISoL (R2ISoL) interconnect interface. The processor may be implemented as a monolithic die that includes the RPU and the NVLink interface, as silicon dies or chiplets within an IC package, such as by utilizing separate compute die(s) and I/O die(s), or as components on a board.

FIG. 10B illustrates an example of a TFD demonstrating an NVLink read request received from an entity, such as a GPU or an accelerator, wherein the RPU may translate a physical address (AS.2.1) carried in the NVLink request, to a physical address (AS.1.1) utilized for accessing the memory. The NVLink request may carry ID-based fields, such as source ID and destination ID, which may be utilized by NVLink switches for routing the request. In some examples, the NVLink request may further include a Tag that may be utilized to identify a transaction and match it with a corresponding NVLink response, and may further include a Length field that may specify the length of the data transfer requested. In some examples, the RPU may translate an NVLink request to multiple read transactions of the protocol utilized by the coherent interconnect, such as in order to fulfill the length of the data transfer specified in the NVLink request. The RPU may perform further translations, such as protocol translations from an NVLink-based protocol to a protocol utilized by the processor's coherent interconnect, and may further send the optionally translated request to a home agent (also known as home node), and/or to a memory controller, requesting the read of address (AS.1.1). In some examples, the requested data may be provided by a processor cache, such as by an LLC, instead of being provided by the memory. The data may then return over the processor's coherent interconnect to the RPU, wherein the RPU provides an NVLink response to the requesting entity. In some examples, the NVLink response may include a Tag that may identify the transaction and may enable matching the NVLink response with a corresponding NVLink request.

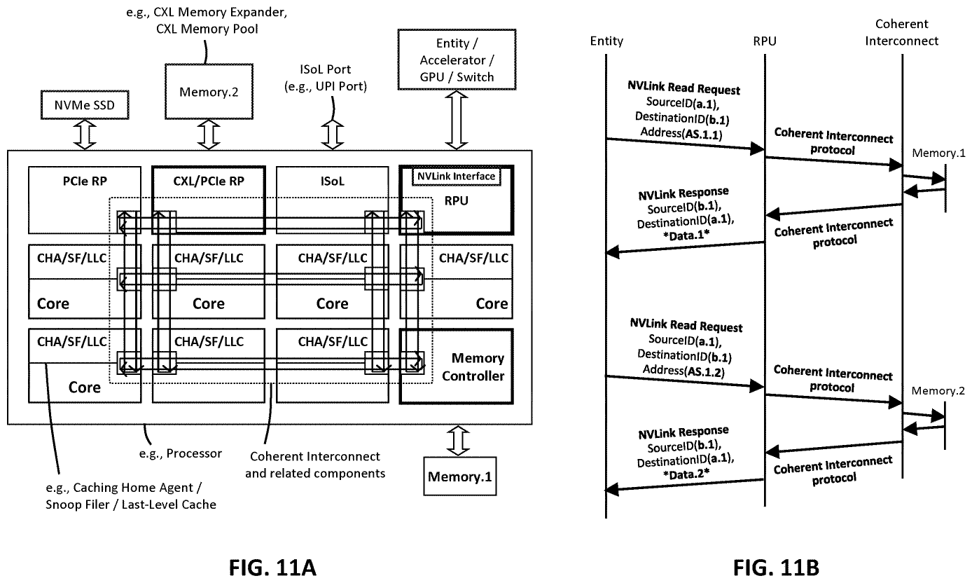

FIG. 11A illustrates an example of a system comprising a processor, including a coherent interconnect, capable of enabling an external entity to access memory resources mapped to the address space utilized by the coherent interconnect. Optionally, the processor may include an MxPU derived from an established processor design that may include processing cores, caching/home agent (CHA), snoop filter (SF), and last-level cache (LLC), optionally implemented as slices distributed across tiles on the coherent interconnect mesh. The processor may further include an ISoL port (such as a port utilizing Intel Coherent Processor Interconnect Protocol (ICPIP), or ARM CHI C2C), a PCIe RP that may be coupled to an NVMe SSD, a CXL/PCIe RP, and/or a memory controller that may be coupled to a first memory, such as DRAM. The processor may be coupled to a second memory, such as a CXL memory expander or a CXL memory pool, and may further include an RPU that includes or coupled to an NVLink interface that may communicate with an entity, such as an accelerator, according to an NVLink-based protocol, wherein the RPU may perform physical address translations to enable the entity to access the first memory (Memory.1) and/or the second memory (Memory.2). The illustrated RPU may be coupled to the coherent interconnect, and may translate between the NVLink-based protocol and a protocol utilized by the coherent interconnect. The processor may be implemented as a monolithic die, as chiplets within an IC package, such as by utilizing separate compute die(s) and I/O die(s), or as components on a board, and may utilize a mesh-based coherent interconnect, or in other examples may utilize a ring, a crossbar, or other types of coherent interconnects. In other examples, the NVLink interface may reside on a separate chiplet, such as an NVLink Fusion, and may be coupled to the coherent interconnect via a UCIe interface or a proprietary chip-to-chip or die-to-die interface.

FIG. 11B illustrates an example of a TFD demonstrating two NVLink requests, such as NVLink read requests, received from an entity (such as an accelerator, GPU, or a switch) and forwarded to different memories mapped to an address space utilized by the coherent interconnect. The RPU may perform physical address translations to enable the entity to access the processor's memories. The processor may have multiple memory resources, such as DRAM coupled to a memory controller of the processor, and/or memory expanders that may be coupled to a CXL RP of the processor. The RPU may further translate from NVLink-based traffic to traffic conforming to a protocol utilized by the coherent interconnect, and may send the optionally translated traffic to the coherent interconnect, requesting a read from memory. In some examples, the requested data may be provided by a processor cache, such as by an LLC, instead of by the memory. The data may then return over the coherent interconnect to the RPU, wherein the RPU provides an NVLink response to the requesting entity. The TFD illustrates two exemplary transactions carrying different physical addresses mapped to different memory resources. The first exemplary transaction includes an NVLink request comprising physical address (AS.1.1), which the RPU translates and forwards via the coherent interconnect protocol to Memory.1, resulting in the retrieval of *Data.1* that is returned to the entity with the first NVLink response. The second exemplary transaction includes an NVLink request comprising physical address (AS.1.2), which the RPU translates and forwards via the coherent interconnect protocol to Memory.2, resulting in the retrieval of *Data.2* that is returned to the entity with the second NVLink response. The physical addresses (AS.1.1) and (AS.1.2) may refer to different memory regions within the address space utilized by the coherent interconnect, enabling the entity to access memory resources based on the RPU's translation capabilities.

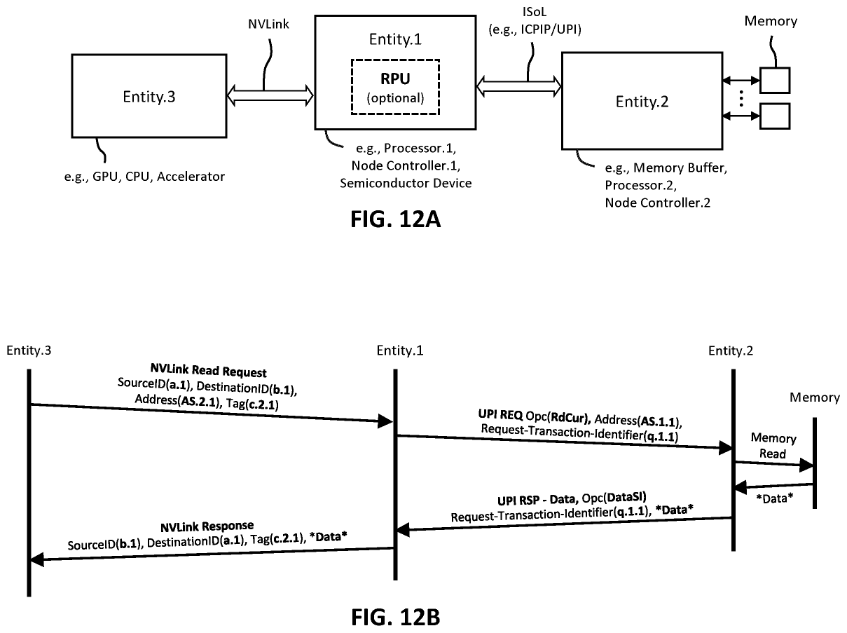

FIG. 12A illustrates an example of a system comprising a first entity (Entity.1), such as a first processor (Processor.1), a first node controller (Node Controller.1), or a semiconductor device, which may include an RPU. The first entity may be coupled to a third entity (Entity.3), which may be an accelerator, a GPU, a CPU, or an NVLink switch, wherein the first entity may communicate with the third entity according to an NVLink-based protocol, such as a protocol utilizing an NVLink interconnect. The first entity may be further coupled to a second entity (Entity.2), which may be a second processor (Processor.2), a memory buffer, or a second node controller (Node Controller.2), wherein the second entity may be coupled to memory, and wherein the first entity may communicate with the second entity according to an ISoL protocol, such as ARM CHI C2C, a protocol utilizing an NVIDIA NVLink-C2C interconnect, or Intel Coherent Processor Interconnect Protocol (ICPIP), such as Intel UPI. The first node controller (Node Controller.1) and the second node controller (Node Controller.2) may each include an ICPIP node controller, such as a UPI node controller (UNC), or an external node controller (e.g., XNC).

The first entity, optionally via the RPU, may translate between messages conforming to the NVLink-based protocol and messages conforming to the ISoL protocol, such as ICPIP, enabling the third entity to access resources coupled to the first entity (Entity.1), such as the memory that may be coupled to the second entity. In some examples, messages conforming to the NVLink-based protocol may be associated with a first address space, such as an NVLink-based address space, an NVLink-based network address space, or a GPU address space; and messages conforming to the ISoL protocol, such as ICPIP (e.g., Intel UPI), may be associated with a second address space, such as a System Physical Address (SPA) space or a Host Physical Address (HPA) space; wherein the first entity, optionally via the RPU, may perform address translations between addresses within the first and second address spaces, respectively, such as between addresses within the NVLink-based address space and addresses within the SPA space or the HPA space. In other examples, messages conforming to the NVLink-based protocol and messages conforming to the ISoL protocol, such as ICPIP (e.g., Intel UPI), may be associated with the same physical address space, such as with a global address space, a partitioned global address space (PGAS), a pod address space, a virtual pod address space, or a fabric address space; wherein the first entity, optionally via the RPU, may perform address translations between addresses within the same address spaces.

The first entity, optionally via the RPU, may perform further translations, such as protocol translations, opcode translations, command translations, TLP translations, or field translations (e.g. cross-field translations), such as between request types of NVLink requests and opcodes in requests conforming to the ISoL Protocol (e.g., Intel UPI RdCur opcode). The first entity, optionally via the RPU, may further translate between values of fields carried in PDUs of the NVLink-based protocol and in PDUs of the ISoL Protocol, e.g., translate traffic class (TC) and/or Tags, wherein the first entity, optionally via the RPU, may maintain tracking between Tags associated with the NVLink-based protocol and Tags associated with the ISoL protocol, such as in order to associate responses with their corresponding requests, within the same domain and/or between different domains.

FIG. 12B illustrates an example of a TFD demonstrating translations performed by a first entity (Entity.1), such as a first processor (Processor.1), a first node controller (Node Controller.1), or a semiconductor device, optionally via an RPU, between NVLink-based traffic and ISoL traffic, such as ICPIP traffic. The NVLink-based traffic may be utilized for communicating with a third entity (Entity.3), such as an accelerator, and the ISoL traffic may be utilized for communicating with a second entity (Entity.2), such as a second processor (Processor.2), or a second node controller (Node Controller.2). The second entity may be coupled to a memory, such as DRAM, which may be mapped to a physical address space (PAS) utilized by the first entity. The third entity may initiate an NVLink request, such as an NVLink read request, comprising SourceID(a.1), DestinationID(b.1), Address(AS.2.1), and Tag(c.2.1), wherein SourceID(a.1) may identify the source entity in the NVLink interconnect, such as the source GPU, wherein DestinationID(b.1) may identify the destination entity in the NVLink interconnect, such as the destination GPU, and wherein the NVLink interconnect may utilized ID-based routing when forwarding the NVLink request. The first entity, optionally via the RPU, may translate the NVLink request to an ISoL (e.g., ICPIP) transaction, such as an Intel UPI transaction that may include a UPI request (REQ message class) comprising Opc(RdCur), Address(AS.1.1), and Request-Transaction-Identifier(q.1.1), wherein the Request-Transaction-Identifier (e.g., RTID) may denote a Tag, a transaction Tag, a transaction identifier, or another field or set of fields carried in UPI transactions which may serve to associate responses with their corresponding requests. The first entity may send the UPI request (REQ) to the second entity.

Upon receiving a response from the second entity, that may include a UPI data response (“RSP-Data” message class, which may also be denoted by “RSP4-Data”) comprising Opc(DataSI), Request-Transaction-Identifier(q.1.1), and *Data*, the first entity, optionally via the RPU, may translate the UPI response (RSP-Data) to an NVLink response comprising SourceID(b.1), DestinationID(a.1), Tag(c.2.1), and *Data*. In some examples, the requested data may be provided by a processor cache instead of by the memory, such as wherein the requested data may be provided by an LLC that may be included in the first entity, or by an LLC that may be included in the second entity. In other examples, the first entity (Entity.1), optionally via the RPU, may translate the NVLink request to an ICPIP transaction, such as an Intel UPI transaction, that may include message classes such as REQ, SNP, WB, RSP (such as RSP2 or RSP4), NCB, or NCS, that may include commands, operations, or opcodes (e.g., Opc), such as RdCode, RdCur, RdData, RdInv, RdInvOwn, SnpCode, SnpCur, SnpData, SnpInv, WbMtoS, WcWr, WcWrPtl, DataE, DataSI, or DataM_CmpO. The first entity, optionally via the RPU, may perform further translations, such as protocol translations, opcode translations, command translations, or translations between protocol data units (PDUs) of the NVLink-based traffic and PDUs of the ISoL traffic (e.g., Intel UPI), such as traffic class (TC) translations, cross-field translations, or Tag translations. The first entity, optionally via the RPU, may maintain tracking between Tags in the NVLink-based domain and Tags in the ISoL domain, such as in order to associate responses with their corresponding requests, within the same domain and/or between different domains.

Heterogeneous computing architectures may incorporate systems wherein entities utilize different protocols while requiring coordinated access to shared resources. In such environments, a first entity operating with CXL.mem may need to access resources coupled to a second entity operating with PCIe. For example, a newer generation server may utilize CXL.mem to access data on a non-CXL server populated with DDR4, where translations between CXL.mem and PCIe enable utilizing the non-CXL server as a memory pool. Translations between CXL.mem messages and PCIe TLPs may facilitate memory operations, data transfers, and resource sharing across different domains while maintaining the requirements of each protocol. Such translations may be performed by a computer, an apparatus, a cable, or other suitable devices positioned between the first entity and the second entity.

In various implementations, a method for translating between Compute Express Link (CXL) messages and Peripheral Component Interconnect Express (PCIe) Transaction Layer Packets (TLPs), comprising: receiving, by a computer from a first entity, a CXL.mem Master-to-Subordinate (M2S) request; translating, by the computer, the CXL.mem M2S request to a PCIe memory request; sending, by the computer to a second entity, the PCIe memory request; receiving, by the computer from the second entity, a PCIe Completion corresponding to the PCIe memory request; translating, by the computer, the PCIe Completion to a CXL.mem Subordinate-to-Master (S2M) response; and sending, by the computer to the first entity, the CXL.mem S2M response. The translation process may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information, such as pending transaction tables or tracker entries, to correlate incoming PCIe Completions with previously transmitted PCIe memory requests and with pending CXL.mem transactions. Additionally, the elements may communicate through one or more intermediary components, such as a switch, a retimer, or other suitable entity that facilitates information transfer.

In some implementations of the method, the CXL.mem M2S request comprises a first physical address belonging to a first physical address space utilized by the first entity, and wherein translating the CXL.mem M2S request to the PCIe memory request comprises generating the PCIe memory request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations of the method, the CXL.mem M2S request comprises MemRd* and a first Tag, the PCIe memory request comprises a non-UIO Memory Read request comprising a second Tag, the PCIe Completion comprises a Completion with Data (CplD) comprising Data, and the CXL.mem S2M response comprises an S2M Data Response (S2M DRS) comprising MemData, the Data, and the first Tag. The computer may maintain a mapping between the first Tag associated with the CXL.mem transaction and the second Tag associated with the PCIe transaction, wherein this mapping may be stored in a tracker entry, a translation table, or similar data structure. Upon receiving the CplD from the second entity, the computer may utilize the second Tag to identify the corresponding pending transaction and retrieve the first Tag for inclusion in the S2M DRS. The non-UIO Memory Read request may conform to non-UIO PCIe memory read semantics as defined in applicable PCIe specifications.

In some implementations, the method further comprises receiving, by the computer from the first entity, a CXL.mem M2S request with Data (M2S RwD) comprising a MemWr* and write data; translating the CXL.mem M2S RwD to a PCIe non-UIO Memory Write request comprising the write data; sending the PCIe non-UIO Memory Write request to the second entity; and sending a CXL.mem S2M No Data Response (S2M NDR) to the first entity. The PCIe non-UIO Memory Write request may be a posted write that may not require a completion from the second entity. The S2M NDR may include Cmp* indicating successful acceptance of the write request by the computer. The computer may include a DevLoad in the S2M NDR to provide telemetry information or to throttle subsequent requests from the first entity.

In some implementations of the method, the computer sends the CXL.mem S2M NDR to the first entity before sending the non-UIO Memory Write request to the second entity. Sending the S2M NDR before the PCIe Memory Write request may reduce latency observed by the first entity and may allow the first entity to proceed with subsequent operations without waiting for the write to propagate to the second entity. The computer may buffer the write data and transmit the PCIe Memory Write request asynchronously, optionally implementing flow control or ordering mechanisms to maintain consistency guarantees.

In some implementations, the method further comprises receiving, by the computer from the first entity, a CXL.mem M2S request with Data (M2S RwD) comprising a MemWr* and write data; translating the CXL.mem M2S RwD to a PCIe UIO Memory Write request (UIOMWr) comprising the write data; sending the PCIe (UIOMWr) to the second entity; receiving, from the second entity, a PCIe UIO Write Completion (UIOWrCpl); and sending a CXL.mem S2M No Data Response (S2M NDR) comprising Cmp* to the first entity. PCIe UIO may provide enhanced capabilities compared to non-UIO PCIe, including support for non-posted writes that return completions. The UIOWrCpl may indicate successful completion of the write operation by the second entity and may carry additional information.

In some implementations of the method, the CXL.mem S2M NDR comprises a DevLoad, and wherein the computer populates the DevLoad with information derived from at least one of the PCIe UIOWrCpl, or telemetry information. In some revisions of the CXL specification, CXL.mem S2M NDR messages may include a DevLoad. The computer may populate the DevLoad of the CXL.mem S2M NDR with information derived from the UIOWrCpl or with telemetry information generated by the computer.

In some implementations of the method, the PCIe UIOWrCpl comprises a CXL DevLoad (CDL) comprising Quality-of-Service (QoS) telemetry, and wherein the computer translates the QoS telemetry carried in the CDL of the PCIe UIOWrCpl to a DevLoad of the CXL.mem S2M NDR, enabling the first entity to receive QoS information originating from the second entity. The CDL may carry telemetry information, such as device load indicators, queue depth information, or latency metrics generated by the second entity. By translating the CDL to the DevLoad, the computer may propagate QoS telemetry across the protocol boundary, enabling the first entity to make informed decisions regarding request pacing, load balancing, or resource allocation based on conditions at the second entity. The translation may involve copying, scaling, adjusting, or mapping of the telemetry values between the CDL and devload field formats.

In some implementations of the method, the CXL.mem M2S request comprises MemRd* and a first Tag, the PCIe memory request comprises a UIO Memory Read (UIOMRd) request comprising a second Tag, the PCIe Completion comprises a UIO Read Completion with Data (UIORdCplD) comprising Data, and the CXL.mem S2M response comprises an S2M Data Response (S2M DRS) comprising MemData, the Data, and the first Tag. The UIOMRd may provide enhanced semantics compared to non-UIO PCIe memory read operations, such as support for out-of-order completions or additional metadata fields. The UIORdCplD may carry the requested data along with status information or telemetry. The computer may extract the data from the UIORdCplD and format it according to CXL.mem S2M DRS requirements for delivery to the first entity.

In some implementations of the method, the CXL.mem S2M response comprises a DevLoad, wherein the computer populates the DevLoad with telemetry information or utilizes the DevLoad to throttle CXL.mem M2S requests from the first entity, wherein the first entity comprises a first host, and wherein the second entity comprises a second host or a PCIe device. The DevLoad may enable the computer to communicate backpressure, congestion indicators, or performance metrics to the first host. The first host may utilize this information to adjust its request rate, implement adaptive flow control, or make scheduling decisions. The second entity may include various types of devices, such as a server, a memory expander, a GPU, a NIC, a storage device, or other PCIe-attached resources.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a first interface configured to communicate with a first entity based on CXL.mem, wherein CXL denotes Compute Express Link; a second interface configured to communicate with a second entity based on Peripheral Component Interconnect Express (PCIe); a computer coupled to the first interface and the second interface, the computer configured to: receive, via the first interface, a CXL.mem Master-to-Subordinate (M2S) request comprising a first physical address belonging to a first physical address space utilized by the first entity; translate the CXL.mem M2S request to a PCIe memory request comprising a second physical address belonging to a second physical address space utilized by the second entity; and send, via the second interface, the PCIe memory request to the second entity. The apparatus may be implemented as a semiconductor device, a card, a module, an active cable, or other suitable form factor. The first interface may expose the apparatus to the first entity as a CXL switch, or as a CXL device, such as a CXL Type-2 device or a CXL Type-3 device. The second interface may expose the apparatus to the second entity as a PCIe switch, as a PCIe device, or as a host via a root port. The computer may include logic for address translation, Tag management, protocol conversion, and transaction tracking. Optionally, the apparatus may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and optional PCIe switch(es) may be positioned between the second interface and the second entity.

In some implementations of the apparatus, the computer is further configured to: receive, via the second interface, a PCIe Completion corresponding to the PCIe memory request; translate the PCIe Completion to a CXL.mem Subordinate-to-Master (S2M) response; and send, via the first interface, the CXL.mem S2M response to the first entity; wherein the first interface exposes to the first entity one of the following: a CXL switch, a CXL Type-2 device, or a CXL Type-3 device; and wherein the second interface exposes to the second entity one of the following: a PCIe switch, a PCIe device, or a root port. When the second interface exposes a root port, the apparatus may function as a host toward the second entity, enabling the apparatus to initiate PCIe transactions to downstream PCIe devices. When the second interface exposes a PCIe device, the apparatus may function as an endpoint toward the second entity, such as when coupled to another host.

In some implementations of the apparatus, the first physical address space comprises the second physical address space. The second physical address space may be a PCIe Memory Address Space, a DMA address space, an IO virtual address (IOVA) space, or a system address space, and may further be a subset of the first physical address space or identical to the first physical address space.

In some implementations of the apparatus, the apparatus comprises a cable including a first module coupled to the first interface, a second module coupled to the second interface, and a physical medium coupling the first module and the second module. The cable may be an active cable that includes the computer for performing protocol and address translations. The first module may include electrical or optical components for communicating with the first entity, and the second module may include electrical or optical components for communicating with the second entity. The cable may conform to various industry standards or specifications, such as those defined by the Optical Internetworking Forum (OIF), the Small Form Factor Committee (SFF), or the IEEE.

In some implementations of the apparatus, the physical medium comprises a twinaxial cable, a multimode fiber (MMF), or a single-mode fiber (SMF); and wherein the cable is configured to couple to the first entity or the second entity via a connector selected from Octal Small Form Factor Pluggable Module (OSFP), Octal Small Form Factor eXtra Dense Pluggable Module (OSFP-XD), Quad Small Form-Factor Pluggable (QSFP), or Quad Small Form-Factor Pluggable Double Density (QSFP-DD). The twinaxial cable may be suitable for shorter reach applications within a rack or between adjacent racks, while fiber options may enable longer reach connectivity. The MMF may be utilized for distances up to several hundred meters, while SMF may be utilized for longer distances. The connector type may be selected based on bandwidth requirements, density considerations, and deployment environment. The cable may be implemented as an Active Optical Cable (AOC) or an Active Copper Cable (ACC) depending on the physical medium utilized.

In various implementations, a system comprising: a first entity coupled to a first memory; a second entity coupled to a second memory, wherein the second entity comprises a Central Processing Unit (CPU) configured to support Peripheral Component Interconnect Express (PCIe) but not Compute Express Link (CXL); and a computer coupled between the first entity and the second entity, the computer configured to: receive, from the first entity, a CXL.mem Master-to-Subordinate (M2S) request; translate the CXL.mem M2S request to a PCIe memory request; send, to the second entity, the PCIe memory request to access the second memory; receive, from the second entity, a PCIe Completion; and send, to the first entity, a CXL.mem Subordinate-to-Master (S2M) response corresponding to the PCIe Completion. The system may enable the first entity to access memory resources coupled to CPUs that do not support CXL, thereby extending the reach of CXL-based memory pooling to include legacy and/or non-CXL infrastructure. The CPU of the second entity may be a processor from a generation that predates CXL support, or may be a processor that uses its CXL capabilities for other purposes. The second memory may be attached to the second entity via memory controllers integrated in the CPU, and the computer may enable the first entity to access this memory utilizing PCIe transactions that the CPU can process.

In some implementations of the system, the second entity and the second memory form a memory pool, and wherein the computer is configured to expose the memory pool to the first entity. The memory pool may appear to the first entity as CXL-attached memory, even though the underlying memory is coupled to a non-CXL CPU. The computer may expose the memory pool by responding to CXL.mem initialization and configuration operations from the first entity and by translating subsequent memory access requests to PCIe transactions directed to the second entity. Multiple second entities and their associated memories may be aggregated into a larger memory pool that the computer exposes to one or more first entities.

In some implementations of the system, the second memory comprises DDR4 memory, and wherein the first memory comprises DDR5 memory. The system may enable tiered memory architectures wherein the first entity utilizes higher-performance memory technologies, such as DDR5, for latency-sensitive operations, while utilizing DDR4 memory coupled to the second entity for capacity-oriented workloads. The computer may enable the first entity to transparently access the DDR4 memory tier utilizing CXL.mem, and memory management software executing on the first entity may place data across tiers based on access patterns, SLA requirements, tenant identities, temperature thresholds, or other policies.

In some implementations of the system, The system of claim 20 wherein the CPU comprises a pre-CXL generation CPU, and the pre-CXL generation CPU is installed in a datacenter server. The pre-CXL generation CPU may include processors that were manufactured or designed before CXL became available, or processors that do not include CXL capability. The datacenter server may be a server that has been decommissioned from primary compute duties but retains functional memory and PCIe connectivity. The system may enable repurposing of such servers as memory pool contributors, thereby extending the useful life of datacenter infrastructure and reducing electronic waste while providing additional memory capacity to CXL-enabled first entities.

In multi-host environments, there may be scenarios where first entities operating with CXL.mem need to access memory or other resources coupled to a second entity operating with PCIe. For example, newer generation servers may utilize CXL.mem to access data on a non-CXL server, where translations between CXL.mem and PCIe enable utilizing the non-CXL server as a shared memory pool. Translations between CXL.mem messages and PCIe TLPs may facilitate memory operations, data transfers, and resource sharing across different protocol domains while maintaining the requirements of each protocol and routing responses to the appropriate requesting entities.

In various implementations, a method for translating between Compute Express Link (CXL) messages and Peripheral Component Interconnect Express (PCIe) Transaction Layer Packets (TLPs), comprising: receiving, by a computer, CXL.mem Master-to-Subordinate (M2S) requests from first entities; translating, by the computer, the CXL.mem M2S requests to PCIe memory requests; sending, by the computer to a second entity, the PCIe memory requests; receiving, by the computer from the second entity, PCIe Completions corresponding to the PCIe memory requests; translating, by the computer, the PCIe Completions to CXL.mem Subordinate-to-Master (S2M) responses; and sending, by the computer, each of the CXL.mem S2M responses to a corresponding one of the first entities. The translation process may encompass various aspects of the protocol messages, including opcodes, addresses, and transaction identifiers, thereby enabling communication between CXL.mem-capable entities and a PCIe-capable entity. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information to correlate incoming PCIe Completions with previously transmitted PCIe memory requests and with the originating first entities, enabling responses to be routed to the correct requester. The first entities may include hosts, accelerators, GPUs, NICs, or other CXL-capable devices that share access to resources coupled to the second entity. Additionally, the elements may communicate through one or more intermediary components, such as a switch, a retimer, or other suitable entity that facilitates information transfer.

In some implementations of the method, the computer maintains separate tracking structures for each of the first entities, and wherein the computer processes CXL.mem M2S requests received from different ones of the first entities in parallel, by storing transaction information in the respective separate tracking structures. The separate tracking structures may enable the computer to manage outstanding transactions from different first entities without interference. Each tracking structure may store information such as CXL.mem Tags, addresses, opcodes, and timestamps associated with transactions from the corresponding first entity. By maintaining separate structures, the computer may support concurrent processing wherein a CXL.mem M2S request from one first entity may be translated and sent while awaiting a PCIe Completion for a request from another first entity. The tracking structures may be implemented as tables, queues, linked lists, content-addressable memories, or other data structures suitable to associate PCIe Completions with their originating CXL.mem transactions and first entities.

In some implementations of the method, the computer sequentially processes the CXL.mem M2S requests received from the first entities by queuing the CXL.mem M2S requests and translating each queued CXL.mem M2S request in order, wherein the computer completes sending one of the PCIe memory requests before translating a subsequent one of the CXL.mem M2S requests. Sequential processing may be utilized in implementations where simplicity, determinism, and/or resource constraints favor processing one request at a time. The computer may queue incoming CXL.mem M2S requests in a first-in-first-out (FIFO) buffer or other queuing structure and may process each request to completion before beginning the next, which may reduce the complexity of tracking concurrent transactions and may provide predictable ordering of memory operations. Sequential processing may be suitable for scenarios where the first entities have relatively low aggregate request rates or where strict ordering guarantees are desired.

In some implementations of the method, a first one of the first entities utilizes a first Host Physical Address (HPA) space, wherein a second one of the first entities utilizes a second HPA space different from the first HPA space, and wherein translating the CXL.mem M2S requests to the PCIe memory requests comprises translating addresses from the first HPA space and addresses from the second HPA space to corresponding addresses in a physical address space utilized by the second entity. The address translation may accommodate scenarios where different first entities operate with independent HPA spaces that may have overlapping address ranges. The computer may maintain separate translation tables or functions for each first entity, mapping addresses from each first entity's HPA space to non-overlapping regions of the second entity's physical address space. Alternatively, the computer may utilize a unified translation mechanism that incorporates first entity identifiers as part of the address mapping. The second entity's physical address space may be a PCIe Memory Address Space, a system address space, or a DMA address space. The translation may involve base-and-offset calculations, page table lookups, or programmable translation functions.

In some implementations of the method, the computer allocates PCIe Tags for the PCIe memory requests, wherein the computer associates the PCIe Tags with identifiers of the corresponding ones of the first entities, and wherein the computer utilizes the PCIe Tags in the PCIe Completions to identify the corresponding ones of the first entities. PCIe Tags serve as transaction identifiers that enable completers to associate completions with their originating requests. The computer may allocate PCIe Tags from a pool and may record, for each allocated Tag, the identifier of the first entity that originated the corresponding CXL.mem M2S request. When a PCIe Completion arrives, the computer may extract the Tag from the completion, look up the associated first entity identifier, and route the translated CXL.mem S2M response to that first entity. The computer may also maintain a mapping between PCIe Tags and CXL.mem Tags to populate the correct Tag in the S2M response.

In some implementations of the method, the computer detects a timeout condition when a PCIe Completion corresponding to one of the PCIe memory requests is not received within a threshold duration, and wherein responsive to detecting the timeout condition, the computer sends a CXL.mem S2M response comprising an error indication to the corresponding one of the first entities. The timeout detection may provide a mechanism for handling non-responsive or failed transactions, preventing indefinite waiting by the first entities. The computer may associate a timestamp or timer with each outstanding PCIe memory request and may periodically check whether any pending transactions have exceeded the threshold duration. The threshold duration may be configurable and may be selected based on expected latencies, system policies, or protocol requirements. Upon detecting a timeout, the computer may release resources associated with the timed-out transaction, such as allocated Tags or tracking structure entries, and may generate an S2M response with an error opcode to notify the first entity of the failure. The timeout mechanism may also trigger logging, alerting, or error recovery procedures.

In some implementations of the method, at least one of the PCIe Completions comprises an error status indicating an Unsupported Request (UR) or a Completer Abort (CA), and wherein the computer translates the error status to an error indication in a corresponding one of the CXL.mem S2M responses. PCIe defines completion status values that indicate error conditions encountered by the completer. An Unsupported Request (UR) status indicates that the completer does not support the request type or that the request targeted an invalid address range. A Completer Abort (CA) status indicates that the completer encountered an error that prevented completion of the request. Other PCIe completion statuses, such as Configuration Request Retry Status (CRS), may also be translated to appropriate CXL.mem error indications. The computer may map these PCIe error statuses to CXL.mem S2M NDR messages with error opcodes or to S2M DRS messages with poison indicators, depending on the nature of the original request and the error encountered. The translation may preserve error semantics to enable the first entity to take appropriate recovery actions.

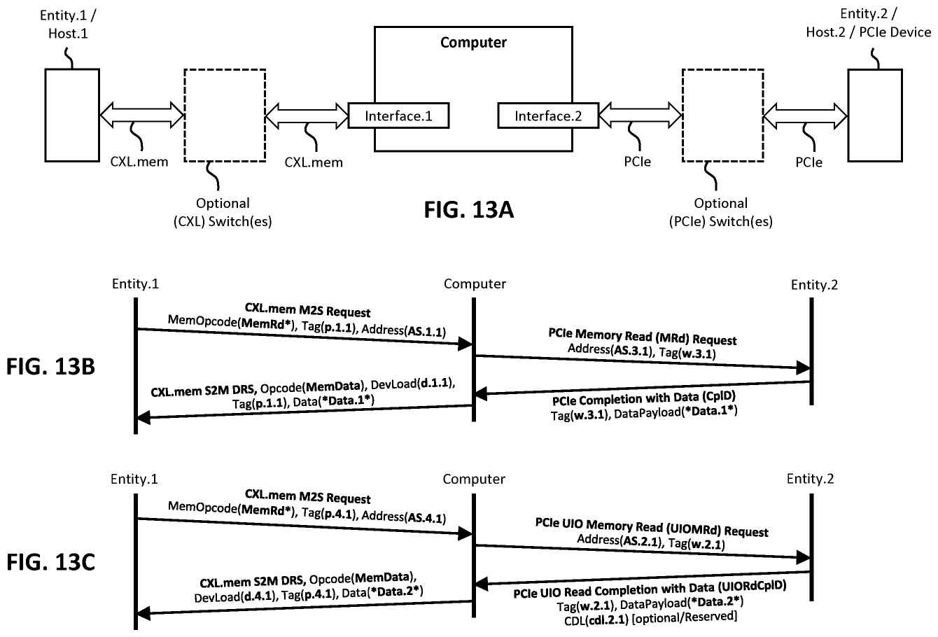

FIG. 13A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). In some examples, the second interface may expose a PCIe device, and may communicate according to PCIe with a second entity (Entity.2), such as a second host (Host.2) or another PCIe device. In other examples, the second interface may expose a root port (RP) and may communicate according to PCIe with a PCIe device. The computer may extract physical addresses within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity. Similarly, optional PCIe switch(es) may be positioned between the second interface and the second entity.

FIG. 13B illustrates an example of a transaction flow diagram (TFD) demonstrating translations, performed by a computer, between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that includes a CXL.mem M2S request comprising MemOpcode(MemRd*), Tag(p.1.1), and Address(AS.1.1). The computer may translate the CXL.mem transaction to a PCIe transaction, which may include a PCIe Memory Read (MRd) request comprising Address(AS.3.1) and Tag(w.3.1), and may send the PCIe MRd to the second entity. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*), and may send the CXL.mem S2M DRS to the first entity. The computer may perform further translations, such as protocol translations, opcode translations, command translations, TLP type translations, or field translations, such as Tag translations, between messages conforming to CXL.mem and TLPs conforming to PCIe. The computer may populate the DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification.

FIG. 13C illustrates an example of a TFD demonstrating translations between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request comprising MemOpcode(MemRd*), Tag(p.4.1), and Address(AS.4.1). The computer may translate the CXL.mem transaction to a PCIe transaction, which may include a PCIe UIO Memory Read (UIOMRd) request comprising Address(AS.2.1) and Tag(w.2.1), and may send the PCIe UIOMRd to the second entity. Upon receiving a response or completion from the second entity, which may include a PCIe UIO Read Completion with Data (UIORdCplD) comprising Tag(w.2.1), DataPayload(*Data.2*), and optionally CDL(cdl.2.1), the computer may translate the PCIe UIORdCplD to a CXL.mem S2M DRS comprising Opcode(MemData), DevLoad(d.4.1), Tag(p.4.1), and Data(*Data.2*) and may send the CXL.mem S2M DRS to the first entity. The optional CDL in the PCIe UIORdCplD, when not reserved, may be populated by the second entity with information such as QoS telemetry. The computer may translate the information carried in the optional CDL of the PCIe UIORdCplD received from the second entity, and populate the translated information in the DevLoad of the CXL.mem S2M DRS sent to the first entity. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

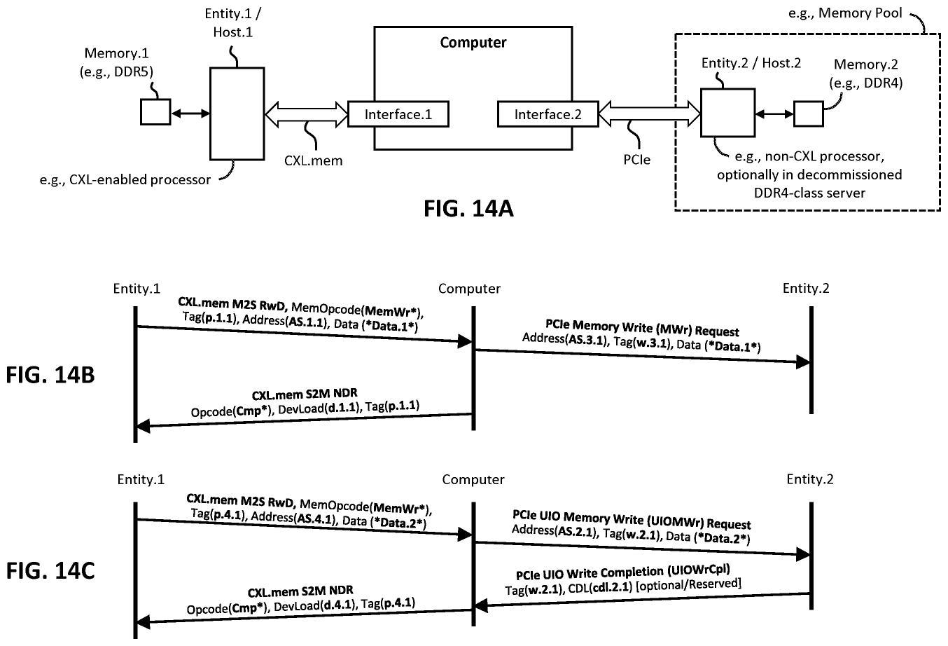

FIG. 14A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). The second interface may expose a PCIe device, and may communicate according to PCIe with a second entity (Entity.2), such as a second host (Host.2). The computer may extract physical addresses carried within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification.

The system may further include a memory pool comprising the second entity and a second memory, such as DDR4, wherein the computer may utilize the memory pool to expose a DDR4 memory tier to the first entity which may be coupled to a first memory, such as DDR5. In some examples, the second entity may not support CXL, or may be configured not to support CXL, potentially preventing the computer from utilizing CXL for accessing the second memory. In some examples, the second entity may include a server, such as a DDR4-class datacenter server, wherein the server may include a non-CXL processor that may not support CXL, such as a pre-CXL generation processor configured to support PCIe but not CXL, and wherein the non-CXL processor may enable the computer to access the second memory by utilizing PCIe.

FIG. 14B illustrates an example of a TFD demonstrating translations, optionally performed by a computer, between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request with data (RwD) comprising MemOpcode(MemWr*), Tag(p.1.1), Address(AS.1.1), and Data (*Data.1*). The computer may translate the CXL.mem M2S RwD transaction to a PCIe transaction, which may include a PCIe Memory Write request (MWr) comprising Address(AS.3.1), Tag(w.3.1), and Data (*Data.1*), and may send the PCIe MWr to the second entity. In some examples, the PCIe MWr may be a posted write that may not be followed by a response or completion from the second entity. The computer may respond to the CXL.mem M2S RwD received from the first entity with a CXL.mem S2M NDR comprising Opcode(Cmp*), DevLoad(d.1.1), and Tag(p.1.1), wherein the computer may send the CXL.mem S2M NDR to the first entity before sending the PCIe MWr to the second entity. Alternatively, the computer may send the CXL.mem S2M NDR to the first entity in parallel to sending the PCIe MWr to the second entity, or the computer may send the CXL.mem S2M NDR to the first entity after sending the PCIe MWr to the second entity. The computer may further populate the DevLoad of the CXL.mem S2M NDR with telemetry information, metadata, or other types of information collected or generated by the computer, or may utilize the DevLoad of the CXL.mem S2M NDR to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

FIG. 14C illustrates an example of a TFD demonstrating translations between CXL.mem requests received from a first entity (Entity.1), such as a first host (Host.1), and PCIe UIO requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe UIO requests sent to the second entity. The first entity may initiate a CXL.mem transaction that may include a CXL.mem M2S request with Data (M2S RwD) comprising MemOpcode(MemWr*), Tag(p.4.1), Address(AS.4.1), and Data (*Data.2*). A computer may translate the CXL.mem M2S RwD transaction to a PCIe transaction, which may include a PCIe UIO Memory Write request (UIOMWr) comprising Address(AS.2.1), Tag(w.2.1), and Data (*Data.2*), and may send the PCIe UIOMWr to the second entity. Upon receiving a response or completion from the second entity, which may include a PCIe UIO Write Completion (UIOWrCpl) comprising Tag(w.2.1) and optionally CDL(cdl.2.1), the computer may translate the PCIe UIOWrCpl to a CXL.mem S2M No Data Response (S2M NDR) comprising Opcode(Cmp*), DevLoad(d.4.1), and Tag(p.4.1), and may send the CXL.mem S2M NDR to the first entity.

The optional CDL in the PCIe UIOWrCpl, when not reserved, may be populated by the second entity with information such as QoS telemetry. The computer may translate the information carried in the optional CDL of the PCIe UIOWrCpl received from the second entity, and populate the translated information in the DevLoad of the CXL.mem S2M NDR sent to the first entity. DevLoad in CXL messages may be optional and may not exist in some revisions of the CXL specification. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. The computer may perform further translations, such as protocol translations, opcode translations, command translations, TLP type translations, or field translations, such as Tag translations, between messages conforming to CXL.mem and TLPs conforming to PCIe.

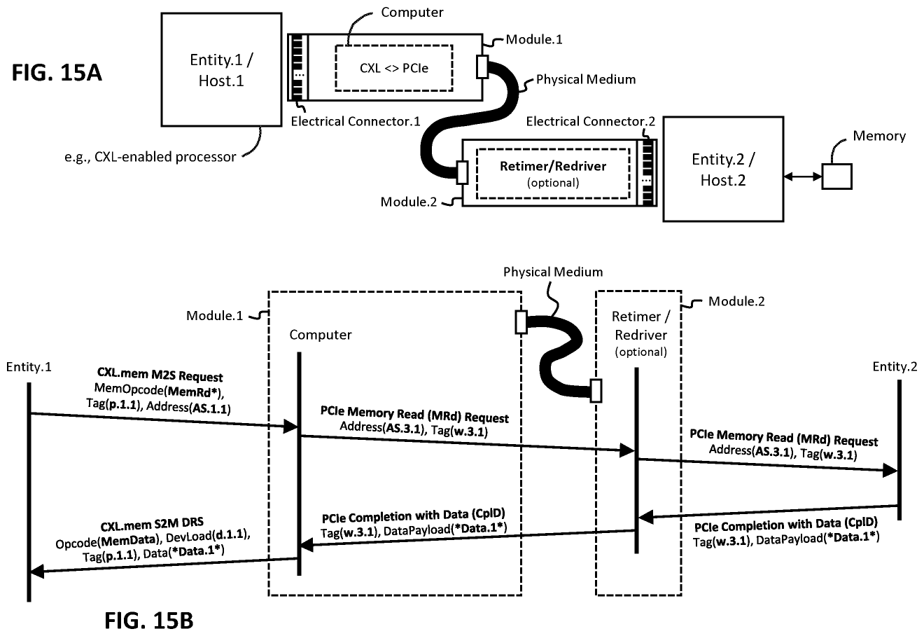

FIG. 15A illustrates an example of a system comprising a cable, such as an active cable, that may include a first module (Module.1), a second module (Module.2), and a physical medium coupling the first module and the second module. The physical medium may include a twinaxial cabling (also known as twinax cable), a multimode fiber (MMF), or a single-mode fiber (SMF). The cable may further include a computer that translates between CXL-based traffic, such as CXL.mem traffic, and a PCIe-based traffic, such as a PCIe or a PCIe-over-Ethernet traffic. The cable may enable a first entity (Entity.1) to access resources coupled to a second entity (Entity.2), such as a second host (Host.2). The first entity (Entity.1), which may be a first host (Host.1), may include a CXL-enabled processor. The access may be via the first module, the physical medium, and the second module. The resources may be memory coupled to the second entity, and the second entity may be a second host that may include a server, such as a DDR4-class datacenter server that may include a non-CXL processor that does not support CXL, such as a pre-CXL generation processor configured to support PCIe.

The cable may communicate with the first entity according to a CXL-based protocol, such as CXL.mem, and may communicate with the second entity according to a PCIe-based protocol. In some examples, messages conforming to the CXL-based protocol, such as CXL.mem, may be associated with a first address space, such as a first Host Physical Address (HPA) space; and messages conforming to the PCIe-based protocol may be associated with a second address space, such as a PCIe Memory Address Space, a DMA address space, an IO virtual address (IOVA) space, a system address space, or a second HPA space; wherein the cable may perform address translations between addresses within the first and second address spaces, respectively, such as between addresses within the first HPA space and addresses within the second HPA space. In other examples, messages conforming to the CXL-based protocol and messages conforming to the PCIe-based protocol may be associated with the same address space, wherein the cable may perform address translations between addresses within the same address space. Additionally, or alternatively, the system may perform further address translations, such as by an I/O Memory Management Unit (IOMMU), a System Memory Management Unit (SMMU), or a DMA address translation. The cable may perform further translations, such as protocol translations, opcode translations, command translations, TLP translations, or field translations between the CXL-based domain and the PCIe-based domain, such as translations of Tags and translations of error indications (e.g. data corruption indications such as poison).

The cable may further include a redriver or a retimer, such as a PCIe retimer, a CXL retimer, a dual-protocol CXL/PCIe retimer, a PAM4 retimer, or a retimer PHY. The cable, such as an OSFP copper cable, an OSFP-XD copper cable, an OSFP Active Optical Cable (AOC), or an OSFP-XD AOC cable, may conform to a standard specification, an industry standard, an implementation agreement (IA), or a multi-source agreement (MSA), such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard (such as SFF-8665), an Optical Internetworking Forum (OIF) implementation agreement, or an Institute of Electrical and Electronics Engineers (IEEE) standard. In some examples, the cable may be coupled to the first entity via a first electrical connector (Connector.1) and may be further coupled to the second entity via a second electrical connector (Connector.2), whereas in other examples, the cable may be coupled to the first entity and/or to the second entity via optical connectors.

FIG. 15B illustrates an example of a TFD demonstrating translations performed by a cable, such as an active cable comprising a computer and optionally a retimer or a redriver. The cable may include a first module (Module.1), a second module (Module.2), and a physical medium coupling the first module and the second module. The translations may be between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that may include a CXL.mem M2S request comprising MemOpcode(MemRd*), Tag(p.1.1), and Address(AS.1.1). The computer included in the cable may translate the CXL.mem transaction to a PCIe transaction, which may include a PCIe Memory Read (MRd) request comprising Address(AS.3.1) and Tag(w.3.1). The computer may send the PCIe MRd to the second entity, optionally via the second module that may include a retimer or a redriver. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*). The computer may send the CXL.mem S2M DRS to the first entity. The computer may populate DevLoad of CXL.mem S2M messages with telemetry information, metadata, or other types of information collected or generated by the cable, or may utilize the DevLoad of CXL.mem S2M messages to throttle CXL.mem requests from the first entity, enabling the cable to control, limit, shape, or throttle the rate of data communications between the first entity and the second entity. The computer may perform further translations, such as protocol translations, opcode translations, command translations, TLP type translations, or field translations, such as Tag translations, between messages conforming to CXL.mem and TLPs conforming to PCIe.

In heterogeneous computing architectures, entities may utilize different PCIe revisions while requiring coordinated access to shared resources. PCIe Unordered IO (UIO) is an optional capability that addresses limitations of PCI/PCIe fabric-based ordering rules, enabling multi-path routing, improved performance, and simplified fabric elements. However, PCIe specifications define UIO for Flit Mode (FM), and require that the entire path from requester to completer uses FM, supports UIO, and has UIO enabled. In environments where a first entity utilizing one PCIe revision needs to access resources coupled to a second entity utilizing a different PCIe revision, translations between PCIe UIO TLPs and PCIe non-UIO TLPs may facilitate memory operations and data transfers across different domains. Such translations may be performed by a computer, an apparatus, a cable, or other suitable devices positioned between the first entity and the second entity. The translations may further enable communication over split flit-mode/non-flit-mode paths, wherein the UIO portion utilizes flit-based encoding while the non-UIO portion may utilize non-flit-based encoding.

In various implementations, a method for translating between Peripheral Component Interconnect Express (PCIe) Transaction Layer Packets (TLPs), comprising: receiving, from a first entity, a first PCIe Memory Read request comprising a first address and a first Tag; translating, by a computer, the first PCIe Memory Read request to a second PCIe Memory Read request comprising a second address and a second Tag; wherein one of the first PCIe Memory Read request and the second PCIe Memory Read request comprises an Unordered Input/Output (UIO) Memory Read (UIOMRd) request, and the other comprises a non-UIO Memory Read (MRd) request; sending, to a second entity, the second PCIe Memory Read request; receiving, from the second entity, a second PCIe Completion comprising the second Tag and a data payload; translating, by the computer, the second PCIe Completion to a first PCIe Completion comprising the first Tag and the data payload; and sending, to the first entity, the first PCIe Completion. The translation process may encompass various aspects of the protocol messages, including opcodes, addresses, Tags, and other TLP fields, thereby enabling communication between entities that utilize different PCIe revisions. The computer may maintain state information, such as pending transaction tables or tracker entries, to correlate incoming PCIe Completions with previously transmitted PCIe Memory Read requests and with pending transactions. The method may be implemented in hardware, firmware, software, or combinations thereof, and may be performed by various types of devices, such as semiconductor devices, switches, bridges, or active cables. Additionally, the elements may communicate through one or more intermediary components, such as a switch, a retimer, or other suitable entity that facilitates information transfer.

In some implementations of the method, the first PCIe Memory Read request comprises the non-UIO MRd, the second PCIe Memory Read request comprises the UIO Memory Read (UIOMRd) request, the second PCIe Completion comprises a UIO Read Completion with Data (UIORdCplD), and the first PCIe Completion comprises a non-UIO Completion with Data (CplD). The non-UIO to UIO translation may enable a first entity that does not support UIO capabilities to access resources coupled to a second entity via a UIO-enabled path. The computer may translate the MRd to a UIOMRd, which may traverse a path supporting multi-path routing or out-of-order completion delivery. Upon receiving the UIORdCplD from the second entity, the computer may translate it to a CplD conforming to non-UIO PCIe completion expected by the first entity.

In some implementations of the method, the UIORdCplD comprises a CXL DevLoad (CDL), and wherein the computer extracts information from the CDL for at least one of: populating a CDL in a response to another entity, throttling subsequent requests, or storing Quality-of-Service (QoS) telemetry. The CDL in the UIORdCplD may carry telemetry information such as device load indicators, queue depth information, or latency metrics populated by the second entity or intermediate components. The computer may extract this information and utilize it for various purposes, such as propagating QoS telemetry to upstream components, implementing adaptive flow control by throttling the rate of subsequent requests, or storing the telemetry for monitoring and analysis. This extraction may enable the computer to make informed decisions regarding request pacing, load balancing, or resource allocation based on conditions observed at the second entity.

In some implementations of the method, the first PCIe Memory Read request comprises the UIO Memory Read (UIOMRd) request, the second PCIe Memory Read request comprises the non-UIO MRd, the second PCIe Completion comprises a non-UIO Completion with Data (CplD), and the first PCIe Completion comprises a UIO Read Completion with Data (UIORdCplD). The UIO to non-UIO translation may enable a first entity utilizing PCIe UIO to access resources coupled to a second entity that does not support UIO capabilities. The computer may translate the UIOMRd to a PCIe MRd, which may extend the reach of UIO-capable devices to legacy PCIe infrastructure or to devices that have not implemented UIO support.

In some implementations of the method, the UIORdCplD comprises a CXL DevLoad (CDL), and wherein the computer populates the CDL with Quality-of-Service (QoS) telemetry information based on at least one of: queue depth at the computer, observed latency, congestion indicators, or bandwidth utilization metrics. When translating from PCIe non-UIO completions that do not include a CDL, the computer may populate the CDL in the UIORdCplD to provide telemetry information to the first entity. The QoS telemetry information may be generated by the computer based on locally observed conditions. Queue depth may indicate the number of pending transactions awaiting completion. Observed latency may reflect the time elapsed between sending requests and receiving completions. Congestion indicators may signal backpressure conditions in downstream paths. Bandwidth utilization metrics may indicate the degree to which available bandwidth is being consumed. The first entity may utilize this telemetry information to make informed decisions about subsequent memory operations, such as throttling request rates, adjusting request priorities, or selecting alternative resources based on observed loading conditions. The computer may thus provide telemetry to the first entity even when the second entity does not support telemetry reporting.

In some implementations of the method, the first address is associated with a first physical address space utilized by the first entity, and wherein the second address is associated with a second physical address space utilized by the second entity. The address translation may be implemented utilizing lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations, the method further comprises receiving, from the first entity, a PCIe non-UIO Memory Write request (MWr) comprising a third address and write data; translating, by the computer, the PCIe MWr to a PCIe UIO Memory Write request (UIOMWr) comprising a fourth address and the write data; sending, to the second entity, the PCIe UIOMWr; and receiving, from the second entity, a PCIe UIO Write Completion (UIOWrCpl). The translation from non-UIO to UIO write may involve converting a posted write (MWr) that does not expect a completion into a non-posted write (UIOMWr) that receives a UIOWrCpl from the second entity. The UIOMWr may traverse a path supporting multi-path routing, potentially improving write performance in fabric topologies with multiple paths between source and destination. The computer may utilize the UIOWrCpl for flow control, error recovery, transaction ordering, or as a basis for generating a write acknowledgment to the first entity, as described in dependent claims.

In some implementations of the method, the computer buffers the write data prior to sending the PCIe UIOMWr, and wherein the computer utilizes the UIOWrCpl for at least one of: flow control, error recovery, or transaction ordering. The computer may buffer the write data internally to decouple the timing of receiving the MWr from the first entity and sending the UIOMWr to the second entity. The UIOWrCpl received from the second entity may provide confirmation that the write data has been accepted, which the computer may utilize for flow control by releasing buffer space, for error recovery by detecting and handling failed writes, or for transaction ordering by confirming completion of writes before allowing subsequent dependent operations.

In some implementations, the method further comprises receiving, from the first entity, a PCIe UIO Memory Write request (UIOMWr) comprising a third address, a third Tag, and write data; translating, by the computer, the PCIe UIOMWr to a PCIe non-UIO Memory Write request (MWr) comprising a fourth address and the write data; sending, to the second entity, the PCIe MWr; and sending, to the first entity, a PCIe UIO Write Completion (UIOWrCpl) comprising the third Tag. The translation from UIO to non-UIO write may involve converting a non-posted write (UIOMWr) that expects a completion into a posted write (MWr) that does not return a completion from the second entity. The computer may generate the UIOWrCpl to acknowledge receipt of the write data to the first entity, even though the second entity does not provide a completion for the posted MWr. This translation may enable UIO-capable devices to write to legacy PCIe devices while maintaining the non-posted write semantics expected by the first entity.

In some implementations of the method, the computer sends the UIOWrCpl to the first entity at one of: before sending the PCIe MWr to the second entity, in parallel with sending the PCIe MWr to the second entity, or after sending the PCIe MWr to the second entity; and wherein the UIOWrCpl comprises a CXL DevLoad (CDL) populated by the computer. The timing of the UIOWrCpl may provide different trade-offs between latency and ordering guarantees. Sending the UIOWrCpl before sending the MWr may reduce latency observed by the first entity and may allow the first entity to proceed with subsequent operations without waiting for the write to propagate to the second entity. Sending the UIOWrCpl in parallel with or after sending the MWr may provide stronger ordering guarantees at the cost of increased latency. The computer may populate the CDL with QoS telemetry information based on locally observed conditions, providing telemetry to the first entity even though the second entity does not return a completion.

In some implementations of the method, the computer buffers the write data, and wherein the computer is configured to retry sending the PCIe MWr to the second entity upon detecting a transmission error. The computer may retain the write data in a buffer after generating the UIOWrCpl to the first entity, enabling error recovery if the posted MWr encounters transmission errors on the path to the second entity. The computer may implement retry logic that re-sends the MWr upon detecting errors, thereby providing reliability guarantees to the first entity even though the posted write on the non-UIO path does not inherently provide acknowledgment. The buffer may be released after the computer determines that the MWr has been successfully transmitted or accepted by downstream components.

In some implementations of the method, communication between the computer and the first entity utilizes a first encoding mode, communication between the computer and the second entity utilizes a second encoding mode different from the first encoding mode, one of the first encoding mode and the second encoding mode comprises flit-based encoding and the other comprises non-flit-based encoding, the first entity comprises at least one of a PCIe host or a PCIe device, and the second entity comprises at least one of a PCIe host or a PCIe device. The split flit/non-flit path may enable communication between entities operating in different encoding modes. PCIe specifications define UIO for flit-based encoding, and do not permit direct translation of UIO TLPs to non-flit-based encoding. By performing TLP type translation, the computer may bridge these incompatible modes, enabling PCIe UIO transactions to reach PCIe devices operating in non-flit mode, or enabling non-flit PCIe devices to access resources via UIO-enabled paths. The first entity and second entity may include various types of hosts and devices, such as servers, processors, GPUs, NICs, storage controllers, memory expanders, or accelerators.

In various implementations, a system for translating between Peripheral Component Interconnect Express (PCIe) Transaction Layer Packets (TLPs), comprising: a first interface configured to communicate with a first entity; a second interface configured to communicate with a second entity; and a computer coupled between the first interface and the second interface, the computer configured to: receive, via the first interface, a first PCIe Memory Read request comprising a first address and a first Tag; translate the first PCIe Memory Read request to a second PCIe Memory Read request comprising a second address and a second Tag; wherein one of the first PCIe Memory Read request and the second PCIe Memory Read request comprises an Unordered Input/Output (UIO) Memory Read (UIOMRd) request, and the other comprises a non-UIO Memory Read (MRd) request; send, via the second interface, the second PCIe Memory Read request; receive, via the second interface, a second PCIe Completion comprising the second Tag and a data payload; translate the second PCIe Completion to a first PCIe Completion comprising the first Tag and the data payload; and send, via the first interface, the first PCIe Completion. The system may be implemented as a semiconductor device, a switch, a bridge, an active cable, or other suitable device positioned between the first entity and the second entity. The first interface and second interface may include physical layer components, link layer components, and transaction layer components configured based on PCIe specifications. The computer may include translation logic, address translation tables, Tag mapping structures, and pending transaction trackers to perform the translation between PCIe UIO and non-UIO TLPs.

In some implementations of the system, the first interface is configured to operate in a first encoding mode, wherein the second interface is configured to operate in a second encoding mode different from the first encoding mode, and wherein one of the first encoding mode and the second encoding mode comprises flit-based encoding and the other comprises non-flit-based encoding. The system may bridge flit-based and non-flit-based encoding modes, enabling UIO transactions originating from or destined to entities operating in Flit Mode to traverse paths operating in Non-Flit Mode, or vice versa. The first interface and second interface may each include encoding and decoding logic appropriate for their respective encoding modes, and the computer may handle the conversion between the different TLP header formats associated with each mode.

In some implementations of the system, the computer comprises: translation logic configured to translate between the UIOMRd and the MRd, and tracker entries, each configured to store a mapping between the first Tag and the second Tag for a pending transaction. The translation logic may include opcode mapping tables, address translation units, and field manipulation circuits to convert between UIO and non-UIO TLP formats. The tracker entries may be implemented as registers, memory structures, or content-addressable memory entries that associate incoming Tags with outgoing Tags and with other transaction state information. The tracker entries may enable the computer to handle concurrent transactions, with each entry tracking a separate pending read or write operation.

In some implementations of the system, the computer is configured to translate between a first physical address belonging to a first physical address space utilized by the first entity and a second physical address belonging to a second physical address space utilized by the second entity; wherein the first entity comprises at least one of a GPU, a Network Interface Card (NIC), a DMA engine, an accelerator, or a PCIe host; and wherein the second entity comprises at least one of a memory device, a memory expander, a memory pool, a storage controller, or a PCIe device. The address translation may be implemented utilizing lookup tables, translation lookaside buffers, page table walkers, or programmable translation functions. The address translation functionality may be configured by system software, firmware, or hardware configuration to establish mappings between the first and second physical address spaces. The computer may support various address space configurations, including identity mapping, offset-based translation, or arbitrary mapping based on page tables or similar structures.

In some implementations of the system, the first interface exposes a first endpoint to the first entity; wherein the second interface exposes a second endpoint to the second entity; and wherein the computer is implemented in an integrated circuit package comprising high-speed differential input/output (I/O) connections positioned according to a ball grid array (BGA) layout. The first endpoint may appear to the first entity as a PCIe device or a PCIe root port, depending on the system configuration. The second endpoint may similarly appear to the second entity as a PCIe device or a PCIe root port. The endpoints may implement capability structures, configuration space registers, and link management functions based on PCIe specifications, enabling the first entity and second entity to discover and communicate with the system using standard PCIe enumeration and configuration mechanisms. Additionally or alternatively, the IC package may conform to PCIe Retimer Supplemental Features and Standard BGA Footprint Specification or similar industry specifications. The BGA layout may facilitate integration of the system into standard PCIe card edge connector configurations, add-in card designs, or motherboard layouts. The high-speed differential I/O connections may support data rates such as 32.0 GT/s or higher as specified by PCIe Revision 6.0 or later specifications.

In various implementations, a method for enabling Unordered Input/Output (UIO) transactions over a split flit-mode/non-flit-mode path, comprising: receiving, via a first interface operating in a first data stream mode, a first Peripheral Component Interconnect Express (PCIe) Transaction Layer Packet (TLP); translating, by a computer, the first PCIe TLP to a second PCIe TLP, wherein the first PCIe TLP comprises a UIO TLP and the second PCIe TLP comprises a non-UIO TLP, or wherein the first PCIe TLP comprises a non-UIO TLP and the second PCIe TLP comprises a UIO TLP; and sending, via a second interface operating in a second data stream mode different from the first data stream mode, the second PCIe TLP; wherein one of the first data stream mode and the second data stream mode comprises Flit Mode (FM), and the other comprises Non-Flit Mode (NFM). PCIe specifications define UIO for Flit Mode, and no translations of UIO TLPs to Non-Flit Mode are permitted according to the PCIe Revision 6.2 specification. The method may enable communication between a first entity and a second entity utilizing UIO over a split FM/NFM path, wherein the UIO TLPs may traverse a path that utilizes FM, whereas the non-UIO TLPs may traverse a path that utilizes NFM. Such split FM/NFM path setup is not permitted in standard PCIe Revision 6.2 environments, and may be enabled by the translation capabilities of the computer. The Data Stream mode may be determined during initial Link training, wherein each PCIe Link is set up following a negotiation of Link width, data rate, and Flit mode by the two agents at each end of the Link.

In some implementations of the method, the first data stream mode comprises FM, the second data stream mode comprises NFM, the first PCIe TLP comprises a UIO TLP, and the second PCIe TLP comprises a non-UIO TLP. The FM-to-NFM direction may enable a first entity operating in Flit Mode with UIO capabilities to access resources coupled to a second entity operating in Non-Flit Mode. The computer may translate the UIO TLP received via the FM interface to a non-UIO TLP for transmission via the NFM interface, thereby bridging the encoding mode boundary while adapting the TLP type to conform to the capabilities of the NFM path.

In some implementations of the method, the first data stream mode comprises NFM, the second data stream mode comprises FM, the first PCIe TLP comprises a non-UIO TLP, and the second PCIe TLP comprises a UIO TLP. The NFM-to-FM direction may enable a first entity operating in Non-Flit Mode to access resources coupled to a second entity via a Flit Mode path that supports UIO. The computer may translate the non-UIO TLP received via the NFM interface to a UIO TLP for transmission via the FM interface, thereby enabling the first entity to benefit from UIO capabilities such as multi-path routing even though the first entity operates in NFM.

In some implementations, the method further comprises receiving, via the second interface, a third PCIe TLP comprising a PCIe Completion corresponding to the second PCIe TLP; translating, by the computer, the third PCIe TLP to a fourth PCIe TLP; and sending, via the first interface, the fourth PCIe TLP to a first entity. The completion flow may complete the transaction initiated by the first PCIe TLP. The third PCIe TLP may include a UIO completion or a non-UIO completion depending on the TLP type of the second PCIe TLP. The computer may translate the third PCIe TLP to the fourth PCIe TLP, which may include a UIO completion or a non-UIO completion corresponding to the TLP type of the first PCIe TLP, thereby maintaining protocol consistency on each side of the computer.

In some implementations of the method, the first PCIe TLP comprises a UIO Memory Read (UIOMRd) request, the second PCIe TLP comprises a non-UIO Memory Read (MRd) request, the third PCIe TLP comprises a non-UIO Completion with Data (CplD), the fourth PCIe TLP comprises a UIO Read Completion with Data (UIORdCplD) comprising a CXL DevLoad (CDL), and wherein the computer populates the CDL. When translating from a CplD that does not include a CDL to a UIORdCplD that includes a CDL, the computer may populate the CDL with QoS telemetry information based on locally observed conditions. This population may enable the first entity to receive telemetry feedback even when the second entity does not support UIO or telemetry reporting.

In some implementations of the method, the first PCIe TLP comprises a non-UIO Memory Read (MRd) request, the second PCIe TLP comprises a UIO Memory Read (UIOMRd) request, the third PCIe TLP comprises a UIO Read Completion with Data (UIORdCplD) comprising a CXL DevLoad (CDL), and the fourth PCIe TLP comprises a non-UIO Completion with Data (CplD). When translating from a UIORdCplD that includes a CDL to a CplD that does not include a CDL, the computer may extract the information from the CDL and utilize it for purposes such as throttling subsequent requests, implementing adaptive flow control, or storing the telemetry for monitoring and analysis.

In some implementations of the method, the first PCIe TLP comprises a PCIe Memory Write request, and wherein the method further comprises: receiving, via the second interface, a third PCIe TLP comprising a PCIe UIO Write Completion (UIOWrCpl) when the second PCIe TLP comprises a UIO Memory Write request (UIOMWr); translating, by the computer, the third PCIe TLP to a fourth PCIe TLP; and sending, via the first interface, the fourth PCIe TLP. When the first PCIe TLP comprises a UIOMWr transmitted via an FM interface, the second PCIe TLP may include a MWr transmitted via an NFM interface as a posted write. The computer may generate a UIOWrCpl to send to the first entity even though the second entity does not return a completion for the posted MWr. Conversely, when the first PCIe TLP comprises a MWr, the computer may translate it to a UIOMWr and receive a UIOWrCpl from the second entity.

In some implementations of the method, the first PCIe TLP comprises a first physical address in a first physical address space, the second PCIe TLP comprises a second physical address in a second physical address space, a first entity coupled to the first interface comprises at least one of a GPU, a Network Interface Card (NIC), a DMA engine, or an accelerator, and wherein a second entity coupled to the second interface comprises at least one of a memory device, a memory expander, a memory pool, a storage controller, or a PCIe host. GPUs may utilize PCIe memory transactions to access large memory pools for graphics rendering, machine learning inference, or general-purpose GPU computing workloads. NICs may utilize PCIe memory transactions to access memory buffers for network packet processing, RDMA, or storage traffic handling. DMA engines may utilize PCIe memory transactions to transfer data between memory regions on behalf of other system components. The address translation may enable these devices to access resources utilizing addresses within their native address space while the second entity operates within its own address space.

In some implementations of the method, the first interface exposes a first endpoint to a first entity, wherein the second interface exposes a second endpoint to a second entity, wherein the first PCIe TLP comprises a first physical address in a first physical address space utilized by the first entity, and wherein the second PCIe TLP comprises a second physical address in a second physical address space utilized by the second entity. The first endpoint may be configured as a PCIe endpoint that appears to the first entity as a PCIe device operating in the first data stream mode. The second endpoint may be configured as a PCIe endpoint that appears to the second entity as a PCIe device operating in the second data stream mode. The endpoints may handle link training, flow control initialization, and capability negotiation according to their respective data stream modes. The address translation between the first physical address space and the second physical address space may be implemented utilizing lookup tables, page tables, base-and-offset calculations, or programmable translation functions.

In various implementations, a system for enabling Unordered Input/Output (UIO) transactions over a split flit-mode/non-flit-mode path, comprising: a first interface configured to operate in a first data stream mode and to communicate with a first entity; a second interface configured to operate in a second data stream mode different from the first data stream mode and to communicate with a second entity; wherein one of the first data stream mode and the second data stream mode comprises Flit Mode (FM), and the other comprises Non-Flit Mode (NFM); and a computer coupled between the first interface and the second interface, the computer configured to: receive, via the first interface, a first Peripheral Component Interconnect Express (PCIe) Transaction Layer Packet (TLP); translate the first PCIe TLP to a second PCIe TLP, wherein the first PCIe TLP comprises a UIO TLP and the second PCIe TLP comprises a non-UIO TLP, or wherein the first PCIe TLP comprises a non-UIO TLP and the second PCIe TLP comprises a UIO TLP; and send, via the second interface, the second PCIe TLP. The system may bridge Flit Mode and Non-Flit Mode encoding boundaries while performing TLP type translation between UIO and non-UIO formats. The first interface and second interface may each include physical layer components configured for their respective data stream modes, including different scrambling, encoding, and framing mechanisms. The computer may include translation logic to convert between the different TLP header formats and field arrangements associated with FM and NFM operation.

In some implementations of the system, the first interface is configured to perform link training to establish the first data stream mode with the first entity, and wherein the first entity comprises at least one of a legacy PCIe device operating in NFM, a GPU, or a NIC; and wherein the second interface is configured to perform link training to establish the second data stream mode with the second entity, and wherein the second entity comprises at least one of a UIO-capable memory device, a memory pool operating in FM, or a fabric switch. The link training may include negotiation of Link width, data rate, and Flit mode between each interface and its respective entity. The first interface may negotiate FM with the first entity if both support FM, or may fall back to NFM otherwise. The second interface may independently negotiate FM or NFM with the second entity. The system may thus establish different data stream modes on each interface based on the capabilities of the connected entities. Additionally, legacy PCIe devices may operate in NFM due to hardware generation or design choices, and may benefit from access to UIO-enabled paths through the system's translation capabilities. GPUs and NICs may operate in either FM or NFM depending on their capabilities and may utilize the system to access memory resources across encoding mode boundaries. Memory pools and fabric switches operating in FM with UIO support may provide high-bandwidth, low-latency memory access that becomes accessible to NFM devices through the system.

In some implementations of the system, the first interface supports a first data rate, wherein the second interface supports a second data rate different from the first data rate, and wherein FM is selected when a data rate exceeds a threshold data rate. PCIe specifications may require FM for data rates exceeding 32.0 GT/s. The system may support different data rates on each interface, with the first interface potentially operating at a higher data rate in FM while the second interface operates at a lower data rate in NFM, or vice versa. This capability may enable the system to connect entities with different performance capabilities while providing translation between encoding modes.

In some implementations of the system, the computer comprises: translation logic configured to translate between UIO TLPs and non-UIO TLPs; and an address translation unit configured to translate between a first physical address belonging to a first physical address space utilized by the first entity and a second physical address belonging to a second physical address space utilized by the second entity. The translation logic may include opcode mapping circuits, header format converters, and field manipulation logic to transform TLPs between UIO and non-UIO formats while also converting between FM and NFM header layouts. The address translation unit may operate in conjunction with the translation logic to modify addresses during the TLP translation process.

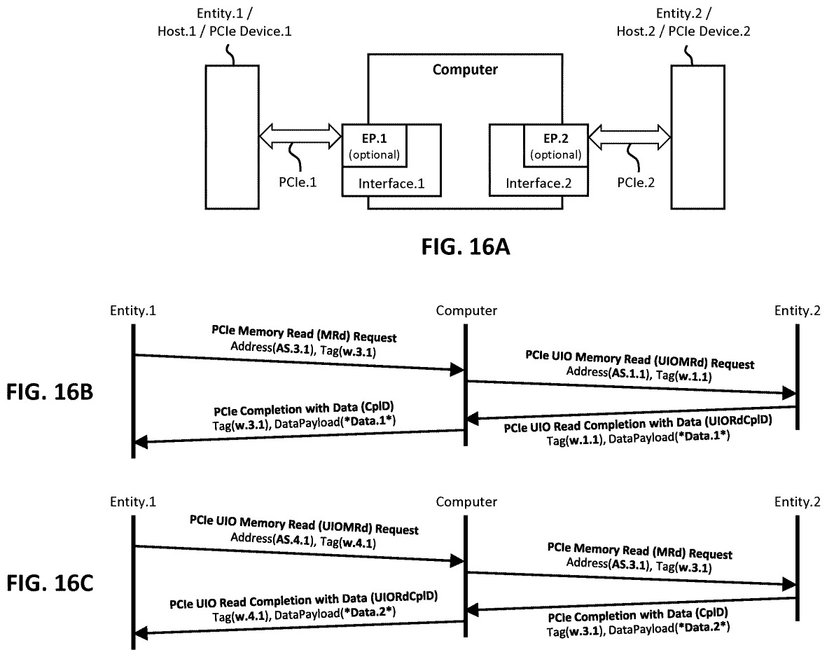

FIG. 16A illustrates an example of a system comprising a computer coupled between first and second interfaces. The first interface (Interface.1) may communicate according to a first PCIe-based protocol, such as PCIe Specification Revision 5.0. The second interface (Interface. 2) may communicate according to a second PCIe-based protocol, such as PCIe Specification Revision 6.2. The computer may be implemented in an IC package having high-speed differential I/O balls positioned according to a ball grid array layout defined by PCIe Retimer Supplemental Features and Standard BGA Footprint Specification. The first interface may expose a first endpoint (EP.1) and may communicate according to the first PCIe-based protocol with a first entity (Entity.1), which may be a first host (Host.1) or a first PCIe device (PCIe Device.1). The second interface may expose a second endpoint (EP.2) and may communicate according to the second PCIe-based protocol, with a second entity (Entity.2), which may be a second host (Host.2) or a second PCIe device (PCIe Device.2). The computer may extract physical addresses from first PDUs, such as first TLPs, received via the first interface, wherein these addresses may refer to a first physical address space utilized by the first entity; translate these addresses; and generate second PDUs, such as second TLPs, carrying the translated physical addresses for transmission via the second interface; wherein these translated addresses may correspond to a second physical address space utilized by the second entity.

FIG. 16B illustrates an example of a transaction flow diagram (TFD) demonstrating translations between TLPs associated with a first PCIe, received from a first entity (Entity.1), which may be a first host (Host.1) or a first PCIe device (PCIe Device.1), and UIO TLPs associated with a second PCIe, sent to a second entity (Entity.2), which may be a second host (Host.2) or a second PCIe device (PCIe Device.2), possibly enabling the first entity to access resources mapped to an address space utilized by the second entity. The first entity may initiate a PCIe transaction that includes a PCIe Memory Read (MRd) request comprising Address(AS.3.1) and Tag(w.3.1). A computer may translate the PCIe transaction to a PCIe UIO transaction that includes a PCIe UIO Memory Read (UIOMRd) request comprising Address(AS.1.1) and Tag(w.1.1), and may send the PCIe UIOMRd to the second entity. Upon receiving a completion from the second entity, which may include a PCIe UIO Read Completion with Data (UIORdCplD) comprising Tag(w.1.1), and DataPayload(*Data.1*), the computer may translate the PCIe UIORdCplD to a PCIe Completion with Data (CplD) comprising Tag(w.3.1) and DataPayload(*Data.1*), and send the PCIe CplD to the first entity.

The computer may perform further translations, such as protocol translations, opcode translations, command translations, TLP type translations, Tag translations, length translations, or field translations. Recent PCIe hosts and devices may utilize the PCIe Unordered IO (UIO) optional capability, originally introduced as ECN, and later incorporated into PCIe Base Specification Revision 6.2. PCIe UIO defines a new wire semantic and related capabilities that address limitations of the PCI/PCIe fabric-based ordering rules, enabling improved performance and efficiency, such as by utilizing multi-path routing. Some PCIe revisions, such as PCIe Revision 6.2, may use two Data Stream modes: Flit Mode (FM), and Non-Flit Mode (NFM). Support of Data Stream in NFM may be mandatory, while support of Data Stream in FM may be mandatory for example only if data rate that exceeds 32.0 GT/s is supported. The Data Stream mode may be determined during initial Link training, wherein each PCIe Link is set up following a negotiation of Link width, data rate, and Flit mode by the two agents at each end of the Link. If FM is not disabled, and if both the Ports (and all Pseudo-Ports, if any) support it, FM may be chosen. Otherwise, NFM may be chosen. The current PCIe specifications define PCIe UIO for FM, and no translations of UIO TLPs to NFM are permitted. According to PCIe Revision 6.2 specifications, UIO may be used when the entire path from requester to completer uses FM, supports UIO, and has UIO enabled. The translations may further enable communication between the first entity and the second entity utilizing UIO over a split FM/NFM path, wherein the UIO TLPs may traverse a path that may utilize FM, whereas the non-UIO TLPs may traverse a path that may utilize NFM. Such split FM/NFM path setup is not allowed in standard PCIe Revision 6.2 environments, and may be enabled by the translation capabilities of the computer.

FIG. 16C illustrates an example of a TFD demonstrating translations between UIO TLPs associated with a first PCIe, received from a first entity (Entity.1), which may be a first host (Host.1) or a first PCIe device (PCIe Device.1), and TLPs associated with a second PCIe, sent to a second entity (Entity.2), which may be a second host (Host.2) or a second PCIe device (PCIe Device.2), possibly enabling the first entity to access resources mapped to an address space utilized by the second entity. The first entity may initiate a PCIe UIO transaction that includes a PCIe UIOMRd comprising Address(AS.4.1) and Tag(w.4.1). A computer may translate the PCIe UIO transaction to a PCIe transaction that includes a PCIe MRd comprising Address(AS.3.1) and Tag(w.3.1), and may send the PCIe MRd to the second entity. Upon receiving a completion from the second entity, which may include a PCIe CplD comprising Tag(w.3.1) and DataPayload(*Data.2*), the computer may translate the PCIe CplD to a PCIe UIORdCplD comprising Tag(w.4.1), and DataPayload(*Data.2*), and send the PCIe UIORdCplD to the first entity. The computer may perform further translations, such as protocol translations, opcode translations, command translations, TLP type translations, Tag translations, length translations, or field translations.

The PCIe specification Revision 6.2 defines PCIe UIO for FM, no translations of UIO TLPs to NFM are permitted, and UIO may be used when the entire path from requester to completer uses FM, supports UIO, and has UIO enabled. The translations may further enable communication between the first entity and the second entity utilizing UIO over a split FM/NFM path, wherein the UIO TLPs may traverse a path that may utilize FM, whereas the non-UIO TLPs may traverse a path that may utilize NFM. Such split FM/NFM path setup is not allowed in standard PCIe Revision 6.2 environments, and may be enabled by the translation capabilities of the computer.

Coherent Hub Interface (CHI) employs a role-based node classification system. Non-limiting examples of CHI node types may include the following. Request Nodes (RN) may generate transactions, including reads and writes, to the interconnect. For example, a Fully Coherent Request Node (RN-F) may include a hardware-coherent cache and may support snoop transactions. An I/O-Coherent Request Node with Distributed Virtual Memory (DVM) support (RN-D) may not include a hardware-coherent cache but may receive DVM transactions and generate a subset of transactions defined by the protocol. An I/O-Coherent Request Node (RN-I) may not include a hardware-coherent cache and may not receive DVM transactions, generating a subset of transactions defined by the protocol without requiring snoop functionality. Home Nodes (HN) may be located within the interconnect and may receive transactions from Request Nodes. For example, a Fully Coherent Home Node (HN-F) may include a Point of Coherence (PoC) that manages coherency by snooping the required RN-Fs, consolidating the snoop responses for a transaction, and sending a single response to the requesting Request Node. HN-F nodes are expected to be the Point of Serialization (PoS) for memory requests, and may include a snoop filter or directory and an integrated interconnect cache. An I/O-coherent Home Node (HN-I) may process a limited subset of request types and may serve as the PoS for IO requests targeting the IO subsystem. Subordinate Nodes (SN) may receive requests from Home Nodes and return responses. For example, a Subordinate Node (SN-F) may be used for normal memory and may be capable of processing non-snoopable read, write, and atomic requests, including Cache Maintenance Operation (CMO) requests. Other CHI implementations may define additional or different node types and classifications.

References herein to ARM CHI component types, such as RN-F, HN-F, HN-I, RN-I, RN-D, SN-F, CCG, CXG, and XP, are intended to encompass the functionality associated with these designations as defined in the ARM AMBA CHI Architecture Specifications and related ARM documentations, including present and future revisions that may refine, rename, or extend these designations.

In some examples utilizing ARM-based coherent mesh architectures, crosspoints (XP) may function as routing nodes that direct traffic between different components of the system. For example, crosspoints may route packets both horizontally and vertically within a mesh structure based on identifiers within protocol messages. Nodes within the mesh may maintain registers accessible through memory-mapped I/O (MMIO) operations, such as via ARM's Advanced Microcontroller Bus Architecture (AMBA) Advanced Peripheral Bus (APB). These registers may contain configuration information and operational parameters that allow system firmware, system software, or diagnostic tools to determine the presence and configuration of specific nodes and blocks within the architecture. Other coherent interconnect architectures may utilize different routing topologies and register access mechanisms.

In some examples, systems integrating CXL with ARM CHI interconnects may utilize specialized interfaces and gateways to manage the translation and routing of different protocol types. For example, a CXL/CCIX Gateway (CCG) may incorporate Request Node (RN) functionality, Home Node (HN) functionality, and link interface logic, managing conversion between CXL-based protocols and CHI-based protocols. The CCG may be coupled to the CHI interconnect via a CXS interface, which may provide a pathway for coherent transactions that is less complex to implement than a full CHI interface. CXL.mem and CXL.cache transactions, being coherent in nature, may be routed through the CCG via the CXS interface. CXL.io transactions, being non-coherent, may be routed through alternative paths, such as via an AXI interface coupled to RN-D or HN-I nodes within the CHI interconnect. For example, CXL.mem and CXL.cache traffic may be routed via a CXS interface to CCG nodes, while CXL.io traffic may be routed via an AXI interface to RN-D and HN-I nodes, allowing different paths to be optimized for their specific protocol characteristics. Other architectures may utilize different interfaces, gateways, or routing approaches for integrating CXL with coherent interconnects.

Non-limiting examples of transaction flows within CHI-based systems with CXL integration may follow the sequences described below. In one example, a requester, which may be a CCG block coupled to CXL Device logic or a CXL Device coupled to a mesh crosspoint, may issue an allocating read request to a Home Node (HN). The initial request may utilize various opcodes such as ReadClean, ReadNotSharedDirty, ReadShared, ReadUnique, ReadPreferUnique, or MakeReadUnique. The Home Node may process these transactions and may employ different response approaches based on system configuration and optimization goals. In one example, the Home Node may utilize combined responses from subordinate nodes, wherein the Home Node sends a downstream read request, such as ReadNoSnp, to a Subordinate node such as a Memory Controller. The Subordinate node may then return a combined response along with the requested data to the original requester using CompData, bypassing the need for the data to flow back through the Home Node. Using CompData may reduce message count and may decrease transaction latency by eliminating one hop in the data return path. The selection between different response approaches may be made by the Home Node based on factors such as current system load, transaction type, or design complexity considerations. In some examples, CCG blocks may be used for coupling RPUs and CXL Devices to mesh interconnects, providing a standardized interface for CXL integration. In other examples, RPUs may expose CHI interfaces capable of connecting to XP crosspoints within the mesh, wherein these RPUs may perform address translations as part of the transaction processing flow.

In various implementations, an apparatus comprising: processing cores coupled via a coherent interconnect to memory controllers, wherein the coherent interconnect is based on Coherent Hub Interface (CHI) protocol (CHI-based protocol), and the memory controllers are coupled to memory channels capable of supporting memory having a capacity of at least 64 GB; at least one interconnect gateway coupled to the coherent interconnect; one or more I/O-Coherent nodes coupled to the coherent interconnect, wherein the one or more I/O-Coherent nodes comprise an I/O-Coherent Request Node with DVM support (RN-D) and/or an I/O-Coherent Request Node (RN-I); a resource provisioning unit (RPU) configured to: receive transmissions comprising data indicative of Compute Express Link (CXL) messages from an entity external to the apparatus, wherein the CXL messages comprise CXL.mem messages, CXL.cache messages, and/or CXL.io messages; route the CXL.mem messages and/or the CXL.cache messages to the one or more CCGs; and route the CXL.io messages to the one or more I/O-Coherent nodes. The apparatus may enable entities communicating according to CXL-based protocol to access resources within a CHI-based system utilizing protocol-aware routing that directs different CXL sub-protocols to appropriate nodes based on their coherency requirements. The CCGs may provide coherent gateway functionality optimized for CXL.mem and CXL.cache transactions that require cache coherency support, while the I/O-Coherent nodes handle CXL.io transactions that operate without cache coherency. The RPU may parse incoming CXL messages to identify their protocol type and apply routing decisions that leverage the specialized capabilities of different node types within the CHI interconnect. This architectural separation may optimize transaction processing by avoiding coherency overhead for CXL.io transactions while providing full coherency support for CXL.mem and CXL.cache transactions.

In some implementations of the apparatus, the RPU is configured to route the CXL.mem messages to the one or more CCGs via a CXS interface, and further comprising a CXL controller configured to translate the CXL.mem messages to CHI-based messages for transmission over the coherent interconnect.

In some implementations of the apparatus, the RPU is configured to route the CXL.cache messages to the one or more CCGs via a CXS interface, and further comprising a CXL controller configured to translate the CXL.cache messages to CHI-based messages. The CXL.cache routing through CCGs may enable external CXL devices to participate in the processor's cache coherency domain, with the CCGs managing snoop operations and coherency state transitions required for cache-line-level sharing.

In some implementations of the apparatus, the one or more I/O-Coherent nodes comprise the RN-D; the RPU is configured to route the CXL.io messages to the RN-D via an AXI interface; and the RN-D translates the CXL.io messages to CHI-based messages for non-coherent or I/O-coherent operations. The AXI interface may leverage its similarity to PCIe for handling CXL.io transactions, which maintain PCIe compatibility, while the RN-D provides DVM support for I/O operations without the overhead of cache coherency management.

In some implementations of the apparatus, the RPU comprises a CXL protocol parser configured to identify whether received CXL messages are CXL.mem, CXL.cache, or CXL.io messages; coherent CXL protocols comprising the CXL.mem messages and the CXL.cache messages are routed through a coherent path via the one or more CCGs; and CXL.io messages are routed through a non-coherent path via the one or more I/O-Coherent nodes. The protocol parser may examine CXL message headers or protocol-specific fields to determine the message type, enabling dynamic routing decisions to appropriate processing path within the CHI interconnect architecture based on the message type.

In some implementations of the apparatus, the CXL messages comprise physical addresses within a second physical address space utilized by the entity; and the RPU is further configured to translate the physical addresses within the second physical address space to physical addresses within a first physical address space utilized by the coherent interconnect. The address translation may map between the external entity's view of physical memory and the internal addressing scheme used by the CHI-based system, enabling CXL devices to access system resources using their native addressing while maintaining proper routing within the coherent interconnect.

In some implementations of the apparatus, the CXL messages comprise CXL Tags for transaction identification; the CHI-based protocol utilizes CHI Tags for transaction tracking; and the RPU is further configured to translate between the CXL Tags and the CHI Tags while maintaining transaction correlation. The Tag translation may include maintaining a mapping table or using algorithmic translation to properly correlate responses with requests across the protocol boundary, enabling end-to-end transaction tracking despite the protocol conversion.

In some implementations of the apparatus, the RPU is further configured to translate CXL opcodes to corresponding CHI opcodes, comprising: translating CXL.mem read opcodes to CHI read transaction types; translating CXL.mem write opcodes to CHI write transaction types; and translating CXL.cache opcodes to CHI cache coherency transaction types. The opcode translation may adapt the different command encodings used by CXL and CHI while maintaining the intent and ordering requirements of the transactions across the protocol boundary.

In some implementations of the apparatus, the one or more CCGs and the one or more I/O-Coherent nodes are mapped to an internal protocol bus with registers accessible utilizing memory-mapped I/O (MMIO) operations; and the registers enable detection of node presence, node type, and routing configuration based on software inspection. The MMIO-accessible registers may contain capability information, configuration parameters, and status indicators that allow system firmware or diagnostic software to discover the CXL-to-CHI translation capabilities and verify proper routing configuration.

In some implementations of the apparatus, the RPU is further configured to: receive a CXL.mem Master-to-Subordinate request (M2S Req) comprising MemRd* from the entity; translate the M2S Req to a CXL.cache Device-to-Host request (D2H Req) comprising RdCurr; and forward the D2H Req to a host via the coherent interconnect. This translation may enable interoperability between CXL.mem devices and CXL.cache hosts, with the RPU converting between CXL.mem and CXL.cache transactions.

In some implementations of the apparatus, the RPU is further configured to: receive a CXL.mem M2S request with Data (M2S RwD) comprising MemWr* and write data; translate the M2S RwD to a CXL.cache D2H request comprising WrCur or MemWr; and forward the D2H request with the write data to the host.

In some implementations of the apparatus, the CXL.mem M2S Req comprises a Tag for transaction identification; the CXL.cache D2H Req utilizes a Command Queue ID (CQID) for transaction tracking; and the RPU translates between the Tag and the CQID while maintaining transaction correlation between the CXL.mem and CXL.cache domains. The Tag to CQID translation may include algorithmic mapping or table-based translation to properly route completions and responses to the originating CXL.mem device utilizing the appropriate command queue structure used by CXL.cache.

In some implementations of the apparatus, the RPU is further configured to: receive CXL.io Configuration Request Transaction Layer Packets (TLPs) from the entity; terminate the Configuration Request TLPs within the RPU; and process the Configuration Request TLPs locally without forwarding translated versions to the coherent interconnect. The local termination of configuration TLPs may allow the RPU to handle device enumeration and configuration without burdening the coherent interconnect with configuration traffic, potentially implementing virtual configuration spaces for CXL devices.

In some implementations of the apparatus, the RPU is further configured to: forward translations of CXL.io Memory Read (MRd) TLPs, Memory Write (MWr) TLPs, and Completion with Data (CplD) TLPs to the coherent interconnect; and block CXL.io Configuration Read (CfgRd0, CfgRd1) TLPs, Configuration Write (CfgWr0, CfgWr1) TLPs, and Completion for Locked Memory Read (CplDLk) TLPs from being forwarded to the coherent interconnect. The selective forwarding may implement security and isolation policies by preventing certain transaction types from propagating into the coherent interconnect while allowing memory-mapped I/O operations to proceed, similar to non-transparent bridge functionality.

In some implementations of the apparatus, the RPU is further configured to receive CXL.io Memory Transaction Layer Packets (Memory TLPs) comprising physical addresses within a CXL.io address space; and the RPU is further configured to translate the physical addresses within the CXL.io address space to physical addresses within a CHI physical address space before routing to the one or more I/O-Coherent nodes. The CXL.io address translation may support different memory maps between the CXL.io device's view and the system's internal addressing, enabling flexible memory allocation and potential address space isolation for different CXL.io devices.

In some implementations of the apparatus, the at least one interconnect gateway comprises a CXL/CCIX Gateway (CCG) that utilizes a streaming interface protocol, wherein the CCG comprises a link agent that supports the streaming interface protocol, providing flit packing and unpacking, end-to-end data integrity, and a flit-retry mechanism.

In some implementations of the apparatus, the at least one interconnect gateway comprises a Coherent Multichip Link (CML) or a Cache Coherent Interconnect for Accelerators (CCIX) Gateway (CXG), wherein the at least one interconnect gateway utilizes a streaming interface protocol and is configured to utilize a 32-bit cyclic-redundancy check (CRC-32) to protect transactions conforming to the streaming interface protocol.

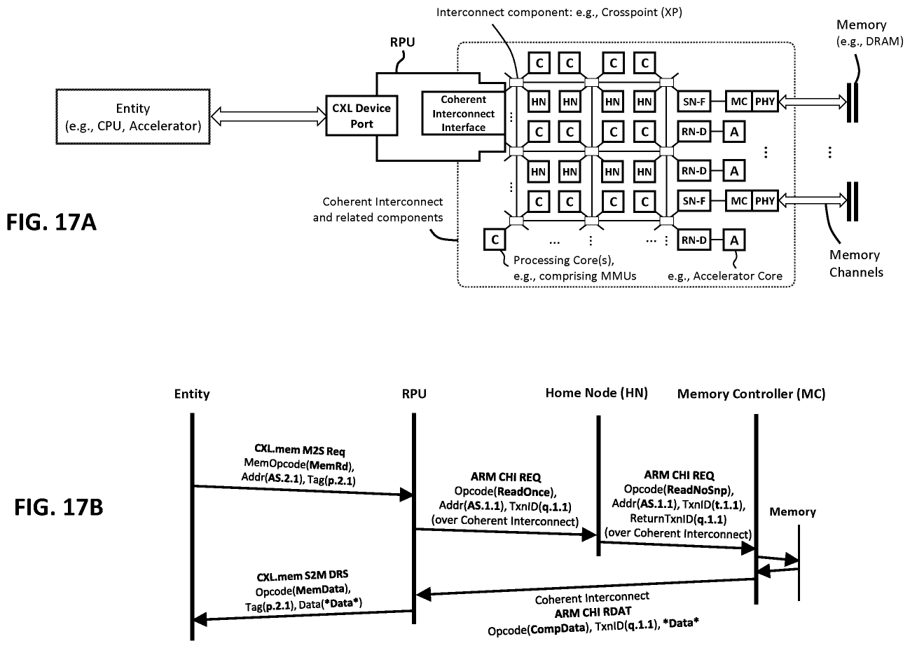

FIG. 17A illustrates an example of a system where an entity, such as a CPU or accelerator, communicates via a CXL device port that is coupled to or included in an RPU. The RPU may further include a Coherent Interconnect Interface that may utilize a protocol based on ARM CHI. The Coherent Interconnect Interface couples the RPU to an interconnect component, such as a crosspoint (XP), within a coherent interconnect. The Coherent Interconnect Interface performs the applicable conversions between a CXL-based domain and a coherent interconnect domain, such as between CXL.mem and ARM CHI, enabling the entity to access the memory (such as DRAM) and other resources coupled to the coherent interconnect. The coherent interconnect may be implemented as a mesh topology connecting various components including processing cores, home nodes (HN), memory controllers (MC), and accelerator cores.

FIG. 17B illustrates an example of a TFD showing address translations between CXL.mem and ARM CHI. An entity, such as a CPU, initiates a CXL.mem M2S request, such as M2S Req comprising a physical address (AS.2.1), MemRd, Addr(AS.2.1), and Tag(p.2.1). The RPU translates the M2S Req to a CHI request, such as ARM CHI REQ carrying ReadOnce, a translated physical address (AS.1.1), and TxnID(q.1.1). The transaction flows through the coherent interconnect to a home node (HN), which may process the request and send the processed request to a memory controller (MC). The HN may translate the received ARM CHI REQ to an ARM CHI REQ carrying ReadNoSnp, Addr(AS.1.1), TxnID(t.1.1), and ReturnTxnID(q.1.1). The memory controller retrieves the data from the memory (such as DRAM) and sends the data to the RPU, such as utilizing ARM CHI RDAT, through the coherent interconnect. For example, the memory controller may utilize ARM CHI RDAT with CompData and TxnID(q.1.1) for sending the data. The wildcard notation *Data* indicates that the data may be encoded, encrypted, or otherwise processed as needed for the transmission. Alternatively, the response and read data paths may be implemented according to other designs, such as wherein the MC may send the data to the HN that sends it to the RPU, or the HN sends a response to the RPU while the MC sends the data to the RPU. The RPU then translates the ARM CHI response back to the CXL.mem domain for delivery to the requesting entity. For example, the RPU may translate the ARM CHI RDAT to CXL.mem S2M DRS comprising MemData, Tag(p.2.1), and the *Data*.

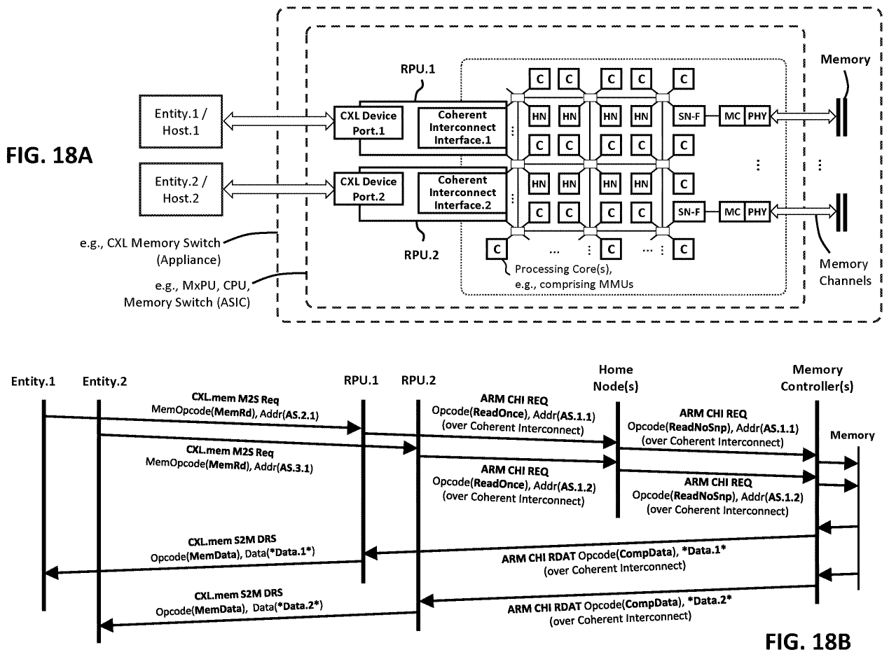

FIG. 18A illustrates an example of a system comprising a CXL memory switch appliance comprising an MxPU, CPU, or a memory switch ASIC, which is coupled to first and second entities denoted as Entity.1/Host.1 and Entity.2/Host.2. The MxPU includes processing cores and memory controllers coupled to a coherent interconnect that in one example utilizes a CHI-based protocol. The MxPU utilizes translations, performed by the RPUs, between CXL-based ports and the MxPU's coherent interconnect. The first RPU (RPU.1) may enable Entity.1/Host.1 to access, via the first CXL device port and the MxPU's coherent interconnect, resources mapped to a physical address space utilized by the MxPU's coherent interconnect, such as memory (e.g., DRAM) resources of the MxPU. Correspondingly, the second RPU (RPU.2) may enable Entity.2/Host.2 to access, via the second CXL device port and the MxPU's coherent interconnect, resources mapped to the physical address space utilized by the MxPU's coherent interconnect, such as the memory resources of the MxPU.

FIG. 18B illustrates an example of a TFD depicting a multi-host memory access scenario wherein two entities access memory through a shared coherent interconnect infrastructure. Entity.1/Host.1 initiates a CXL.mem M2S request comprising MemOpcode(MemRd) and Addr(AS.2.1) from a second physical address space, which RPU.1 translates to ARM CHI REQ carrying Opcode(ReadOnce) and Addr(AS.1.1) from the coherent interconnect's first physical address space. Concurrently or sequentially, Entity.2/Host.2 may initiate a CXL.mem M2S request comprising MemOpcode(MemRd) and Addr(AS.3.1) from a third physical address space, which RPU.2 translates to ARM CHI REQ carrying Opcode(ReadOnce) and Addr(AS.1.2) from the coherent interconnect's first physical address space. Both transactions flow through the coherent interconnect to one or more home nodes, which send respective ARM CHI REQ messages to one or more memory controllers, for example with Opcode(ReadNoSnp) and the addresses Addr(AS.1.1) and Addr(AS.1.2), respectively. The memory controller(s) retrieve the requested data from memory and send ARM CHI RDAT messages with Opcode(CompData) carrying *Data.1* and *Data.2*, representing the data retrieved from the addresses AS.1.1 and AS.1.2, respectively. RPU.1 translates the first response to CXL.mem S2M DRS with Opcode(MemData) and Data(*Data.1*) and sends it to Entity.1/Host.1. RPU.2 translates the second response to CXL.mem S2M DRS with Opcode(MemData) and Data(*Data.2*) and sends it to Entity.2/Host.2. The illustrated example demonstrates how hosts may share access to the same memory resources based on RPUs that perform physical address translations. Additionally or alternatively, the illustrated example may be viewed as two separate transactions that utilize the same processor's coherent interconnect to access the memory, wherein the entities maintain their respective physical address space that are translated to the physical address space utilized by the coherent interconnect.

Depending on system characteristics, such as implementation choices and platform configurations, different physical addresses, such as (AS.1.1) and (AS.1.2), within a physical address space utilized by the coherent interconnect, may be typically partitioned, such as via hashing or interleaving schemes, across a set of home nodes. Such partitioning is typically performed in order to reduce bottleneck effects in the system and spread the load of transaction processing across home nodes of the coherent interconnect, and may result in mapping the different physical addresses, such as (AS.1.1) and (AS.1.2), to the same home node, or to different home nodes. Similarly, different physical addresses may be associated with one memory controller, or with different memory controllers, such as according to a separate mapping scheme, which may be different from the mapping scheme utilized for selecting a home node for processing the request. Alternatively, other examples may co-locate the home node function with a specific memory controller, utilizing a unified mapping scheme that selects both a home node and a memory controller.

In heterogeneous computing architectures, entities may utilize different protocols while requiring coordinated access to shared resources. PCIe UIO and CXL UIO define wire semantics and TLP types to enable multi-path fabrics and improved performance. In environments where a first entity supporting CXL.io UIO needs to access resources coupled to a second entity supporting PCIe, translations between CXL.io UIO TLPs and PCIe TLPs may facilitate memory operations and data transfers across different domains. Such translations may be performed by a computer, an apparatus, a cable, or other suitable devices positioned between the first entity and the second entity. The translations may further enable communication over split flit/non-flit paths, wherein the CXL.io UIO portion utilizes flit-based encoding while the PCIe portion may utilize non-flit-based encoding.

In various implementations, a method for translating between Compute Express Link (CXL) Transaction Layer Packets (TLPs) and Peripheral Component Interconnect Express (PCIe) TLPs, comprising: receiving, from a first entity, a CXL.io Unordered Input/Output (UIO) Memory Read (UIOMRd) request comprising a first address and a first Tag; translating, by a computer, the CXL.io UIOMRd to a PCIe memory request comprising a second address and a second Tag; sending, to a second entity, the PCIe memory request; receiving, from the second entity, a PCIe Completion corresponding to the PCIe memory request; translating, by the computer, the PCIe Completion to a CXL.io UIO Read Completion with Data (UIORdCplD) comprising the first Tag and a data payload; and sending, to the first entity, the CXL.io UIORdCplD. The translation process may encompass various aspects of the protocol messages, including opcodes, addresses, Tags, and other TLP fields, thereby enabling communication between entities that utilize different protocols. The computer may maintain state information, such as pending transaction tables or tracker entries, to correlate incoming PCIe Completions with previously transmitted PCIe memory requests and with pending CXL.io transactions. The method may be implemented in hardware, firmware, software, or combinations thereof, and may be performed by various types of devices, such as semiconductor devices, switches, or active cables. Additionally, the elements may communicate through one or more intermediary components, such as a switch, a retimer, or other suitable entity that facilitates information transfer.

In some implementations of the method, the first address is associated with a first physical address space utilized by the first entity, and wherein translating the CXL.io UIOMRd to the PCIe memory request comprises generating the PCIe memory request comprising the second address that is associated with a second physical address space utilized by the second entity. The address translation may be implemented utilizing lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations of the method, the PCIe memory request comprises a PCIe UIO Memory Read (UIOMRd) request, the PCIe Completion comprises a PCIe UIORdCplD, and the CXL.io UIORdCplD comprises a CXL DevLoad (CDL) populated by the computer with Quality-of-Service (QoS) telemetry information. The UIO-to-UIO path may preserve UIO semantics across the protocol boundary, enabling multi-path routing and out-of-order completion capabilities on both sides of the computer. The CDL in CXL.io UIO completions may carry telemetry information such as device load indicators, queue depth information, or latency metrics. The computer may populate the CDL with information derived from the PCIe UIORdCplD, from the computer itself, or from intermediate components. This telemetry propagation may enable the first entity to make informed decisions regarding request pacing, load balancing, or resource allocation.

In some implementations of the method, the PCIe memory request comprises a PCIe non-UIO Memory Read (MRd) request, and the PCIe Completion comprises a PCIe non-UIO Completion with Data (CplD). The UIO-to-non-UIO translation may enable a first entity utilizing CXL.io UIO to access resources coupled to a second entity that does not support UIO capabilities. The computer may translate the UIOMRd to MRd that conforms to non-UIO PCIe memory read. This translation may extend the reach of UIO-capable devices to legacy PCIe infrastructure or to devices that have not implemented UIO support.

In some implementations of the method, the CXL.io UIORdCplD comprises a CXL DevLoad (CDL), and wherein the computer populates the CDL with Quality-of-Service (QoS) telemetry information. When translating from PCIe non-UIO completions that do not include a CDL, the computer may generate QoS telemetry information based on locally observed conditions, such as queue depths, latency measurements, or congestion indicators. The computer may thus provide telemetry to the first entity even when the second entity does not support telemetry reporting.

In some implementations of the method, communication between the computer and the first entity utilizes flit-based encoding, and wherein communication between the computer and the second entity utilizes non-flit-based encoding. The split flit/non-flit path may enable communication between entities operating in different encoding modes. PCIe specifications define UIO for flit-based encoding, and do not permit direct translation of UIO TLPs to non-flit-based encoding. The translations may enable the computer to bridge these incompatible modes, enabling CXL.io UIO transactions to reach PCIe devices operating in non-flit mode. This capability may extend the utility of UIO-based systems to include legacy PCIe infrastructure.

In some implementations, the method further comprises receiving, from the first entity, a CXL.io UIO Memory Write request (UIOMWr) comprising a third address, a third Tag, and write data; translating, by the computer, the CXL.io UIOMWr to a PCIe UIOMWr comprising a fourth address, a fourth Tag, and the write data; sending, to the second entity, the PCIe UIOMWr; receiving, from the second entity, a PCIe UIO Write Completion (UIOWrCpl) comprising the fourth Tag; translating, by the computer, the PCIe UIOWrCpl to a CXL.io UIOWrCpl comprising a CXL DevLoad (CDL) and the third Tag; and sending, to the first entity, the CXL.io UIOWrCpl. UIO write transactions may provide non-posted write with completion acknowledgment, unlike non-UIO PCIe memory writes that are posted. The computer may maintain a mapping between the third Tag associated with the CXL.io transaction and the fourth Tag associated with the PCIe transaction. Upon receiving the PCIe UIOWrCpl from the second entity, the computer may utilize the fourth Tag to identify the corresponding pending transaction and retrieve the third Tag for inclusion in the CXL.io UIOWrCpl.

In some implementations of the method, the third address is associated with a first physical address space, wherein the fourth address is associated with a second physical address space, and wherein the computer translates between the third address and the fourth address. The computer may track both read and write transactions in the same tracker entries or may maintain separate tracking structures for different transaction types.

In some implementations, the method further comprises receiving, from the first entity, a CXL.io UIO Memory Write request (UIOMWr) comprising a third address and write data; translating, by the computer, the CXL.io UIOMWr to a PCIe non-UIO Memory Write request (MWr) comprising a fourth address and the write data; and sending, to the second entity, the PCIe MWr. The PCIe non-UIO Memory Write request may be a posted write that does not require a completion from the second entity. The computer may synthesize a CXL.io UIOWrCpl to send to the first entity upon accepting the write request, since CXL.io UIOMWr is non-posted and the first entity expects a completion, while the underlying PCIe non-UIO MWr is a posted write that does not generate a PCIe completion. The translation from non-posted UIO to posted non-UIO may involve buffering the write data and managing ordering requirements.

In some implementations of the method, the third address is associated with a first physical address space utilized by the first entity; wherein the fourth address is associated with a second physical address space utilized by the second entity; wherein the first entity comprises a CXL host or a CXL device; and wherein the second entity comprises a PCIe host or a PCIe device. The first entity may include CXL hosts such as processors or CXL devices such as accelerators, memory expanders, or NICs. The second entity may include PCIe hosts such as processors or PCIe devices such as GPUs, storage controllers, or network adapters. The address translation may accommodate the different address space configurations utilized by these various entity types.

In various implementations, an apparatus comprising: a first interface configured to communicate with a first entity based on CXL.io Unordered Input/Output (UIO), wherein CXL denotes Compute Express Link; a second interface configured to communicate with a second entity based on Peripheral Component Interconnect Express (PCIe); and a computer coupled to the first interface and the second interface, the computer configured to: receive, via the first interface, a CXL.io UIO Memory Read (UIOMRd) request comprising a first address and a first Tag; translate the CXL.io UIOMRd to a PCIe memory request comprising a second address and a second Tag; and send, via the second interface, the PCIe memory request to the second entity. The apparatus may be implemented as a semiconductor device, a card, a module, an active cable, or other suitable form factor. The first interface may expose the apparatus to the first entity as a CXL device, such as a CXL Type-2 device or a CXL Type-3 device. The second interface may expose the apparatus to the second entity as a PCIe device or as a host via a root port. The computer may include logic for address translation, Tag management, protocol conversion, and transaction tracking. Optionally, the apparatus may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and optional PCIe switch(es) may be positioned between the second interface and the second entity.

In some implementations of the apparatus, the computer is further configured to: receive, via the second interface, a PCIe Completion corresponding to the PCIe memory request; translate the PCIe Completion to a CXL.io UIO Read Completion with Data (UIORdCplD) comprising the first Tag and a data payload; and send, via the first interface, the CXL.io UIORdCplD to the first entity. The computer may maintain tracker entries or similar data structures to associate incoming PCIe Completions with their corresponding CXL.io requests. The translation may include extracting the data payload from the PCIe Completion and formatting it for CXL.io UIORdCplD.

In some implementations of the apparatus, the first address is associated with a first physical address space utilized by the first entity, the second address is associated with a second physical address space utilized by the second entity, and wherein the computer is further configured to translate between the first address and the second address. The apparatus may include address translation logic, which may be implemented using lookup tables, content-addressable memory, translation lookaside buffers, or programmable translation functions. The translation may enable the first entity to access resources using addresses within its native address space while the second entity operates within its own address space.

In some implementations of the apparatus, the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information. The apparatus may extract CDL information from the PCIe UIORdCplD or may generate telemetry based on locally observed conditions. The CDL may enable end-to-end QoS telemetry propagation across the protocol boundary.

In some implementations of the apparatus, the PCIe memory request comprises a PCIe non-UIO Memory Read (MRd) request, the PCIe Completion comprises a PCIe non-UIO Completion with Data (CplD), wherein communication via the first interface utilizes flit-based encoding, and wherein communication via the second interface utilizes non-flit-based encoding. The apparatus may bridge flit-based and non-flit-based encoding modes, enabling CXL.io UIO transactions to reach legacy PCIe devices. The computer may handle the different header formats and encoding requirements of each mode.

In some implementations of the apparatus, the first interface exposes a first endpoint to the first entity, and wherein the second interface exposes a second endpoint to the second entity. The first endpoint may be configured as a CXL endpoint that appears to the first entity as a CXL device. The second endpoint may be configured as a PCIe endpoint that appears to the second entity as a PCIe device. The apparatus may thus function as a bridge between CXL and PCIe domains while presenting standard endpoint interfaces to both entities.

In some implementations of the apparatus, the apparatus comprises a cable including a first module coupled to the first interface, a second module coupled to the second interface, and a physical medium coupling the first module and the second module. The cable may be an active cable that includes the computer for performing protocol and address translations. The first module may include electrical or optical components for communicating with the first entity, and the second module may include electrical or optical components for communicating with the second entity. The physical medium may include twinaxial cable, multimode fiber (MMF), or single-mode fiber (SMF). The cable may be implemented as an Active Optical Cable (AOC) or an Active Copper Cable (ACC).

In various implementations, a system comprising: a first entity configured to communicate based on CXL.io Unordered Input/Output (UIO), wherein CXL denotes Compute Express Link; a second entity configured to communicate based on Peripheral Component Interconnect Express (PCIe); and a computer coupled between the first entity and the second entity, the computer configured to: receive, from the first entity, a CXL.io UIO Memory Read (UIOMRd) request comprising a first address; translate the CXL.io UIOMRd to a PCIe memory request comprising a second address; send, to the second entity, the PCIe memory request; receive, from the second entity, a PCIe Completion corresponding to the PCIe memory request; translate the PCIe Completion to a CXL.io UIO Read Completion with Data (UIORdCplD); and send, to the first entity, the CXL.io UIORdCplD. The system may be deployed in datacenters, HPC environments, or AI/ML training and inference clusters. The system architecture may enable CXL-based hosts or devices to access PCIe-attached resources using CXL.io UIO transactions, which may provide performance benefits such as multi-path routing and out-of-order completions. The computer may function as a bridge that maintains the requirements of each protocol while enabling interoperability.

In some implementations of the system, the first address is associated with a first physical address space utilized by the first entity, the second address is associated with a second physical address space utilized by the second entity, wherein the first entity comprises a CXL host or a CXL device, and wherein the second entity comprises at least one of a memory device, a memory expander, a memory pool, a Graphics Processing Unit (GPU), a Network Interface Card (NIC), an accelerator, a PCIe host, or a PCIe device. GPUs may be accessed via the system for AI/ML workloads, graphics rendering, or general-purpose GPU computing. NICs may be accessed for network packet processing, RDMA, or storage traffic handling. Memory devices, memory expanders, or memory pools may provide expanded memory capacity beyond what is directly attached to the first entity. The address translation may enable the first entity to access these diverse resources using a unified address space.

In some implementations of the system, the PCIe memory request comprises a PCIe non-UIO Memory Read (MRd) request, the PCIe Completion comprises a PCIe non-UIO Completion with Data (CplD), and wherein the CXL.io UIORdCplD comprises a CXL DevLoad (CDL) populated by the computer with Quality-of-Service (QoS) telemetry information. The system may enable CXL.io UIO-capable entities to access legacy PCIe devices while still receiving QoS telemetry in the completion. The computer may generate telemetry information based on observed system conditions when the second entity does not provide such information.

In some implementations of the system, the PCIe memory request comprises a PCIe UIOMRd, the PCIe Completion comprises a PCIe UIORdCplD, and wherein the CXL.io UIORdCplD comprises a CXL DevLoad (CDL) populated by the computer with Quality-of-Service (QoS) telemetry information. The UIO-to-UIO system configuration may preserve UIO semantics end-to-end, enabling multi-path routing and enhanced performance on both sides of the computer. QoS telemetry may be propagated from the second entity through the computer to the first entity.

In some implementations of the system, communication between the computer and the first entity utilizes flit-based encoding, and wherein communication between the computer and the second entity utilizes non-flit-based encoding. The system may enable deployment scenarios where newer CXL infrastructure utilizing flit-based encoding needs to communicate with legacy PCIe infrastructure utilizing non-flit-based encoding. The computer may handle the encoding mode differences transparently to the first and second entities.

In heterogeneous computing architectures, entities may communicate using different revisions of CXL.io, wherein earlier protocol revisions may lack support for UIO capabilities present in newer protocol revisions. CXL.io UIO defines wire semantics and TLP types to enable multi-path fabrics and improved performance. In environments where a first entity supporting a first CXL.io needs to access resources coupled to a second entity supporting a second CXL.io with UIO capabilities, translations between CXL.io non-UIO TLPs and CXL.io UIO TLPs may facilitate memory operations and data transfers across incompatible domains. Such translations may be performed by a computer, an apparatus, a cable, or other suitable devices positioned between the first entity and the second entity.

In various implementations, a method for translating between Compute Express Link (CXL) Transaction Layer Packets (TLPs), comprising: receiving, from a first entity, a CXL.io Memory Read (MRd) request comprising a first address and a first Tag; translating, by a computer, the CXL.io MRd to a CXL.io Unordered Input/Output (UIO) Memory Read (UIOMRd) request comprising a second address and a second Tag; sending, to a second entity, the CXL.io UIOMRd; receiving, from the second entity, a CXL.io UIO Read Completion with Data (UIORdCplD) comprising the second Tag and a data payload; translating, by the computer, the CXL.io UIORdCplD to a CXL.io Completion with Data (CplD) comprising the first Tag and the data payload; and sending, to the first entity, the CXL.io CplD. The translation process may encompass various aspects of the protocol messages, including opcodes, addresses, Tags, and other TLP fields, thereby enabling communication between entities that utilize different CXL.io revisions. The computer may convert non-UIO TLP formats to UIO TLP formats for the request path and convert UIO TLP formats back to non-UIO TLP formats for the completion path. The method may be implemented in hardware, firmware, software, or combinations thereof, and may be performed by various types of devices, such as semiconductor devices, switches, or active cables. Additionally, the elements may communicate through one or more intermediary components, such as a switch, a retimer, or other suitable entity that facilitates information transfer.

In some implementations of the method, the first address is associated with a first physical address space utilized by the first entity, and wherein translating the CXL.io MRd to the CXL.io UIOMRd comprises generating the CXL.io UIOMRd comprising the second address that is associated with a second physical address space utilized by the second entity. The address translation may be implemented utilizing mechanisms such as lookup tables, page tables, hash tables, base-and-offset calculations, or programmable translation functions. The first and second physical address spaces may have different sizes, different base addresses, or different memory layouts, and the translation may accommodate these differences while maintaining the meaning of the memory operations. In some examples, the first physical address space may include a first HPA space utilized by a first host, and the second physical address space may include a second HPA space utilized by a second host or an address space utilized by a CXL device.

In some implementations of the method, the computer maintains state information comprising tracker entries or pending transaction tables to correlate the CXL.io UIORdCplD with the CXL.io UIOMRd and to associate the second Tag with the first Tag. The computer may allocate tracker entries upon receiving the CXL.io MRd and may store information including the first Tag, the first address, and transaction metadata. When the computer generates the CXL.io UIOMRd, it may assign the second Tag and record the mapping between the first Tag and the second Tag in the tracker entry. Upon receiving the CXL.io UIORdCplD comprising the second Tag, the computer may utilize the state information to identify the corresponding pending transaction and retrieve the first Tag for inclusion in the CXL.io CplD. The tracker entries may be implemented in hardware registers, content-addressable memory, or other suitable storage structures.

In some implementations of the method, the CXL.io UIORdCplD comprises a CXL DevLoad (CDL) field carrying Quality-of-Service (QoS) telemetry information, the second entity utilizes the CDL field for throttling requests from the computer, and the computer does not propagate the CDL field to the first entity in the CXL.io CplD. The CDL in CXL.io UIO completions may carry telemetry information such as device load indicators, queue depth information, or latency metrics populated by the second entity. The second entity may utilize the CDL to communicate its current load state to the computer, enabling the computer to adjust request pacing or implement congestion management. Because the CXL.io utilized by the first entity does not support UIO, the CXL.io CplD does not include a CDL field, and the computer may drop the CDL information when performing the translation and/or log or utilize the CDL information internally for its own traffic management decisions.

In some implementations of the method, a first CXL.io utilized for communicating the CXL.io MRd is an earlier revision than a second CXL.io utilized for communicating the CXL.io UIOMRd, and wherein a first interface utilized by the computer to communicate with the first entity and a second interface utilized by the computer to communicate with the second entity each comprise a CXL endpoint or a switch port. The first CXL.io may conform to an earlier CXL specification revision, such as CXL Specification Revision 1.1, that does not support UIO capabilities, while the second CXL.io may conform to a later CXL specification revision, such as CXL Specification Revision 3.2, that supports UIO capabilities. The first interface may expose a first CXL endpoint or a first switch port to the first entity, and the second interface may expose a second CXL endpoint or a second switch port to the second entity. The computer may thus function as a bridge between different CXL.io revisions while presenting CXL interfaces to both entities. Optionally, the computer may be implemented in an IC package having high-speed differential I/O balls positioned according to a ball grid array layout defined by a PCIe Retimer Supplemental Features and Standard BGA Footprint Specification.

In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

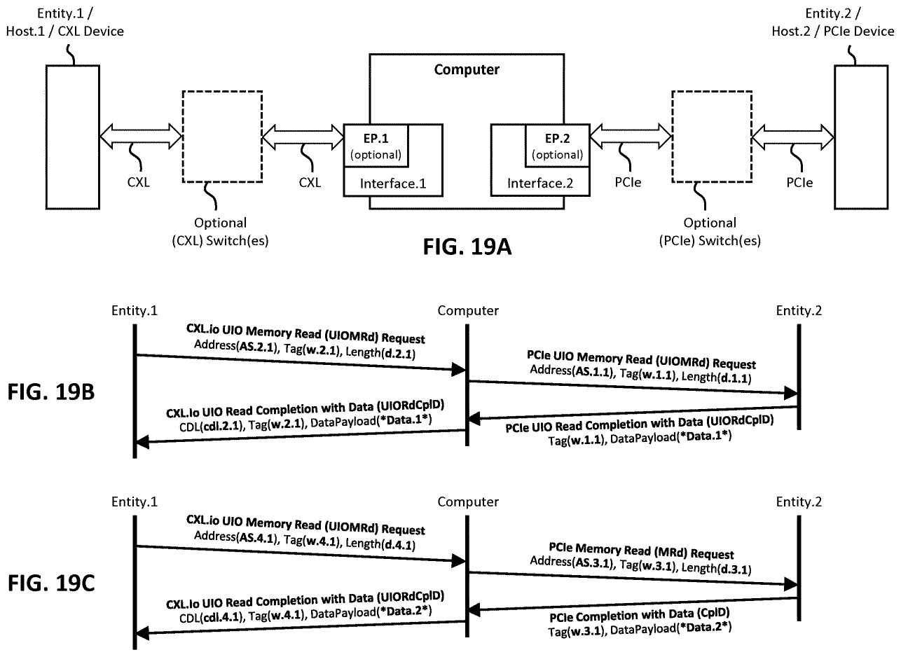

FIG. 19A illustrates an example of a system comprising a computer coupled between a first interface (Interface.1) that may communicate according to a CXL-based protocol, such as CXL.io, CXL.mem, or CXL.cache, and a second interface (Interface.2) that may communicate according to a PCIe-based protocol, such as a protocol conforming to PCI Express Base Specification Revision 6.2. The computer may be implemented in an IC package having high-speed differential I/O balls positioned according to a ball grid array layout defined by the PCIe Retimer Supplemental Features and Standard BGA Footprint Specification. The first interface may expose a first endpoint (EP.1) and may communicate according to a CXL-based protocol with a first entity (Entity.1), which may be a first host (Host.1) or a CXL device. The second interface may expose a second endpoint (EP.2) and may communicate according to a PCIe-based protocol, with a second entity (Entity.2), which may be a second host (Host.2) or a PCIe device. The computer may extract physical addresses from TLPs, PDUs, or messages, received via the first interface, wherein these addresses may refer to a first HPA space utilized by the first entity; translate these addresses; and generate TLPs, PDUs, or messages carrying the translated physical addresses for transmission via the second interface; wherein these translated addresses may correspond to a second HPA space utilized by the second entity. Optional switch(es), such as CXL switches, may be positioned between the first interface and the first entity. Additionally or alternatively, optional switch(es), such as PCIe switches, may be positioned between the second interface and the second entity.

FIG. 19B illustrates an example of a TFD demonstrating translations, performed by a computer, between CXL-based protocol data units (PDUs), such as CXL.io TLPs, received from a first entity (Entity.1), which may be a first host (Host.1) or a CXL device, and PCIe TLPs, sent to a second entity (Entity.2), which may be a second host (Host.2) or a PCIe device, possibly enabling the first entity to access resources mapped to an address space utilized by the second entity. The first entity may initiate a CXL.io transaction that includes a CXL.io UIO Memory Read (UIOMRd) request comprising Address(AS.2.1), Tag(w.2.1), and Length(d.2.1). The computer may translate the CXL.io transaction to a PCIe transaction that includes a PCIe UIOMRd comprising Address(AS.1.1), Tag(w.1.1), and Length(d.1.1), and may send the PCIe UIOMRd to the second entity. Upon receiving a completion from the second entity, which may include a PCIe UIO Read Completion with Data (UIORdCplD) comprising Tag(w.1.1) and DataPayload(*Data.1*), the computer may translate the PCIe UIORdCplD to a CXL.io UIORdCplD comprising CDL(cdl.2.1), Tag(w.2.1), and DataPayload(*Data.1*), wherein the CDL may be populated by the computer with information related to QoS, such as QoS telemetry value or values. The computer may perform further translations, such as protocol translations, opcode translations, command translations, or TLP type translations, e.g., translating between CXL.io UIO TLPs, such as CXL.io UIOMRd TLP, and PCIe non-UIO TLPs, such as PCIe MRd.

Recent PCIe hosts and devices may leverage the PCIe Unordered IO (UIO) optional capability, originally introduced as ECN, and later incorporated into PCIe Base Specification Revision 6.2. PCIe UIO defines a new wire semantic and related capabilities that address limitations of the PCI/PCIe fabric-based ordering rules, enabling improved performance and efficiency, such as by utilizing multi-path routing. The computer may further perform other translations, such as field translations between TLPs conforming to CXL.io and TLPs conforming to PCIe, translations between CXL.io Tags and PCIe Tags, translations between reserved fields, and/or translations between reserved and non-reserved fields.

FIG. 19C illustrates an example of a TFD demonstrating translations between CXL.io TLPs, received from a first entity (Entity.1), and PCIe TLPs, sent to a second entity (Entity.2), possibly enabling the first entity to access resources mapped to an address space utilized by the second entity. The computer may perform further translations, such as protocol translations, opcode translations, command translations, TLP type translations, or field translations, between CXL.io TLPs and PCIe TLPs. The first entity may initiate a CXL.io transaction that includes a CXL.io UIOMRd comprising Address(AS.4.1), Tag(w.4.1), and Length(d.4.1). The computer may translate the CXL.io transaction to a PCIe transaction that includes a PCIe Memory Read (MRd) request comprising Address(AS.3.1), Tag(w.3.1), and Length(d.3.1), and may send the PCIe MRd to the second entity. Upon receiving a completion from the second entity, which may include a PCIe Completion with Data (CplD) comprising Tag(w.3.1) and DataPayload(*Data.2*), the computer may translate the PCIe CplD to a CXL.io UIORdCplD comprising CDL(cdl.4.1), Tag(w.4.1), and DataPayload(*Data.2*), wherein the CDL may be populated by the computer with information related to QoS.

The translations may further enable communication between the first entity and the second entity over a split flit/non-flit path, wherein the CXL.io UIO portion of the path may utilize CXL protocol flits, whereas the PCIe non-UIO portion of the path may utilize Non-Flit Mode (NFM). Such split flit/non-flit path setup is not allowed in standard PCIe Revision 6.2 environments when the whole path utilizes PCIe. In the context of PCIe, Flit Mode (FM) and NFM may use different header formats, wherein routing elements may be required to translate between the FM TLP and NFM TLP formats when the Ingress Port and Egress Port are in different modes. The current PCIe specifications define PCIe UIO for FM, and no translations of UIO TLPs to NFM are permitted.

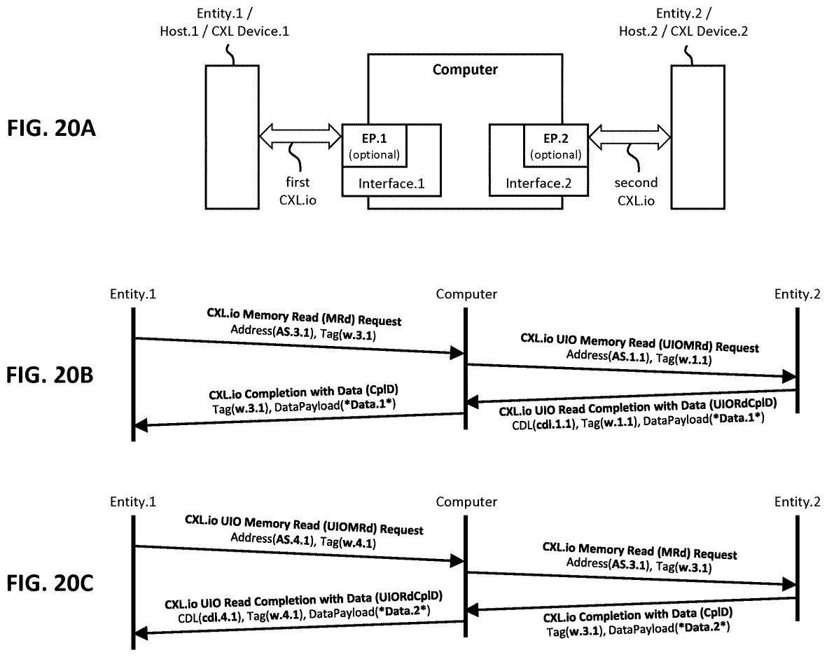

FIG. 20A illustrates an example of a system comprising a computer coupled between first and second interfaces. The first interface (Interface.1) may communicate according to first CXL.io, such as CXL.io conforming to CXL Specification Revision 1.1. The second interface (Interface. 2) may communicate according to second CXL.io, such as CXL.io conforming to CXL Specification Revision 3.2. The computer may be implemented in an IC package having high-speed differential I/O balls positioned according to a ball grid array layout defined by PCIe Retimer Supplemental Features and Standard BGA Footprint Specification. The first interface may expose a first endpoint (EP.1) and may communicate according to the first CXL.io with a first entity (Entity.1), which may be a first host (Host.1) or a first CXL device (CXL Device.1). The second interface may expose a second endpoint (EP.2) and may communicate according to the second CXL.io, with a second entity (Entity.2), which may be a second host (Host.2) or a second CXL device (CXL Device.2). The computer may extract physical addresses from first PDUs, such as first CXL.io TLPs, received via the first interface, wherein these addresses may refer to a first physical address space utilized by the first entity; translate these addresses; and generate second PDUs, such as second CXL.io TLPs, carrying the translated physical addresses for transmission via the second interface; wherein these translated addresses may correspond to a second physical address space utilized by the second entity.

FIG. 20B illustrates an example of a TFD demonstrating translations between CXL.io non-UIO TLPs associated with first CXL.io, received from a first entity (Entity.1), which may be a first host (Host.1) or a first CXL device (CXL Device.1), and CXL.io UIO TLPs associated with second CXL.io, sent to a second entity (Entity.2), which may be a second host (Host.2) or a second CXL device (CXL Device.2), possibly enabling the first entity to access resources mapped to an address space utilized by the second entity. The first entity may initiate a CXL.io non-UIO transaction that may include a CXL.io Memory Read (MRd) request comprising Address(AS.3.1) and Tag(w.3.1). A computer may translate the CXL.io non-UIO transaction to a CXL.io UIO transaction that may include a CXL.io UIO Memory Read (UIOMRd) request comprising Address(AS.1.1) and Tag(w.1.1), and may send the CXL.io UIOMRd to the second entity. Upon receiving a completion from the second entity, which may include a CXL.io UIO Read Completion with Data (UIORdCplD) comprising CDL(cdl.1.1), Tag(w.1.1), and DataPayload(*Data.1*), the computer may translate the CXL.io UIORdCplD to a CXL.io Completion with Data (CplD) comprising Tag(w.3.1) and DataPayload(*Data.1*), and send the CXL.io CplD to the first entity. CDL in CXL.io UIO completions may be populated with information related to QoS, such as QoS telemetry value or values. The second entity may utilize the CDL for throttling requests from the computer. The computer may perform additional translations, such as protocol translations, opcode translations, command translations, TLP type translations, Tag translations, length translations, or field translations.

Translations from CXL.io non-UIO to CXL.io UIO may enable CXL hosts and CXL devices to utilize additional capabilities on top of capabilities provided by CXL.io non-UIO, such as peer-to-peer flows to CXL.mem regions, QoS telemetry via CDL Devload (CDL) field in UIO completions, non-posted UIO writes, access to Global-Fabric-Attached Memory Devices (GFDs), use of the Global Integrated Memory (GIM), and cross-domain UIO accesses over a CXL fabric.

FIG. 20C illustrates an example of a TFD demonstrating translations between CXL.io UIO TLPs associated with first CXL.io, received from a first entity (Entity.1), which may be a first host (Host.1) or a first CXL device (CXL Device.1), and CXL.io non-UIO TLPs associated with second CXL.io, sent to a second entity (Entity.2), which may be a second host (Host.2) or a second CXL device (CXL Device.2), possibly enabling the first entity to access resources mapped to an address space utilized by the second entity. The first entity may initiate a CXL.io UIO transaction that may include a CXL.io UIOMRd comprising Address(AS.4.1) and Tag(w.4.1). A computer may translate the CLX. io UIO transaction to a CLX. io non-UIO transaction that may include a CXL.io MRd comprising Address(AS.3.1) and Tag(w.3.1), and may send the CXL.io MRd to the second entity. Upon receiving a completion from the second entity, which may include a CXL.io Completion with Data (CplD) comprising Tag(w.3.1) and DataPayload(*Data.2*), the computer may translate the CXL.io CplD to a CXL.io UIORdCplD comprising CDL(cdl.4.1), Tag(w.4.1), and DataPayload(*Data.2*), and send the CXL.io UIORdCplD to the first entity. CDL in CXL.io UIO completions may be populated with information related to QoS, such as QoS telemetry value or values. The computer may utilize CDL for throttling requests from the first entity. The computer may perform additional translations, such as protocol translations, opcode translations, command translations, TLP type translations, Tag translations, length translations, or field translations. Translations from CXL.io UIO to CXL.io non-UIO may enable newer CXL hosts and CXL devices to utilize legacy non-UIO resources over CXL fabrics and mixed CXL/PCIe fabrics.

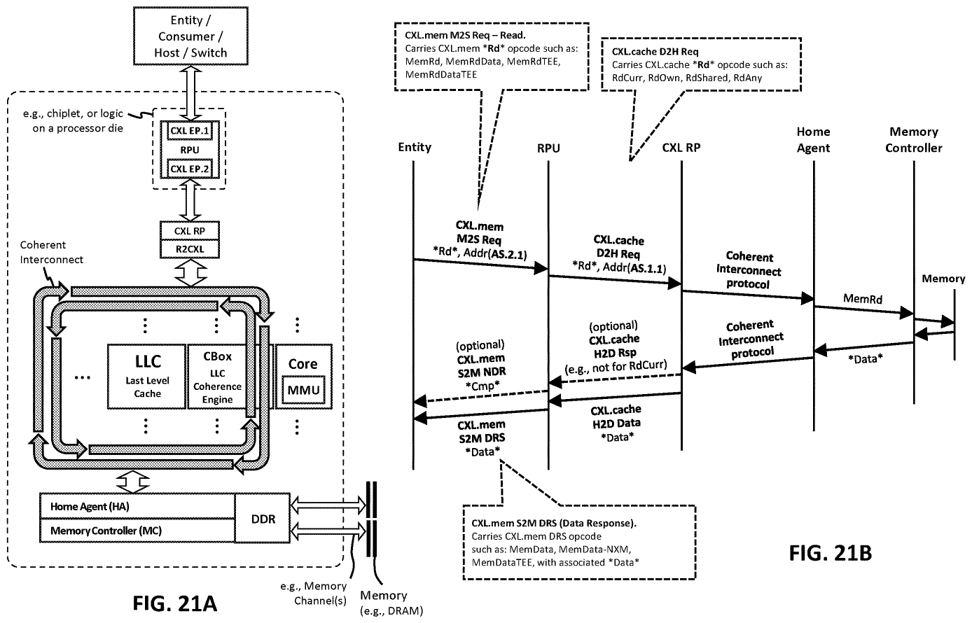

FIG. 21A illustrates an example of a system comprising a processor, including a coherent interconnect, capable of enabling an external entity to access memory resources mapped to the address space utilized by the coherent interconnect. Optionally, the processor is an MxPU derived from an established processor design that may include coherent interconnect (such as a ring-based or a mesh-based coherent interconnect), processing cores, LLC, a CXL RP, and a memory controller optionally coupled via memory channels to memory, such as DRAM. The CXL RP may be coupled to the coherent interconnect via a Ring-to-CXL (R2CXL) logic. An RPU, which may be included in the MxPU, performs address translations that may enable an entity such as a host to access the memory. The MxPU may expose to the entity, optionally via the RPU, a first CXL device, such as a Type-3 CXL device or a Type-2 CXL device, utilizing a first CXL endpoint (CXL EP.1). The first CXL device may communicate with the entity according to a protocol based on CXL, such as CXL.mem. The MxPU may further expose, optionally via the RPU and the CXL RP, a second CXL device such as a Type-1 CXL device or a Type-2 CXL device, utilizing a second CXL endpoint (CXL EP.2). In some examples, the RPU and its CXL devices may be implemented in a chiplet inside an IC package of a processor, such as inside an IC package of an MxPU, whereas in other examples, the RPU and its CXL devices may be implemented as functional blocks on the same die with the CXL RP, or split between processor dies or chiplets. Alternatively, the RPU may be implemented as a discrete component coupled to a processor component.

FIG. 21B illustrates an example of a TFD demonstrating a CXL.mem read request (M2S request *Rd*) received from an entity, such as a host or a switch, wherein the RPU may translate between CXL.mem and CXL.cache, and may further translate a physical address (AS.2.1) from a second host physical address space, carried in the CXL.mem M2S request, to a physical address (AS.1.1) from a first HPA space, carried in a CXL.cache D2H request, wherein the first HPA space is utilized by the processor and/or by the coherent interconnect. The RPU may perform further translations, such as opcode translations and Tag to CQID translations. The CXL.cache request, carrying the translated address (AS.1.1), is sent to the CXL RP for further processing and fetching of the requested data, such as from the LLC over the on-chip ring-based coherent interconnect, or from the DRAM via the memory controller. The data may then return over the coherent interconnect to the RPU, via the CXL RP, wherein the RPU may perform further translations between CXL.cache and CXL.mem and provide CXL.mem Data Response (DRS) and optionally CXL.mem No Data Response (NDR) to the requesting entity.

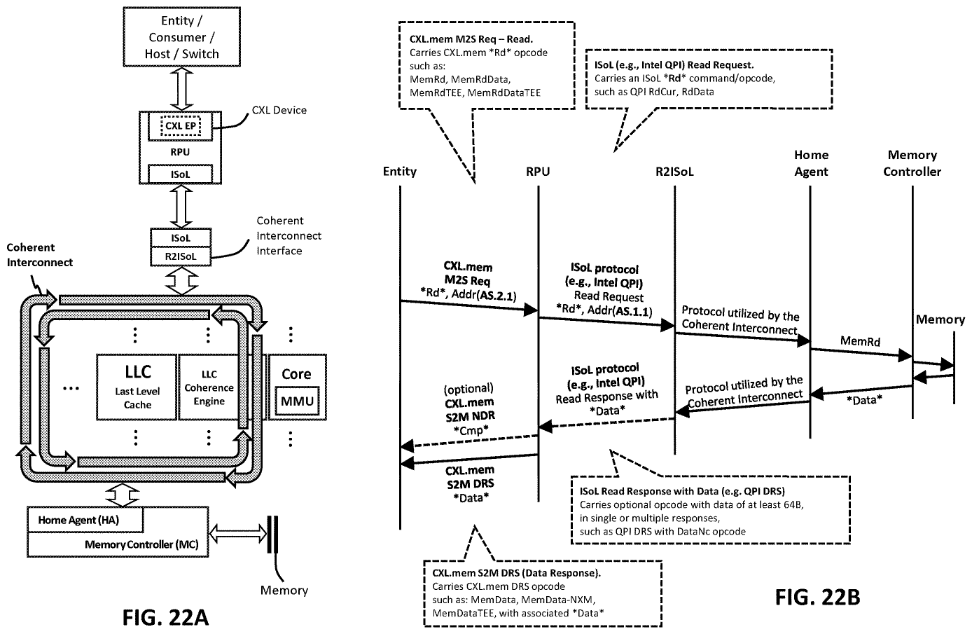

FIG. 22A illustrates an example of a system comprising a processor, including a coherent interconnect, capable of enabling an external entity to access memory resources mapped to the address space utilized by the coherent interconnect. Optionally, the processor is an MxPU derived from an established processor design that may include an RPU that may include, or be coupled to, a CXL device, such as a GFD, a CXL Type-3 device, or a CXL Type-2 device. The CXL device may include a CXL EP, wherein the RPU may be implemented as a chiplet, a logic on the processor die, a discrete component coupled to the processor, or other implementations. The processor may further include processing cores with MMUs, LLC, and LLC Coherence Engine (such as CBox) coupled via an on-chip coherent interconnect that may utilize a ring topology as one example. The processor may further include a Home Agent (HA) and Memory Controller (MC) coupled to memory, such as DRAM, optionally via memory channels. The RPU may be coupled to the coherent interconnect via an ISoL interface, such as Intel QPI, Intel UPI, or CHI C2C, and via a coherent interconnect interface, such as Ring-to-ISoL (R2ISoL) logic. The CXL device, which may reside within the RPU, may communicate with an entity, such as a host, according to a protocol based on CXL, such as CXL.mem, wherein the RPU performs address translations between the host's HPA space and the processor's physical address space to enable the host to access the memory and other resources accessible via the coherent interconnect. Alternatively, the figure may illustrate some examples of a two-socket (2S) or a two-processor (2P) system that may function as a memory switch or a memory pool, wherein the RPU may be embedded in the first processor coupled to the entity, and further coupled to a second processor via an ISoL interface, whereas the RPU enables the entity to access memory of the second processor, via the first processor and the ISoL interface.

FIG. 22B illustrates an example of a TFD demonstrating a CXL.mem M2S Read request received from an entity, such as a host or a switch. The request carries a CXL.mem read opcode such as MemRd, MemRdData, MemRdTEE, or MemRdDataTEE, along with a physical address (AS.2.1) from a second host physical address space utilized by the entity. The RPU translates the physical address (AS.2.1) to a physical address (AS.1.1) from a first HPA space utilized by the processor and/or the coherent interconnect. The RPU may also translate the CXL.mem request to an ISoL request (such as Intel QPI read request) including a read command/opcode such as QPI RdCur or RdData. The translated request is sent via the coherent interconnect to fetch the requested data, which may be retrieved from the LLC or from DRAM. The requested data returns to the RPU via the coherent interconnect and the ISoL interface using the ISoL protocol. The RPU then provides responses to the requesting entity including: CXL.mem S2M DRS carrying CXL.mem DRS opcodes such as MemData, MemData-NXM, or MemDataTEE with associated data, and optionally CXL.mem S2M NDR with a completion status. The ISoL read response may carry optional opcodes with data of at least 64B, in single or multiple responses, such as QPI DRS with DataNc opcode.

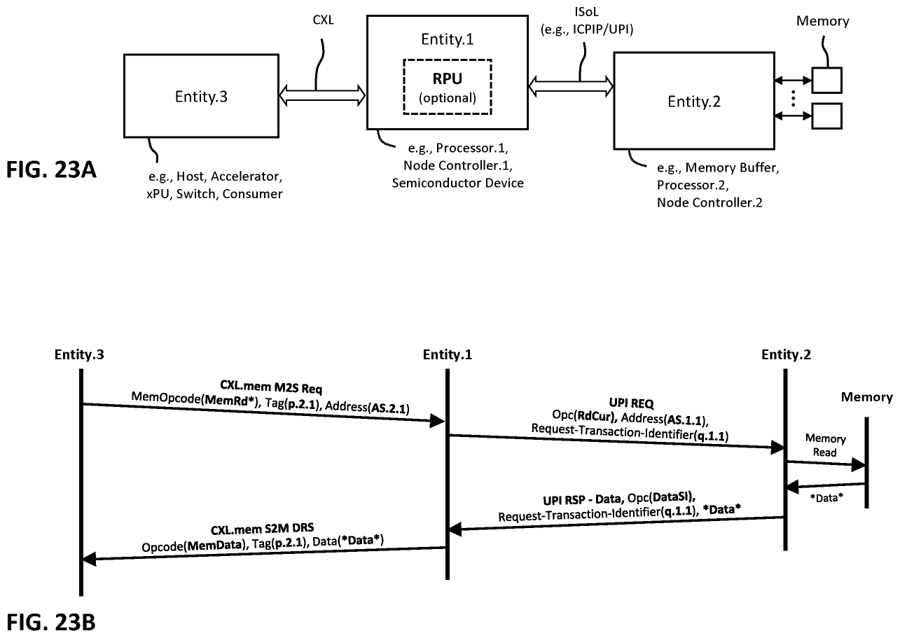

FIG. 23A illustrates an example of a system comprising a first entity (Entity.1), such as a first processor (Processor.1), a first node controller (Node Controller.1), or a semiconductor device, that may include an RPU. The first entity may be coupled to a third entity (Entity.3), which may be a host, an accelerator, an xPU, a switch (e.g., a CXL switch), or a resource consumer, wherein the first entity may communicate with the third entity according to a CXL-based protocol, such as at least one of CXL.mem, CXL.io, or CXL.cache. The first entity may be further coupled to a second entity (Entity.2), which may be a second processor (Processor.2), a memory buffer, or a second node controller (Node Controller.2), wherein the second entity may be coupled to a memory, and wherein the first entity may communicate with the second entity according to an ISoL protocol, such as ARM CHI C2C, a protocol utilizing an NVIDIA NVLink-C2C interconnect, or an Intel Coherent Processor Interconnect Protocol (ICPIP), such as Intel UPI. The first node controller (Node Controller.1) and the second node controller (Node Controller.2) may each include an ICPIP node controller, such as a UPI node controller (UNC), or an external node controller (e.g., XNC). The first entity, optionally via the RPU, may translate between the CXL-based protocol, such as CXL.mem, and the ISoL protocol, such as ICPIP, enabling the third entity to access resources coupled to the first entity, such as the memory that may be coupled to the second entity.

In some examples, the CXL-based protocol, such as CXL.mem, may be associated with a first address space, such as a first Host Physical Address (HPA) space, and the ISoL protocol, such as ICPIP, may be associated with a second address space, such as a System Physical Address (SPA) space or a second Host Physical Address (HPA) space; wherein the first entity, optionally via the RPU, may perform address translations between addresses within the first and second address spaces, respectively, such as between addresses within the first HPA space and addresses within the SPA space or within the second HPA space. In other examples, the CXL-based protocol, such as CXL.mem, and the ISoL protocol, such as ICPIP, may be associated with the same physical address space, such as with the same HPA space, the same SPA space, or with a global address space, a partitioned global address space (PGAS), a pod address space, a virtual pod address space, or a fabric address space; wherein the first entity, optionally via the RPU, may perform address translations between addresses within the same address spaces. The first entity (Entity.1), optionally via the RPU, may perform further translations, such as opcode, command, or TLP translations, e.g., translating between commands or opcodes in requests conforming to the CXL-based protocol (e.g. CXL.mem M2S Req MemRd) to opcodes in requests conforming to the ISoL Protocol (e.g., Intel UPI RdCur). The first entity, optionally via the RPU, may further perform other translations, such as translations between messages conforming to the CXL-based protocol and protocol data units (PDUs) conforming to the ISoL Protocol, Tag translations, traffic class (TC) translations, and/or cross-field translations, wherein the first entity, optionally via the RPU, may maintain tracking between Tags associated with the CXL-based protocol and Tags associated with the ISoL protocol, such as in order to associate responses with their corresponding requests.

FIG. 23B illustrates an example of a TFD demonstrating translations between CXL.mem traffic and ISoL traffic, such as ICPIP (e.g., Intel UPI) traffic. The translations may be performed by a first entity (Entity.1), such as a first processor (Processor.1), a first node controller (Node Controller.1), or a semiconductor device, optionally via an RPU. The CXL-based protocol may be utilized for communicating with a third entity (Entity.3), such as a host, and the ISoL protocol may be utilized for communicating with a second entity (Entity.2), such as a second processor (Processor.2), or a second node controller (Node Controller.2). The second entity may be coupled to a memory, such as DRAM, which may be mapped to a physical address space (PAS) utilized by the first entity. The third entity may initiate a CXL transaction that may include a CXL.mem M2S Req comprising MemOpcode(MemRd*), Tag(p.2.1), and Address(AS.2.1). The first entity, optionally via the RPU, may translate the CXL transaction to an ISoL (e.g., ICPIP) transaction, such as an Intel UPI transaction that may include a UPI request (REQ message class) comprising Opc(RdCur), Address(AS.1.1), and Request-Transaction-Identifier(q.1.1), wherein the Request-Transaction-Identifier (e.g., RTID) may denote a Tag, a transaction Tag, a transaction identifier, or another field or set of fields carried in UPI transactions which may serve to associate responses with their corresponding requests.

The first entity (Entity.1) may send the UPI request (REQ) to the second entity. Upon receiving a response from the second entity, that may include a UPI data response (“RSP-Data” message class, which may also be denoted by “RSP4-Data”) comprising Opc(DataSI), Request-Transaction-Identifier(q.1.1), and *Data*, the first entity, optionally via the RPU, may translate the UPI response (RSP-Data) to a CXL.mem S2M DRS comprising Opcode(MemData), Tag(p.2.1), and Data(*Data*). In some examples, the requested data may be provided by a processor cache instead of by the memory, such as where the requested data may be provided by an LLC that may be included in the first entity, or by an LLC that may be included in the second entity. In other examples, the first entity, optionally via the RPU, may translate the CXL transaction to an ICPIP transaction, such as an Intel UPI transaction, that may include message classes such as REQ, SNP, WB, RSP (such as RSP2 or RSP4), NCB, or NCS, that may include commands, operations, or opcodes (e.g., Opc), such as RdCode, RdCur, RdData, RdInv, RdInvOwn, SnpCode, SnpCur, SnpData, SnpInv, WbMtoS, WcWr, WcWrPtl, DataE, DataSI, or DataM_CmpO.

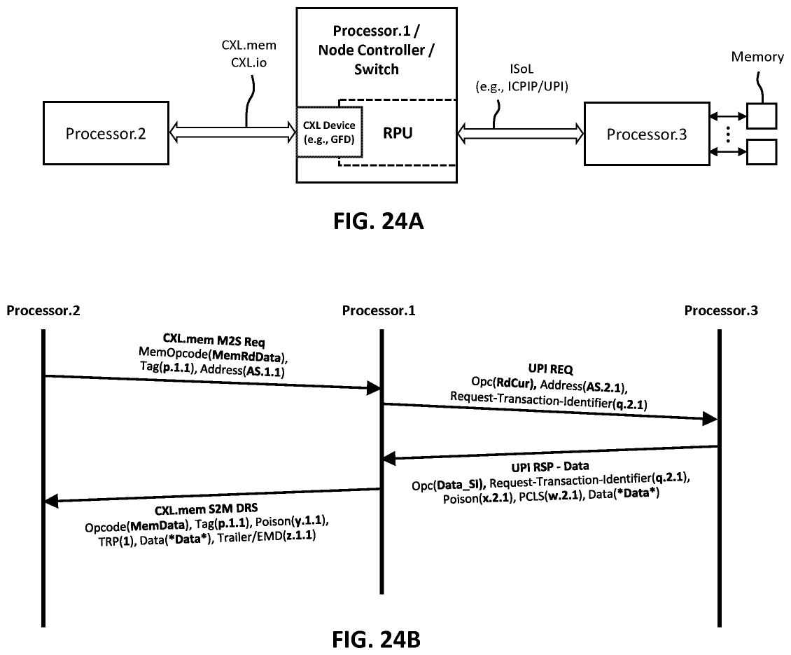

FIG. 24A illustrates an example of a system comprising a first processor (Processor.1), a node controller, or a switch, that may include an RPU and a CXL device, such as a Global Fabric-Attached Memory (G-FAM) Device (GFD), wherein the CXL device may be included in or coupled to the RPU. The first processor may be coupled to a second processor (Processor.2), wherein the first processor may communicate with the second processor, via the CXL device, according to a CXL-based protocol, such as at least one of CXL.mem, CXL.io, or CXL.cache. The first processor may be further coupled to a third processor (Processor.3) that may be coupled to memory, and wherein the first processor may communicate with the third processor according to an ISoL protocol, such as NVIDIA NVLink-C2C, ARM CHI C2C, or Intel Coherent Processor Interconnect Protocol (ICPIP), such as Intel UPI. The first processor, optionally via the RPU, may translate between the CXL-based protocol, such as CXL.mem or CXL.io, and the ISoL protocol, such as ICPIP (e.g., Intel UPI), enabling the second processor to access, via the CXL device, resources coupled to the third processor, such as the memory.

In some examples, the CXL-based protocol, may be associated with a first address space, such as a first Host Physical Address (HPA) space, and the ISoL protocol, such as ICPIP, may be associated with a second address space, such as a System Physical Address (SPA) space or a second Host Physical Address (HPA) space; wherein the first processor, optionally via the RPU, may perform address translations between addresses within the first and second address spaces, respectively, such as between addresses within the first HPA space and addresses within the SPA space or within the second HPA space. In other examples, messages conforming to the CXL-based protocol and messages conforming to the ISoL protocol may be associated with the same physical address space, such as with the same HPA space; wherein the first processor, optionally via the RPU, may perform address translations between addresses within the same address spaces. The first processor, optionally via the RPU, may perform further translations, such as protocol translations, opcode translations, command translations, TLP translations, or translations between messages conforming to the CXL-based protocol and PDUs conforming to the ISoL Protocol, Tag translations, traffic class (TC) translations, and/or cross-field translations; wherein the first processor, optionally via the RPU, may maintain tracking between Tags associated with the CXL-based protocol and Tags associated with the ISoL protocol, such as in order to associate responses with their corresponding requests.

FIG. 24B illustrates an example of a TFD demonstrating translations between CXL.mem and UPI. The illustrated translations are performed by a first processor (Processor.1), a node controller, or a switch, optionally via an RPU, between a CXL-based protocol, such as CXL.io and/or CXL.mem, utilized for communicating with a second processor (Processor.2), and an ISoL protocol, such as ICPIP (e.g., Intel UPI), utilized for communicating with a third processor (Processor.3) that may be coupled to memory, such as DRAM, which may be mapped to a physical address space (PAS) utilized by the first processor. The first processor may utilize translations, such as protocol translations, to convey indications, metadata, and other information, which may be related to the transaction, such as error and data corruption indications, such as poison, status indications, or directory information such as prior cacheline state (PCLS), which may be used to gather performance statistics. The second processor may initiate a CXL transaction that may include a CXL.mem M2S Req comprising MemOpcode(MemRdData), Tag(p.1.1), and Address(AS.1.1). The first processor, optionally via the RPU, may translate the CXL transaction to an ISoL (e.g., ICPIP) transaction, such as an Intel UPI transaction that may include UPI REQ comprising Opc(RdCur), Address(AS.2.1), and Request-Transaction-Identifier RTID(q.2.1), wherein the first processor may send the UPI REQ to the third processor.

Upon receiving a response from the third processor, that may include a UPI RSP-Data comprising Opc(Data_SI), Request-Transaction-Identifier (RTID) (q.2.1), Poison(x.2.1), PCLS(w.2.1) and Data(*Data*), the first processor, optionally via the RPU, may translate the UPI RSP-Data to a CXL.mem S2M DRS comprising Opcode(MemData), Tag(p.1.1), Poison(y.1.1), TRP(1), Data(*Data*), and Trailer/EMD(z.1.1), whereas TRP(1) indicates Trailer Present, i.e., indicating that a trailer is included in the message, wherein the first processor, optionally via the RPU, may utilize the CXL.mem S2M DRS trailer for conveying status information such as the PCLS, optionally as EMD (Extended Metadata) information. Other revisions of the CXL specifications may utilize a Byte-Enables Present (BEP) field instead of the Trailer Present (TRP) field. The first processor, optionally via the RPU, may perform further translations, such as translations of error indications, such as poison, from the ISoL (e.g., ICPIP/UPI) domain, to the CXL-based domain, wherein poison (e.g., a bit in the protocol message or PDU) may indicate that the data contains an error, and may be logged, ignored, or silently discarded, possibly causing Silent Data Corruption (SDC). The first processor, optionally via the RPU, may further perform other translations, such as translations between messages conforming to the CXL-based protocol and PDUs conforming to the ISoL Protocol (e.g., Intel UPI), Tag translations, traffic class (TC) translations, and/or cross-field translations.

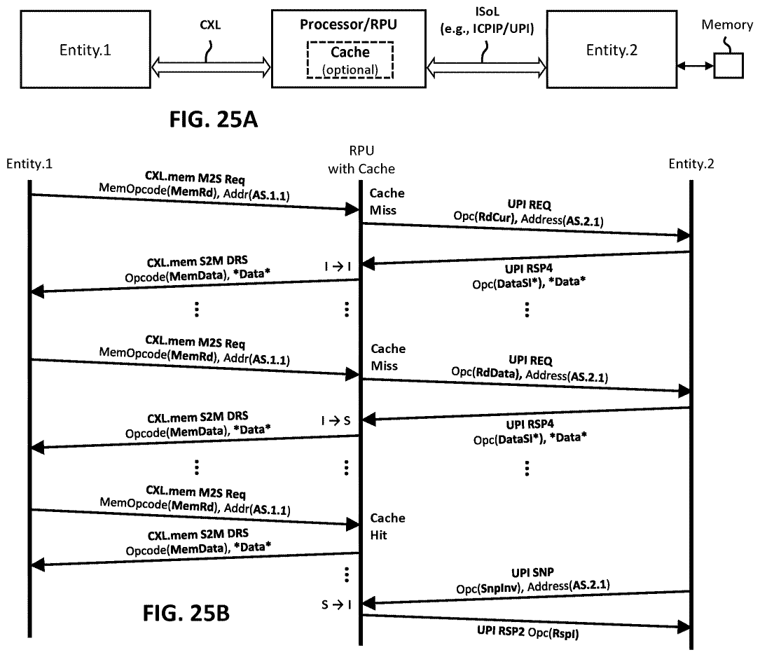

FIG. 25A illustrates an example of a system comprising a processor or an RPU, denoted as Processor/RPU, which may include a cache. The Processor/RPU may be coupled to a first entity (Entity.1), which may be a host, a second processor, a CXL Switch, or a resource consumer, wherein the Processor/RPU may communicate with the first entity according to a CXL-based protocol, such as at least one of CXL.mem, CXL.io, or CXL.cache. The Processor/RPU may be further coupled to a second entity (Entity.2), which may be a third processor, a node controller, or a memory buffer, wherein the second entity may be coupled to a memory, and wherein the Processor/RPU may communicate with the second entity according to an ISoL protocol, such as NVIDIA NVLink-C2C, ARM CHI C2C, or Intel Coherent Processor Interconnect Protocol (ICPIP), such as Intel UPI. The Processor/RPU may translate between the CXL-based protocol, such as at least one of CXL.io, CXL.mem, or CXL.cache, and the ISoL protocol, such as ICPIP, enabling the first entity to access resources coupled to the second entity, such as the memory. The Processor/RPU may cache data retrieved from the second entity and may respond to CXL requests received from the first entity with data from the cache, instead of issuing read requests to the second entity. Additionally or alternatively, the Processor/RPU may prefetch data from the second entity into the cache. The Processor/RPU may perform further translations between the CXL-based domain and the ISoL domain, such as protocol translations, address translations, opcode translations, command translations, TLP translations, and translations between messages conforming to the CXL-based protocol and PDUs conforming to the ISoL Protocol, Tag translations, traffic class (TC) translations, and/or cross-field translations; wherein the Processor/RPU may maintain tracking between Tags associated with the CXL-based protocol and Tags associated with the ISoL protocol, such as in order to associate responses with their corresponding requests.

FIG. 25B illustrates an example of a TFD demonstrating translations performed by a processor or an RPU, denoted as Processor/RPU, that may include a cache, between CXL-based traffic, such as at least one of CXL.io, CXL.mem, or CXL.cache, utilized for communicating with a first entity (Entity.1), and ISoL traffic, such as ICPIP (e.g., Intel UPI), utilized for communicating with a second entity (Entity.2) that may be coupled to memory, such as DRAM, wherein the memory may be mapped to a physical address space (PAS) utilized by the Processor/RPU. The Processor/RPU may translate between the CXL-based domain and the ISoL domain, such as translate between messages conforming to the CXL-based protocol and messages conforming to the ISoL protocol, for example translations between CXL.mem and ICPIP. The TFD illustrates three exemplary transactions between the first entity and the Processor/RPU. The first exemplary transaction may include CXL.mem M2S Req comprising MemOpcode(MemRd) and Address(AS.1.1), wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the CXL.mem M2S Req to UPI REQ comprising Opc(RdCur) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a CXL.mem S2M DRS comprising Opcode(MemData) and *Data*, without storing the data retrieved from the second entity in the cache, denoted in the drawing by “I-to-I”, indicating that the cache state associated with the cacheline address remains invalid.

The second exemplary transaction may include CXL.mem M2S Req comprising MemOpcode(MemRd) and Address(AS.1.1), referencing the same address as the first exemplary transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the CXL.mem M2S Req to UPI REQ comprising Opc(RdData) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a CXL.mem S2M DRS comprising Opcode(MemData) and *Data*, and may store the data retrieved from the second entity in the cache, denoted in the drawing by “I-to-S”, indicating that the cache state associated with the cacheline address transitioned from invalid to shared, possibly indicating that the cacheline data is shared between the Processor/RPU and the second entity.

The third exemplary transaction may include CXL.mem M2S Req comprising MemOpcode(MemRd) and Address(AS.1.1), referencing the same address as the first and the second transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache hit, wherein the Processor/RPU may respond to the request from the first entity with CXL.mem S2M DRS comprising Opcode(MemData) and *Data* from the cache, without sending a translated UPI REQ to the second entity. Following the third transaction, the second entity may invalidate the cacheline address (AS.2.1) associated with the UPI domain, which may be stored in the Processor/RPU cache. The second entity may send to the Processor/RPU a UPI SNP comprising Opc(SnpInv) and Address(AS.2.1), wherein the Processor/RPU may respond to the UPI SNP by sending to the second entity a UPI RSP (e.g., UPI RSP2) comprising Opc(RspI), indicating that the Processor/RPU invalidated the associated cacheline address from the cache, denoted in the drawing by “S-to-I”, indicating that the cache state associated with the cacheline address transitioned from shared to invalid.

In some examples, the Processor/RPU may perform cache lookups before performing translations related to the CXL request received from the first entity, or may perform cache lookups after performing some or all of the translations related to the CXL request received from the first entity. In some examples, the Processor/RPU may be further organize the cache and perform cache lookups according to addresses associated with the CXL-based domain (e.g., CXL.mem domain). Additionally or alternatively, the Processor/RPU may be further organize the cache and perform cache lookups according to translated addresses associated with the ISoL domain (e.g., UPI domain).

In various implementations, an apparatus comprising: a coherent interconnect that utilizes a protocol based on Coherent Hub Interface (CHI-based protocol), comprising an interconnect component configured to receive CHI-based messages; processing cores coupled via the coherent interconnect to memory controllers coupled to memory channels capable of supporting memory having a capacity of at least 64 GB; a resource provisioning unit (RPU) comprising an NVLink interface and a CHI interface; wherein the NVLink interface utilizes differential pairs and is capable of communicating according to an NVLink-based protocol with an entity external to the apparatus; wherein the CHI interface is coupled to the interconnect component; and wherein the RPU is configured to translate between messages conforming to the NVLink-based protocol and messages conforming to the CHI-based protocol to enable the entity to access resources via the NVLink interface and the coherent interconnect.

In some implementations of the apparatus, the RPU is further configured to: translate first physical addresses associated with the NVLink-based protocol to second physical addresses associated with the CHI-based protocol, and translate NVLink command encodings to corresponding CHI opcodes. The RPU may perform address translation from the NVLink domain to the CHI domain. The address translation may support different memory mapping schemes between the NVLink and CHI domains, while the command translation may preserve the intent of the transaction. For example, when translating an NVLink read request transaction, received from a GPU, to a CHI request transaction, targeting an xPU coherent interconnect, wherein the CHI transaction carries ReadOnce for obtaining a non-cacheable snapshot of the data, satisfying the intent of the I/O-coherent NVLink read request. The RPU may preserve the ordering requirements of the original NVLink traffic within the CHI-based protocol framework.

In some implementations of the apparatus, the resources are selected from at least one of: registers within the apparatus, SRAM, HBF, or HBM within the apparatus, at least some of the 64 GB of memory, network devices coupled to the apparatus, or storage devices coupled to the apparatus.

In some implementations of the apparatus, the RPU further comprises a request node which does not include a hardware-coherent cache, and wherein the request node is configured to communicate with the interconnect component according to the CHI-based protocol.

In some implementations of the apparatus, the request node is coupled to the interconnect component and is further configured to expose registers accessible utilizing memory-mapped I/O (MMIO) operations, to enable the entity to detect at least one of: node type, node configuration, or connection topology based on register inspection.

In some implementations of the apparatus, the request node is configured to expose the registers via Advanced Microcontroller Bus Architecture (AMBA) Advanced Peripheral Bus (APB) interface, to enable the entity to read the registers via the NVLink interface.

In some implementations of the apparatus, the request node comprises an I/O-Coherent Request Node (RN-I) or an I/O-Coherent Request Node with Distributed Virtual Memory (DVM) support (RN-D); and the RPU is configured to translate NVLink read requests to CHI read requests. The integration with ARM mesh architecture may allow the NVLink-coupled entity to participate in the broader system interconnect fabric, with interconnect components, such as crosspoints, providing routing decisions based on transaction addresses and types. The MMIO-accessible registers enable system firmware or diagnostic software to discover the structure of the coherent interconnect, the presence of request nodes and home nodes included in the RPU, verify correct node connections, detect NVLink translation capabilities in the RPU via additional register inspections, and configure operational parameters for the translation path.

In some implementations of the apparatus, the RPU further comprises a home node which does not include a Point of Coherence (PoC) and is not capable of processing snoopable requests, and wherein the home node is configured to communicate with the interconnect component according to the CHI-based protocol.

In some implementations of the apparatus, the home node comprises a I/O-coherent Home Node (HN-I), enabling the processing cores to access resources via the NVLink interface.

In some implementations of the apparatus, the RPU further comprises a request node and a home node, the request node couples the NVLink interface to the interconnect component, and the home node couples the NVLink interface to a second interconnect component. The RPU may implement routing decisions based on transaction types, directing memory access transactions from the NVLink domain through a request node, such as an RN-I node, while receiving, from a home node, such as an HN-I node, transactions targeting the NVLink domain. The apparatus may enable entities communicating according to NVLink-based protocol to perform I/O-coherent accesses to resources within a CHI-based system through appropriate non-coherent or I/O-coherent nodes. A request node, such as an RN-D node, may receive DVM transactions and generate a subset of CHI transactions without maintaining a hardware-coherent cache. The home node, such as an HN-I node, may process a limited subset of request types and manage ordering between I/O requests targeting the I/O subsystem without maintaining coherency utilizing snooping. The RPU may perform protocol-specific translations including command mapping, address formatting, address translations, orchestration and tracking of transaction IDs, and transaction sequencing between the NVLink and CHI domains.

In some implementations of the apparatus, the RPU further comprises an interconnect gateway configured to communicate with the interconnect component according to the CHI-based protocol, wherein the RPU is further configured to utilize a streaming interface protocol to enable connectivity between the NVLink interface and the coherent interconnect via the interconnect gateway.

In some implementations of the apparatus, the streaming interface protocol transports packets of an intermediate protocol; and wherein the RPU is further configured to translate between messages conforming to the intermediate protocol and messages conforming to the CHI-based protocol.

In some implementations of the apparatus, the intermedia protocol conforms to PCIe, and the RPU is further configured to translate a PCIe UIO memory read request utilizing a UIOMRd TLP type to a CHI REQ comprising ReadOnce.

In some implementations of the apparatus, the streaming interface protocol is based on Advanced Microcontroller Bus Architecture (AMBA) Credited eXtensible Stream (CXS); and wherein the interconnect gateway provides credit-based flow-control and supports bi-directional connectivity between the NVLink interface and the coherent interconnect.

In some implementations of the apparatus, the interconnect gateway comprises CXL/CCIX Gateway (CCG) comprising a link agent that supports the streaming interface protocol, providing flit packing and unpacking, end-to-end data integrity, and a flit-retry mechanism for reliability, availability and serviceability (RAS) containment when data corruption is detected.

In some implementations of the apparatus, the interconnect gateway comprises at least one of Coherent Multichip Link (CML) or Cache Coherent Interconnect for Accelerators (CCIX) Gateway (CXG); and wherein the gateway is configured to utilize a 32-bit cyclic-redundancy check (CRC-32) to protect transactions conforming to the streaming interface protocol.

In some implementations of the apparatus, the RPU comprises a request agent (RA) proxy configured to communicate with the interconnect component according to the CHI-based protocol, enabling the entity to access, via the NVLink interface, resources coupled to the coherent interconnect.

In some implementations of the apparatus, the RPU comprises a home agent (HA) proxy configured to communicate with the interconnect component according to the CHI-based protocol, enabling the processing cores to access resources via the NVLink interface.

In some implementations of the apparatus, the interconnect component comprises a crosspoint comprising at least four mesh ports and at least two device ports; and wherein the RPU is coupled to a device port of the at least two device ports.

In some implementations of the apparatus, the coherent interconnect comprises a scalable coherent fabric (SCF), the interconnect component comprises a Cache Switch Node (CSN), and the RPU is coupled to the CSN via the CHI interface. In some implementations, the xPU may be based on an NVIDIA SCF coherent interconnect that includes CSNs as a crosspoint, and an NVLink-C2C for connecting to an external entity, such as a GPU, via an NVLink interface.

In some implementations of the apparatus, the SCF comprises an SCF Cache partition (SCC); and wherein the RPU and the SCC are coupled to the CSN, providing the entity, via the NVLink interface, with low-latency access to caching resources of the apparatus.

In some implementations of the apparatus, the memory comprises dynamic random-access memory (DRAM), and the entity comprises an NVLink Switch, a GPU, or an accelerator.

In various implementations, a method comprising: operating a coherent interconnect that utilizes a protocol based on Coherent Hub Interface (CHI-based protocol), comprising an interconnect component that receives CHI-based messages; communicating, via the coherent interconnect, between processing cores and memory controllers that communicate with memory channels coupled to memory having a capacity of at least 64 GB; operating a resource provisioning unit (RPU) comprising an NVLink interface and a CHI interface, wherein the NVLink interface utilizes differential pairs and communicates according to an NVLink-based protocol with an entity external to the RPU, and wherein the CHI interface communicates with the interconnect component; and translating, by the RPU, between messages conforming to the NVLink-based protocol and messages conforming to the CHI-based protocol to enable the entity to access resources via the NVLink interface and the coherent interconnect.

In some implementations, the method further comprises translating, by the RPU, first physical addresses associated with the NVLink-based protocol to second physical addresses associated with the CHI-based protocol, and translating NVLink command encodings to corresponding CHI opcodes.

In some implementations of the method, the RPU comprises a request agent (RA) proxy, and further comprising communicating, by the RA proxy, with the interconnect component according to the CHI-based protocol, enabling the entity to access, via the NVLink interface, resources coupled to the coherent interconnect.

In some implementations of the method, the RPU comprises a home agent (HA) proxy, and further comprising communicating, by the HA proxy, with the interconnect component according to the CHI-based protocol, enabling the processing cores to access resources via the NVLink interface.

In various implementations, a system comprising: a coherent interconnect that utilizes a protocol based on Coherent Hub Interface (CHI-based protocol), comprising interconnect components configured to route CHI-based messages; processing cores coupled via the coherent interconnect to memory controllers coupled to memory channels coupled to memory having a capacity of at least 64 GB; resource provisioning units (RPUs) comprising external interfaces and CHI interfaces, wherein at least one of the external interfaces comprises an NVLink interface utilizing differential pairs for communication according to an NVLink-based protocol with one or more external entities; wherein the CHI interfaces are coupled to the interconnect components; and wherein the RPUs are configured to translate between protocols utilized by the external interfaces and the CHI-based protocol; whereby the translate enables the external entities to access system resources via the external interfaces and the coherent interconnect.

In some implementations of the system, the RPUs are configured to translate physical addresses from physical address spaces associated with their external interface protocol to addresses from physical address spaces associated with the CHI-based protocol, and to translate command encodings from the external interface protocol to command encodings from corresponding CHI opcodes.

In some implementations of the system, the RPUs comprise at least one of request agent (RA) proxies or home agent (HA) proxies configured to communicate with the interconnect components according to the CHI-based protocol; wherein the RA proxies enable external entities to access memory and I/O resources coupled to the coherent interconnect, and the HA proxies enable the processing cores to access external memory resources via the external interfaces, thereby implementing a distributed shared memory architecture.

In some implementations of the system, at least one of the RPUs comprises an interconnect gateway configured to communicate with a corresponding interconnect component according to the CHI-based protocol; wherein the interconnect gateway utilizes a streaming interface protocol to enable connectivity between the external interface associated with the at least one of the RPUs and the coherent interconnect via the at least one of the RPUs. The external interfaces associated with the RPUs may implement various protocol bridging architectures to enable communication between external entities and the coherent interconnect. In one example, an RPU may utilize proxy-based mechanisms such as Request Agent (RA) proxy and Home Agent (HA) proxy for NVLink translations. In alternative implementations, the RPUs may employ direct translation engines that perform stateless or stateful conversion between external protocols and CHI-based messages, transaction queuing and reordering mechanisms that handle protocol-specific ordering requirements, or address remapping units that maintain translation tables for converting between addresses from different physical address spaces. The RPUs may implement credit-based flow control, transaction tracking structures, or protocol-specific state machines that manage the lifecycle of transactions as they traverse between domains. These various implementation approaches may enable external entities to access system memory while system components access resources attached to the external entities.

Optionally, the architectural flexibility of the RPUs may enable multiple protocols to co-exist within the system utilizing various mechanisms. Different RPUs in the system may support UALink through UPLI message processing engines, CXL protocol through CXL.mem and/or CXL.cache transaction handlers, PCIe protocol through TLP processing units, or proprietary interconnect protocols through custom translation logic. The system may include RPUs configured for multi-protocol operation, such as multi-protocol RPUs embedded in a Fabric Processing Unit (FPU) or in a software-defined fabric processor, wherein an RPU implements protocol detection and routing logic, shared transaction buffers with protocol-specific handling, unified address translation units that support multiple addressing schemes, or configurable state machines that adapt to different protocol requirements. The streaming interface protocol utilized by the interconnect gateway may provide a common transport mechanism with protocol-agnostic packetization and framing, enabling these diverse protocols to efficiently communicate with the CHI-based coherent interconnect. The RPUs may implement protocol-specific optimizations such as transaction coalescing, speculative prefetching, or latency hiding techniques while maintaining protocol semantics and coherency requirements utilizing appropriate translation and synchronization mechanisms.

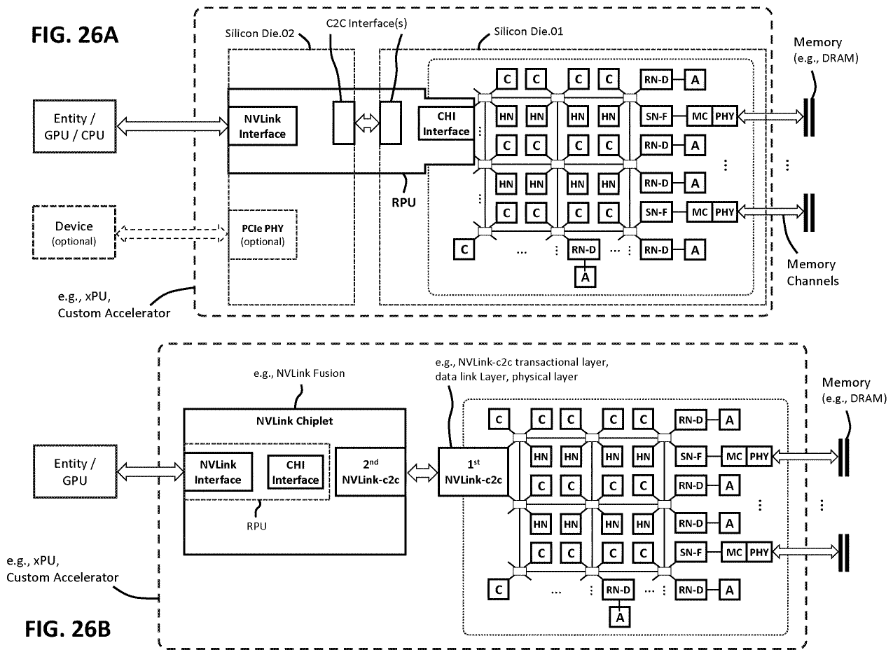

FIG. 26A illustrates an example of an xPU coupled to an entity such as a CPU or a GPU. The xPU includes an RPU which translates between NVLink traffic protocol and CHI-based traffic. The xPU further includes at least two silicon dies, wherein the first die includes a CHI interface of the RPU, and the second die includes an NVLink interface of the RPU. The second die may further include an optional PCIe PHY to communicate according to PCIe with a device external to the xPU. The first die and the second die are coupled by at least one C2C interface, utilizing chip-to-chip or die-to-die protocols such as CHI C2C or NVLink-C2C. The RPU may enable coherent memory access from the entity to the xPU, and optionally, from the device to the xPU.

FIG. 26B illustrates an example of an xPU coupled to an entity such as an NVIDIA Blackwell GPU. The xPU includes processing cores, acceleration cores, memory controllers, a coherent interconnect, and an NVLink chiplet, such as NVLink Fusion, that is coupled to the coherent interconnect via a first NVLink-C2C. The NVLink chiplet includes a second NVLink-C2C, and an RPU that translates between NVLink traffic and CHI-based traffic. The RPU includes an NVLink interface for coupling to the entity, and a CHI interface for coupling to the second NVLink-C2C. The NVLink-C2C interfaces are optionally integrated into NVLink-C2C controllers that includes transactional layers, data link layers and physical layers. The RPU may enable the GPU to access, via the NVLink interface, resources mapped to the physical address space utilized by the xPU coherent interconnect. Correspondingly, the RPU may enable the processing cores of the xPU to access, via the NVLink interface, resources of the GPU, such as HBM, High-Bandwidth Flash (HBF), or GDDR memory.

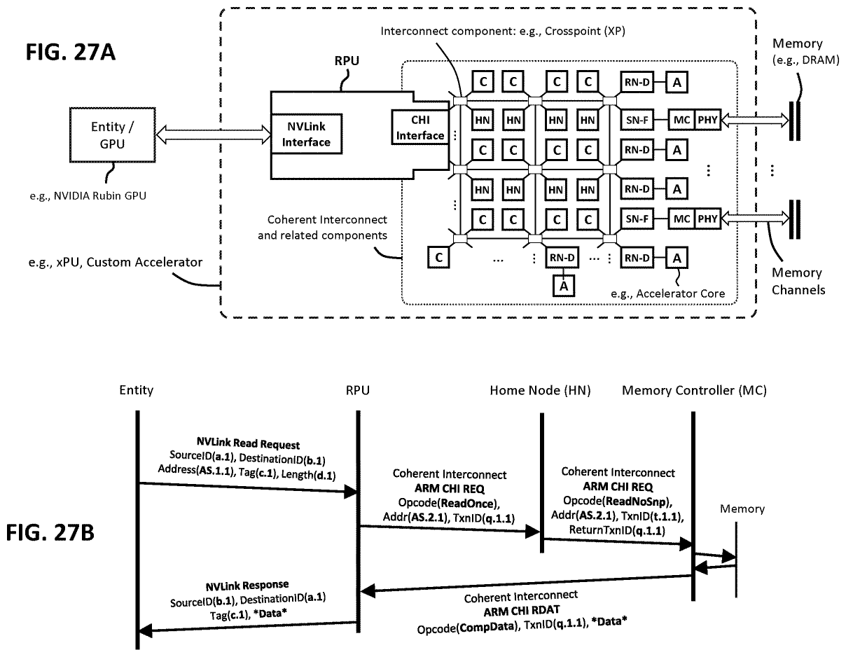

FIG. 27A illustrates an example of a system that translates between NVLink-based traffic and coherent interconnect CHI-based traffic. The NVLink connections are coupled via an RPU to an interconnect component such as a crosspoint (e.g., XP), which may serve as a fundamental building block of a coherent interconnect, providing switching or routing of CHI messages between participating elements such as request nodes, home nodes, gateways, protocol bridges, or other elements that connect to the coherent interconnect. The RPU may translate between NVLink traffic utilized by an entity, such as a GPU or a CPU, to CHI-based traffic utilized by the interconnect component, possibly eliminating intermediate protocol translations. Alternatively, the RPU may translate between an NVLink traffic and CHI traffic by utilizing intermediate protocols such as Advance Extensible Interface (AXI), or AXI Coherency Extensions Lite (ACE-Lite), or by utilizing streaming interface protocols such as Credited eXtensible Stream (CXS). Direct translation from NVLink to CHI may provide high-performance connectivity between a GPU coupled to the NVLink interface and memory coupled to the coherent interconnect, a performance gain that may be reflected via lower-latency accesses to memory and higher-bandwidth of reads and writes.

FIG. 27B illustrates an example of a transaction flow diagram (TFD) showing the translation of NVLink traffic to CHI traffic. An entity, such as a GPU or a CPU, initiates an NVLink read request, that is received by the RPU via the NVLink interface. The RPU translates the NVLink request to a CHI request carrying ReadOnce, optionally translating the physical address (AS.1.1) associated with NVLink to a physical address (AS.2.1) associated with CHI. The RPU may capture identification information associated with the NVLink request, such as source identifier of the requesting entity, and transaction Tag identifier, and may record the information together with identification information associated with the CHI request generated, such as the transaction ID (TxnID), in order to support the generation of an NVLink response for the NVLink request received from the entity. The RPU sends the CHI request, via the CHI interface, to an interconnect component, such as a crosspoint (e.g., an XP on a CHI coherent interconnect), that forwards the request to a home node. The home node processes the request and issues a CHI request carrying ReadNoSnp to a memory controller coupled to the coherent interconnect. The memory controller may read the requested data from memory, and may send the data to the RPU, or alternatively the memory controller may send the data to the home node, wherein the home node is responsible for sending the data to the RPU. When the RPU receives the data via the CHI interface, the RPU may issue an NVLink response with the data to the requesting entity, utilizing the identification information the RPU captured when processing and translating the NVLink request.

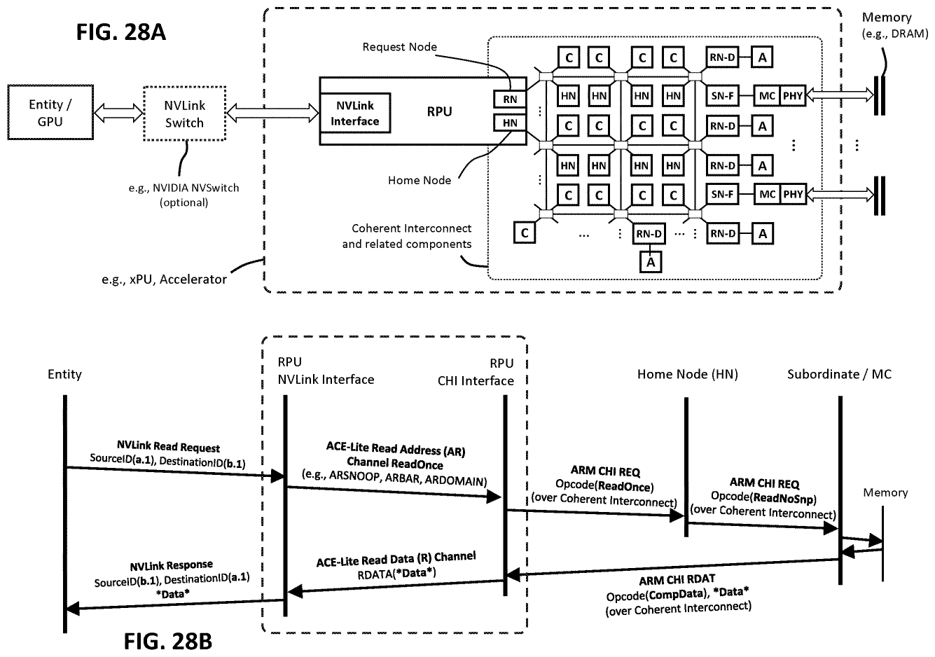

FIG. 28A illustrates an example of a system that translates between NVLink-based traffic and CHI-based traffic. The NVLink connections are coupled via an RPU to crosspoint (e.g., XP) interconnect components of the CHI coherent interconnect. The RPU may include request nodes (e.g., RNs), such as I/O-coherent RN-I nodes and/or RN-D, and/or home nodes (e.g., HNs), such as non-coherent HN-I nodes. This example enables external entities, such as GPUs, CPUs, or accelerators, which communicate utilizing NVLink traffic, to access resources within the ARM-based processor's coherent domain utilizing appropriate translations and routing, such as by an RPU translating from NVLink traffic utilized by a GPU entity, to CHI traffic, utilized by a crosspoint (XP) component of the CHI interconnect, wherein a request node or a home node provides the CHI interface for connecting to the XP.

FIG. 28B illustrates an example of an RPU that translates between NVLink traffic and CHI traffic, utilizing an intermediate protocol based on ARM Advanced Microcontroller Bus Architecture (AMBA) Advance Extensible Interface (AXI) Coherency Extensions Lite (ACE-Lite). The RPU may further translate physical addresses associated with NVLink to physical addresses associated with CHI. The RPU may process and translate the NVLink traffic, received from an NVLink interface, to ACE-Lite traffic for further processing, and send the ACE-Lite traffic to a request node (e.g., RN). The request node translates the ACE-Lite traffic to CHI traffic and provides a CHI interface for connecting to the coherent interconnect. In this example, the RPU receives from an entity, such as a GPU or a CPU, NVLink traffic that includes a read request. The RPU translates the NVLink traffic to an intermediate ACE-Lite ReadOnce, that is further translated by a request node to a CHI ReadOnce destined to a home node (e.g., HN). The home node processes the CHI ReadOnce and may issue a ReadNoSnp to a memory controller, for servicing the original read request received from the entity via the NVLink interface. The memory controller reads the requested data from memory, and may send the data via the coherent interconnect to the CHI interface of the RPU for delivery to the entity over the NVLink interface.

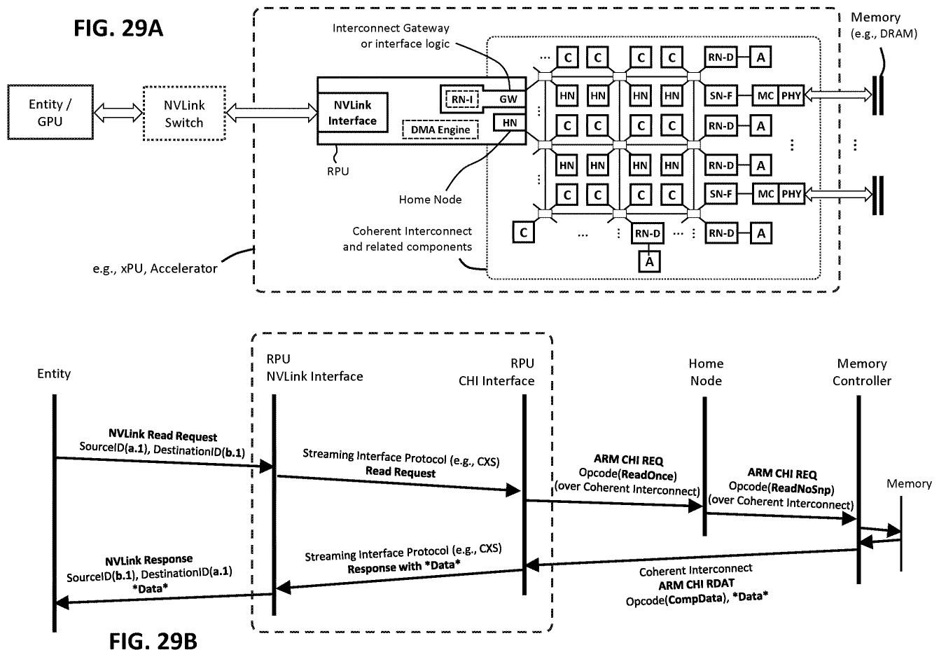

FIG. 29A illustrates an example of a system that translates between an interface based on NVLink, and interconnect components that communicate according to a protocol based on ARM CHI. The system enables entities, such as GPUs or CPUs, to access, via an optional NVLink switch, and an NVLink interface, resources coupled to the coherent interconnect. The NVLink connections are coupled, via an RPU, to crosspoint (e.g., XP) interconnect components of the coherent interconnect. The RPU may include a gateway or interface logic (marked GW in the figure), such as CXL/CCIX Gateway (CCG), Coherent Multichip Link (CML), Cache Coherent Interconnect for Accelerators (CCIX) Gateway (CXG), CHI C2C, or NVLink-C2C, that may include a CHI interface coupled to the coherent interconnect, enabling connectivity between the NVLink interface and the coherent interconnect, via the RPU. The gateway or interface logic may utilize a streaming interface protocol, such as Credited eXtensible Stream (CXS), to provide packing and un-packing of CHI C2C or an intermediate protocol over the streaming interface. The RPU may further include one or more request nodes (e.g., RN-I), home nodes (e.g., HN-I), optionally placed in the GW, that may enable DMA engines in the RPU to move blocks of data between the NVLink interface and the CHI interface. Examples of the gateway or interface logic include CCG, CML, CXG, CHI C2C, or NVLink-C2C.

FIG. 29B illustrates an example of an RPU that translates between NVLink traffic and CHI traffic. The RPU may further translate NVLink physical addresses to CHI physical addresses. The RPU utilizes a streaming interface protocol that may be based on ARM Advanced Microcontroller Bus Architecture (AMBA) Credited eXtensible Stream (CXS). Optionally, the RPU may utilize an intermediate protocol, such as CCIX, PCIe, or CXL, over the streaming interface protocol, and may translate from NVLink to intermediate protocol, and/or from the intermediate protocol to CHI. Optionally or alternatively, the RPU may include interfacing logic such as CHI C2C or NVLink-C2C, that may utilize a streaming interface protocol based on CXS.

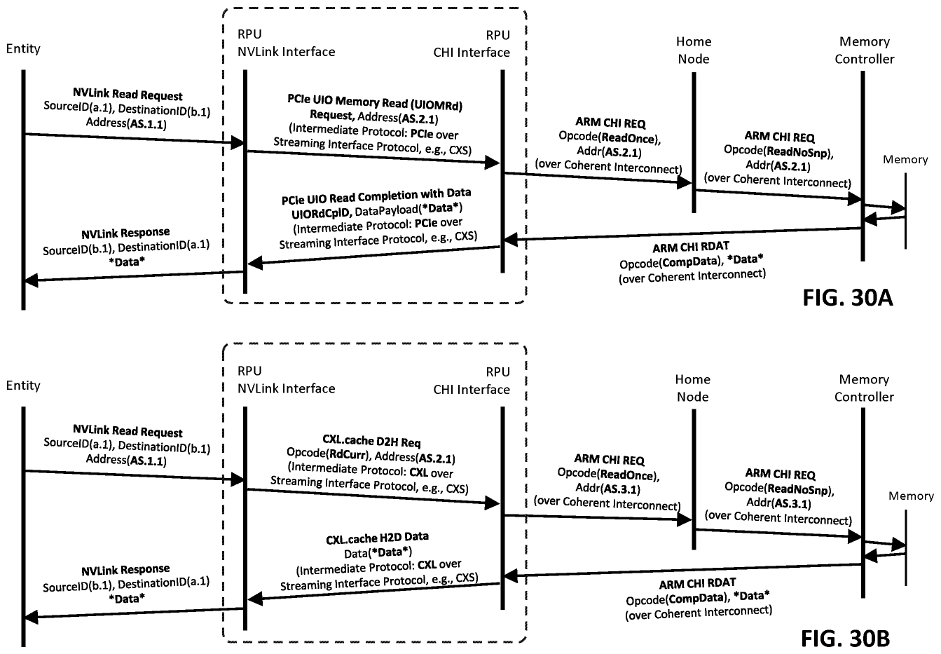

FIG. 30A illustrates an example of a TFD showing a read transaction from an entity such as a GPU to memory resources of an xPU or a memory pool, wherein an RPU provides translations between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.2.1), optionally utilizing one stage of address translation. The RPU may utilize a streaming interface protocol, such as CXS, and may utilize PCIe as an intermediate protocol over the CXS streaming interface protocol, translating from NVLink to the PCIe intermediate protocol, and/or from the PCIe intermediate protocol to CHI.

The entity/GPU initiates the transaction by sending an NVLink read request carrying a physical address (AS.1.1) to the RPU, which translates the NVLink read request to a PCIe UIO Memory Read request utilizing a UIOMRd TLP type, optionally translating the physical address (AS.1.1) carried in the NVLink read request to a different physical address (AS.2.1) carried in the UIOMRd TLP. The RPU further translates the PCIe UIO Memory Read request to an ARM CHI REQ carrying ReadOnce and a physical address (AS.2.1 in the illustrated example), which is sent via the coherent interconnect to the Home Node (HN). The Home Node processes the request and sends a subsequent ARM CHI REQ with ReadNoSnp and the physical address (AS.2.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to PCIe UIO Read Completion with Data, utilizing a UIORdCplD TLP type, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other TLP types such as MRd for a PCIe or CXL request, CplD for PCIe or CXL response, and other intermediate protocols such as CXL.mem or CXL.io.

FIG. 30B illustrates an example of a TFD showing a read transaction from an entity such as a GPU to memory resources of an xPU or a memory pool, wherein an RPU translates between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.3.1), optionally utilizing two stages of address translation with an intermediate address (AS.2.1) that may be associated with an intermediate protocol. The RPU utilizes a streaming interface protocol, such as CXS, and may utilize CXL as an intermediate protocol over the CXS streaming interface protocol, translating from NVLink to the CXL intermediate protocol, and/or from the CXL intermediate protocol to CHI.

The entity/GPU initiates the transaction by sending an NVLink read request carrying a physical address (AS.1.1) to the RPU, which translates the NVLink read request to a CXL.cache D2H request comprising RdCurr, optionally translating the physical address (AS.1.1) carried in the NVLink read request to a different physical address (AS.2.1) carried in the CXL.cache D2H request, wherein (AS.2.1) may be an intermediate address associated with the intermediate protocol. The RPU further translates the CXL.cache D2H request to an ARM CHI REQ carrying ReadOnce, optionally translating the physical address (AS.2.1) carried in the CXL.cache D2H request to a different physical address (AS.3.1), carried in the ARM CHI REQ, which is sent via the coherent interconnect to the Home Node (HN). The Home Node processes the request and sends a subsequent ARM CHI REQ with ReadNoSnp and the physical address (AS.3.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to CXL.cache H2D Data, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other opcodes, such as CXL.cache RdShared or CXL.cache RdAny, other TLP types such as MRd for a PCIe or CXL request, CplD for PCIe or CXL response, and other intermediate protocols such as CXL.mem or CXL.io.

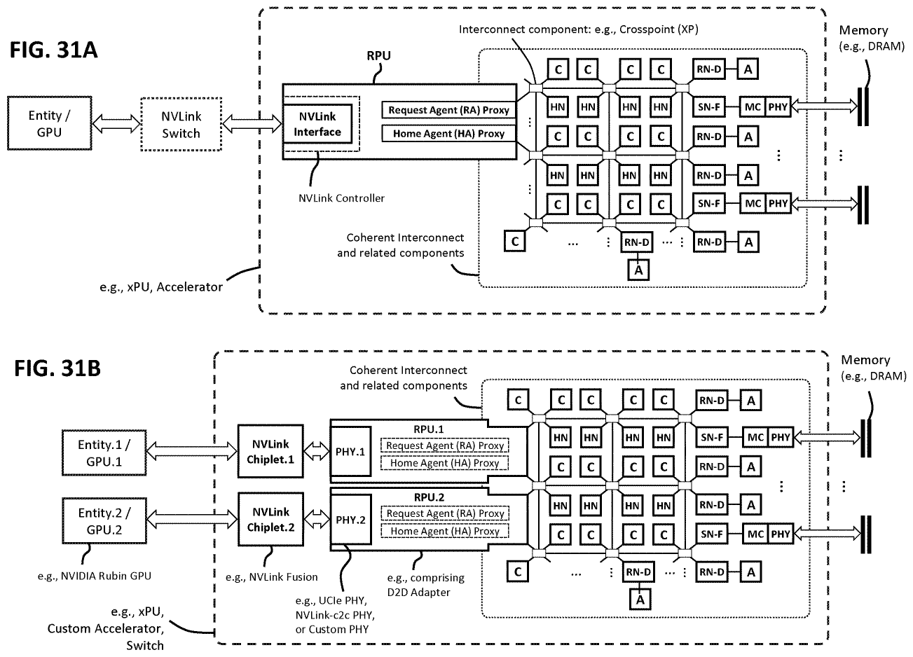

FIG. 31A illustrates an example of a system comprising an external entity coupled to an optional NVLink switch coupled to a processor comprising (such as an xPU) comprising an RPU comprising an NVLink interface, a Request Agent (RA) Proxy, and a Home Agent (HA) Proxy. The RPU may further comprise an NVLink controller, wherein the NVLink controller may include the NVLink interface. The RPU may be coupled to an interconnect component, such as a crosspoint (e.g., XP), optionally via the RA Proxy and/or the HA Proxy, wherein the RPU may communicate with the interconnect component according to a CHI-based protocol. The RPU may be further coupled, via the NVLink interface, and optionally via an NVLink switch, to an external entity, such as a GPU, wherein the RPU may communicate with the external entity according to an NVLink-based protocol. The RPU may translate between messages conforming to the NVLink-based protocol and messages conforming to the CHI-based protocol, possibly enabling the external entity to access resources of the xPU, such as xPU local memory (e.g., DRAM), and/or enabling the xPU to access resources of the external entity, such as remote memory coupled to the entity. The Request Agent (RA) proxy may receive requests that originate outside of the coherent interconnect, such as from remote agents, from the NVLink interface, from the NVLink controller, from an attached accelerator die, or from a remote chip, wherein the RA proxy may represent such remote initiators as a proxy when communicating with the coherent interconnect, e.g., by utilizing a Source ID (SrcID) namespace and a Transaction ID (TxnID) namespace associated with the coherent interconnect. The Home Agent (HA) proxy may own an address window backed by memory that may be placed on another chip or silicon die, such as on the external entity, wherein the HA proxy may enable processing cores of the xPU to access resources coupled to the external entity, such as memory (e.g., HBM and/or HBF).

FIG. 31B illustrates an example of a system comprising an xPU, such as a custom accelerator, that may utilize translations between NVLink and CHI, wherein the xPU may utilize NVLink for communicating with a first entity and with a second entity, which may each be a GPU external to the xPU, and wherein the xPU may further utilize CHI for intra-xPU communications between xPU resources coupled to a coherent interconnect of the xPU. The xPU may include first and second NVLink chiplets, or silicon dies, such as NVLink Fusion, coupled to the first and second entities, respectively. The first and second NVLink chiplets may be further coupled to first and second RPUs, respectively, via first and second physical layers (PHYs), respectively. The first and second RPUs may each include a Die-to-Die (D2D) adapter, a Request Agent (RA) Proxy, and/or a Home Agent (HA) proxy, wherein each RPU may communicate with the coherent interconnect, via the RA Proxy and/or the HA Proxy. The first and second PHYs may each include a UCIe PHY, an NVLink-C2C PHY, or a custom PHY.

The translations between NVLink and CHI may enable the first and/or the second entity to access resources coupled to the coherent interconnect of the xPU; and may further enable processing cores of the xPU to access resources coupled to the first and/or second entity. The translations between NVLink and CHI may further enable the xPU to perform as a switch, such as an NVLink switch, that may utilize NVLink to enable communication between the first entity and the second entity. The first entity may communicate with the second entity via the xPU, such as via the first NVLink chiplet, the first RPU, the coherent interconnect, the second RPU, and the second NVLink chiplet. Similarly, the second entity may communicate with the first entity via the xPU, such as via the second NVLink chiplet, the second RPU, the coherent interconnect, the first RPU, and the first NVLink chiplet.

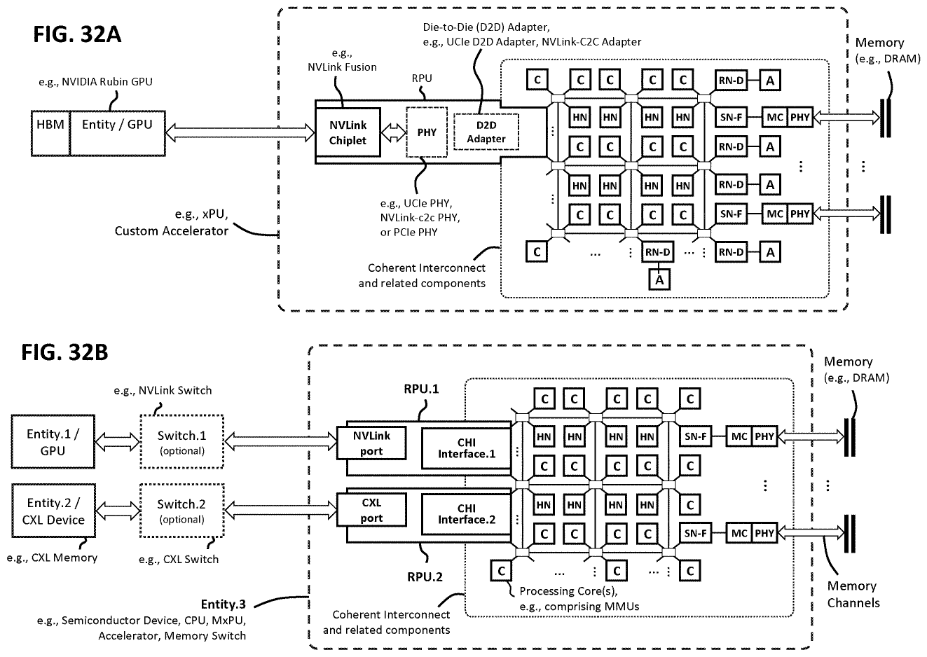

FIG. 32A illustrates an example of a system comprising an xPU comprising an RPU that translates between NVLink traffic and CHI traffic. The RPU may include a die-to-die (D2D) adapter, such as UCIe D2D adapter or NVLink-C2C adapter, which may perform at least one of: (1) Serve as an interfacing logic coupling the coherent interconnect and a die-to-die link; (2) Packetize CHI C2C into flits that can be streamed out to another chip or die, and correspondingly, handle de-packetization in the reverse direction; (3) Provide a CHI interface for connecting to an interconnect component such as a crosspoint (e.g., XP); or (4) Couple to a PHY such as a UCIe PHY, an NVLink-C2C PHY, or a PCIe PHY, for connecting to an NVLink chiplet, such as NVLink Fusion.

FIG. 32B illustrates an example of a system comprising a third entity (Entity.3), such as a semiconductor device, a CPU, an MxPU, an accelerator, or a memory switch, wherein the third entity may be coupled to a memory, such as DRAM, optionally via memory channels. The third entity may include a coherent interconnect, a first RPU (RPU.1) comprising an NVLink port and a first CHI interface (CHI Interface.1), and a second RPU (RPU.2) comprising a CXL port and a second CHI interface (CHI Interface.2). The third entity may be coupled, via the NVLink port and optionally via a first switch (Switch.1), such as an NVLink switch or an NVSwitch, to a first entity (Entity.1), such as a GPU, wherein the third entity may be further coupled, via the CXL port and optionally via a second switch (Switch.2), which may be a CXL switch, to a second entity (Entity.2), such as a CXL device (e.g., CXL memory). The third entity may utilize translations between NVLink and CHI that may enable the first entity to access the memory of the third entity, wherein the third entity may further utilize translations between CXL and CHI that may enable the second entity to access the memory of the third entity.

In some examples, the translations between NVLink and CHI, and the translations between CXL and CHI, may enable the third entity to perform as a switch, such as a multi-protocol switch or a hybrid switch, enabling communication between the first entity and the second entity, which may enable the GPU to utilize the CXL memory. For example, the first entity may communicate with the second entity via the third entity, such as via the first RPU comprising the NVLink port and the first CHI interface (CHI Interface.1), via the coherent interconnect, and via the second RPU that includes the CXL port and the second CHI interface (CHI Inetrface.2). In another example, the second entity may communicate with the first entity via the third entity, such as via the second RPU, the coherent interconnect, and the first RPU.

In some examples, the third entity may enable communication between the NVLink domain and the CXL domain, such as communication between NVLink ports and CXL ports, or communication between NVLink interfaces and CXL ports, whereas in other examples the communication between the NVLink domain and the CXL domain may be restricted, optionally by an access control list (ACL), such as to a subset of the NVLink ports and/or to a subset of the CXL ports. Additionally or alternatively, communication between the NVLink domain and the CXL domain may be restricted to a subset of allowed address regions associated with one or more address spaces, or may be restricted to a subset of allowed protocols, such as CXL.mem (e.g., not allowing CXL.cache transactions).

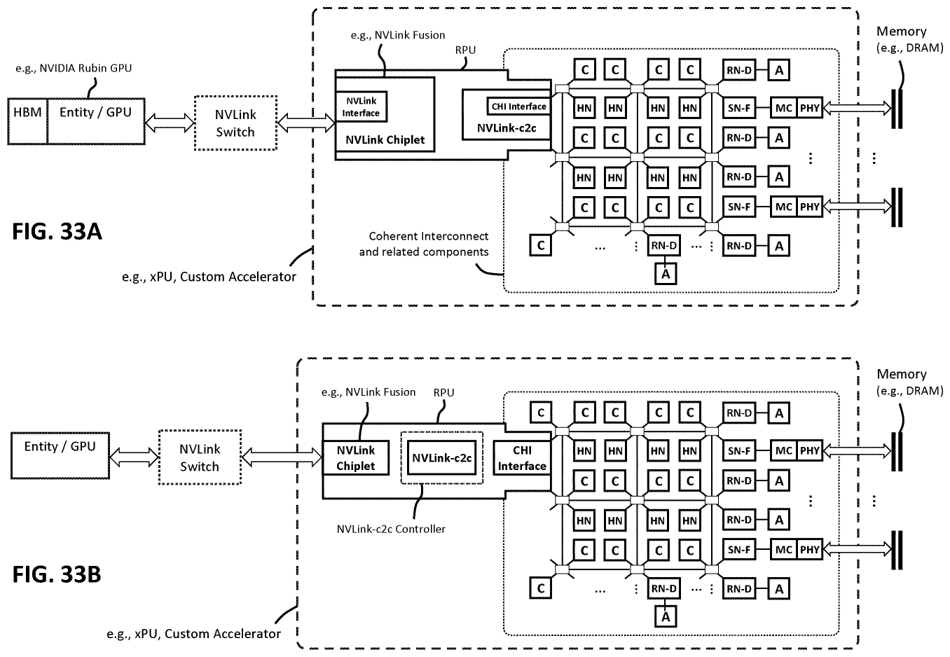

FIG. 33A illustrates an example of a system comprising an xPU or a custom accelerator, coupled to an entity such as a GPU, optionally via an NVLink switch. The xPU includes an RPU which translates between an NVLink traffic and CHI traffic. The RPU includes an NVLink chiplet, such as NVLink Fusion, that provides an NVLink interface for coupling to the external entity. The RPU further includes an NVLink-C2C for coupling the NVLink chiplet to the coherent interconnect, wherein the NVLink-C2C utilizes a CHI interface for connecting to at least one crosspoint of the coherent interconnect. The RPU may provide bi-directional memory access between the xPU and the GPU, enabling the xPU to read from the GPU's HBM, and enabling the GPU to read from DRAM coupled to the xPU. Alternatively, the RPU may provide unidirectional memory access, enabling the GPU to access xPU memory but not vice-versa, such as by exposing at least some of the xPU resources as a memory expander or a memory pool for use by the GPU.

FIG. 33B illustrates an example of a system comprising an xPU coupled to an entity such as a GPU. The xPU includes an RPU which translates between NVLink traffic and CHI-based traffic, wherein the RPU includes a CHI interface for coupling to a coherent interconnect, an NVLink-C2C logic, optionally integrated into an NVLink-C2C controller that includes a transactional layer, a data link layer and a physical layer. The RPU further includes an NVLink chiplet, such as NVLink Fusion, for coupling to the GPU, wherein the NVLink chiplet is further coupled to the coherent interconnect via the NVLink-C2C logic, optionally communicating with at least one crosspoint interconnect component according to a protocol based on ARM CHI.

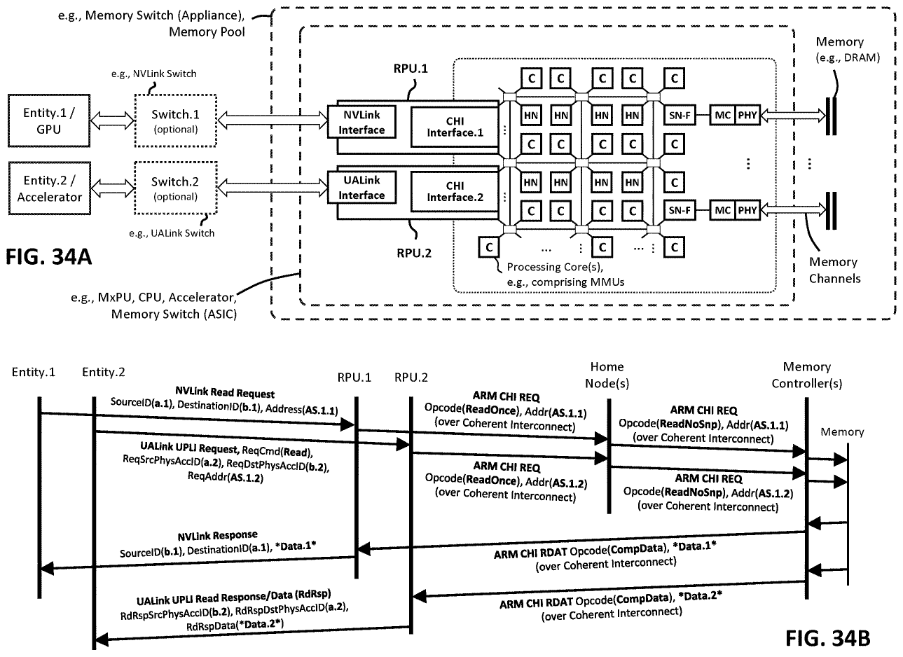

FIG. 34A illustrates an example of a system that may function as a multi-protocol memory switch appliance or a multi-protocol memory pool, and may include an MxPU, CPU, accelerator, or a memory switch ASIC, that may be coupled to two entities, optionally via switches: (1) Entity.1/GPU via an optional first switch (Switch.1), such as an NVLink switch or NVSwitch, and (2) Entity.2/Accelerator via an optional second switch (Switch.2), such as a UALink switch. The MxPU includes processing cores and memory controllers coupled to a coherent interconnect that may be based on CHI. The MxPU may utilize different translations for the external interfaces, performed by different RPUs, such as between NVLink-based interfaces and the MxPU coherent interconnect, or between UALink-based interfaces and the MxPU coherent interconnect. The first RPU (RPU.1) may enable Entity.1/GPU to access resources mapped to a physical address space utilized by the MxPU coherent interconnect, wherein the access is via the optional first switch, the NVLink interface and the MxPU coherent interconnect. Examples of resources mapped to the physical address space utilized by the MxPU coherent interconnect include DRAM or other memory resources of the MxPU. Correspondingly, the second RPU (RPU.2) may enable Entity.2/Accelerator to access, via the optional second switch, the UALink interface and the MxPU's coherent interconnect, resources mapped to a physical address space utilized by the MxPU's coherent interconnect, such as DRAM or other memory resources of the MxPU.

FIG. 34B illustrates an example of a TFD depicting a multi-entity memory access scenario wherein a GPU/first entity and an accelerator/second entity access memory mapped to one or more address spaces utilized by the coherent interconnect (CohInterMappedMemory) utilizing heterogeneous protocol message translations. Entity.1/GPU.1 initiates an NVLink request: Read with SourceID(a.1) to identify the source GPU, DestinationID(b.1) to identify the destination, and Address(AS.1.1) representing a physical address, such as an NVLink network address. RPU.1 translates the NVLink request to ARM CHI REQ carrying Opcode(ReadOnce) while preserving Addr(AS.1.1) unchanged. Concurrently or sequentially, Entity.2/Accelerator may initiate a UALink UPLI request (Req) with ReqCmd(Read), ReqSrcPhysAccID(a.2) to identify the source accelerator, ReqDstPhysAccID(b.2) to identify the destination, and ReqAddr(AS.1.2) representing a request address, such as a network physical address (NPA). RPU.2 translates the UALink UPLI request to ARM CHI REQ carrying Opcode(ReadOnce) while preserving Addr(AS.1.2) unchanged. Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and Data.1* for Entity.1/GPU. RPU.2 translates the second ARM CHI RDAT message to UALink UPLI read response/data (RdRsp) with RdRspSrcPhysAccID(b.2), RdRspDstPhysAccID(a.2), and RdRspData(*Data.2*) for Entity.2/Accelerator.

The illustrated example demonstrates how heterogeneous entities utilizing different protocols may share access to the same CohInterMappedMemory through different RPUs that translate messages between different protocols while preserving the physical addresses. Alternatively, the illustrated example may be viewed as separate NVLink and UALink transactions that utilize the same coherent interconnect infrastructure to access the CohInterMappedMemory. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

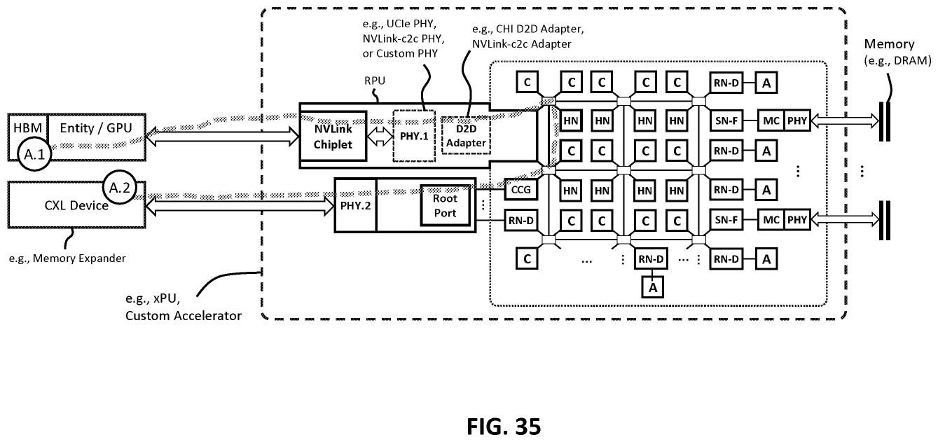

FIG. 35 illustrates an example of a heterogeneous computing system comprising an xPU or custom accelerator that utilizes an ARM-based mesh architecture with protocol interconnections. The xPU comprises a coherent interconnect implemented as a mesh topology with crosspoints (XP) that route transactions between various system components. Processing cores (C) are distributed throughout the mesh architecture and coupled to the coherent interconnect via the crosspoints. Home nodes are positioned within the mesh, optionally including HN-I nodes that may handle I/O-coherent transactions and HN-F nodes that may manage fully coherent transactions. System Node Fully coherent (SN-F) nodes are coupled to memory controllers (MC) which interface with external memory via physical layers (PHYs). The memory may be DRAM accessible through the memory channels. An entity comprising an NVIDIA Rubin GPU with integrated HBM is coupled to the xPU coherent interconnect via an NVLink chiplet. The NVLink chiplet, which may be an NVLink Fusion chiplet or custom PHY, is coupled utilizing a first physical layer (PHY.1, such as a UCIe PHY) to a die-to-die (D2D) adapter, which may be a CHI D2D Adapter or an NVLink-C2C Adapter, that enables communication between the NVLink chiplet and the coherent interconnect. The NVLink chiplet may provide the NVLink physical layer interface and may additionally provide higher protocol layers including the NVLink data link layer and transaction layer functionality.

Moreover, a CXL device, which may be a memory expander, may be coupled to the xPU coherent interconnect via a second physical layer (PHY.2) and a root port. The root port provides the interface between the CXL device and the coherent interconnect, enabling the CXL device to be discovered and configured by the system. The xPU architecture may enable the GPU to access memory resources of the CXL memory expander utilizing translations performed by the RPU and the coherent interconnect. The transaction path denoted as A.1 to A.2 in the figure illustrates a memory access flow that may represent an NVLink read transaction initiated by the GPU. The transaction may traverse from the GPU through the NVLink chiplet to the ARM mesh interconnect, wherein the RPU may translate the NVLink read request to a CHI transaction compatible with the ARM mesh interconnect. The CHI transaction may then be routed through the coherent interconnect to the appropriate home node and subsequently to the root port, wherein it may be further translated to a CXL.mem MemRd transaction for delivery to the CXL memory expander (A.2). The xPU may additionally comprise accelerator cores that may perform specialized computation tasks and may access both the GPU-attached HBM and the CXL-attached memory through the coherent interconnect.

In various implementations, an apparatus comprising: processing cores coupled via a coherent interconnect to: a interconnect gateway, an I/O-Coherent node, and memory controllers; wherein the coherent interconnect is based on Coherent Hub Interface (CHI) protocol (CHI-based protocol), the processing cores are configured to respond to snoop requests that utilize physical addresses within a first physical address space, and the memory controllers are coupled to memory channels capable of supporting memory having a capacity of at least 64 GB; and a resource provisioning unit (RPU) configured to: receive transmissions comprising data indicative of Compute Express Link (CXL) messages; wherein the CXL messages comprise CXL.mem messages and/or CXL.cache messages, and at least some of the second CXL.mem and/or CXL.cache messages carry physical addresses within a second physical address space; translate the physical addresses within the second physical address space to physical addresses within a first physical address space; generate first CXL.mem and/or CXL.cache messages based on the second CXL.mem and/or CXL.cache messages and the physical addresses within the first physical address space; and forward the first CXL.mem and/or CXL.cache messages to the interconnect gateway.

In some implementations of the apparatus, the interconnect gateway comprises a Compute Express Link (CXL)/Cache-Coherent Interconnect for Accelerators (CCIX) Gateway (CCG), and the I/O-Coherent node comprises an I/O-Coherent Request Node with DVM support (RN-D) and/or an I/O-Coherent Request Node (RN-I).

In some implementations of the apparatus, the RPU forwards the first CXL.mem and/or CXL.cache messages to the CCG via a CXS interface; and wherein the apparatus is further configured to translate the first CXL.mem and/or CXL.cache messages to CHI-based messages for transmission over the coherent interconnect. The CXS interface may provide an intermediate protocol layer between CXL and CHI, with the CCG performing the final protocol conversion to CHI while managing coherency requirements for the translated messages.

In some implementations of the apparatus, the apparatus operates as a Global Fabric-Attached Memory (G-FAM) Device (GFD); the RPU receives CXL.mem messages in the transmissions; and the received CXL.mem messages are forwarded to the CCG after address translation.

In some implementations of the apparatus, the CCG and the I/O-Coherent node are mapped to an internal protocol bus with configuration registers; the configuration registers are accessible utilizing memory-mapped I/O (MMIO) operations; and the configuration registers enable discovery of address translation capabilities and configuration of address translation parameters. The MMIO-accessible configuration registers may allow system software to discover the presence of address translation functionality, configure address translation tables or parameters, and monitor translation statistics or error conditions through standardized register interfaces.

In some implementations of the apparatus, the data is further indicative of second CXL.io messages, and the RPU is further configured to: translate the second CXL.io messages to first CXL.io messages, and forward the first CXL.io messages to the I/O-Coherent node.

In some implementations of the apparatus, the RPU forwards the first CXL.io messages to the I/O-Coherent node via an AXI interface, and wherein the I/O-Coherent node comprises an RN-D that translates the first CXL.io messages to CHI-based messages for non-coherent operations. The AXI interface may leverage its PCIe-like characteristics to handle CXL.io messages, which maintain PCIe compatibility, while the RN-D provides appropriate translation to CHI for I/O operations without cache coherency overhead.

In some implementations of the apparatus, the transmissions are received via a physical layer based on IEEE 802.3 physical medium attachment (PMA); and wherein the data indicative of CXL messages is encapsulated within a carrier protocol transmitted over the physical layer based on IEEE 802.3 PMA. The use of IEEE 802.3 PMA may enable CXL messages to be transported over longer distances using established physical layer technology, with the carrier protocol providing encapsulation while enabling transmission over Ethernet-compatible physical infrastructure.

In some implementations of the apparatus, the carrier protocol is based on Ethernet or based on IEEE 802.3, and wherein the data indicative of CXL messages is encapsulated within Ethernet frames or IEEE 802.3 frames, respectively.

In some implementations of the apparatus, the carrier protocol is based on Ultra Ethernet Transport (UET) protocol; and wherein the data indicative of CXL messages is encapsulated within Link Layer Retry eligible frames (LLR-eligible frames).

In some implementations of the apparatus, the carrier protocol is based on Scale Up Ethernet (SUE); and wherein the data indicative of CXL messages is encapsulated within an SUE-based Protocol Data Unit (PDU). Examples of SUE-based PDU may include SUE PDU, SUE Lite PDU, or PDUs based on future revisions of SUE.

In some implementations of the apparatus, the RPU is further configured to: translate the first CXL.mem and/or CXL.cache messages to CHI-based messages after generating the first CXL.mem and/or CXL.cache messages; and forward the CHI-based messages to the interconnect gateway. The two-stage process may first perform address translation while maintaining CXL-based format, then convert to CHI-based format for transmission over the coherent interconnect, enabling modular processing wherein address translation logic can be separated from protocol conversion logic.

In some implementations of the apparatus, the second CXL.mem and/or CXL.cache messages comprise source Tags from an originating entity; the RPU maintains a Tag mapping table that associates the source Tags with local Tags; and the first CXL.mem and/or CXL.cache messages comprise the local Tags, enabling the RPU to correlate responses with original requests. The Tag mapping may enable the RPU to manage transaction tracking across the address translation boundary, so that responses can be properly routed back to the originating entity even though the transactions use different physical address spaces and potentially different Tag namespaces.

In some implementations of the apparatus, the RPU is further configured to: receive transmissions from entities that utilize different physical address spaces, maintain separate address translation contexts for the entities, and generate the first CXL.mem and/or CXL.cache messages with appropriate address translations based on the originating entity. The multi-entity support may enable the RPU to serve as a consolidation point for CXL devices or hosts associated with different physical address space views, while providing unified access to the system's memory resources utilizing appropriate per-entity address translations.

In some implementations of the apparatus, the RPU enforces memory access permissions during address translation, comprising: validating that addresses within the second physical address space are within permitted ranges for the originating entity; and generating error responses for attempts to access addresses outside permitted ranges. The address translation process may incorporate security and isolation mechanisms that prevent entities from accessing memory regions allocated to other entities or system-reserved areas, implementing hardware-enforced memory protection at the protocol translation boundary.

In some implementations of the apparatus, the RPU is further configured to: receive CHI-based protocol responses from the coherent interconnect via the interconnect gateway; translate physical addresses within the CHI-based protocol responses from the first physical address space to the second physical address space; generate CXL response messages based on the CHI-based protocol responses and the translated addresses; and transmit the CXL response messages to the originating entity. The bidirectional address translation enables the response messages to carry addresses that are meaningful to the originating entity, maintaining address space consistency throughout the complete transaction lifecycle from request to response.

In some implementations of the apparatus, the interconnect gateway comprises CXL/CCIX Gateway (CCG) that utilizes a streaming interface protocol, wherein the CCG comprises a link agent that supports the streaming interface protocol, providing flit packing and unpacking, end-to-end data integrity, and a flit-retry mechanism for reliability, availability and serviceability (RAS) containment when data corruption is detected.

In some implementations of the apparatus, the interconnect gateway comprises at least one of Coherent Multichip Link (CML) or Cache Coherent Interconnect for Accelerators (CCIX) Gateway (CXG) that utilizes a streaming interface protocol, and wherein the interconnect gateway is configured to utilize a 32-bit cyclic-redundancy check(CRC-32) to protect transactions conforming to the streaming interface protocol.

In various implementations, an apparatus comprising: an integrated circuit comprising processing cores comprising memory management units (MMUs) and coherent caches; wherein the processing cores are configured to respond to snoop requests that utilize physical addresses within a physical address space (PAS), and wherein the MMUs are configured to translate virtual addresses to physical addresses within the PAS; a coherent interconnect coupling the processing cores to memory controllers coupled to memory channels capable of supporting memory having a capacity of at least 64 GB, and wherein the processing cores are configured to execute an operating system (OS) that accesses the memory utilizing the physical addresses within the PAS; a resource provisioning unit (RPU) comprising an NVLink-based interface configured to communicate, according to an NVLink-based protocol, with an entity coupled to the apparatus; and wherein the RPU is further coupled to the coherent interconnect and configured to translate physical addresses associated with the NVLink-based protocol to physical addresses within the PAS; whereby the translate of the physical addresses enables the entity to access the memory via the NVLink-based interface and the memory controllers.

In some implementations of the apparatus, the NVLink-based interface comprises at least one differential pair and is configured to support reliable communication by utilizing at least one of: a replay buffer configured to enable retransmissions of packets that were not positively acknowledged by a receiver, or a Forward Error Correction (FEC) code configured to enable correction of symbol errors.

In some implementations of the apparatus, The apparatus of claim 1, wherein, in addition to the physical address translations, the RPU is further configured to translate between first fields conforming to the NVLink-based protocol message formats, and second fields conforming to message formats of a protocol utilized by the coherent interconnect.

In some implementations of the apparatus, the protocol utilized by the coherent interconnect is based on Coherent Hub Interface (CHI-based protocol), and the RPU is further configured to translate read requests corresponding to the NVLink-based protocol to requests corresponding to the CHI-based protocol carrying ReadOnce or ReadShared. The RPU may further translate CHI responses to NVLink responses, such as CHI responses carrying CompData to NVLink responses. Additionally, the RPU may maintain transaction context to properly correlate requests and responses across the protocol domains. The translation to CHI ReadOnce may be utilized for non-cacheable data accesses, while ReadShared may be utilized for cacheable shared data. The RPU may handle protocol-specific differences in flow control, credit management, and response ordering between the NVLink and CHI domains. The CompData responses from CHI may carry the requested data along with completion status, which the RPU translates into appropriate NVLink response formats.

In some implementations of the apparatus, the protocol utilized by the coherent interconnect is based on an Intel Coherent Processor Interconnect Protocol (ICPIP-based protocol) for scalable multiprocessors with a shared physical address space, and wherein the RPU is further configured to translate memory access requests corresponding to the NVLink-based protocol to requests corresponding to the ICPIP-based protocol, while maintaining coherency state tracking for physical addresses within the PAS that are associated with the coherent caches. Examples of ICPIP include Intel's Ultra Path Interconnect (UPI) and future Intel's Coherent Processor Interconnect Protocols. Optionally, the coherency state tracking between NVLink and ICPIP domains may include monitoring cacheline states and ensuring consistency across protocol boundaries. The RPU may include state machines to track outstanding transactions and their coherency implications. The translation may accommodate differences in data transfer granularity and response timing between NVLink and ICPIP protocols.

In some implementations of the apparatus, the protocol utilized by the coherent interconnect is based on Infinity Fabric (IF-based), and wherein the RPU is further configured to translate NVLink-based traffic to IF-based traffic, while preserving memory ordering required by the entity. The preservation of memory ordering may include tracking command dependencies and enforcing completion ordering as required by both NVLink and Infinity Fabric specifications. The RPU may include ordering enforcement logic that respect producer-consumer relationships and memory barrier semantics across the protocol boundary. The RPU may translate NVLink commands that include partial write indicators to appropriate Infinity Fabric write command types while maintaining data integrity.

In some implementations of the apparatus, the RPU is further configured to translate commands or encodings associated with the NVLink-based protocol to commands or opcodes associated with a protocol utilized by the coherent interconnect, based on a mapping between request types of the NVLink-based protocol and corresponding request types of the protocol utilized by the coherent interconnect. The mapping may be implemented utilizing lookup tables, state machines, or programmable translation logic. The RPU may handle various NVLink categories including memory reads, memory writes, and atomic operations, translating them to appropriate coherent interconnect opcodes while preserving transaction semantics.

In some implementations of the apparatus, the RPU is further configured to translate a request corresponding to the NVLink-based protocol to at least one message corresponding to the protocol utilized by the coherent interconnect; wherein the at least one message causes prefetch to a cache of a processor comprising the processing cores. The RPU may translate NVLink requests, such as requests carrying explicit or implicit prefetch hints, to messages of a protocol utilized by the coherent interconnect that effectively prefetch data into a cache of the processor, enabling reduced memory access latency for anticipated future accesses. An example of a prefetch hint may include a case wherein the RPU detects a pattern of reading pairs of addresses that are adjacent to each other or separated by a distinguishable stride.

In some implementations of the apparatus, the RPU is further configured to utilize an intermediate protocol selected from Peripheral Component Interconnect Express (PCIe) or Compute Express Link (CXL) when translating between the NVLink-based protocol and a protocol utilized by the coherent interconnect. The use of an intermediate protocol may facilitate translation by leveraging existing protocol conversion logic. When utilizing PCIe as an intermediate protocol, the RPU may translate NVLink traffic to PCIe Transaction Layer Packets (TLPs) and subsequently to coherent interconnect transactions. When utilizing CXL as an intermediate protocol, the RPU may leverage CXL.cache or CXL.mem as appropriate for the transaction type. The intermediate protocol stage may enable reuse of existing protocol bridges and translation logic.

In some implementations of the apparatus, the RPU is further configured to maintain mappings between transaction identifiers utilized by the NVLink-based protocol and transaction identifiers utilized by the coherent interconnect, enabling correlation of requests and responses across domains. The transaction identifier mappings may accommodate different identifier formats, sizes, and allocation schemes between NVLink and the coherent interconnect. Transaction identifiers may be used to identify a transaction, such as when supporting outstanding requests in-flight through the RPU, or may be used to convey properties associated with messages or transactions, such as trace identifiers used for debugging and performance measurements, or authorization identifiers used for security. The RPU may include identifier pools and allocation mechanisms to prevent identifier exhaustion and may support identifier recycling upon transaction completion. The mapping structures may be optimized for fast lookup during high-frequency transaction processing and may utilize on-silicon SRAM, content-addressable memory (CAM) or Ternary Content-Addressable Memory (TCAM) structures.

In some implementations of the apparatus, the RPU is further configured to: maintain a transaction tracking structure to monitor outstanding transactions from the entity, allocate coherent interconnect transaction identifiers for transactions initiated by the RPU, and release identifiers upon transaction completion. The transaction tracking structure may be implemented using content-addressable memories, linked lists, or circular buffers optimized for the expected transaction rates. The RPU may include timeout logic to handle lost or excessively delayed transactions and may support error recovery procedures. The tracking structure may maintain additional transaction attributes such as timestamps, retry counts, or quality-of-service parameters.

In some implementations of the apparatus, the RPU is further configured to enable bidirectional access by translating requests between messages conforming to the NVLink-based protocol and messages conforming to the protocol utilized by the coherent interconnect; whereby the entity accesses the memory according to the NVLink-based protocol, and the processing cores access resources attached to the entity via the coherent interconnect. The bidirectional access capability may enable memory pooling and memory sharing architectures wherein system memory and entity-attached memory form a memory space accessible from both domains via translations. The RPU may maintain separate translation contexts for each direction and may apply different translation policies based on the initiator and target of each transaction. The bidirectional capability may support various computing paradigms including GPU-direct operations and peer-to-peer transfers. When processing cores access entity-attached resources, such as High-Bandwidth Memory (HBM) resources, the RPU may handle different memory attributes between the two domains.

In some implementations of the apparatus, the entity comprises at least one of: high-bandwidth memory (HBM), High-Bandwidth Flash (HBF), Low-Power Double Data Rate (LPDDR) memory, or Graphics Double Data Rate (GDDR) memory; and wherein the RPU is further configured to map a portion of the entity memory into the PAS, enabling the processing cores to access the entity memory based on memory-mapped operations. The mapping of entity memory such as HBM, HBF, LPDDR, or GDDR memory into PAS may include establishing memory windows with specific attributes optimized for the memory type. The RPU may handle differences in memory access granularity, bandwidth characteristics, and latency profiles between system memory and entity memory. The memory-mapped operations may be subject to caching policies and coherency protocols appropriate for cross-domain memory access.

In some implementations of the apparatus, the RPU is further configured to provide access control by validating the physical addresses associated with the NVLink-based protocol against permitted address ranges for the entity, and blocking NVLink-based traffic targeting prohibited address ranges. The permitted address ranges may be configured utilizing secure configuration registers or loaded from trusted firmware during system initialization. The RPU may support different access control contexts for different operational modes or security domains. The blocking of prohibited traffic may generate error responses conforming to NVLink error reporting logic and may trigger security event logging.

In some implementations of the apparatus, the RPU is further configured to evaluate transaction attributes associated with the NVLink-based protocol, including source identifiers and access types, and to apply security policies to allow or deny traffic based on preconfigured security rules. The security policies may consider combinations of transaction attributes including source device identification, vendor-defined commands or fields, transaction type, address range, and temporal factors. The RPU may provide role-based access control wherein different entities have different access privileges. The security rules may be updateable utilizing authenticated channels and may support both static and dynamic security policy enforcement.

In some implementations of the apparatus, the RPU is further configured to detect access patterns in NVLink-based traffic from the entity, and generates prefetch requests based on predicted future accesses; and wherein the prefetch requests are routed via the coherent interconnect and the memory controllers. The access pattern detection may utilize algorithms such as stride detection, stream buffers, or correlation-based prediction algorithms. The RPU may maintain pattern history tables to track access behaviors and may adapt prefetching aggressiveness based on prefetch accuracy metrics. The prefetch requests may be tagged with lower priority to avoid interfering with demand requests and may be cancelled if subsequent access patterns diverge from predictions.

In some implementations of the apparatus, the RPU is further configured to coalesce coherent interconnect transactions targeting contiguous or nearby addresses into fewer NVLink-based transactions; whereby the coalescing improves memory bandwidth utilization. The request coalescing may consider factors including address proximity, request types, and timing windows when determining which transactions to combine. The RPU may include write combining buffers for write transactions and may support read coalescing for sequential read patterns. In one example, coherent interconnects may use up to 64-byte transfers, that may reflect a nominal cacheline size utilized by the coherent interconnect, whereas NVLink may use larger transfers up to 256 bytes, making coalescing beneficial for bandwidth efficiency.

In some implementations of the apparatus, the NVLink-based interface is configured to support virtual channels, and the RPU is further configured to map the virtual channels to quality-of-service (QoS) attributes in a protocol utilized by the coherent interconnect. The virtual channel to QoS mapping may enable differentiated service levels for different traffic classes, such as bulk data transfers versus latency-sensitive communications. The RPU may include programmable mapping tables to allow flexible QoS policy configuration. The mapping may consider both NVLink virtual channel priorities and coherent interconnect QoS mechanisms to maintain end-to-end service level objectives.

In some implementations of the apparatus, the memory comprises dynamic random-access memory (DRAM), and the entity comprises a graphics processing unit (GPU) or an accelerator coupled to the apparatus via the NVLink-based interface; and wherein the RPU enables the entity to access the DRAM with cache-line granularity. An entity, such as a GPU or an accelerator, may utilize the NVLink interface for memory access to memory resources attached to the processor. Optionally, when the entity is coupled through an NVLink switch, the RPU may handle switch-specific routing information and may support entities sharing the NVLink interface through switch-based connectivity. The GPU or accelerator entity may utilize the NVLink interface for high-bandwidth memory access patterns characteristic of parallel computing workloads. The RPU may optimize translations for the specific access patterns and bandwidth requirements of GPU or accelerator workloads.

In various implementations, a method for enabling an entity to access memory via an NVLink-based interface, comprising: operating a processor comprising processing cores, memory management units (MMUs), and coherent caches; wherein the processing cores respond to snoop requests that utilize physical addresses within a physical address space (PAS), and the MMUs translate virtual addresses to physical addresses within the PAS; communicating, via a coherent interconnect, between the processing cores and memory controllers that communicate with memory channels coupled to memory having a capacity of at least 64 GB; executing, by the processing cores, an operating system (OS) that accesses the memory utilizing the physical addresses within the PAS; communicating according to an NVLink-based protocol with the entity via an NVLink-based interface; and translating physical addresses associated with the NVLink-based protocol to physical addresses within the PAS.

In some implementations, the method further comprises translating from non-address fields conforming to the NVLink-based protocol message formats to corresponding fields conforming to message formats of a protocol utilized by the coherent interconnect; and wherein the translating of the physical addresses is performed by a resource provisioning unit (RPU) coupled between the NVLink-based interface and the coherent interconnect.

In some implementations of the method, the protocol utilized by the coherent interconnect is based on Coherent Hub Interface (CHI-based protocol); and wherein the translating between non-address fields comprises translating NVLink-based protocol read commands to CHI-based protocol opcodes or commands comprising ReadOnce or ReadShared. The method may further include translating CHI response opcodes to NVLink response opcodes, such as translating CHI responses carrying CompData to NVLink responses.

In some implementations of the method, the protocol utilized by the coherent interconnect is based on an Intel Coherent Processor Interconnect Protocol (ICPIP-based protocol) for scalable multiprocessors with a shared physical address space; and wherein the translating between non-address fields comprises translating NVLink-based protocol memory access commands to ICPIP-based protocol requests while maintaining coherency state tracking between domain of the NVLink-based protocol and domain of the ICPIP-based protocol.

In some implementations of the method, the protocol utilized by the coherent interconnect is based on Infinity Fabric (IF-based); and wherein the translating between non-address fields comprises translating NVLink-based commands to IF-based commands while preserving memory ordering required by the entity.

In some implementations, the method further comprises translating NVLink-based commands to commands associated with a protocol utilized by the coherent interconnect, based on a mapping between NVLink-based transaction types and corresponding transaction types of the protocol utilized by the coherent interconnect. It is noted that in the context of such implementations, NVLink-based commands and NVLink-based encodings may be used interchangeably.

In some implementations of the method, the translating of the physical addresses comprises utilizing an intermediate protocol selected from Peripheral Component Interconnect Express (PCIe) or Compute Express Link (CXL) as an intermediate stage between the NVLink-based protocol and a protocol utilized by the coherent interconnect.

In some implementations, the method further comprises translating transaction identifiers utilized by the NVLink-based protocol to transaction identifiers utilized by the coherent interconnect, maintaining a transaction tracking structure to monitor outstanding transactions from the entity, allocating coherent interconnect transaction identifiers for RPU-initiated transactions, and releasing identifiers upon transaction completion.

In some implementations, the method further comprises validating the physical addresses associated with the NVLink-based protocol against permitted address ranges for the entity, and blocking NVLink-based traffic targeting prohibited address ranges; and further comprising evaluating NVLink-based traffic attributes including source identifiers and access types, and applying security policies to allow or deny traffic based on preconfigured security rules.

In some implementations, the method further comprises detecting access patterns in NVLink-based traffic from the entity, and generating prefetch requests based on predicted future accesses, wherein the prefetch requests are routed via the coherent interconnect and the memory controllers.

In various implementations, a system comprising: a host processor; a memory having a capacity of at least 64 GB; a coherent interconnect architecture coupling processing elements to the memory, wherein the processing elements utilize a local physical address space to access the memory; and a resource provisioning unit (RPU) configured to translate physical addresses associated with an NVLink-based protocol, utilized by an entity coupled to the RPU via an NVLink-based interface, to physical addresses within the local physical address space; whereby the translate of the physical addresses enables the entity to utilize the memory as disaggregated memory accessed via the NVLink-based interface and the memory controllers.

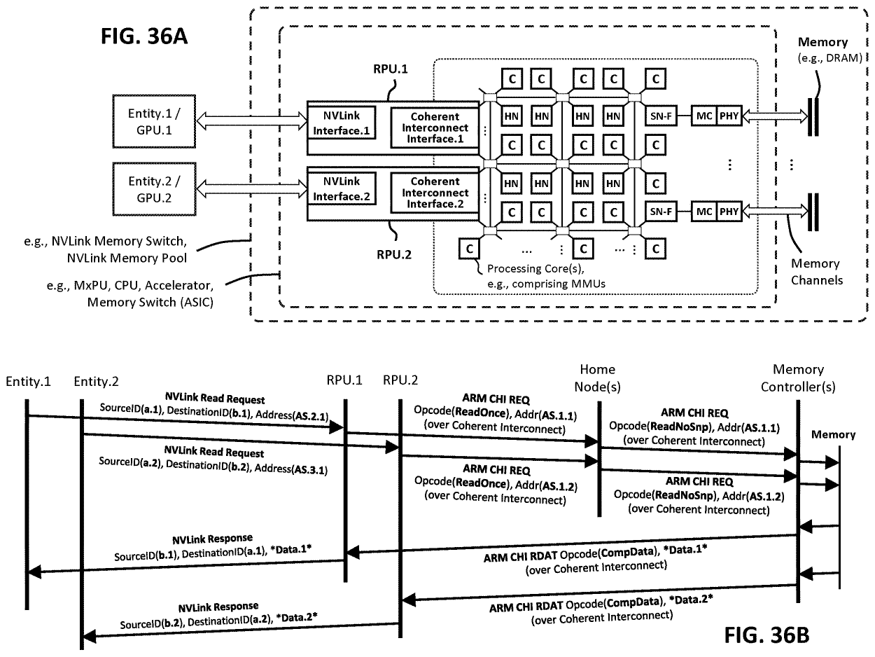

FIG. 36A illustrates an example of a system that may function as an NVLink memory switch appliance or an NVLink memory pool, and may include an MxPU, CPU, accelerator, or a memory switch ASIC, that is coupled to two entities denoted as Entity.1/GPU.1 and Entity.2/GPU.2. The MxPU includes processing cores and memory controllers coupled to a coherent interconnect that may be based on CHI. The MxPU utilizes translations, performed by the RPUs, between NVLink-based interfaces and an MxPU's coherent interconnect. The first RPU (RPU.1) may enable Entity.1/GPU.1 to access resources mapped to a physical address space utilized by the MxPU's coherent interconnect, wherein the access is via the first NVLink interface and the MxPU's coherent interconnect. Examples of resources mapped to the physical address space utilized by the MxPU's coherent interconnect include DRAM or other memory resources of the MxPU. Correspondingly, the second RPU (RPU.2) may enable Entity.2/GPU.2 to access, via the second NVLink interface and the MxPU's coherent interconnect, resources mapped to a physical address space utilized by the MxPU's coherent interconnect, such as memory resources of the MxPU.

FIG. 36B illustrates an example of a TFD depicting a multi-entity memory access scenario wherein first and second entities/GPUs access memory mapped to one or more physical address spaces utilized by the coherent interconnect (CohInterMappedMemory), through NVLink to ARM CHI translations. Entity.1/GPU.1 initiates a first NVLink request: Read with SourceID(a.1) to identify the source GPU, DestinationID(b.1) to identify the destination GPU, and Address(AS.2.1) representing an NVLink network address from a second physical address space. RPU.1 translates the first NVLink request to ARM CHI REQ carrying Opcode(ReadOnce), and Addr(AS.1.1) from a first physical address space utilized by the coherent interconnect. Concurrently or sequentially, Entity.2/GPU.2 may initiate a second NVLink request: Read with SourceID(a.2), DestinationID(b.2), and Address(AS.3.1) representing an NVLink network address optionally from a third physical address space or from the second physical address space. RPU.2 translates the second NVLink request to ARM CHI REQ carrying Opcode(ReadOnce) and Addr(AS.1.2) from the first physical address space utilized by the coherent interconnect.

Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and Data.1* for Entity.1/GPU.1. RPU.2 translates the second ARM CHI RDAT message to NVLink response with SourceID(b.2), DestinationID(a.2), and *Data.2* for Entity.2/GPU.2. The illustrated example demonstrates how entities/GPUs may share access to the same CohInterMappedMemory through different RPUs that translate between NVLink and ARM CHI, including physical address translations. Alternatively, the illustrated example may be viewed as two separate NVLink transactions that utilize the same coherent interconnect infrastructure to access CohInterMappedMemory, wherein the GPU entities may access the CohInterMappedMemory via a shared or separate address spaces that are translated to the shared coherent interconnect physical address space. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

Depending on system characteristics, such as implementation choices and platform configurations, different physical addresses, such as (AS.1.1) and (AS.1.2), within a physical address space utilized by the coherent interconnect, may be typically partitioned, such as via hashing or interleaving schemes, across a set of home nodes. Such partitioning is typically performed in order to reduce bottleneck effects in the system and spread the load of transaction processing across home nodes of the coherent interconnect, and may result in mapping the different physical addresses, such as (AS.1.1) and (AS.1.2), to the same home node, or to different home nodes. Similarly, different physical addresses may be associated with one memory controller, or with different memory controllers, such as according to a separate mapping scheme, which may be different from the mapping scheme utilized for selecting a home node for processing the request. Alternatively, other implementations may co-locate the home node function with a specific memory controller, utilizing a unified mapping scheme that selects both a home node and a memory controller.

In heterogeneous computing architectures, NVLink-based entities such as GPUs, accelerators, and NVLink switches may need to access resources coupled to CXL-based entities such as CXL hosts, CXL devices, CXL switches, or CXL-attached memory pools. NVLink-based protocols and CXL.io utilize different message formats, addressing schemes, and transaction semantics. NVLink-based requests may carry NVLink-based network addresses or GPU physical addresses within a first address space, while CXL.io requests may carry Host Physical Addresses (HPAs) within a second address space. A computer, which may be implemented as a processor, a switch, an RPU, a semiconductor device, a chiplet, an active cable, or other suitable device, may be positioned between an NVLink-based interface and a CXL.io interface to translate between these incompatible protocol domains. The computer may translate addresses, Tags, opcodes, and other fields, and may propagate QoS telemetry information carried in CDL fields of CXL.io UIO completions. The translation may be performed in one direction from NVLink to CXL.io, in the reverse direction from CXL.io to NVLink, or bidirectionally. In the reverse direction, the computer may generate CDL values in CXL.io UIO completions based on load or congestion information observed at the NVLink domain, even when the NVLink-based protocol does not natively carry CDL. Such CDL generation by a host-side entity may extend QoS telemetry capabilities beyond what CXL specifications define for CXL devices alone.

In various implementations, a method comprising: receiving, by a computer from a first entity via a first interface, an NVLink-based request comprising a first physical address; translating, by the computer, the NVLink-based request to a CXL.io request comprising a read-class Transaction Layer Packet (TLP) type and a second physical address, wherein CXL denotes Compute Express Link; sending, by the computer via a second interface, the CXL.io request to a second entity; receiving, by the computer from the second entity, a CXL.io completion comprising data and a Tag; translating, by the computer, the CXL.io completion to an NVLink-based response; and sending the NVLink-based response comprising the data to the first entity. The method may enable an NVLink-based entity, such as a GPU, an accelerator, or an NVLink switch, to access resources coupled to a CXL-based entity, such as a CXL host, a CXL device, a CXL switch, or a CXL-attached memory pool, by translating NVLink-based requests to CXL.io requests and translating CXL.io completions to NVLink-based responses. The computer may be a processor, a switch, an RPU, an active cable, or a semiconductor device positioned between the first entity and the second entity. The first interface may communicate according to an NVLink-based protocol, and the second interface may communicate according to CXL.io. The NVLink-based request may be an NVLink read request comprising fields such as SourceID, DestinationID, Address, Tag, and Length. The computer may translate the NVLink-based request to a CXL.io request comprising a read-class TLP type, which may be either a standard Memory Read (MRd) or a UIO Memory Read (UIOMRd). The CXL.io completion may be a CplD or a UIORdCplD, and may carry a CDL field when the UIO path is utilized. The computer may translate the data and Tag from the CXL.io completion into the NVLink-based response, reconstructing the NVLink response fields such as SourceID, DestinationID, and Tag for delivery to the first entity. In some examples, the computer may issue one or more CXL.io requests in response to an NVLink-based request, such as when splitting a large NVLink read into smaller CXL.io reads, or when prefetching data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCplD). UIO may be utilized when the path between the computer and the second entity supports Flit Mode and has UIO enabled. The UIOMRd may provide multi-path routing and out-of-order completion delivery capabilities. The UIORdCplD may include a CDL that carries QoS telemetry populated by the second entity or intermediate components.

In some implementations of the method, the CXL.io UIORdCplD comprises a CXL DevLoad (CDL) field, and wherein the computer performs at least one of: (i) translating information carried in the CDL to one or more fields of the NVLink-based response, or (ii) utilizing information carried in the CDL for at least one of throttling subsequent requests to the second entity or collecting Quality-of-Service (QoS) telemetry. The CDL may carry device load indicators such as light load, optimal load, moderate overload, or severe overload encodings. The computer may translate CDL information to reserved fields, vendor-defined fields, or custom fields of the NVLink-based response, or may collect CDL values over time to build a telemetry profile of the second entity. When utilizing CDL for throttling, the computer may reduce or modulate the rate of subsequent CXL.io requests based on the observed loading state.

In some implementations of the method, the CXL.io request comprises a CXL.io Memory Read (MRd) request, and the CXL.io completion comprises a CXL.io Completion with Data (CplD). The standard MRd and CplD types may be utilized when the second entity does not support UIO, when UIO is not enabled along the path, or when the path between the computer and the second entity does not utilize Flit Mode. The CplD does not include a CDL, and the computer may populate any QoS-related fields in the NVLink-based response with locally generated information or default values.

In some implementations of the method, the first physical address refers to an NVLink-based network address or a GPU physical address belonging to a first address space, the second physical address refers to a Host Physical Address (HPA) belonging to a second address space, wherein the NVLink-based request further comprises a first Tag, the computer assigns a second Tag to the CXL.io request, and the computer maintains a mapping between the first Tag and the second Tag to correlate the CXL.io completion with the NVLink-based request. The address translation may be implemented utilizing lookup tables, page tables, base-and-offset calculations, or programmable translation functions. The Tag mapping may be maintained in tracker entries, content-addressable memory, or translation tables. Upon receiving the CXL.io completion comprising the Tag, the computer may look up the corresponding first Tag and include it in the NVLink-based response for proper correlation at the first entity.

In some implementations of the method, the computer translates an NVLink-based request to CXL.io requests, the computer prefetches data from the second entity into a cache coupled to the computer, the first entity comprises at least one of a GPU, an accelerator, or an NVLink switch, and the second entity comprises at least one of a CXL host, a CXL device, or a CXL switch. The computer may split a large NVLink read request, such as a 256-byte read, to smaller CXL.io read requests, such as 64-byte or 128-byte reads, to accommodate differences in maximum payload sizes between the NVLink-based protocol and CXL.io. The computer may additionally prefetch data from addresses adjacent to or following the requested address, storing the prefetched data in the cache for servicing anticipated subsequent requests from the first entity with reduced latency.

In some implementations of the method, the computer translates error indications between the CXL.io completion and the NVLink-based response, comprising translating at least one of a poison indication or a data corruption indication. The poison indication in CXL.io may indicate that the data payload has been corrupted or is otherwise invalid. The computer may translate this indication to a corresponding error indication in the NVLink-based response, enabling the first entity to handle the error accordingly.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system, which may be configured for translation from NVLink-based traffic to CXL.io traffic, may include a semiconductor device, a bridge, a switch, or another apparatus that includes a first interface configured to communicate according to an NVLink-based protocol and a second interface configured to communicate according to CXL.io. A computer coupled between the interfaces may translate physical addresses between a first address space, such as an NVLink-based network address space or a GPU physical address space, and a second address space, such as an HPA space, associated with CXL.io. The computer may additionally translate between NVLink-based requests and other CXL sub-protocols such as CXL.mem or CXL.cache. The system may include optional switches on one or both sides of the computer, and the computer may be implemented in various form factors including a retimer BGA package. Such systems may serve heterogeneous AI computing architectures where NVLink-based accelerators need to access CXL-attached resources including memory expansion devices, coherent memory pools, or host-managed device memory.

In various implementations, a system comprising: a first interface configured to communicate according to an NVLink-based protocol with a first entity; a second interface configured to communicate according to CXL.io with a second entity, wherein CXL denotes Compute Express Link; and a computer coupled between the first and second interfaces, configured to translate between NVLink-based requests received via the first interface and CXL.io requests transmitted via the second interface; wherein the computer is further configured to translate physical addresses between a first address space associated with the NVLink-based protocol and a second address space associated with CXL.io. The system may enable an NVLink-based entity, such as a GPU or an accelerator, to access resources coupled to a CXL-based entity, such as a CXL host, a CXL device, or a CXL-attached memory device, through the translating computer. The first interface may be coupled to the first entity directly or through one or more NVLink switches, and the second interface may be coupled to the second entity directly or through one or more CXL switches. The computer may be implemented as a processor, a switch, an RPU, a semiconductor device, or an active cable. The first address space may include an NVLink-based network address space or a GPU physical address space, and the second address space may include an HPA space. The computer may translate addresses utilizing lookup tables, page tables, base-and-offset calculations, or programmable translation functions. In some examples, the computer may additionally translate between NVLink-based requests and CXL.mem requests or CXL.cache requests, enabling access to different types of CXL-attached resources through the same system.

In some implementations of the system, the computer is further configured to translate between NVLink-based requests and at least one of CXL.mem requests or CXL.cache requests via the second interface; and wherein the NVLink-based requests comprise requests associated with an artificial intelligence (AI) model, comprising at least one of: requests for AI model parameters stored in a CXL-attached memory device accessible via CXL.mem, or requests for AI model data maintained in a cache coherency domain accessible via CXL.cache. The multi-channel CXL translation may enable AI accelerators to access model parameters from CXL-attached memory expansion devices via CXL.mem, while simultaneously accessing coherent data structures via CXL.cache. The computer may select the appropriate CXL sub-protocol based on the address range, transaction type, or memory attributes of each NVlink-based request.

In some implementations of the system, the computer is implemented in an integrated circuit (IC) package having high-speed differential I/O balls positioned according to a ball grid array (BGA) layout defined by a retimer specification. The retimer BGA form factor may enable the computer to be deployed in existing retimer sockets within server platforms, utilizing a standardized physical footprint such as the PCIe 5.0, 6.0, or 7.0 Retimer Supplemental Features and Standard BGA Footprint Specification.

In some implementations of the system, the computer comprises a cache configured to store prefetched data received via the second interface, the prefetched data comprising data associated with an artificial intelligence (AI) model comprising at least one of model weights, activation tensors, or embedding tables, and the computer comprises at least one of a processor, a switch, or a Request Processing Unit (RPU). The cache may store prefetched AI model data to reduce latency for subsequent NVLink-based requests from the first entity. AI model weights, activation tensors, and embedding tables may exhibit predictable sequential access patterns that benefit from prefetching. The RPU, processor, or switch may manage the prefetch scheduling and cache allocation policies.

In some implementations of the system, one or more NVLink switches are positioned between the first interface and the first entity, one or more CXL switches are positioned between the second interface and the second entity, and the first entity comprises an AI accelerator that processes an artificial intelligence (AI) model distributed across AI accelerators coupled via the one or more NVLink switches. The NVLink switches may couple AI accelerators that collectively process a distributed AI model, such as when model parameters or activations are partitioned across accelerators using model parallelism, tensor parallelism, or pipeline parallelism. The CXL switches may couple the second interface to one or more CXL-attached memory devices, memory pools, or hosts that store portions of the AI model data.

In some implementations, translation may be performed from CXL.io traffic to NVLink-based traffic. A first entity, such as a CXL host, may initiate CXL.io read requests targeting resources coupled to a second entity, such as a GPU, that communicates according to an NVLink-based protocol. The computer may translate CXL.io requests to NVLink-based requests and translate NVLink-based responses to CXL.io completions. The computer may determine NVLink routing fields such as SourceID and DestinationID based on routing information, since CXL.io requests do not natively carry NVLink routing fields. Additionally, when translating to CXL.io UIO completions such as UIORdCplD, the computer may populate a CDL field with QoS telemetry information derived from the NVLink domain, from locally observed load or congestion conditions, or from information carried in the NVLink-based response. This CDL generation by a host-side or bridge-side entity extends the telemetry model beyond the CXL specification, which defines CDL population for CXL devices under specific conditions. Such translation may enable CXL hosts to access GPU memory storing AI model data, intermediate computations, or inference results.

In various implementations, a method comprising: receiving, by a computer from a first entity via a first interface, a CXL.io request comprising a read-class Transaction Layer Packet (TLP) type and a first physical address, wherein CXL denotes Compute Express Link; translating, by the computer, the CXL.io request to an NVLink-based request comprising a second physical address; sending, by the computer via a second interface that communicates according to an NVLink-based protocol, the NVLink-based request to a second entity; receiving, by the computer from the second entity, an NVLink-based response comprising data; translating, by the computer, the NVLink-based response to a CXL.io completion comprising the data; and sending the CXL.io completion to the first entity. The method may enable a CXL-based entity, such as a CXL host or a CXL device, to access resources coupled to an NVLink-based entity, such as a GPU, by translating CXL.io requests to NVLink-based requests and translating NVLink-based responses to CXL.io completions. The computer may be a processor, a switch, an RPU, a bridge, an active cable, or a semiconductor device positioned between the first entity and the second entity. The first interface may communicate according to CXL.io, and the second interface may communicate according to an NVLink-based protocol. The CXL.io request may be a CXL.io MRd or a CXL.io UIOMRd, and the CXL.io completion may be a CplD or a UIORdCplD, respectively. The computer may translate the first physical address, which may be an HPA or an address within a CXL address space, to the second physical address, which may be an NVLink-based network address or a GPU physical address. The computer may additionally determine NVLink routing fields such as SourceID and DestinationID for the outgoing NVLink-based request based on routing information, address mapping tables, or configuration maintained by the computer. The NVLink-based response may include fields such as SourceID, DestinationID, Tag, and data, and the computer may translate these to the corresponding CXL.io completion fields. In some examples, the computer may aggregate CXL.io requests into an NVLink-based request, or may prefetch additional data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCplD). The UIO path may be utilized when the first entity supports UIO capabilities and the path between the first entity and the computer has UIO enabled. The UIORdCplD may include a CDL that the computer may populate with telemetry information derived from the NVLink domain.

In some implementations of the method, the computer populates a CXL DevLoad (CDL) field in the CXL.io UIORdCplD with information based on at least one of: load information observed by the computer, congestion information associated with the second entity, or Quality-of-Service (QoS) telemetry derived from the NVLink-based response. The CDL generation by the computer may extend the CXL DevLoad telemetry model to the NVLink domain, where the NVLink-based protocol does not natively carry CDL. The computer may derive load or congestion information from the response latency, queue depth, or other observable characteristics of the second entity. The computer may populate the CDL utilizing the same encoding as defined for CXL devices, such as light load, optimal load, moderate overload, or severe overload, enabling the first entity to make informed scheduling or resource allocation decisions based on conditions at the second entity.

In some implementations of the method, the CXL.io request comprises a CXL.io Memory Read (MRd) request, and the CXL.io completion comprises a CXL.io Completion with Data (CplD). The standard MRd and CplD types may be utilized when the first entity does not support UIO or when UIO is not enabled along the path. The CplD does not include a CDL, and the computer may utilize any QoS or load information internally for traffic management or monitoring rather than propagating it to the first entity.

In some implementations of the method, the CXL.io request further comprises a first Tag, the NVLink-based request further comprises a second Tag assigned by the computer, the computer maintains a mapping between the first Tag and the second Tag, and translating the CXL.io request to the NVLink-based request comprises determining a SourceID and a DestinationID for the NVLink-based request based on routing information maintained by the computer. The computer may assign the second Tag from a pool of available NVLink Tags and store the mapping in a tracker entry. The SourceID and DestinationID may be determined based on routing tables, address range configurations, or forwarding information maintained by the computer, since CXL.io requests do not natively carry NVLink routing fields. Upon receiving the NVLink-based response comprising the second Tag, the computer may retrieve the corresponding first Tag for inclusion in the CXL.io completion.

In some implementations of the method, the computer aggregates CXL.io requests received from the first entity, and translates the aggregated CXL.io requests to an NVLink-based request. The computer may aggregate smaller CXL.io read requests targeting adjacent or contiguous addresses into a larger NVLink-based read request, leveraging the NVLink-based protocol's support for larger payload sizes to improve bandwidth utilization and reduce the number of transactions on the NVLink-based interface.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system may be configured to translate from CXL.io traffic to NVLink-based traffic. The system may include a computer coupled between a first interface configured to communicate according to CXL.io and a second interface configured to communicate according to an NVLink-based protocol. The computer may translate CXL.io requests received from a first entity, such as a CXL host, to NVLink-based requests transmitted to a second entity, such as a GPU. The computer may include an RPU with a cache, and may be implemented as a bridge, a switch, a standalone translation device, or a chiplet. The system may include optional NVLink switches or CXL switches on either side of the computer. Such systems may enable CXL hosts to access GPU memory resources, such as memory storing AI model data, intermediate computation results, or inference outputs, through the CXL.io interface.

In various implementations, a system comprising: a first interface configured to communicate according to CXL.io with a first entity, wherein CXL denotes Compute Express Link; a second interface configured to communicate according to an NVLink-based protocol with a second entity; and a computer coupled between the first and second interfaces, configured to translate between CXL.io requests received via the first interface and NVLink-based requests transmitted via the second interface. The system may enable a CXL-based entity, such as a CXL host, a CXL device, or a CXL switch, to access resources coupled to an NVLink-based entity, such as a GPU, an accelerator, or an NVLink switch, through the computer that performs translation between the CXL.io and NVLink-based protocol domains. The computer may translate addresses, Tags, routing fields, error indications, and other protocol-specific fields. The computer may additionally determine NVLink routing fields such as SourceID and DestinationID for outgoing NVLink-based requests, since CXL.io requests do not carry NVLink routing information. In some examples, the computer may include an RPU coupled to a cache, and may be coupled to a memory. The first interface may be coupled to the first entity directly or through one or more CXL switches, and the second interface may be coupled to the second entity directly or through one or more NVLink switches. The computer may be implemented as a bridge, a switch, a standalone translation device, a semiconductor device, or a chiplet.

In some implementations of the system, the computer is configured to determine a SourceID and a DestinationID for NVLink-based requests transmitted via the second interface based on routing information maintained by the computer. The routing information may include routing tables, address-to-destination mappings, forwarding information, or configuration data programmed by a management entity. The SourceID and DestinationID may be utilized by NVLink switches or the second entity to route and deliver the NVLink-based requests.

In some implementations of the system, the computer is further configured to translate at least one of poison indications or data corruption indications between messages communicated via the first interface and messages communicated via the second interface. The poison indication in CXL.io may be propagated to or from corresponding error fields in NVLink-based messages, enabling end-to-end error visibility across the protocol boundary.

In some implementations of the system, the computer comprises a Request Processing Unit (RPU) coupled to a cache configured to store data associated with translations between the CXL.io requests and the NVLink-based requests, and wherein the computer is further configured to translate between fields of the CXL.io requests and fields of the NVLink-based requests, comprising at least one of: Traffic Class (TC) to QoS priority, Tag to Tag, or length to length translations. The RPU may manage the translation state and orchestrate the protocol conversions. The cache may store data retrieved from the second entity to reduce latency for repeated or adjacent accesses. The cross-field translations may include mapping CXL.io Traffic Class values to NVLink QoS priority levels, mapping CXL.io Tags to NVLink Tags, and translating length fields to accommodate differences in granularity or maximum transfer sizes between the protocols.

In some implementations of the system, the computer is included in at least one of a bridge, a switch, or a standalone translation device, which enables the first entity to access, via CXL.io, GPU memory of the second entity storing data associated with an artificial intelligence (AI) model. The bridge, switch, or standalone translation device may be deployed in AI inference or training systems where CXL hosts need to read intermediate results, model outputs, or gradient data from GPU memory. The translation device may enable such access without requiring the GPU to natively support CXL.io.

In some implementations of the system, the computer comprises an NVLink Fusion chiplet coupled to a processing die via an NVLink Chip-to-Chip (NVLink-C2C) coherent interface; and wherein at least one of: one or more NVLink switches are positioned between the second interface and the second entity, or one or more CXL switches are positioned between the first interface and the first entity. The NVLink Fusion chiplet may implement the translation logic as a separate die within a multi-die package, communicating with the processing die via the NVLink-C2C coherent interface. The NVLink switches or CXL switches may extend the system topology to include multiple NVLink-based entities or multiple CXL-based entities, respectively.

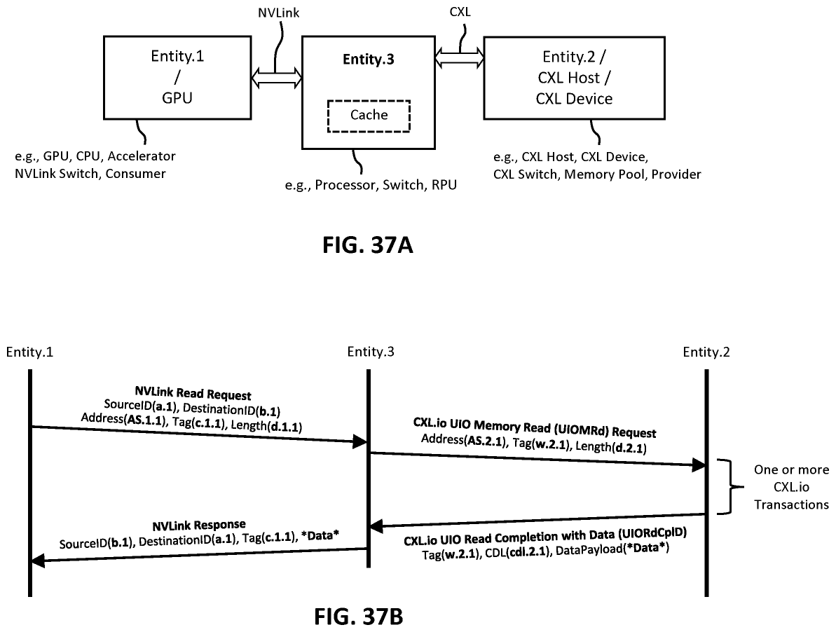

FIG. 37A illustrates an example of a system comprising a third entity (Entity.3), such as a processor, a switch, or an RPU, optionally comprising a cache, that may enable NVLink-based resource consumers to access resources coupled to CXL-based entities. The third entity is coupled to a first entity (Entity.1), which may be a GPU, a CPU, an accelerator, an NVLink switch, or a consumer, wherein the third entity may communicate with the first entity according to an NVLink-based protocol. The third entity is further coupled to a second entity (Entity.2), which may be a CXL host, a CXL device, a CXL switch, a CXL-based memory pool, or a resource provider, wherein the third entity may communicate with the second entity according to a CXL-based protocol, such as at least one of CXL.io, CXL.mem, or CXL.cache. In some examples, messages conforming to the NVLink-based protocol may be associated with a first address space, such as an NVLink-based address space, an NVLink-based network address space, or a GPU address space; and messages conforming to the CXL-based protocol, such as CXL.io, may be associated with a second address space, such as a System Physical Address (SPA) space or a Host Physical Address (HPA) space; wherein the third entity may perform address translations between addresses within the first and second address spaces, respectively. In other examples, messages conforming to the NVLink-based protocol and messages conforming to the CXL-based protocol may be associated with the same physical address space, such as a global address space, a pod address space, or a fabric address space; wherein the third entity may perform address translations between addresses within the same address space. The third entity may perform further translations, such as protocol translations, opcode translations, command translations, request translations, or TLP translations, such as when translating between NVLink requests and CXL.io requests. The third entity may further translate between PDUs of the NVLink-based protocol and PDUs of the CXL protocol, translate Tags, and/or translate error indications, such as data corruption indications or poison. The optional cache within the third entity, shown in dashed outline, may store prefetched data or data retrieved from the second entity to reduce latency for subsequent requests from the first entity. Optionally, the first entity may be a GPU, CPU, accelerator, NVLink switch, or consumer; the third entity may be a processor, switch, or RPU; and the second entity may be a CXL host, CXL device, CXL switch, memory pool, or provider.

FIG. 37B illustrates an example of a transaction flow diagram (TFD) demonstrating a third entity (Entity.3), such as a processor, a switch, or an RPU, that may translate between NVLink-based traffic and CXL-based traffic, such as CXL.io traffic. The third entity may receive from a first entity (Entity.1), which may be a GPU, an NVLink read request that may include SourceID(a.1), DestinationID(b.1), Address(AS.1.1), Tag(c.1.1), and Length(d.1.1), wherein SourceID(a.1) may denote the NVLink interconnect address utilized by the requesting entity, such as a source GPU, and wherein DestinationID(b.1) may denote the NVLink interconnect address utilized by the target of the NVLink request, and may be utilized for routing or forwarding the NVLink request to its destination. The third entity may translate the NVLink request to a CXL.io request that may include a CXL.io UIO Memory Read (UIOMRd) request comprising Address(AS.2.1), Tag(w.2.1), and Length(d.2.1), and may send the CXL.io UIOMRd to a second entity (Entity.2), which may be a CXL host or a CXL device. The third entity may further translate between other values of the NVLink request and the CXL.io request, such as between addresses, Tags, QoS-related values, or identifications (IDs), which may serve to route or forward the NVLink request to its destination. In some examples, the third entity may translate an NVLink request to multiple CXL.io request, such as in order to split a large data read request (e.g., splitting a large 256 B NVLink read request to smaller 64 B CXL.io read requests), or in order to prefetch data, optionally into a cache that may be included in or coupled to the third entity. Upon receiving a response from the second entity (Entity.2), which may include a CXL.io UIORdCplD comprising Tag(w.2.1), CDL(cdl.2.1), and DataPayload(*Data*), the third entity may translate the CXL.io UIORdCplD to an NVLink response comprising SourceID(b.1), DestinationID(a.1), Tag(c.1.1), and *Data*. The CDL that may be included in the CXL.io UIORdCplD may be populated with information related to QoS, such as QoS telemetry value or values. The third entity may translate information carried in the CDL and send it via one or more fields of the NVLink response, such as via reserved fields, vendor-defined fields, or custom fields. Alternatively or additionally, the third entity may collect QoS information, telemetry, or statistics from UIORdCplD completions.

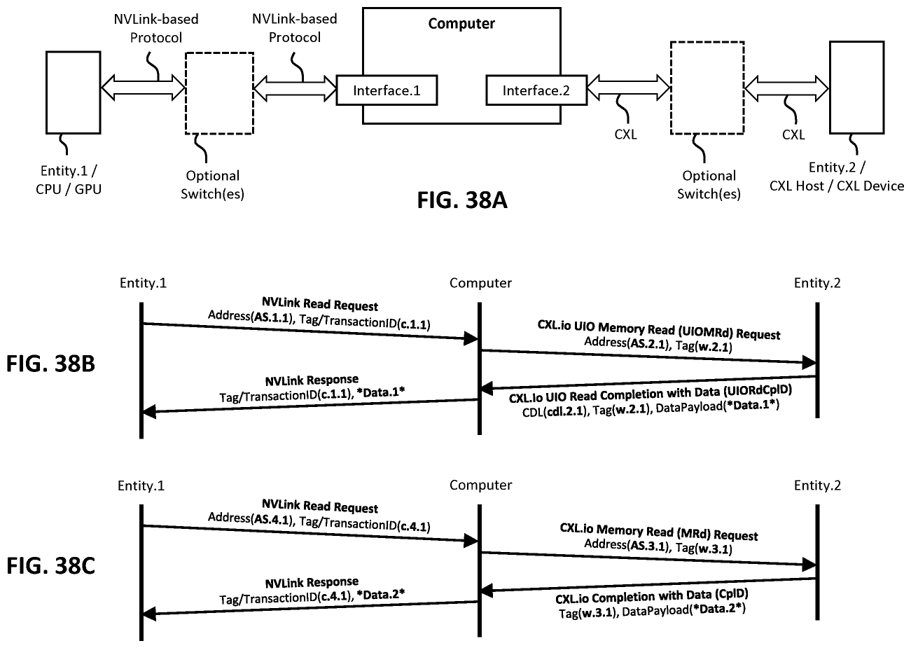

FIG. 38A illustrates an example of a system comprising a computer coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a CXL-based protocol, such as CXL.io, with a second entity (Entity.2), which may be a CXL host or a CXL device. Optionally, the computer may be implemented in a semiconductor device package. The computer may extract physical addresses from requests received via the first interface, wherein these addresses may refer to an NVLink-based address space, an NVLink-based network address space, or a GPU address space utilized by the first entity. The computer may further translate these addresses, and generate requests carrying the translated physical addresses for transmission via the second interface; wherein these translated addresses may correspond to an HPA space utilized by the second entity. Optional switch(es), such as NVLink switches, may be positioned between the first interface and the first entity, as shown in dashed outline on the left side of the figure. Similarly, optional switch(es), such as CXL switches, may be positioned between the second interface and the second entity, as shown in dashed outline on the right side of the figure. The NVLink-based protocol labels on the connections between the first entity, the optional switches, and the first interface indicate that NVLink-based traffic traverses the left side of the illustrated system. The CXL labels on the connections between the second interface, the optional switches, and the second entity indicate that CXL-based traffic traverses the right side of the illustrated system. Optionally, the computer may be included in a switch or a bridge. In some examples, the computer may be implemented in an IC package having high-speed differential I/O balls positioned according to a ball grid array layout defined by a retimer specification, such as the PCIe 5.0, 6.0, or 7.0 Retimer Supplemental Features and Standard BGA Footprint Specification.

FIG. 38B illustrates an example of a TFD demonstrating translations between NVLink-based requests, such as NVLink read requests, received from a first entity (Entity.1), which may be a CPU or a GPU, and CXL.io UIO TLPs sent to a second entity (Entity.2), which may be a CXL host or a CXL device, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.1.1), and Tag/TransactionID(c.1.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io UIO Memory Read (UIOMRd) request comprising a physical address, such as HPAs Address(AS.2.1), and Tag(w.2.1), and may send the CXL.io UIOMRd to the second entity. Upon receiving the CXL.io UIOMRd, the second entity may respond with a completion, which may include a CXL.io UIO Read Completion with Data (UIORdCplD) comprising CDL(cdl.2.1), Tag(w.2.1), and DataPayload(*Data.1*), wherein the CDL may be populated by the CXL device (or alternatively by the CXL host) with information related to QoS, such as QoS telemetry value or values. The computer may translate the CXL.io UIORdCplD to an NVLink response comprising Tag/TransactionID(c.1.1) and *Data.1*, and may send the NVLink response to the first entity. In some examples, the computer may issue multiple CXL.io UIO memory read requests in response to receiving an NVLink request from the first entity, such as when splitting an NVLink request for a large block of data to smaller CXL.io UIO memory read requests, or when prefetching data from the second entity. The computer may translate requests or transactions initiated from the NVLink-based domain to the CXL domain, or may translate requests or transactions initiated from the CXL domain to the NVLink-based domain.

FIG. 38C illustrates an example of a TFD demonstrating translations between NVLink-based requests, such as NVLink read requests, received from a first entity (Entity.1), which may be a CPU or a GPU, and CXL.io TLPs sent to a second entity (Entity.2), which may be a CXL host or a CXL device. The translation is performed by a computer, which may be a semiconductor device. The first entity may initiate an NVLink request, which may be an NVLink read request, comprising physical address Address(AS.4.1), and Tag/TransactionID(c.4.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io Memory Read (MRd) request comprising physical address Address(AS.3.1) and Tag(w.3.1), and may send the CXL.io MRd to the second entity. Upon receiving a completion from the second entity, which may include a CXL.io Completion with Data (CplD) comprising Tag(w.3.1) and DataPayload(*Data.2*), the computer may translate the CXL.io CplD to an NVLink response comprising Tag/TransactionID(c.4.1) and *Data.2*, and may send the NVLink response to the first entity. In some examples, the computer may issue multiple CXL.io memory read requests in response to receiving an NVLink request from the first entity, such as when splitting an NVLink request for a large block of data to smaller CXL.io memory read requests, or when prefetching data from the second entity.

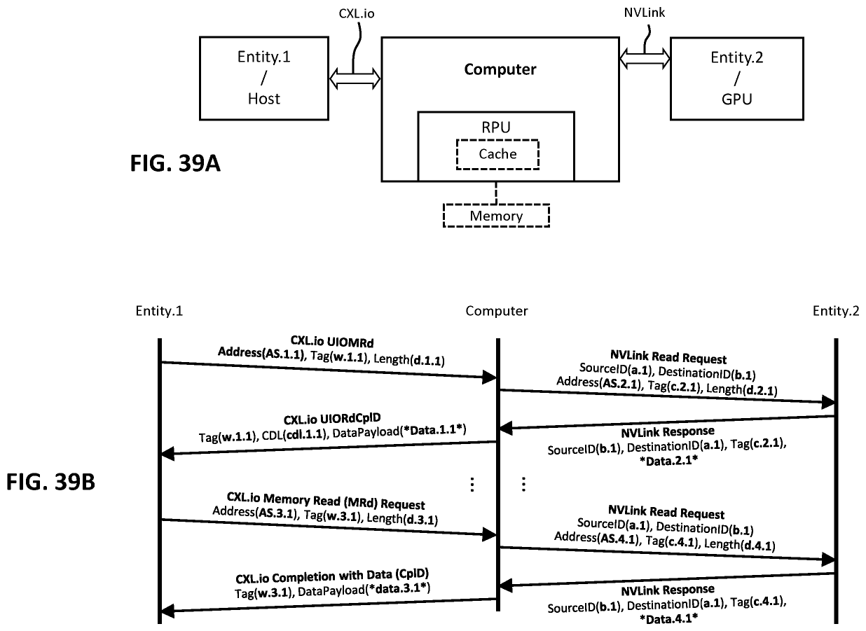

FIG. 39A illustrates an example of a system comprising a computer configured to translate between CXL.io traffic and NVLink-based traffic. A first entity (Entity.1), which may be a host, is coupled to the computer via a CXL.io interface. A second entity (Entity.2), which may be a GPU, is coupled to the computer via an NVLink interface. The computer includes an RPU that may orchestrate the protocol translation logic. The RPU may include an optional cache, which may store data associated with translations between CXL.io requests and NVLink-based requests, such as prefetched data, cached responses, or translation state. The computer is further coupled to an optional memory, shown in dashed outline below the computer, that may store routing tables, address translation tables, Tag mapping entries, or other state information utilized by the RPU during translation. The system enables the first entity (Host) to access resources coupled to the second entity (GPU) through the computer by translating CXL.io requests to NVLink-based requests and translating NVLink-based responses to CXL.io completions. The computer may determine NVLink routing fields such as SourceID and DestinationID for outgoing NVLink-based requests, since CXL.io requests do not natively carry NVLink routing fields. When translating NVLink-based responses to CXL.io UIO completions, the computer may populate a CDL field with QoS telemetry information derived from the NVLink domain, from load or congestion information observed by the computer, or from information carried in the NVLink-based response.

FIG. 39B illustrates an example of a TFD demonstrating translations between CXL.io read requests received from a first entity (Entity.1) and NVLink-based read requests sent to a second entity (Entity.2), with the translation performed by a computer positioned between the first and second entities. The figure shows two separate transaction flows separated by a vertical ellipsis, representing two alternative translation paths: an upper UIO path and a lower non-UIO path. In the upper UIO path, the first entity sends a CXL.io UIOMRd comprising Address(AS.1.1), Tag(w.1.1), and Length(d.1.1) to the computer. The computer translates the CXL.io UIOMRd to an NVLink read request comprising SourceID(a.1), DestinationID(b.1), Address(AS.2.1), Tag(c.2.1), and Length(d.2.1), and sends the NVLink read request to the second entity. The computer determines the SourceID(a.1) and DestinationID(b.1) based on routing information maintained by the computer, since the CXL.io UIOMRd does not carry NVLink routing fields. Upon receiving an NVLink Response from the second entity comprising SourceID(b.1), DestinationID(a.1), Tag(c.2.1), and *Data.2.1*, the computer translates the NVLink Response to a CXL.io UIORdCplD comprising Tag(w.1.1), CDL(cdl.1.1), and DataPayload(*Data.1.1*), and sends the CXL.io UIORdCplD to the first entity. The CDL(cdl.1.1) may be populated by the computer with QoS telemetry information based on load information observed by the computer, congestion information associated with the second entity, or information derived from the NVLink Response, since the NVLink-based protocol does not natively carry a CDL field.

In the lower non-UIO path, the first entity sends a CXL.io Memory Read (MRd) request comprising Address(AS.3.1), Tag(w.3.1), and Length(d.3.1) to the computer. The computer translates the CXL.io MRd to an NVLink read request comprising SourceID(a.1), DestinationID(b.1), Address(AS.4.1), Tag(c.4.1), and Length(d.4.1), and sends the NVLink read request to the second entity. Upon receiving an NVLink Response from the second entity comprising SourceID(b.1), DestinationID(a.1), Tag(c.4.1), and *Data.4.1*, the computer translates the NVLink Response to a CXL.io Completion with Data (CplD) comprising Tag(w.3.1) and DataPayload(*Data.3.1*), and sends the CXL.io CplD to the first entity. Unlike the upper UIO path, the CplD in the lower non-UIO path does not include a CDL. In both paths, the computer translates addresses between the CXL.io domain (Address AS.1.1 and AS.3.1) and the NVLink domain (Address AS.2.1 and AS.4.1), translates Tags between the CXL.io domain (Tag w.1.1 and w.3.1) and the NVLink domain (Tag c.2.1 and c.4.1), and determines NVLink SourceID and DestinationID routing fields for the outgoing NVLink read requests.

In some implementations, a computer, such as an RPU, may be coupled between an NVLink interface and a CXL interface, and may translate between NVLink-based traffic and CXL.mem traffic. The computer may receive NVLink-based requests from a first entity, such as a GPU or an accelerator, and may translate the NVLink-based requests to CXL.mem M2S requests for transmission to a second entity, such as a CXL device, a CXL memory expander, or a CXL memory pool. The translation may include address translation between physical address spaces, opcode translation between NVLink commands and CXL.mem memory opcodes, and Tag translation between NVLink transaction identifiers and CXL.mem Tags. The computer may be implemented as a discrete component, as a chiplet within an IC package, as an IP block within a processor, or may be integrated into an active cable or an NVLink switch. The translation may enable NVLink-coupled accelerators to access CXL memory resources for GPU memory disaggregation, capacity expansion, AI model parameter storage, key-value (KV) cache offloading, and other memory-intensive AI workloads.

In various implementations, a method comprising: receiving, by a computer from a first entity via a first interface that communicates according to an NVLink-based protocol, an NVLink-based request comprising a first physical address associated with a first address space; translating, by the computer, the first physical address to a second physical address associated with a second address space; generating, by the computer, a CXL.mem Master-to-Subordinate (M2S) request comprising a read-class memory opcode and the second physical address, wherein CXL denotes Compute Express Link; sending, by the computer via a second interface, the CXL.mem M2S request to a second entity; receiving, by the computer from the second entity, a CXL.mem Subordinate-to-Master Data Response with Status (S2M DRS) comprising data; and sending, by the computer to the first entity, an NVLink-based response comprising the data. The computer may translate the NVLink-based request by terminating the NVLink transaction and initiating a corresponding CXL.mem transaction. For example, the read-class memory opcode may include MemRd, MemRdData, or other read-class opcodes defined by CXL.mem. The address translation may be implemented utilizing lookup tables, page tables, base-and-offset calculations, or programmable translation functions. The computer may translate requests initiated from the NVLink-based domain to the CXL domain, may translate requests initiated from the CXL domain to the NVLink-based domain, or may translate requests initiated from both domains.

In some implementations of the method, the NVLink-based request is associated with a data payload size exceeding a maximum CXL.mem data payload size, and wherein generating the CXL.mem M2S request comprises generating CXL.mem M2S requests corresponding to the NVLink-based request. For example, an NVLink-based read request for 256 Bytes of data may be translated to four CXL.mem M2S requests, each targeting a 64-Byte cacheline. The computer may generate the CXL.mem M2S requests with sequential or non-sequential addresses derived from the first physical address.

In some implementations, the method further comprises accumulating data from CXL.mem S2M DRS responses corresponding to the CXL.mem M2S requests before sending the NVLink-based response to the first entity. The computer may buffer partial data from individual S2M DRS responses and assemble the complete data payload before generating the NVLink-based response. The S2M DRS responses may arrive out of order, and the computer may utilize Tag mappings to associate each response with the corresponding CXL.mem M2S request.

In some implementations, the method further comprises maintaining, by the computer, a mapping between a first Tag associated with the NVLink-based request and a second Tag associated with the CXL.mem M2S request, and utilizing the mapping to associate the CXL.mem S2M DRS with the NVLink-based request. The mapping may be stored in a tracker entry, a translation table, or a content-addressable memory. The first Tag may include an NVLink Tag or TransactionID, and the second Tag may be a CXL.mem Tag allocated from a Tag space utilized by the computer toward the second entity.

In some implementations, the method further comprises generating, by the computer, a second CXL.mem M2S request comprising a MemSpecRd opcode and a third physical address; and sending the second CXL.mem M2S request to the second entity. The computer may generate speculative read requests to prefetch data from the second entity before, or without, the first entity explicitly requesting it. The speculative reads may reduce read latency when the second entity exhibits long access times, such as when accessing slow memory media or remote memory resources over a fabric.

In some implementations of the method, the first address space comprises an NVLink-based network address space or a GPU physical address space, and the second address space comprises a Host Physical Address (HPA) space; and wherein the first entity comprises a GPU, an accelerator, or an NVLink switch, and the second entity comprises a CXL device, a CXL memory expander, or a CXL memory pool. The NVLink-based network address space may be utilized for routing NVLink requests across the NVLink fabric. The HPA space may be utilized by a CXL host or CXL device for memory access operations. The address translation may accommodate differences in size, base addresses, or memory layouts between the address spaces.

In some implementations of the method, the CXL.mem S2M DRS further comprises a Poison indication, and the NVLink-based response further comprises an error indication translated from the Poison indication. The Poison indication in CXL.mem S2M DRS may signal that the data contains an error. The computer may translate the Poison indication to an equivalent error indication in the NVLink-based response to propagate the error status to the first entity.

In some implementations, the method further comprises receiving, from the first entity via the first interface, an NVLink-based write request comprising write data; generating, by the computer, a CXL.mem Master-to-Subordinate Request with Data (M2S RwD) comprising MemWr* and the write data; sending the CXL.mem M2S RwD to the second entity via the second interface; receiving, from the second entity, a CXL.mem Subordinate-to-Master No Data Response (S2M NDR); and sending an NVLink-based write response to the first entity. For example, MemWr* may include MemWr, MemWrPtl, or other memory write opcode variants defined by CXL.mem. The write data may be transferred from the NVLink domain to the CXL.mem domain with optional byte enable manipulation when the write is partial. The S2M NDR may include a Cmp opcode indicating completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to an NVLink-based protocol and a second interface configured to communicate according to CXL, with a computer coupled between the interfaces. The computer may be implemented in various form factors, such as an IC package conforming to a retimer BGA specification, an NVLink Fusion chiplet within a processor IC package, a discrete bridge device, or a component integrated into an active cable or an NVLink switch. The system may include optional NVLink switches and CXL switches to support multi-entity topologies. The computer may translate between physical address spaces and between NVLink-based requests and CXL.mem M2S requests, enabling NVLink-coupled entities to access CXL memory resources.

In various implementations, a system comprising: a first interface configured to communicate according to an NVLink-based protocol with a first entity; a second interface configured to communicate according to Compute Express Link (CXL) with a second entity; and a computer coupled between the first and second interfaces, configured to: translate physical addresses associated with the NVLink-based protocol to physical addresses associated with CXL; and translate between NVLink-based requests received via the first interface and CXL.mem Master-to-Subordinate (M2S) requests transmitted via the second interface. The computer may further translate CXL.mem S2M responses received via the second interface to NVLink-based responses transmitted via the first interface. The computer may include logic for address translation, Tag management, protocol conversion, and transaction tracking. The system may be deployed in datacenters, HPC environments, or AI training and inference clusters to enable NVLink-coupled accelerators to access CXL-attached memory resources such as CXL memory expanders or CXL memory pools.

In some implementations of the system, the computer is packaged in an integrated circuit (IC) package comprising input/output (I/O) connection points arranged according to a retimer ball grid array (BGA) specification. The retimer BGA form factor may enable the computer to be deployed in existing retimer sockets within server platforms, optionally facilitating adoption without requiring board-level redesign.

In some implementations, the system further comprises at least one of: an NVLink switch coupled between the first interface and the first entity, the NVLink switch configured to route NVLink-based requests from NVLink entities to the first interface; or a CXL switch coupled between the second interface and the second entity, the CXL switch configured to route CXL.mem M2S requests to CXL devices or CXL memory pools. The NVLink switch may be an NVSwitch that aggregates traffic from accelerators/GPUs toward the computer. The CXL switch may enable the computer to access multiple CXL memory devices or memory pools via a CXL interface, expanding the addressable memory capacity.

In some implementations of the system, the computer comprises an NVLink Fusion chiplet within an integrated circuit (IC) package of a processor, the NVLink Fusion chiplet comprising the first interface and coupled to the processor via a die-to-die (D2D) interface, the D2D interface utilizing a Universal Chiplet Interconnect Express (UCIe) PHY or a proprietary chip-to-chip PHY. The NVLink Fusion chiplet may enable integration of NVLink connectivity into processors that may not have native NVLink support. The D2D interface may couple the chiplet to a coherent interconnect within the processor, such as an on-chip ring or mesh interconnect.

In some implementations of the system, the NVLink-based protocol and CXL are associated with a same physical address space, the same physical address space comprising a global address space, a pod address space, or a fabric address space. When both protocols are associated with the same physical address space, the computer may perform address translations between addresses within the same space, such as range adjustments or offset calculations, rather than translations between fundamentally different address spaces.

In some implementations, a computer may translate CXL.mem requests to NVLink-based requests, enabling CXL hosts or CPUs to access memory residing on an NVLink fabric via NVLink-coupled entities such as accelerators/GPUs. NVLink provides a distributed memory model where GPUs may access memory via other GPUs. This translation may provide a CXL.mem bridge or gateway for non-NVLink compute elements, such as CPUs, to access memory on the NVLink fabric. The computer may be implemented as a discrete component, integrated into an active cable, or included in an NVLink switch.

In various implementations, a method comprising: receiving, by a computer from a first entity via a first interface that communicates according to Compute Express Link (CXL), a CXL.mem Master-to-Subordinate (M2S) request comprising a read-class memory opcode and a first physical address associated with a first address space; translating, by the computer, the first physical address to a second physical address associated with a second address space; generating, by the computer, an NVLink-based request comprising the second physical address; sending, by the computer via a second interface that communicates according to an NVLink-based protocol, the NVLink-based request to a second entity; receiving, by the computer from the second entity, an NVLink-based response comprising data; and generating, by the computer, a CXL.mem Subordinate-to-Master Data Response with Status (S2M DRS) comprising the data, and sending the CXL.mem S2M DRS to the first entity. The computer may translate the CXL.mem M2S request by terminating the CXL.mem transaction and initiating a corresponding NVLink transaction. The read-class memory opcode in the CXL.mem M2S request may include opcodes such as MemRd, MemRdData, or MemSpecRd. The computer may translate the HPA from the CXL.mem M2S request to an NVLink network address utilized for routing the NVLink request to its destination on the NVLink fabric. The CXL.mem S2M DRS may carry a MemData opcode and the data retrieved from the second entity.

In some implementations, the method further comprises maintaining, by the computer, a mapping between a first Tag associated with the CXL.mem M2S request and a second Tag associated with the NVLink-based request, and utilizing the mapping to associate the NVLink-based response with the CXL.mem M2S request. Upon receiving the NVLink-based response, the computer may utilize the second Tag to retrieve the first Tag from the mapping and include the first Tag in the CXL.mem S2M DRS for transaction completion at the first entity.

In some implementations of the method, the first address space comprises a Host Physical Address (HPA) space, and the second address space comprises an NVLink-based network address space; and wherein the NVLink-based request further comprises a DestinationID derived from the first physical address, the DestinationID identifying a target entity on an NVLink fabric coupled to the second interface. The computer may derive the DestinationID from the translated address, from a routing table, or from address-range-to-destination mappings. The DestinationID may be utilized for routing the NVLink request through NVLink switches to the target entity on the NVLink fabric.

In some implementations of the method, the first entity comprises a CXL host or a CPU, and the second entity comprises a GPU, an NVLink switch, or an accelerator; and wherein the NVLink-based response comprises data retrieved from a memory accessible via the second entity on an NVLink fabric. The translation may enable CPUs to access GPU-attached memory, such as HBM and/or High-Bandwidth Flash (HBF), via the CXL.mem-to-NVLink bridge, facilitating scenarios where CPUs participate alongside NVLink GPUs in AI inference or training workloads.

In some implementations, the method further comprises receiving, from the second entity, a second NVLink-based response that does not carry data; and generating a CXL.mem Subordinate-to-Master No Data Response (S2M NDR) based on the second NVLink-based response, and sending the CXL.mem S2M NDR to the first entity. The S2M NDR may carry a Cmp opcode to indicate completion of a write or invalidation operation. The computer may translate NVLink completion indications to the corresponding CXL.mem S2M NDR opcode.

In some implementations, the method further comprises receiving, from the first entity via the first interface, a CXL.mem Master-to-Subordinate Request with Data (M2S RwD) comprising MemWr* and write data; generating, by the computer, an NVLink-based write request comprising the write data; sending the NVLink-based write request to the second entity via the second interface; receiving, from the second entity, an NVLink-based write response; and generating a CXL.mem Subordinate-to-Master No Data Response (S2M NDR), and sending the CXL.mem S2M NDR to the first entity. MemWr* may include MemWr, MemWrPtl, or other memory write opcode variants. The computer may translate the CXL.mem write data and byte enables to corresponding NVLink write request formats. The S2M NDR may be sent after the NVLink-based write response is received, or may be sent before the NVLink write completes as an early completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to CXL and a second interface configured to communicate according to an NVLink-based protocol, with a computer coupled between the interfaces to translate CXL.mem M2S requests to NVLink-based requests. The computer may be integrated into an active cable, included in an NVLink switch, or implemented as a discrete bridge device. The system may position the computer closer to the CXL interface for signal integrity, since CXL runs over PCIe electricals designed for shorter-reach connectivity, while NVLink may incorporate signaling compatible with longer-reach deployments.

In various implementations, a system comprising: a first interface configured to communicate according to Compute Express Link (CXL) with a first entity; a second interface configured to communicate according to an NVLink-based protocol with a second entity; and a computer coupled between the first and second interfaces, configured to: translate physical addresses associated with CXL to physical addresses associated with the NVLink-based protocol; and translate between CXL.mem Master-to-Subordinate (M2S) requests received via the first interface and NVLink-based requests transmitted via the second interface. The computer may further translate NVLink-based responses received via the second interface to CXL.mem S2M responses transmitted via the first interface. The system may enable CXL hosts or CPUs to access memory on an NVLink fabric, such as GPU-attached HBM and/or HBF, via the NVLink-based protocol. The computer may maintain transaction tracking structures for matching NVLink responses to pending CXL.mem requests.

In some implementations, the system further comprises an active cable comprising a first pluggable module coupled to the first interface, a second pluggable module coupled to the second interface, and a physical medium coupling the first and second pluggable modules; wherein the computer is integrated into the active cable and converts between CXL signaling conforming to PCIe electrical specifications at the first interface and NVLink signaling at the second interface. The physical medium may include twinaxial cable, multimode fiber, or single-mode fiber. The active cable may be implemented as an Active Optical Cable (AOC) or an Active Copper Cable (ACC). The signaling conversion within the cable may simplify system integration by presenting standard CXL and NVLink interfaces at each end.

In some implementations of the system, the second interface utilizes fewer lanes than the first interface, and wherein the NVLink-based protocol operates at a higher per-lane signaling rate than CXL, such that the second interface achieves a bandwidth comparable to the first interface utilizing the fewer lanes. The lane reduction may simplify cable design by reducing the number of copper wires or optical fibers, which may reduce cost and complexity of the interconnect while maintaining bandwidth parity between the two interfaces.

In some implementations of the system, the computer is positioned closer to the first interface than to the second interface; and wherein the first interface communicates via electrical signaling conforming to PCIe physical layer specifications designed for shorter-reach connectivity, and the second interface communicates via electrical signaling compatible with longer-reach interconnect deployments. Positioning the computer closer to the CXL interface may improve signal integrity for the shorter-reach CXL signaling, while the longer-reach NVLink signaling may tolerate the additional distance to the second entity.

In some implementations of the system, the computer is included in an NVLink switch, the NVLink switch coupled to NVLink entities via the second interface; and wherein the computer translates CXL.mem M2S requests from the first entity to NVLink-based requests directed to at least one of the NVLink entities. The NVLink switch may route the translated NVLink-based requests to the appropriate NVLink entity based on destination identifiers or address-based routing. Integrating the computer into the NVLink switch may enable a CXL host to access memory across multiple NVLink-coupled accelerators/GPUs.

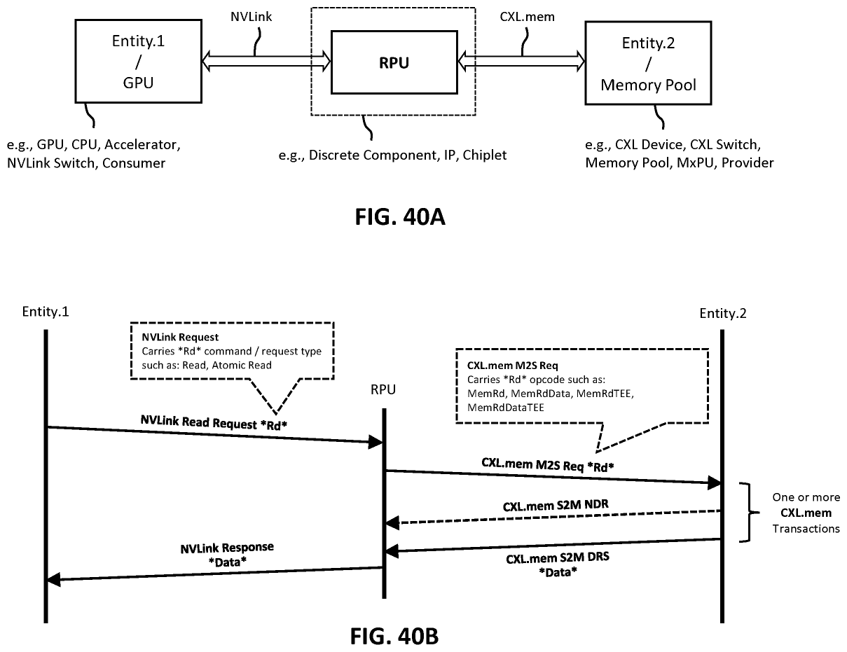

FIG. 40A illustrates an example of a system comprising an apparatus, such as an RPU, coupled between a first entity (Entity.1) and a second entity (Entity.2). The RPU may translate between NVLink-based traffic and CXL-based traffic, such as CXL.mem traffic. Entity.1, shown as a GPU, may communicate with the RPU according to an NVLink-based protocol, and may include a GPU, CPU, Accelerator, NVLink Switch (NVSwitch), or other resource consumer. Entity.2, shown as a Memory Pool, may communicate with the RPU according to CXL.mem, and may include a CXL Device, CXL Switch, Memory Pool, MxPU, or other resource provider. The RPU may be implemented as a discrete component, an IP block within a processor, or a chiplet within an IC package. Additionally or alternatively, the RPU may translate between the NVLink-based traffic and CXL.io traffic, and/or between the NVLink-based traffic and CXL.cache traffic.

FIG. 40B illustrates an example of a Transaction Flow Diagram (TFD) demonstrating an apparatus, such as an RPU, that may translate between NVLink-based traffic and CXL-based traffic, such as CXL.mem traffic. The TFD shows three entities: Entity.1 (a GPU or Consumer) on the left, the RPU in the center, and Entity.2 (a CXL Device or Provider) on the right. The first entity may send an NVLink Read Request carrying a *Rd* command or request type, such as Read or Atomic Read, to the RPU. The RPU may translate the NVLink Read Request to a CXL.mem M2S Req carrying a *Rd* opcode, such as MemRd, MemRdData, MemRdTEE, or MemRdDataTEE, and may send the CXL.mem M2S Req to the second entity. The second entity may respond with one or more CXL.mem transactions, including a CXL.mem S2M NDR and/or a CXL.mem S2M DRS carrying *Data*. The RPU may translate the CXL.mem S2M DRS to an NVLink Response carrying *Data* and send the NVLink Response to the first entity. In some examples, the RPU may translate an NVLink-based request to multiple CXL.mem request, such as when splitting an NVLink request for a data payload of 256 Bytes to CXL.mem M2S requests each carrying 64 Bytes. The RPU may accumulate data from one or more CXL.mem S2M DRS messages before sending the data via an NVLink-based response.

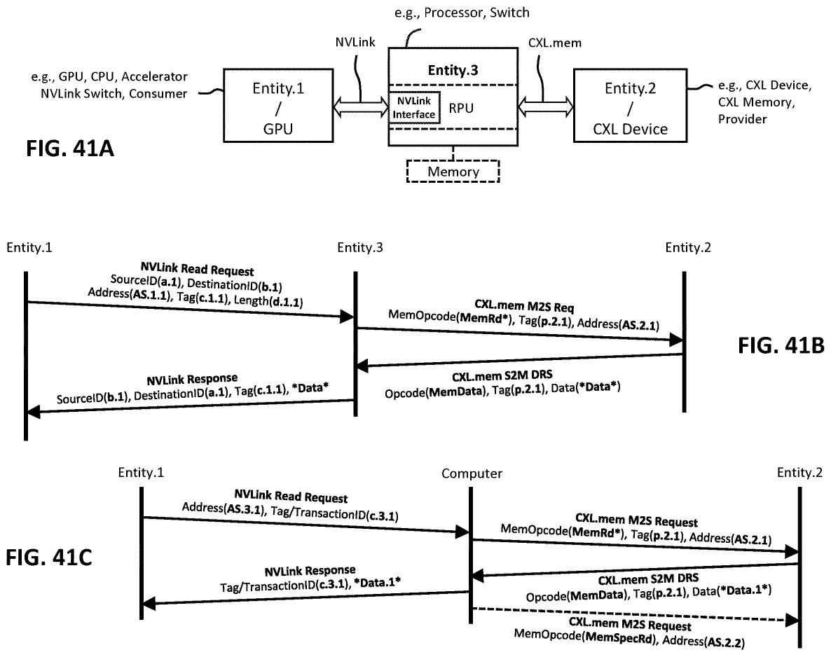

FIG. 41A illustrates an example of a system comprising a third entity (Entity.3), such as a processor or a switch. Entity.3 includes an NVLink Interface and an RPU, and includes or is coupled to an optional Memory. Entity.3 is coupled to a first entity (Entity.1), which may be a GPU, CPU, Accelerator, NVLink Switch (NVSwitch), or resource consumer, via an NVLink-based protocol. Entity.3 is further coupled to a second entity (Entity.2), which may be a CXL Device, CXL Memory, or resource provider, via CXL.mem. In some examples, messages conforming to the NVLink-based protocol may be associated with a first physical address (PA) space, such as a GPU physical address space or an NVLink-based network address space, and messages conforming to CXL.mem may be associated with a second PA space, such as HPA space. The RPU may perform address translations between addresses within the first PA space and addresses within the second PA space. In other examples, messages conforming to the NVLink-based protocol and messages conforming to CXL.mem may be associated with the same PA space, such as a global address space. Optionally, the RPU may perform further translations between the NVLink-based domain and CXL.mem domain, such as protocol translations, opcode translations, command translations, and field translations.

FIG. 41B illustrates an example of a TFD demonstrating translations performed by a third entity (Entity.3), such as a processor, a switch, or an RPU, between messages conforming to an NVLink-based protocol utilized for communicating with a first entity (Entity.1), such as a GPU, a CPU, or an accelerator, and messages conforming to CXL.mem utilized for communicating with a second entity (Entity.2), such as a CXL device or CXL memory. The first entity may initiate an NVLink Read Request comprising SourceID(a.1), DestinationID(b.1), Address(AS.1.1), Tag(c.1.1), and Length(d.1.1), wherein SourceID(a.1) may denote the NVLink interconnect address utilized by the requesting entity, and DestinationID(b.1) may denote the NVLink interconnect address utilized by the target of the NVLink request. The third entity may translate the NVLink request to a CXL.mem M2S Req comprising MemOpcode(MemRd*), Tag(p.2.1), and Address(AS.2.1), and may send the CXL.mem M2S Req to the second entity. Upon receiving a response from the second entity, which may include a CXL.mem S2M DRS comprising Opcode(MemData), Tag(p.2.1), and Data(*Data*), the third entity may translate the CXL.mem S2M DRS to an NVLink Response comprising SourceID(b.1), DestinationID(a.1), Tag(c.1.1), and *Data*. The third entity may perform further translations, such as protocol translations, opcode translations, command translations, or translations between PDUs conforming to the NVLink-based protocol and messages conforming to CXL.mem, such as translations of Tags and translations of error indications, such as poison.

FIG. 41C illustrates an example of a TFD demonstrating translations, such as address translations, optionally performed by a computer, between NVLink-based requests received from a first entity (Entity.1), which may be a CPU or a GPU, and CXL.mem requests sent to a second entity (Entity.2), which may be a CXL device. The first entity may initiate an NVLink Read Request comprising Address(AS.3.1) and Tag/TransactionID(c.3.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.mem M2S Request comprising MemOpcode(MemRd*), Tag(p.2.1), and Address(AS.2.1), and may send the CXL.mem M2S Request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to an NVLink response comprising Tag/TransactionID(c.3.1) and *Data.1*, and send the NVLink response to the first entity. The computer may further initiate speculative memory reads targeting the second entity, such as a CXL.mem M2S request comprising MemOpcode(MemSpecRd) and Address(AS.2.2), to facilitate data prefetches and potentially reduce read latency from the second entity. Optionally, the computer may utilize the speculative memory reads on behalf of the first entity. When utilizing MemSpecRd, some of the CXL.mem M2S Req fields, such as Tag, MetaField, MetaValue, and SnpType, may be reserved. In some examples, the computer may issue multiple CXL.mem reads in response to receiving an NVLink request from the first entity, such as when splitting an NVLink request for a large block of data (e.g., 256 B) to smaller CXL.mem reads (e.g., 64 B each), or when prefetching data from the second entity utilizing CXL.mem reads. The computer may translate requests or transactions initiated from the NVLink-based domain to the CXL domain, and/or may translate requests or transactions initiated from the CXL domain to the NVLink-based domain.

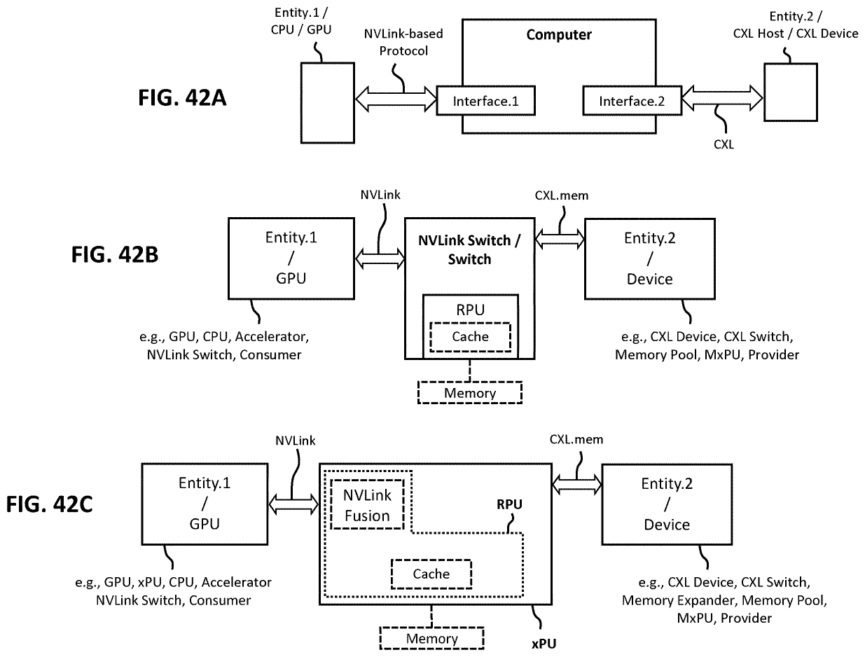

FIG. 42A illustrates an example of a system comprising a computer coupled between a first interface (Interface.1) and a second interface (Interface.2). Interface.1 may communicate according to an NVLink-based Protocol with a first entity (Entity.1), which may be a CPU or a GPU. Interface.2 may communicate according to CXL with a second entity (Entity.2), which may be a CXL host or a CXL device. The computer may extract addresses from requests received via the first interface, wherein these addresses may refer to a first address space, such as an NVLink-based address space, an NVLink-based network address space, or a GPU address space utilized by the first entity. The computer may further translate these addresses and generate requests carrying the translated addresses for transmission via the second interface, wherein the translated addresses may refer to a second address space utilized by the second entity. In other examples, the first address space and the second address space may be associated with the same address space, such as a common address space, a global address space, a pod address space, or a fabric address space. The computer may be implemented in an IC package having high-speed differential I/O balls positioned according to a ball grid array layout defined by a retimer specification. Optional switch(es), such as NVLink switches, may be positioned between the first interface and the first entity. Similarly, optional switch(es), such as CXL switches, may be positioned between the second interface and the second entity.

FIG. 42B illustrates an example of a system comprising an NVLink Switch, or Switch that includes an RPU and a Cache. The switch is coupled to a first entity (Entity.1), shown as a GPU, via an NVLink-based protocol, and to a second entity (Entity.2), shown as a Device, via CXL.mem. Entity.1 may be a GPU, CPU, Accelerator, NVLink Switch, or Consumer. Entity.2 may be a CXL Device, CXL Switch, Memory Pool, MxPU, or Provider. The switch may further be coupled to a Memory. The RPU within the switch may translate between NVLink-based requests received from the first entity and CXL.mem M2S requests transmitted to the second entity. The Cache within the switch may store data for reducing latency or accumulating data from multiple CXL.mem responses.

FIG. 42C illustrates an example of a system comprising a processor, such as an xPU, that includes an RPU that may include an NVLink Fusion chiplet or IP block. The RPU may further include a Cache, and may be coupled to a Memory. The RPU may be coupled, via the NVLink Fusion component, to a first entity (Entity.1) that may be a GPU, xPU, CPU, Accelerator, NVLink Switch, or Consumer. The RPU is coupled via CXL.mem to a second entity (Entity.2), shown as a Device. Entity.2 may be a CXL Device, CXL Switch, Memory Expander, Memory Pool, MxPU, or Provider. The NVLink Fusion chiplet may include the NVLink interface and may be part of the RPU, such that protocol translation between NVLink-based traffic and CXL.mem traffic may be performed within the NVLink Fusion chiplet. The NVLink Fusion chiplet may also include an NVLink PHY. In other examples, the NVLink interface and the RPU may be implemented as functional blocks on the same die with the xPU, or split between silicon dies or chiplets inside the IC package of the xPU.

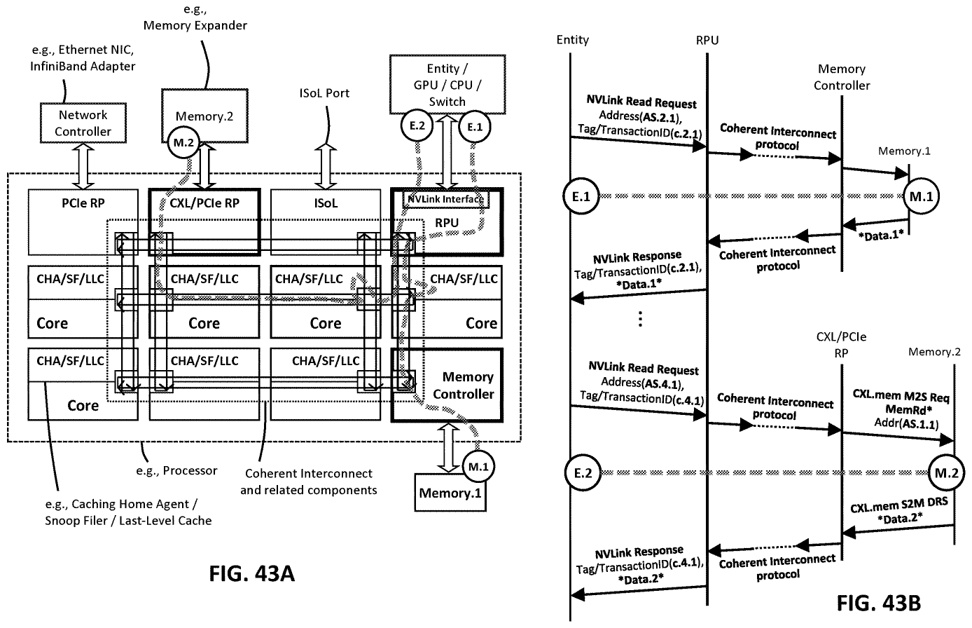

FIG. 43A illustrates an example of a system comprising a processor including a coherent interconnect, which may enable an external entity, such as a GPU, CPU, or Switch, to access memory resources mapped to an address space utilized by the coherent interconnect, such as via one or more of the two illustrated paths denoted as (E.1)-(M.1) and (E.2)-(M.2). The processor may include processing cores, and coherent interconnect, and related components, such as Caching Home Agent/Snoop Filter/Last-Level Cache (CHA/SF/LLC) slices. The processor may further include a PCIe RP coupled to a Network Controller (e.g., Ethernet NIC, InfiniBand Adapter), a CXL/PCIe RP coupled to a second memory (Memory.2, such as a Memory Expander), a memory controller coupled to a first memory (Memory.1), such as DRAM, and an ISoL port (e.g., utilizing NVIDIA NVLink-C2C, ARM CHI C2C, or Intel Coherent Processor Interconnect Protocol (ICPIP)). The processor includes an RPU coupled to an NVLink interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL/PCIe RP, such as over path (E.2)-(M.2). The illustrated RPU may be coupled to the coherent interconnect, and may translate between the NVLink-based protocol and a protocol utilized by the coherent interconnect. The processor may be implemented as a monolithic die, as chiplets within an IC package, or as components on a board, and may utilize a mesh-based coherent interconnect, or other types of coherent interconnects such as a ring, a crossbar, or a Network on Chip (NoC).

FIG. 43B illustrates an example of a TFD demonstrating two NVLink requests, such as NVLink read requests, received from an entity, such as a GPU or a CPU, processed by an RPU and forwarded, possibly using a protocol utilized by a coherent interconnect of a processor, to different memories that may be mapped to an address space utilized by the coherent interconnect. The paths from the RPU to the different memories may traverse other components, such as CHA/SF/LLC slices, memory controllers, or in other examples a home agent or a home node, optionally for resolving coherency. The RPU may perform physical address translations between first physical addresses, such as from GPU physical addresses or NVLink-based network addresses that may be carried in the NVLink requests, and second physical addresses, such as Host Physical Addresses (HPAs), which may refer to an address space utilized by the coherent interconnect, wherein the physical address translations may enable the entity to access the processor's memories. The processor may have multiple memory resources, such as first memory (Memory.1), which may be DRAM coupled to a memory controller of the processor, and/or second memory (Memory.2), which may be a CXL memory expander coupled to a CXL/PCIe RP of the processor. The RPU may further translate between NVLink-based requests and requests based on a protocol utilized by the coherent interconnect, and send the translated requests to the coherent interconnect, requesting read from memory. In some examples, the requested data may be provided by a processor cache, such as by an LLC, instead of by the memory. The data may then return over the coherent interconnect to the RPU, wherein the RPU may provide the data to the requesting entity via an NVLink response.

The TFD illustrates two exemplary transactions between the entity and the RPU, (Entity/GPU/CPU / Switch), processed by an RPU and forwarded via the coherent interconnect protocol to different memories. The TFD illustrates two exemplary transactions corresponding to two distinct memory read paths denoted as (E.1)-(M.1) and (E.2)-(M.2), each associated with a different physical address mapped to different memory resources. The first exemplary transaction (E.1) includes a first NVLink Read Request comprising Address(AS.2.1) and Tag/TransactionID(c.2.1). The RPU may translate the first NVLink request and forward the translated request via the Coherent Interconnect protocol, resulting in the retrieval of *Data.1* from the first memory (Memory.1) via the Memory Controller, wherein *Data.1* may be sent to the entity via the Coherent Interconnect protocol and via the RPU with the first NVLink Response comprising Tag/TransactionID(c.2.1) and *Data.1*.

The second exemplary transaction (E.2) includes a second NVLink Read Request comprising Address(AS.4.1) and Tag/TransactionID(c.4.1). The RPU may translate the second NVLink read request and may further translate the physical address (AS.4.1) carried in the second NVLink read request to a translated physical address (AS.1.1) which may refer to an address space utilized by the coherent interconnect. The RPU may forward the translated request, that may include the translated physical address (AS.1.1), via the coherent interconnect protocol, resulting in the retrieval of *Data.2* from the second memory (Memory.2) via the CXL/PCIe RP, utilizing a CXL.mem M2S request comprising MemRd* and Address(AS.1.1). The second memory (Memory.2) may respond with a CXL.mem S2M DRS comprising *Data.2*, which may be sent to the RPU via the coherent interconnect protocol. The RPU may then send *Data.2* to the entity via the second NVLink response. It is noted that the physical addresses (AS.2.1) and (AS.4.1) may refer to different memory regions within an address space, such as a GPU physical address space or an NVLink-based network address space, which may be exposed via an NVLink interface, enabling the entity to access memory resources based on the translation capabilities of the RPU.

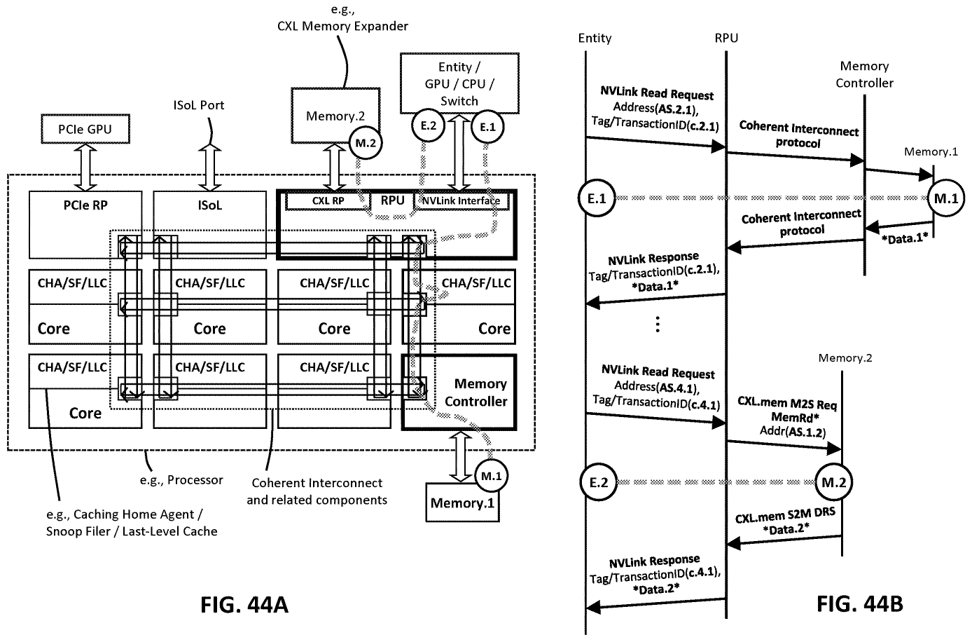

FIG. 44A illustrates an example of a system comprising a processor, including a coherent interconnect, capable of enabling an external entity, such as a GPU, CPU, or accelerator, to access memory resources mapped to an address space utilized by the coherent interconnect, such as via one or more of the two illustrated paths denoted as (E.1)-(M.1) and (E.2)-(M.2). The processor may include processing cores and CHA/SF/LLC, optionally implemented as distributed slices coupled to the coherent interconnect. The processor may further include a PCIe RP that may be coupled to a PCIe GPU, an ISoL port (e.g., utilizing NVLink-C2C, CHI C2C, or Intel Coherent Processor Interconnect Protocol (ICPIP), e.g., Intel UPI), and a Memory Controller coupled to a first memory (Memory.1). The processor includes an RPU that comprises a CXL RP, wherein the CXL RP is coupled to a second memory (Memory.2), such as a CXL Memory Expander. The RPU further includes an NVLink Interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL RP within the RPU, such as over path (E.2)-(M.2). The illustrated RPU and NVLink Interface are coupled to the coherent interconnect, and may translate between the NVLink-based protocol and a protocol utilized by the coherent interconnect. The processor may utilize a mesh-based coherent interconnect, or other types of coherent interconnects such as a ring, a crossbar, or a Network on Chip (NoC).

FIG. 44B illustrates an example of a TFD demonstrating two NVLink requests, such as NVLink read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations between first physical addresses, such as NVLink-based physical addresses, NVLink-based network addresses, or GPU physical addresses, and second physical addresses, such as Host Physical Addresses (HPAs) or System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between an NVLink-based protocol, such as a protocol utilizing an NVLink interconnect, and a protocol utilized by the coherent interconnect, wherein the RPU may send the optionally translated NVLink requests to the coherent interconnect, requesting reads from memory, such as from the first memory or from the second memory. Additionally or alternatively, the RPU may translate NVLink-based traffic to CXL-based traffic (e.g., CXL.mem), and send the translated NVLink traffic to the second memory via the CXL RP. In some examples, the requested data may be provided by a cache of the processor, such as by an LLC, instead of by the memory. The data may then return over the coherent interconnect to the RPU, wherein the RPU may provide an NVLink response to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first NVLink request comprising Address(AS.2.1) and Tag/TransactionID(c.2.1). The Tag/TransactionID may denote a Tag, a transaction Tag, a transaction identifier, or another field or set of fields carried in NVLink requests and/or NVLink responses, which may serve to associate the NVLink responses with the NVLink requests. The RPU may translate the first NVLink request and forward the translated request via the coherent interconnect protocol, resulting in the retrieval of *Data.1* from the first memory (Memory.1) via the memory controller, wherein *Data.1* may be sent to the entity via the coherent interconnect protocol and via the RPU with the first NVLink response. The second exemplary transaction corresponds to the memory read path denoted as (E.2)-(M.2), and may include a second NVLink request comprising Address(AS.4.1) and Tag/TransactionID(c.4.1). The RPU may translate the second NVLink request to a CXL.mem M2S request comprising MemRd* and translated Address(AS.1.2), wherein the RPU may send the translated request to the second memory (Memory.2) via the CXL RP. *Data.2* is retrieved from the second memory utilizing a CXL.mem S2M DRS, and sent to the RPU via the CXL RP, wherein the RPU may send *Data.2* to the entity via the second NVLink response.

Some implementations of the following method relate to processing pipelines, such as in a Fabric Processing Unit (FPU), for extracting and reconstructing CXL PDUs from carrier protocol communications received over a physical layer based on IEEE 802.3 PMA, possibly via software-defined methods, such as via protocol processing firmware executed on an FPU. A carrier protocol may refer to a protocol that transports or encapsulates other protocol data for transmission across a network or fabric, such as Ethernet, Ultra Ethernet Transport (UET), Ethernet for Scale-Up Networking (ESUN), Scale Up Ethernet (SUE), NVLink, or UALink. A passenger protocol may refer to a protocol whose data is encapsulated within the carrier protocol for transport, such as CXL.mem, CXL.cache, or CXL.io. A carrier protocol PDU refers to a protocol data unit of the carrier protocol, and a CXL PDU refers to a protocol data unit of a CXL sub-protocol. The CXL PDU may represent data indicative of a CXL message or a subset thereof, and may include fields that have been formatted, reduced, or otherwise adapted for transport within the carrier protocol PDU.

Modern datacenter architectures may benefit from transporting CXL traffic over network fabrics that utilize IEEE 802.3-based physical layers, enabling memory disaggregation, composable infrastructure, and remote memory access across rack-scale and cluster-scale deployments. When CXL PDUs are encapsulated within carrier protocol PDUs, the carrier protocol may utilize different field formats, may omit fields that are not required for transport, or may encode CXL information in carrier-specific representations. A processing pipeline within an RPU or similar processing unit may receive carrier protocol PDUs, extract encapsulated CXL information, translate fields between carrier and CXL formats, and reconstruct complete CXL PDUs that conform to the CXL specification for delivery to CXL devices or hosts. The pipeline may include stages for physical coding sublayer (PCS) processing, parsing, validity checking, stream extraction, access control, field translation, stream editing, address translation, and protocol translation, wherein different stages may be utilized depending on the carrier protocol type, the passenger protocol type, and the system configuration.

In various implementations, a method comprising: receiving, via a physical layer based on IEEE 802.3 physical medium attachment (PMA), a transmission comprising a protocol data unit (PDU) of a carrier protocol (carrier protocol PDU) encapsulating data indicative of a Compute Express Link (CXL) PDU; parsing the carrier protocol PDU to identify a passenger protocol type; extracting, from the carrier protocol PDU, fields of the CXL PDU; translating at least one extracted field from a format associated with the carrier protocol PDU to a field conforming to a CXL specification; and reconstructing an output CXL PDU comprising the translated field and at least one additional field not present in the carrier protocol PDU. The processing pipeline may be implemented as hardware, firmware, software, or combination thereof, within an FPU, an RPU, or a similar processing unit that is coupled to the physical layer based on IEEE 802.3 PMA. The physical layer may receive transmissions from external entities such as hosts, accelerators, switches, or memory devices that communicate CXL traffic encapsulated within carrier protocol PDUs. The parsing stage may examine protocol-specific patterns or markers in the data stream to identify both the carrier protocol type and the type of CXL sub-protocol (such as CXL.mem, CXL.cache, or CXL.io) encapsulated within. The extraction stage may identify and extract fields of interest from the carrier protocol PDU, including data indicative of CXL opcodes, physical addresses, transaction identifiers, and other protocol-specific fields. The translation stage may convert one or more extracted fields from a representation or encoding utilized by the carrier protocol into a representation that conforms to the CXL specification, such as translating a carrier-specific command encoding into a CXL opcode. The reconstruction stage may assemble a complete CXL PDU by combining translated fields with additional fields that were not included in the carrier protocol PDU, such as reserved fields, validity indicators, or metadata fields that may be omitted from the carrier PDU to conserve bandwidth but are utilized by CXL devices for proper parsing and processing of the CXL request.

In some implementations of the method, the at least one additional field is reconstructed based on at least one of a configuration or a default value, and wherein the method further comprises validating access permissions based on at least one of a physical address or an opcode extracted from the CXL PDU, and blocking the output CXL PDU from further processing when the access permissions are not satisfied. The reconstruction of fields not present in the carrier protocol PDU may utilize configuration parameters stored in registers or memory of the RPU, or may utilize default values defined by the CXL specification or by system policy. For example, a Valid field may be reconstructed as valid based on the presence of a well-formed carrier protocol PDU, while Reserved (RSVD) fields may be reconstructed utilizing configured default values such as zero. The access control validation may be performed by an Access Control List (ACL) module within the processing pipeline that evaluates extracted CXL fields against access policies. The ACL module may examine physical addresses to determine whether the requesting entity is permitted to access the targeted memory region, and may examine opcodes to determine whether the requested operation type is permitted. When access permissions are not satisfied, the pipeline may discard the CXL PDU, generate an error response, or log the access violation. This access control may operate at the CXL protocol level rather than at the carrier protocol level, enabling fine-grained memory access control that is specific to the CXL address space and operation types.

In some implementations, the method further comprises translating a physical address extracted from the CXL PDU from a first physical address space to a second physical address space. The address translation may be performed by an Address Translator stage within the processing pipeline, downstream of the field extraction and translation stages. The first physical address space may correspond to a Host Physical Address (HPA) space utilized by the external entity that originated the CXL request, while the second physical address space may correspond to an HPA space utilized by a local host or a Device Physical Address (DPA) space utilized by a local CXL device. The translation may be implemented utilizing lookup tables, page tables, hash tables, base-and-offset calculations, or programmable translation functions. The address translation may enable entities utilizing different address spaces to communicate via CXL over the carrier protocol fabric, without requiring the entities to share a common address space or address mapping.

In some implementations, the method further comprises translating the output CXL PDU from a first CXL channel to a second CXL channel, wherein the first CXL channel and the second CXL channel are different CXL sub-protocols. The protocol translation may be performed by a Protocol Translator stage within the processing pipeline, downstream of the stream editing and address translation stages. The first CXL channel may be CXL.mem and the second CXL channel may be CXL.cache, or vice versa, depending on the system configuration and the types of entities involved. For example, the Protocol Translator may translate a CXL.mem M2S request message into a CXL.cache H2D request message when the receiving entity is a CXL host that issues snoop requests to a local CXL device. Conversely, the Protocol Translator may translate a CXL.cache H2D request message into a CXL.mem M2S request message when the receiving entity is a memory device that processes memory access requests. The cross-channel translation may enable heterogeneous CXL deployments where different entities utilize different CXL sub-protocols while communicating through a common carrier protocol fabric.

In some implementations of the method, the carrier protocol comprises at least one of Ethernet, Ultra Ethernet Transport (UET), Ethernet for Scale-Up Networking (ESUN), Scale Up Ethernet (SUE), NVLink, or UALink, and wherein the physical layer based on IEEE 802.3 PMA operates at a lane rate of at least 100 Gbps. Different carrier protocols may utilize the IEEE 802.3 PMA in different ways while maintaining compatibility with the PMA interface specifications. Ethernet may utilize standard Ethernet framing with MAC-layer processing, while UET, ESUN, and SUE may utilize optimized framing adapted for high-performance computing and artificial intelligence workloads. UALink may utilize the IEEE 802.3 PMA as its physical layer while employing UALink-specific data link and transport layer protocols. The lane rate of at least 100 Gbps may correspond to IEEE 802.3 PMA specifications such as 100 GBASE or higher rates, enabling sufficient bandwidth for CXL memory traffic that may involve high-frequency, low-latency transactions. Higher lane rates, such as 200 Gbps or 400 Gbps per lane, may further increase the available bandwidth for encapsulated CXL traffic.

In some implementations, the method further comprises receiving a CXL response PDU, removing at least one field from the CXL response PDU, encapsulating remaining fields of the CXL response PDU within a second carrier protocol PDU, and transmitting the second carrier protocol PDU via the physical layer based on IEEE 802.3 PMA. The return path may operate as a reverse pipeline that processes CXL responses generated by local CXL devices or hosts for transmission to remote entities via the carrier protocol fabric. The removal of fields from the CXL response PDU may reduce bandwidth consumption by omitting fields that can be reconstructed at the receiving end, such as Valid fields, Reserved fields, or metadata fields that carry default or derivable values. The encapsulation may include generating carrier protocol headers and trailers appropriate for the carrier protocol type being utilized. The return path processing may mirror the inbound processing pipeline stages in reverse order, with the Stream Editor stripping unnecessary fields, the Field Translator converting CXL-specific field representations into carrier-specific formats, and the PCS performing encoding operations such as 64 B/66 B encoding, scrambling, and FEC encoding for transmission via the IEEE 802.3 PMA.

In some implementations of the method, the CXL PDU comprises a CXL.mem Master-to-Subordinate (M2S) PDU, the extracted fields comprise a MemOpcode field and an Address field, and the at least one additional field not present in the carrier protocol PDU comprises at least one of a Valid field, a Reserved (RSVD) field, a MetaField field, a SnpType field, or a Traffic Class (TC) field. The CXL.mem M2S PDU may refer to a Master-to-Subordinate message from either the M2S Req channel, which carries requests without data such as reads and invalidations, or the M2S RwD channel, which carries requests with data such as writes. Both channel types may include a MemOpcode field and an Address field as the primary extracted fields, along with other fields such as Valid, MetaField, SnpType, Tag, TC, and RSVD. When the carrier protocol PDU encapsulates CXL.mem information, the MemOpcode and Address fields may be included because they carry the operation type and target address that are needed for routing and processing. Other fields, such as Valid, RSVD, MetaField, SnpType, and TC, may be omitted from the carrier protocol PDU when their values can be reconstructed. The Valid field may be reconstructed based on the presence of a well-formed carrier protocol PDU. The RSVD field may be reconstructed utilizing a default value of zero. The MetaField, SnpType, and TC fields may be reconstructed based on RPU configuration parameters, system policies, or context derived from the MemOpcode and other extracted fields. The Tag field, which provides a transaction identifier for response correlation, may also be extracted from the carrier protocol PDU.

In some implementations of the method, the translating comprises translating a command field of the carrier protocol PDU to the MemOpcode field conforming to the CXL specification, the MemOpcode field comprising at least one of MemRd, MemRdData, MemWr, MemWrPtl, or MemInv. The carrier protocol may encode memory operation types utilizing a carrier-specific command field that differs in format, bit width, or encoding from the CXL MemOpcode field. The Field Translator may map carrier-specific command encodings to CXL MemOpcode values such as MemRd for memory read operations, MemRdData for memory read operations with specific metadata handling, MemWr for full cacheline write operations, MemWrPtl for partial cacheline write operations, or MemInv for invalidation operations. The mapping may be configurable, enabling the same processing pipeline to support different carrier protocols that utilize different command encoding schemes.

In some implementations of the method, the CXL PDU comprises a CXL.cache Host-to-Device (H2D) request PDU, the extracted fields comprise an Opcode field, an Address field, and a Unique Queue ID (UQID) field, and the at least one additional field not present in the carrier protocol PDU comprises at least one of a Valid field or a Reserved (RSVD) field. The CXL.cache H2D request PDU may include fields as defined by the CXL specification, including Valid, Opcode, Address, UQID, and RSVD fields. The Opcode field may carry H2D request opcodes such as SnpData, SnpInv, or SnpCur that indicate the type of snoop operation. The Address field may carry the physical address of the cacheline targeted by the snoop operation. The UQID field may identify the host entry that originated the request, enabling response routing. The Valid and RSVD fields may be omitted from the carrier protocol PDU because their values can be reconstructed: the Valid field based on PDU presence, and the RSVD field utilizing default values. Different flit modes defined by the CXL specification (such as 68 B flit, 256 B flit, or PBR flit) may include different sets of additional fields such as CacheID, SPID, and DPID, which may also be subject to extraction or reconstruction depending on the flit mode negotiated for the target CXL link.

In some implementations of the method, the CXL PDU comprises a CXL.cache Device-to-Host (D2H) request PDU, the extracted fields comprise an Opcode field, a command queue identifier (CQID) field, and an Address field, and the at least one additional field not present in the carrier protocol PDU comprises at least one of a Valid field, a NonTemporal (NT) field, or a Reserved (RSVD) field. The CXL.cache D2H request PDU may include fields as defined by the CXL specification, including Valid, Opcode, CQID, NT, Address, and RSVD fields. The D2H request direction carries requests from a device toward a host, with D2H request opcodes such as RdShared, RdOwn, RdCurr, RdOwnNoData, CLFlush, or other D2H request opcodes. The CQID field may identify the device tracker entry associated with the request. The NT (NonTemporal) field may provide a caching hint indicating that the requested data is not expected to be reused in the near term, allowing the host to avoid caching the data in a preferred cache position or to treat it as non-cacheable. The RSVD field in D2H requests may be larger than in H2D requests, and the NT field may carry a default value that can be reconstructed based on system configuration. The field set for D2H requests differs from H2D requests in both the transaction identifier (CQID versus UQID) and the available fields (NT versus CacheID in certain flit modes), which may result in different extraction and reconstruction behavior for each direction.

In some implementations of the method, the CXL PDU comprises a CXL.io Transaction Layer Packet (TLP), the extracted fields comprise a Type field, an Address field, and a Tag field, and the translating comprises translating a command field of the carrier protocol PDU to a Fmt/Type field of the CXL.io TLP. CXL.io utilizes TLPs based on the PCIe Transaction Layer specification. The TLP header may include fields such as Fmt/Type (which encodes the packet format and transaction type), TC (Traffic Class), Attr (Attributes), EP (Error Poisoned), Length, Requester ID, Tag, and Address, among others. The Fmt and Type fields together determine the TLP type, such as Memory Read (MRd), Memory Write (MWr), Completion with Data (CplD), or Configuration Read/Write. The carrier protocol may encode the CXL.io transaction type utilizing a carrier-specific command field that differs from the PCIe Fmt/Type encoding. The Field Translator may map carrier-specific commands to appropriate Fmt/Type values. In flit mode, the Fmt field may be absorbed into the Type field, and the translation may accommodate both flit mode and non-flit mode TLP header formats. The Tag and Address fields may be extracted from the carrier protocol PDU for routing and transaction tracking, while other TLP header fields such as TC, Attr, and EP may be omitted from the carrier PDU and reconstructed utilizing default values or configuration parameters.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a physical layer based on IEEE 802.3 physical medium attachment (PMA) configured to receive a transmission comprising a protocol data unit (PDU) of a carrier protocol (carrier protocol PDU) encapsulating data indicative of a Compute Express Link (CXL) PDU; and a processing unit coupled to the physical layer, the processing unit configured to: parse the carrier protocol PDU to identify a passenger protocol type; extract, from the carrier protocol PDU, fields of the CXL PDU; translate at least one extracted field from a format associated with the carrier protocol PDU to a field conforming to a CXL specification; and reconstruct an output CXL PDU comprising the translated field and at least one additional field not present in the carrier protocol PDU. The apparatus may be implemented as an integrated circuit, an SoC, an FPGA, a SmartNIC, a data processing unit (DPU), a Fabric Processing Unit (FPU), or any other suitable hardware platform that includes a physical layer based on IEEE 802.3 PMA and a processing unit capable of performing the described operations. The processing unit may include dedicated hardware logic, a programmable processor, or a combination thereof. The processing unit may implement the pipeline stages, including parsing, extraction, translation, and reconstruction, as hardware pipeline stages that process carrier protocol PDUs at line rate, or as software-driven stages that provide configurability and flexibility. The apparatus may include physical layers based on IEEE 802.3 PMA for communicating with external entities, and may include processing units or pipeline instances for parallel processing of carrier protocol PDUs.

Some implementations of the following method further relate to bandwidth-optimized transport of CXL protocol data over carrier protocols utilizing a physical layer based on IEEE 802.3 PMA. When CXL PDUs are transported over carrier protocol fabrics, the bandwidth available for encapsulated CXL traffic may be constrained by the carrier protocol overhead, the physical layer data rate, and the number of concurrent transactions. Bandwidth optimization may be achieved by encapsulating a subset of the CXL PDU fields within the carrier protocol PDU, omitting fields that can be reconstructed at the receiving end. Different levels of field inclusion may be utilized depending on available bandwidth, quality-of-service requirements, and/or system configuration.

For example, a CXL.mem M2S request may include fields such as Valid, MemOpcode, MetaField, SnpType, Address, Tag, TC, and RSVD. A complete format may include all fields, while a reduced format may omit the Valid and RSVD fields, and an essential format may include the MemOpcode, Address, and Tag fields. The omitted fields may be reconstructed by the receiving processing unit based on configuration parameters, default values, or context derived from the received fields. Similar bandwidth optimization may be applied to CXL.cache and CXL.io PDUs by identifying fields that can be omitted and reconstructed.

In various implementations, a method comprising: receiving, via a physical layer based on IEEE 802.3 physical medium attachment (PMA), a protocol data unit (PDU) of a carrier protocol (carrier protocol PDU) encapsulating a subset of fields of a Compute Express Link (CXL) PDU, the subset excluding at least one field defined by a CXL specification for the CXL PDU; extracting the subset of fields from the carrier protocol PDU; reconstructing the at least one excluded field; and generating a CXL request comprising the extracted subset of fields and the at least one reconstructed field. The method may enable bandwidth-efficient transport of CXL traffic over carrier protocol fabrics by transmitting those CXL PDU fields that cannot be derived or reconstructed at the receiving end. The sender may analyze the CXL PDU and determine which fields carry information that is not derivable from other fields or from system configuration, and may include those fields in the carrier protocol PDU. The receiver may extract the included fields, reconstruct the excluded fields, and assemble a complete CXL request that conforms to the CXL specification. The bandwidth savings may be proportional to the number and size of excluded fields, and may vary depending on the CXL sub-protocol, the message type, and the level of field inclusion selected. For CXL.mem M2S requests, the savings may range from omitting a few bits (Valid and RSVD) to omitting several fields (MetaField, SnpType, TC, Valid, RSVD), depending on the selected format level.

In some implementations of the method, the at least one excluded field is reconstructed based on at least one of a configuration, a default value, or context derived from the subset of fields. Different reconstruction methods may be utilized for different excluded fields depending on the nature of the field and the information available. Configuration-based reconstruction may utilize values stored in registers or memory of the processing unit, such as system-wide settings for Traffic Class or metadata policies. Default-value reconstruction may utilize values defined by the CXL specification or by system convention, such as zero for Reserved fields or a valid indication for the Valid field when the carrier protocol PDU is well-formed. Context-based reconstruction may derive field values from other extracted fields, such as inferring a SnpType value from the MemOpcode when certain operation types imply specific snoop behaviors. The reconstruction method for each excluded field may be independently configurable, enabling the system to adapt to different deployment scenarios and CXL specification revisions.

In some implementations, the method further comprises receiving a CXL response, excluding at least one field of the CXL response defined by the CXL specification, and transmitting, via the physical layer based on IEEE 802.3 PMA, a carrier protocol PDU encapsulating a subset of fields of the CXL response excluding the at least one excluded field of the CXL response. The bandwidth optimization may be applied symmetrically on both the request and response paths. CXL responses, such as S2M No-Data Response (NDR) messages or S2M Data Response (DRS) messages for CXL.mem, or D2H response and D2H Data messages for CXL.cache, may also include fields that can be omitted for transport. The processing unit may analyze the CXL response, identify fields that can be reconstructed by the remote receiving entity, exclude those fields, and encapsulate the remaining fields within a carrier protocol PDU for transmission. The level of field reduction on the response path may be the same as or different from the level utilized on the request path, depending on the specific response message type and the fields available for reconstruction.

In some implementations, the method further comprises receiving the carrier protocol PDU by a remote processing unit, extracting the subset of fields of the CXL response, and reconstructing the at least one excluded field of the CXL response. The remote processing unit may receive the carrier protocol PDU transmitted by the local processing unit, extract the encapsulated subset of fields of the CXL response, and reconstruct the at least one excluded field. The remote processing unit may utilize its own configuration parameters, default values, or context to reconstruct excluded response fields. The remote processing unit may be implemented within an RPU, a SmartNIC, a DPU, or any other suitable entity coupled to a physical layer based on IEEE 802.3 PMA. The configuration parameters utilized by the remote processing unit for reconstruction may be synchronized with those utilized by the local processing unit for field exclusion, either through out-of-band configuration protocols or through negotiation during connection establishment.

In some implementations of the method, the CXL PDU comprises a CXL.mem Master-to-Subordinate (M2S) request, the subset of fields comprises MemOpcode, MetaField, SnpType, Address, Tag, and TC fields, and the at least one excluded field comprises a Valid field and a Reserved (RSVD) field. The reduced format for CXL.mem M2S requests may retain the fields that carry operational semantics (MemOpcode for the operation type, MetaField and SnpType for coherency behavior, Address for the target location, Tag for transaction tracking, and TC for traffic classification) while omitting the Valid field and the Reserved field. The Valid field may be reconstructed based on the presence of a well-formed carrier protocol PDU, since the receipt of a properly framed and validated carrier protocol PDU implies that the encapsulated CXL information is valid. The Reserved field may be reconstructed utilizing a default value of zero, as reserved fields are defined by the CXL specification to be cleared by the sender and ignored by the receiver.

In some implementations of the method, the CXL PDU comprises a CXL.mem M2S request, the subset of fields comprises MemOpcode, Address, and Tag fields, and the at least one excluded field comprises a Valid field, a MetaField field, a SnpType field, a TC field, and a Reserved (RSVD) field. In one example, the essential format may include the minimum fields for basic CXL.mem operation: MemOpcode to specify the memory operation, Address to identify the target physical address, and Tag to enable transaction tracking and response correlation. The excluded fields (Valid, MetaField, SnpType, TC, and RSVD) may be reconstructed utilizing default values or configuration parameters. The MetaField may be reconstructed as No-Op when the system configuration does not utilize metadata operations, the SnpType may be reconstructed based on the MemOpcode (such as defaulting to No-Op or to a configured snoop type), and the TC may be reconstructed utilizing a configured traffic class priority. The essential format may provide the greatest bandwidth savings and may be suitable for deployments where the carrier protocol bandwidth is constrained or where the additional fields carry predictable values.

In some implementations of the method, the CXL PDU comprises a CXL.cache Host-to-Device (H2D) request, the subset of fields comprises an Opcode field, an Address field, and a UQID field, and the at least one excluded field comprises at least one of a Valid field or a Reserved (RSVD) field. The CXL.cache H2D request may include Opcode, Address, UQID, Valid, and RSVD fields in the 68 B flit format. The Opcode field may carry snoop opcodes such as SnpData, SnpInv, or SnpCur. The Address field carries the cacheline address targeted by the snoop. The UQID identifies the host entry originating the request. The Valid and RSVD fields may be omitted from the carrier protocol PDU and reconstructed. In 256 B flit or PBR flit formats, additional fields such as CacheID, SPID, and DPID may also be subject to field reduction and reconstruction, and the set of excluded fields may vary based on the negotiated flit mode.

In some implementations of the method, the CXL PDU comprises a CXL.cache Device-to-Host (D2H) request, the subset of fields comprises an Opcode field, a command queue identifier (CQID) field, and an Address field, and the at least one excluded field comprises at least one of a Valid field, a NonTemporal (NT) field, or a Reserved (RSVD) field. The CXL.cache D2H request may include Opcode, CQID, NT, Address, Valid, and RSVD fields. The D2H request carries device-initiated requests toward a host, with opcodes such as RdShared, RdOwn, RdCurr, RdOwnNoData, or CLFlush. The CQID identifies the device tracker entry for response routing. The NT field provides a caching hint indicating that the requested data is not expected to be reused in the near term, allowing the host to avoid caching the data in a preferred cache position or to treat it as non-cacheable, and may carry a default value in many configurations. The RSVD field in D2H requests may include a larger number of reserved bits compared to H2D requests, making it a suitable candidate for exclusion. The reconstruction of the NT field may utilize a configured default caching policy, while the RSVD field may be reconstructed as zero.

In some implementations of the method, the CXL PDU comprises a CXL.io Transaction Layer Packet (TLP), the subset of fields comprises a Fmt/Type field, an Address field, a Requester ID field, and a Tag field, and the at least one excluded field comprises at least one of a Traffic Class (TC) field, an Attributes (Attr) field, or a reserved field. CXL.io TLP headers may include fields such as Fmt/Type, TC, Attr, EP, Length, Requester ID, Tag, and Address, among others. The Fmt/Type fields (or the combined Type field in flit mode) determine the transaction type and packet format. The Address and Tag fields are retained for routing and transaction tracking. The Requester ID identifies the originating function. The TC field, which indicates the traffic class for quality-of-service handling, may be reconstructed utilizing a configured default traffic class. The Attr field, which includes attributes such as relaxed ordering and no-snoop hints, may be reconstructed from configuration. Reserved fields and other padding may be reconstructed utilizing zero values. The bandwidth savings from excluding these fields may be proportional to the TLP header size, which varies depending on whether the TLP utilizes 32-bit or 64-bit addressing and whether flit mode or non-flit mode is in use.

In some implementations, the method further comprises selecting between a first format comprising a first subset of fields and a second format comprising a second subset of fields based on at least one of available bandwidth, quality-of-service parameters, or a configuration setting. The processing unit may dynamically select between different field inclusion levels based on runtime conditions or system configuration. When the carrier protocol fabric has sufficient bandwidth, a complete or reduced format with more fields may be selected to minimize reconstruction overhead and maximize protocol compliance fidelity. When bandwidth is constrained, an essential format with fewer fields may be selected to maximize the number of CXL transactions that can be transported within the available bandwidth. Quality-of-service parameters may influence the selection, such as utilizing a complete format for high-priority traffic classes and a reduced format for lower-priority traffic. The selection may be performed on a per-connection basis, a per-transaction basis, or a per-time-interval basis, and may be negotiated between the sender and receiver during connection establishment or renegotiated during operation in response to changing network conditions.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a physical layer based on IEEE 802.3 physical medium attachment (PMA) configured to receive a protocol data unit (PDU) of a carrier protocol (carrier protocol PDU) encapsulating a subset of fields of a Compute Express Link (CXL) PDU, the subset excluding at least one field defined by a CXL specification for the CXL PDU; and a processing unit configured to extract the subset of fields from the carrier protocol PDU, reconstruct the at least one excluded field, and generate a CXL request comprising the extracted subset of fields and the at least one reconstructed field. The apparatus may be implemented as an RPU, a SmartNIC, a DPU, a network interface, a switch, an active cable, or any other suitable device that receives carrier protocol PDUs via a physical layer based on IEEE 802.3 PMA and processes encapsulated CXL traffic. The processing unit may include hardware logic, a programmable processor, or a combination thereof, configured to perform the extraction, reconstruction, and CXL request generation operations. The apparatus may support multiple levels of field inclusion and may be configurable to select between different levels based on system requirements. The apparatus may further include a CXL device or CXL port coupled to the processing unit for delivering the generated CXL requests to the CXL fabric.

In some implementations of the apparatus, the processing unit is configured to reconstruct the at least one excluded field based on at least one of a configuration, a default value, or context derived from the subset of fields. The processing unit may maintain configuration registers or memory structures that store reconstruction parameters for each field type and each CXL sub-protocol. The configuration parameters may be programmed during system initialization, updated during operation via management interfaces, or negotiated with remote entities during connection establishment. Default values may be defined by the CXL specification version targeted by the system, enabling automatic reconstruction without explicit configuration for fields that have specification-defined default behaviors.

In some implementations of the apparatus, the processing unit is further configured to receive a CXL response, exclude at least one field of the CXL response defined by the CXL specification, and transmit, via the physical layer based on IEEE 802.3 PMA, a carrier protocol PDU encapsulating a subset of fields of the CXL response excluding the at least one excluded field of the CXL response. The apparatus may support bidirectional bandwidth optimization by applying field reduction to both request and response directions. The processing unit may analyze outgoing CXL responses to identify fields that can be excluded for transport while maintaining the ability for the remote entity to reconstruct the complete response. The response field exclusion may be coordinated with the remote entity to facilitate proper reconstruction at the receiving end.

In some implementations of the apparatus, the processing unit is further configured to select between a first format comprising a first subset of fields and a second format comprising a second subset of fields based on at least one of available bandwidth, quality-of-service parameters, or a configuration setting. The apparatus may monitor bandwidth utilization on the carrier protocol fabric and dynamically adjust the field inclusion level to optimize performance. When bandwidth utilization is low, the apparatus may select a format with more fields to minimize reconstruction overhead. When bandwidth utilization is high or approaching congestion thresholds, the apparatus may select a format with fewer fields to reduce per-transaction bandwidth consumption and maintain throughput. The quality-of-service parameters may include priority levels, latency targets, or throughput guarantees that influence the selection of field inclusion formats for different traffic classes or transaction types.

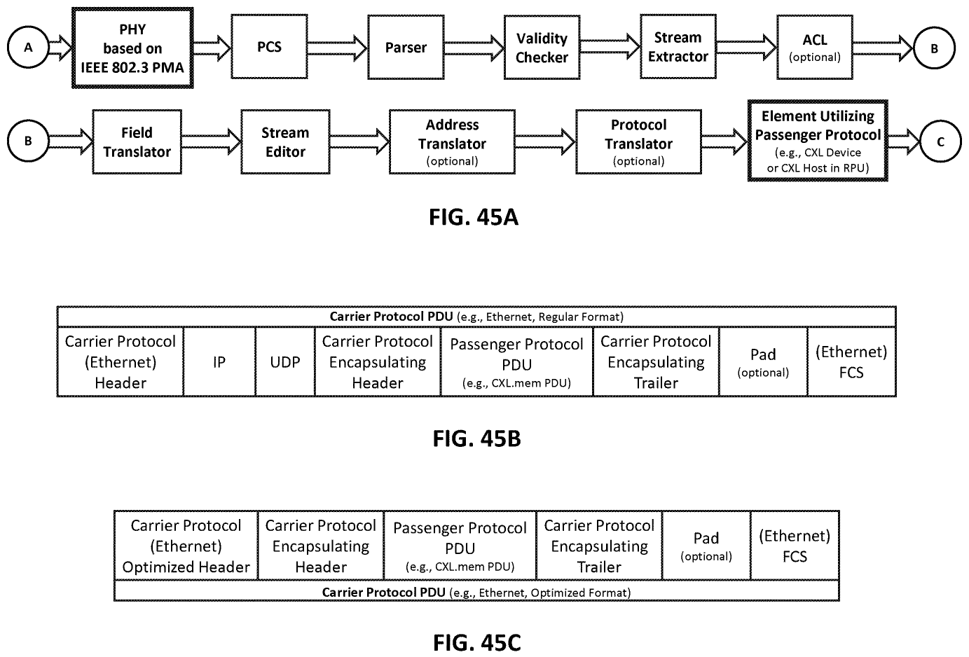

FIG. 45A illustrates an example of a processing pipeline for extracting passenger protocol messages from carrier protocol communications received over a physical layer based on IEEE 802.3 Physical Medium Attachment (PMA). The pipeline may process various carrier protocols that utilize a PMA based on IEEE 802.3, such as certain versions of Ethernet, ESUN, SUE, UALink, or NVLink, to extract encapsulated passenger protocol messages such as CXL.mem, CXL.cache, or CXL.io messages. The figure describes a transmission received by a PMA that is based on IEEE 802.3, which forwards a data stream of the carrier protocol to a Physical Coding Sublayer (PCS). The PCS may include protocol-specific processing operations that may vary based on the carrier protocol being utilized. For Ethernet examples, the PCS may perform operations such as 64 B/66 B block decoding, block framing, block synchronization, descrambling, lane deskewing, and/or forward error correction (FEC) decoding. For UALink or NVLink examples, the PCS may additionally or alternatively perform other operations specific to those protocols while maintaining compatibility with the IEEE 802.3 PMA interface.

The PCS forwards processed data to a Parser. The data may take the form of a partially-delineated stream wherein protocol boundaries have been identified but detailed field parsing has not yet been performed. The Parser may analyze the received data to identify protocol structures and extract protocol-specific information. The Parser may perform analysis operations including identification of the carrier protocol type by examining protocol-specific patterns or markers in the data stream, identification of the passenger protocol type that is encapsulated within the carrier protocol, delineation of Protocol Data Units (PDUs) of the carrier protocol (Carrier PDU) according to the specific framing rules of the identified carrier protocol (such as Ethernet framing, frame-boundary delimitation, and frame synchronization which may involve operations similar to those performed by an Ethernet MAC), and identification of locations of interest within the carrier protocol PDU such as headers, addresses, identifiers, payload sections, and other fields that may be required by subsequent stages of the processing pipeline. The Parser may add metadata fields to the processed data, such as metadata identifying protocol types and data patterns.

The Parser forwards to a Validity Checker a structured data with location information, such as an array of offsets to locations of interest in the Carrier PDU. The Validity Checker performs validation operations on the received data structure, such as validation of data stream format conformance and carrier PDU validity checks including cyclic redundancy checks (CRC) or other error detection logic specific to the carrier protocol. The Validity Checker forwards validated data structures to a Stream Extractor.

The Stream Extractor processes the validated data structures to extract passenger protocol information, such as extracting fields of interest from the Carrier PDU including data indicative of passenger protocol opcodes and physical addresses within a second physical address space utilized by the requesting entity. The Stream Extractor may identify and extract various passenger protocol fields required for message processing, regardless of the specific passenger protocol type. The Stream Extractor forwards its output to an optional Access Control List (ACL) module that may validate access permissions based on the extracted fields. The ACL feeds validated data to a Field Translator that performs field-level transformations between carrier and passenger protocol formats, such as translating fields of interest from the Carrier PDU (e.g., a command field) to fields conforming to the Passenger Protocol specifications (e.g., a CXL opcode field required for constructing a CXL request).

The Field Translator feeds transformed field data to a Stream Editor that reconstructs complete passenger protocol messages. The Stream Editor may perform several operations including reconstruction and formatting of translated fields into a PDU structure compliant with a valid Passenger Protocol PDU (Passenger PDU), such as CXL, insertion of mandatory or optional Passenger Protocol fields that may not be included in the Carrier PDU such as reserved fields of a CXL message that may be omitted from the Carrier PDU but are necessary for an element utilizing passenger protocol, such as a CXL device, to properly parse the request wherein values of omitted fields may be reconstructed based on RPU configurations and/or configurable default values, and removal of intermediate data and metadata that was collected and generated in the processing pipeline but is not part of a compliant Passenger PDU, such as a CXL request.

When no address translation or protocol translation is required, the Stream Editor forwards the Passenger PDU to an element utilizing passenger protocol, such as a CXL device within an RPU. When address translation and/or protocol translation is required, the Stream Editor forwards the Passenger PDU, such as a CXL.mem M2S Req message carrying a physical address within a second HPA space, to an optional Address Translator. The Address Translator translates physical addresses between different physical address spaces, such as translating from a second HPA space to a first HPA space, and forwards the result to an optional Protocol Translator. The Protocol Translator may perform protocol-specific translations, such as translating from a CXL.mem M2S Req message to a CXL.cache D2H Req message. The translated Passenger PDU is then forwarded to the appropriate protocol device, such as forwarding a CXL.cache D2H Req message carrying the physical address within the first HPA space to an element utilizing passenger protocol, such as a CXL host.

FIG. 45B illustrates an example of a packet structure that may be suitable for Layer 3 (L3) switching operations. L3 switching typically refers to packet forwarding based on network layer information, typically using IP addresses or similar network-layer identifiers to make routing decisions across different network segments or subnets. The illustrated packet structure shows a carrier protocol PDU in a regular format that may be processed by standard networking equipment while carrying an encapsulated passenger protocol PDU. The packet structure includes a Carrier Protocol Header, shown as an Ethernet header, which may contain standard Ethernet fields such as destination MAC address, source MAC address, and EtherType or length fields. Following the Ethernet header, the packet includes an IP header that may contain network layer routing information including source and destination IP addresses, protocol identifiers, and other IP-specific fields required for L3 routing decisions. A UDP header follows the IP header and may contain transport layer information including source and destination port numbers that may be used to identify specific services or applications. The packet includes a Carrier Protocol Encapsulating Header that may carry metadata specific to the encapsulation scheme. This header may include a PDU Version (Ver) field that indicates the version or format of the protocol PDU structure, enabling the Parser to correctly interpret the packet structure. A Source Node ID (SourceNodeID) field may identify the originating node in a format specific to the overlay network or fabric topology. A Destination Node ID (DestinationNodeID) field may identify the target node for routing within the overlay network. A Segmentation ID (SegmentID) field may be used for infrastructure virtualization, such as to provide isolation between different tenants or logical networks in multi-tenant environments. A PDU Sequence Number (PSN) field may provide ordering information for reliable delivery or reassembly of segmented messages. A Passenger Protocol (PassengerProt) field may identify the type of passenger protocol encapsulated within the PDU, such as CXL.io, CXL.cache, or CXL.mem, enabling the Parser to apply appropriate processing rules. The Passenger Protocol PDU section may contain the actual passenger protocol message, such as a CXL.mem PDU, that is being transported across the network. The Passenger Protocol PDU section may include the fields required by the passenger protocol specification, or a subset of the fields that enable reconstruction of the message, as further discussed below.

The packet further includes a Carrier Protocol Encapsulating Trailer that may carry additional metadata and integrity information. This trailer may include an Encapsulating CRC (E-CRC) field that provides error detection for the encapsulated portion of the packet, potentially offering stronger integrity protection than the standard Ethernet FCS. A Data Poisoning (Poison) field may be used to mark data that is known to be corrupted, allowing protocols such as CXL or UPI to propagate error indications across the network. A Reported Load (ReportedLoad) field may communicate congestion or load information from the source device, possibly augmented with congestion information from intermediate components along the path, such as CXL DevLoad indicators, enabling network-aware load balancing or congestion management. The packet structure may further include an optional Pad field that may be used to meet minimum frame size requirements of the carrier protocol, and may conclude with an Ethernet Frame Check Sequence (FCS) that provides error detection for the entire Ethernet frame according to Ethernet specifications.

FIG. 45C illustrates an example of a packet structure that may be suitable for Layer 2 (L2) switching operations. L2 switching typically refers to packet forwarding based on data link layer information, typically using MAC addresses to make forwarding decisions within a network segment or broadcast domain. The Carrier Protocol Optimized Header may contain condensed addressing or routing information suitable for L2 forwarding decisions. The Carrier Protocol Encapsulating Header, Passenger Protocol PDU, and Carrier Protocol Encapsulating Trailer may contain similar fields and serve similar functions as described for the L3 packet structure in FIG. 45B, adapted for the L2 switching context. The packet structure maintains the optional Pad field and Ethernet FCS for compatibility with the frame requirements as defined by the Ethernet specification.

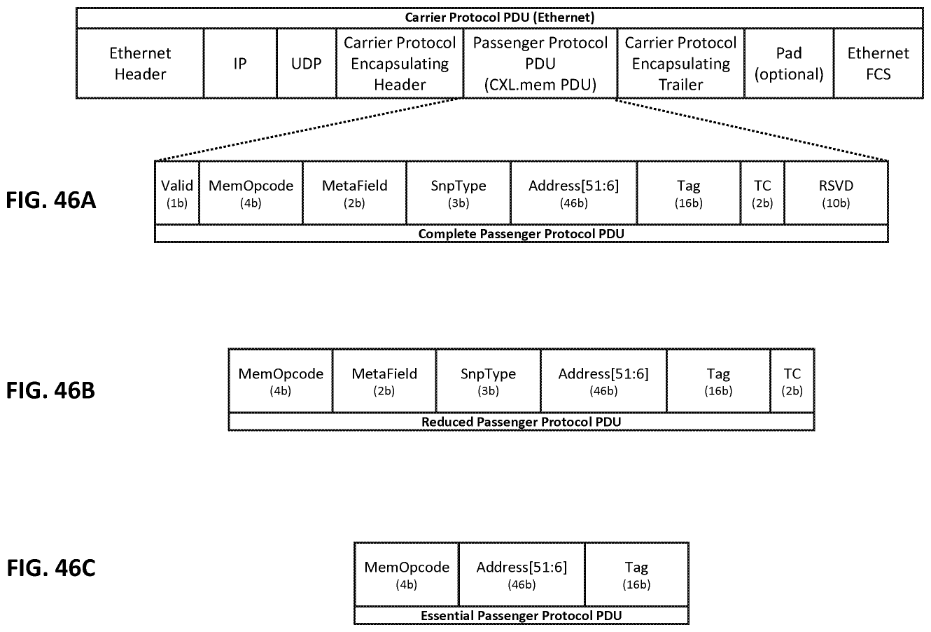

FIG. 46A to FIG. 46C illustrate three examples of variations for the Passenger Protocol PDU that may be encapsulated within the Carrier Protocol PDU illustrated in FIG. 45B. These variations illustrate different levels of field inclusion that may be utilized to optimize bandwidth utilization while maintaining the ability to reconstruct complete passenger protocol messages. The lower part of FIG. 46A illustrates a complete Passenger Protocol PDU for a CXL.mem message conforming to Revision 1.1 of the CXL Specification. The complete PDU includes the fields required by CXL.mem: a Valid field (1 bit) that indicates whether the message contains valid data, a MemOpcode field (4 bits) that specifies the memory operation type, a MetaField field (2 bits) that contains metadata about the transaction, a SnpType field (3 bits) that indicates the snoop type for cache coherency operations, an Address field (46 bits) that carries the physical address for the operation, a Tag field (16 bits) that provides a unique identifier for tracking the transaction, a TC field (2 bits) that may indicate traffic class or priority information, and a Reserved (RSVD) field (10 bits) that is reserved for future use or protocol compliance. This complete format may be utilized when full protocol compliance is required or when the carrier protocol has sufficient bandwidth to accommodate the fields.

FIG. 46B illustrates an example of a reduced Passenger Protocol PDU, wherein some of the fields that can be reconstructed are omitted from the Carrier PDU to reduce bandwidth requirements. The reduced PDU retains the MemOpcode field (4 bits), MetaField field (2 bits), SnpType field (3 bits), Address field (46 bits), Tag field (16 bits), and TC field (2 bits). The reconstructed fields, which are not included in the Carrier PDU but are required for a CXL device for parsing the CXL request, may be reconstructed by the Stream Editor of the RPU. For FIG. 46B, the fields to be reconstructed are the one bit Valid field and the 10 bits Reserved (RSVD) field. The Valid field may be reconstructed based on the presence of a well-formed PDU, while the RSVD field may be reconstructed using configured default values.

FIG. 46C illustrates an example of an essential Passenger Protocol PDU, which may include essentially the minimum fields required for basic operation of the passenger protocol. The essential PDU comprises the MemOpcode field (4 bits) that specifies the operation to be performed, the Address field (46 bits) that identifies the physical address, and the Tag field (16 bits) that enables transaction tracking and response correlation. The fields omitted from the essential PDU, including Valid, MetaField, SnpType, TC, and RSVD fields, may be reconstructed by the Stream Editor using protocol-specific default values or configuration parameters.

### TERMINOLOGY

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2C, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D 1.4 ), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### GENERAL CONSIDERATIONS

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or exchange/ exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A method comprising:
operating a computer coupled between a first interface that communicates according to an NVLink-based protocol with a first entity, and a second interface that communicates according to a PCI Express (PCIe) protocol with a second entity;
translating, by the computer, between NVLink-based Protocol Data Units (PDUs) communicated via the first interface and PCIe Transaction Layer Packets (TLPs) communicated via the second interface, wherein the translating comprises: translating physical addresses between a first address space associated with the NVLink-based protocol and a second address space associated with the PCIe protocol; and translating between NVLink-based request types and PCIe TLP types.

2. The method of claim 1, wherein the NVLink-based PDUs comprise an NVLink-based request from the first entity, the NVLink-based request comprising a first address in the first address space; wherein the PCIe TLPs comprise a PCIe Memory Read (MRd) request comprising a second address in the second address space; and wherein the translating further comprises translating the NVLink-based request to the PCIe MRd and sending the PCIe MRd to the second entity via the second interface.

3. The method of claim 2, wherein the PCIe TLPs further comprise a PCIe Completion with Data (CplD) from the second entity, the PCIe CplD comprising a data payload corresponding to the PCIe MRd; and wherein the translating further comprises translating the PCIe CplD to an NVLink-based response comprising the data payload.

4. The method of claim 1, wherein the PCIe TLPs comprise a PCIe Memory Read (MRd) request from the second entity, the PCIe MRd comprising a first address in the second address space; wherein the NVLink-based PDUs comprise an NVLink-based request comprising a second address in the first address space; and wherein the translating further comprises translating the PCIe MRd to the NVLink-based request and sending the NVLink-based request to the first entity via the first interface.

5. The method of claim 4, wherein the NVLink-based PDUs further comprise an NVLink-based response from the first entity, the NVLink-based response comprising a data payload; and wherein the translating further comprises translating the NVLink-based response to a PCIe Completion with Data (CplD) comprising the data payload.

6. The method of claim 5, wherein the PCIe MRd further comprises a RequesterID, and wherein the PCIe CplD further comprises a CompleterID and the RequesterID, and wherein the computer generates the CompleterID for the PCIe CplD.

7. The method of claim 4, wherein the PCIe MRd further comprises a RequesterID and a first Tag, and wherein the NVLink-based request further comprises a SourceID, a DestinationID, and a second Tag; and wherein translating the PCIe MRd to the NVLink-based request comprises generating the SourceID and the DestinationID, and translating the first Tag to the second Tag.

8. The method of claim 1, wherein the PCIe TLPs communicated via the second interface utilize a Flit Mode (FM) format, and wherein the first entity comprises a GPU or an accelerator, and the second entity comprises a PCIe host or a PCIe device.

9. The method of claim 1, wherein the computer translates between Flit Mode (FM) and Non-Flit Mode (NFM) TLP formats for the PCIe TLPs communicated via the second interface, and wherein the NVLink-based PDUs carry data associated with an artificial intelligence (AI) model comprising at least one of: a large language model (LLM), a mixture-of-experts (MoE) model, a multi-modal model, or a diffusion model.

10. The method of claim 1, wherein the PCIe TLPs carry a data payload not exceeding 64 Double Words (DWs), and wherein the computer translates an NVLink-based PDU to multiple PCIe TLPs.

11. The method of claim 1, wherein at least one physical address within the second address space, which is a PCIe memory address space, is not mapped to an NVLink address in the first address space, and wherein the NVLink-based PDUs and the PCIe TLPs carry data associated with an artificial intelligence (AI) workload, the data comprising at least one of: model weights, key-value (KV) cache entries, activation tensors, or embedding tables.

12. A non-transitory computer-readable medium comprising instructions which, when executed by a processor, cause the processor to perform the method of claim 1.

13. One or more integrated circuits configured to perform the method of claim 1, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

14. An active cable comprising first and second pluggable modules coupled by a physical medium; wherein the active cable further comprises hardware circuitry, integrated into the active cable, configured to perform the method of claim 1.

15. A system comprising:
a first interface configured to communicate according to an NVLink-based protocol with a first entity;
a second interface configured to communicate according to a PCI Express (PCIe) protocol with a second entity; and
a computer coupled between the first and second interfaces, configured to translate between NVLink-based traffic communicated via the first interface and PCIe traffic communicated via the second interface, comprising translating physical addresses between a first address space associated with the NVLink-based protocol and a second address space associated with the PCIe protocol.

16. The system of claim 15, wherein the computer is implemented in an IC package having differential input/output (I/O) balls positioned according to a ball grid array (BGA) layout, and wherein the system further comprises a cable including a first module and a second module coupled by a physical medium, the computer residing within the first module or the second module.

17. The system of claim 15, wherein the computer comprises an NVLink Fusion chiplet, and wherein an NVLink switch is coupled between the first interface and the first entity.

18. The system of claim 15, wherein the second interface operates in Flit Mode (FM), and wherein the NVLink-based traffic and the PCIe traffic carry data associated with an artificial intelligence (AI) workload comprising at least one of: model training, model inference, or model fine-tuning.

19. A method comprising:
operating a computer coupled between a first interface that communicates according to an NVLink-based protocol with a first entity, and a second interface that communicates according to a PCI Express (PCIe) protocol with a second entity;
translating, by the computer, between NVLink-based Protocol Data Units (PDUs) communicated via the first interface and PCIe UIO Transaction Layer Packets (TLPs) communicated via the second interface.

20. The method of claim 19, wherein the NVLink-based PDUs comprise an NVLink-based request from the first entity; wherein the PCIe UIO TLPs comprise a PCIe UIO Memory Read (UIOMRd) request; and wherein the translating further comprises translating the NVLink-based request to the PCIe UIOMRd and sending the PCIe UIOMRd to the second entity via the second interface.

21. The method of claim 20, wherein the PCIe UIO TLPs further comprise a PCIe UIO Read Completion with Data (UIORdCplD) from the second entity, the UIORdCplD comprising a data payload; and wherein the translating further comprises translating the UIORdCplD to an NVLink-based response comprising the data payload.

22. The method of claim 19, wherein the PCIe UIO TLPs comprise a PCIe UIO Memory Read (UIOMRd) request from the second entity; wherein the NVLink-based PDUs comprise an NVLink-based request; and wherein the translating further comprises translating the UIOMRd to the NVLink-based request and sending the NVLink-based request to the first entity via the first interface.

23. The method of claim 22, wherein the NVLink-based PDUs further comprise an NVLink-based response from the first entity, the NVLink-based response comprising a data payload; and
wherein the translating further comprises translating the NVLink-based response to a PCIe UIO Read Completion with Data (UIORdCplD) comprising the data payload.

24. The method of claim 19, wherein the translating further comprises translating physical addresses between a first address space associated with the NVLink-based protocol and a second address space associated with the PCIe protocol.

25. The method of claim 19, wherein the PCIe UIO TLPs carry a data payload not exceeding 64 Double Words (DWs), wherein the PCIe UIO TLPs are associated with a UIO Virtual Channel, and wherein the NVLink-based PDUs carry data associated with an artificial intelligence (AI) model comprising at least one of: a large language model (LLM), a mixture-of-experts (MoE) model, or a multi-modal model.

26. A non-transitory computer-readable medium comprising instructions which, when executed by a processor, cause the processor to perform the method of claim 19.

27. One or more integrated circuits configured to perform the method of claim 19, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

28. An active cable comprising first and second pluggable modules coupled by a physical medium; wherein the active cable further comprises hardware circuitry, integrated into the active cable, configured to perform the method of claim 19.

29. A system comprising:
a first interface configured to communicate according to an NVLink-based protocol with a first entity;
a second interface configured to communicate according to a PCI Express (PCIe) protocol with a second entity; and
a computer coupled between the first and second interfaces, configured to translate between NVLink-based traffic communicated via the first interface and PCIe UIO Transaction Layer Packets (TLPs) communicated via the second interface.

30. The system of claim 29, wherein at least one physical address within a PCIe memory address space is not mapped to an NVLink address, and wherein the first entity comprises a GPU, a CPU, or an accelerator, and the second entity comprises a PCIe host or a PCIe device.
